(19) United States
(12) Patent Application Publication
(10) Pub. No.: US 2015/0250174 A1
(43) Pub. Date: Sep. 10, 2015

(54) USE OF N-THIO-ANTHRANILAMIDE COMPOUNDS ON CULTIVATED PLANTS

(71) Applicant: BASF SE, Ludwigshafen (DE)

(72) Inventors: Matthias Pohlman, Freinsheim (DE); Karsten Körber, Eppelheim (DE); Jean-Yves Wach, Mannheim (DE); Florian Kaiser, Mannheim (DE); Prashant Deshmukh, Mannheim (DE); Deborah L. Culbertson, Fuquay Varina, NC (US); W. David Rogers, Durham, NC (US); Koshi Gunjima, Toyohashi (JP); Michael David, Raleigh, NC (US); Franz-Josef Braun, Durham, NC (US)

(21) Appl. No.: 14/432,295

(22) PCT Filed: Sep. 27, 2013
(86) PCT No.: PCT/EP2013/070146

§ 371 Date: Mar. 30, 2015

Related U.S. Application Data
(60) Provisional application No. 61/708,071, filed on Oct. 1, 2012.
(60) Provisional application No. 61/764,083, filed on Feb. 13, 2013.

(51) Int. Cl. A01N 43/56

(52) U.S. Cl. CPC A01N 43/56

(57) ABSTRACT

The present invention relates to agricultural methods for controlling pests and/or increasing the plant health of a cultivated plant with at least one modification, using anthranilamide compounds of formula (I)

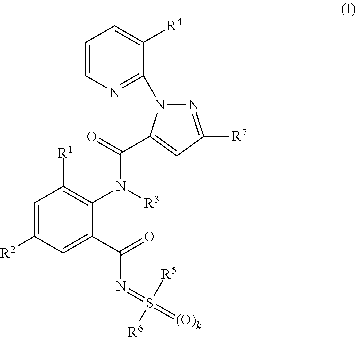

wherein R¹, R², R³, R⁴, R⁵, R⁶, R⁷ and k are as defined in the description;
and their mixtures.

The present invention relates to a method for controlling pests and/or increasing the plant health of a cultivated plant with at least one modification (hereinafter abbreviated as “cultivated plant”) as compared to the respective non-modified control plant, comprising the application of a pesticidally active compound of formula I

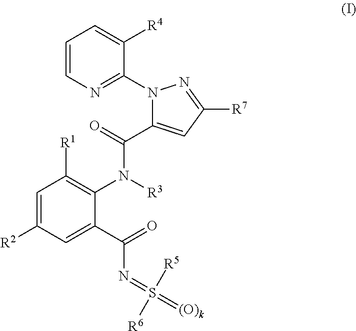

wherein
R¹ is selected from the group consisting of halogen, methyl and halomethyl;
R² is selected from the group consisting of hydrogen, halogen, halomethyl and cyano;
R³ is selected from hydrogen, C₁-C₆ alkyl, C₁-C₆ haloalkyl, C₂-C₆-alkenyl, C₂-C₆-haloalkenyl, C₂-C₆-alkinyl, C₂-C₆-haloalkinyl, C₃-C₈-cycloalkyl, C₃-C₈-halocycloalkyl, C₁-C₄-haloalkoxy-C₁-C₄-alkyl,
   C(═O)R^{a}, C(═O)OR^{b} and C(═O)NR^{c}R^{d};
R⁴ is hydrogen or halogen;
R⁵, R⁶ are selected independently of one another from the group consisting of hydrogen, C₁-C₁₀-alkyl, C₃-C₈-cycloalkyl, C₂-C₁₀-alkenyl, C₂-C₁₀-alkynyl, wherein the aforementioned aliphatic and cycloaliphatic radicals may be substituted with 1 to 10 substituents R^{e}, and phenyl, which is unsubstituted or carries 1 to 5 substituents R^{f}; or
   R⁵ and R⁶ together represent a C₂-C₇-alkylene, C₂-C₇-alkenylene or C₆-C₉-alkynylene chain forming together with the sulfur atom to which they are attached a 3-, 4-, 5-, 6-, 7-, 8-, 9- or 10-membered saturated, partially unsaturated or fully unsaturated ring, wherein 1 to 4 of the CH₂ groups in the C₂-C₇-alkylene chain or 1 to 4 of any of the CH₂ or CH groups in the C₂-C₇-alkenylene chain or 1 to 4 of any of the CH₂ groups in the C₆-C₉-alkynylene chain may be replaced by 1 to 4 groups independently selected from the group consisting of C═O, C═S, O, S, N, NO, SO, SO₂ and NH, and wherein the carbon and/or nitrogen atoms in the C₂-C₇-alkylene, C₂-C₇-alkenylene or C₆-C₉-alkynylene chain may be substituted with 1 to 5 substituents independently selected from the group consisting of halogen, cyano, C₁-C₆-alkyl, C₁-C₆-haloalkyl, C₁-C₆-alkoxy, C₁-C₆-haloalkoxy, C₁-C₆-alkylthio, C₁-C₆-haloalkylthio, C₃-C₈-cycloalkyl, C₃-C₈-halocycloalkyl, C₂-C₆-alkenyl, C₂-C₆-haloalkenyl, C₂-C₆-alkynyl and C₂-C₆-haloalkynyl; said substituents being identical or different from one another if more than one substituent is present;
R⁷ is selected from the group consisting of bromo, chloro, difluoromethyl, trifluoromethyl, nitro, cyano, OCH₃, OCHF₂, OCH₂F, OCH₂CF₃, S(═O)ₙCH₃, and S(═O)ₙCF₃;
R^{a} is selected from the group consisting of C₁-C₆-alkyl, C₂-C₆-alkenyl, C₂-C₆-alkinyl, C₃-C₈-cycloalkyl, C₁-C₆-alkoxy, C₁-C₆-alkylthio, C₁-C₆-alkylsulfinyl, C₁-C₆-alkylsulfonyl, wherein one or more CH₂ groups of the aforementioned radicals may be replaced by a C═O group, and/or the aliphatic and cycloaliphatic moieties of the aforementioned radicals may be unsubstituted, partially or fully halogenated and/or may carry 1 or 2 substituents selected from C₁-C₄ alkoxy;
   phenyl, benzyl, pyridyl and phenoxy, wherein the last four radicals may be unsubstituted, partially or fully halogenated and/or carry 1, 2 or 3 substituents selected from C₁-C₆-alkyl, C₁-C₆-haloalkyl, C₁-C₆-alkoxy, C₁-C₆-haloalkoxy, (C₁-C₆-alkoxy)carbonyl, C₁-C₆-alkylamino and di-(C₁-C₆-alkyl)amino,
R^{b} is selected from the group consisting of C₁-C₆-alkyl, C₂-C₆-alkenyl, C₂-C₆-alkinyl, C₃-C₈-cycloalkyl, C₁-C₆-alkoxy, C₁-C₆-alkylthio, C₁-C₆-alkylsulfinyl, C₁-C₆-alkylsulfonyl, wherein one or more CH₂ groups of the aforementioned radicals may be replaced by a C═O group, and/or the aliphatic and cycloaliphatic moieties of the aforementioned radicals may be unsubstituted, partially or fully halogenated and/or may carry 1 or 2 substituents selected from C₁-C₄-alkoxy;
   phenyl, benzyl, pyridyl and phenoxy, wherein the last four radicals may be unsubstituted, partially or fully halogenated and/or carry 1, 2 or 3 substituents selected from C₁-C₆-alkyl, C₁-C₆-haloalkyl, C₁-C₆-alkoxy, C₁-C₆-haloalkoxy and (C₁-C₆-alkoxy)carbonyl;
R^{c}, R^{d} are, independently from one another and independently of each occurrence, selected from the group consisting of hydrogen, cyano, C₁-C₆-alkyl, C₂-C₆-alkenyl, C₂-C₆-alkinyl, C₃-C₈-cycloalkyl, wherein one or more CH₂ groups of the aforementioned radicals may be replaced by a C═O group, and/or the aliphatic and cycloaliphatic moieties of the aforementioned radicals may be unsubstituted, partially or fully halogenated and/or may carry 1 or 2 radicals selected from C₁-C₄-alkoxy;
   C₁-C₆-alkoxy, C₁-C₆-haloalkoxy, C₁-C₆-alkylthio, C₁-C₆-alkylsulfinyl, C₁-C₆-alkylsulfonyl, C₁-C₆-haloalkylthio, phenyl, benzyl, pyridyl and phenoxy, wherein the four last mentioned radicals may be unsubstituted, partially or fully halogenated and/or carry 1, 2 or 3 substituents selected from C₁-C₆-alkyl, C₁-C₆-haloalkyl, C₁-C₆-alkoxy, C₁-C₆ haloalkoxy and (C₁-C₆-alkoxy)carbonyl; or
   R^{c} and R^{d}, together with the nitrogen atom to which they are bound, may form a 3-, 4-, 5-, 6- or 7-membered saturated, partially unsaturated or fully unsaturated heterocyclic ring which may additionally contain 1 or 2 further heteroatoms or heteroatom groups selected from N, O, S, NO, SO and SO₂, as ring members, where the heterocyclic ring may optionally be substituted with halogen, C₁-C₄-haloalkyl, C₁-C₄-alkoxy or C₁-C₄-haloalkoxy;
R^{e} is independently selected from the group consisting of halogen, cyano, nitro, —OH, —SH, —SCN, C₁-C₆-alkyl, C₂-C₆-alkenyl, C₂-C₆-alkinyl, C₃-C₈-cycloalkyl, wherein one or more CH₂ groups of the aforementioned radicals may be replaced by a C═O group, and/or the aliphatic and cycloaliphatic moieties of the aforementioned radicals may be unsubstituted, partially or fully halogenated and/or may carry 1 or 2 radicals selected from C₁-C₄ alkoxy;
   C₁-C₆-alkoxy, C₁-C₆-haloalkoxy, C₁-C₆-alkylthio, C₁-C₆-alkylsulfinyl, C₁-C₆-alkylsulfonyl, C₁-C₆-haloalkylthio, —OR^{a}, —NR^{c}R^{d}, —S(O)ₙR^{a}, —S(O)ₙNR^{c}R^{d}, —C(═O)R^{a}, —C(═O)NR^{c}R^{d}, —C(═O)OR^{b}, —C(═S)R^{a}, —C(═S)NR^{c}R^{d}, —C(═S)OR^{b}, —C(═S)SR^{b}, —C(═NR^{c})R^{b}, —C(═NR^{c})NR^{c}R^{d}, phenyl, benzyl, pyridyl and phenoxy, wherein the last four radicals may be unsubstituted, partially or fully halogenated and/or carry 1, 2 or 3 substituents selected from C₁-C₆-alkyl, C₁-C₆-haloalkyl, C₁-C₆-alkoxy and C₁-C₆-haloalkoxy; or
   two vicinal radicals R^{e} together form a group ═O, ═CH(C₁-C₄-alkyl), ═C(C₁-C₄-alkyl)C₁-C₄-alkyl, ═N(C₁-C₆-alkyl) or ═NO(C₁-C₆-alkyl);
R^{f} is independently selected from the group consisting of halogen, cyano, nitro, —OH, —SH, —SCN, C₁-C₆-alkyl, C₂-C₆-alkenyl, C₂-C₆-alkinyl, C₃-C₈-cycloalkyl, wherein one or more CH₂ groups of the aforementioned radicals may be replaced by a C═O group, and/or the aliphatic and cycloaliphatic moieties of the aforementioned radicals may be unsubstituted, partially or fully halogenated and/or may carry 1 or 2 radicals selected from C₁-C₄ alkoxy;
   C₁-C₆-alkoxy, C₁-C₆-haloalkoxy, C₁-C₆-alkylthio, C₁-C₆-alkylsulfinyl, C₁-C₆-alkylsulfonyl, C₁-C₆-haloalkylthio, —OR^{a}, —NR^{c}R^{d}, —S(O)ₙR^{a}, —S(O)ₙNR^{c}R^{d}, —C(═O)R^{a}, —C(═O)NR^{c}R^{d}, —C(═O)OR^{b}, —C(═S)R^{a}, —C(═S)NR^{c}R^{d}, —C(═S)OR^{b}, —C(═S)SR^{b}, —C(═NR^{c})R^{b}, and —C(═NR^{c})NR^{c}R^{d};
k is 0 or 1;
n is 0, 1 or 2;
or a stereoisomer, salt, tautomer or N-oxide, or a polymorphic crystalline form, a co-crystal or a solvate of a compound or a stereoisomer, salt, tautomer or N-oxide thereof;
   to a cultivated plant, parts of such plant, plant propagation material, or at its locus of growth.

The term “compound of formula (I) or a stereoisomer, salt, tautomer or N-oxide thereof” is understood to include a polymorphic crystalline form, a co-crystal or a solvate of a compound or a stereoisomer, salt, tautomer or N-oxide, even if not mentioned explicitly.

In some cases the compounds according to the invention may also be described as CP1. Analogously, the mixtures of the compounds according to the invention may be described as CP1 mixtures in some cases.

Compounds of Formula I

WO 2007/006670 describes N-thio-anthranilamide compounds with a sulfilimine or sulfoximine group and their use as pesticides. PCT/EP2012/065650, PCT/EP2012/065651, and the unpublished applications U.S. 61/578,267, U.S. 61/593,897 and U.S. 61/651,050 describe certain N-Thio-anthranilamide compounds and their use as pesticides.

PCT/EP2012/065648, PCT/EP2012/065649 and EP11189973.8 describe processes for the synthesis of N-Thio-anthranilamide compounds.

However, although the anthranilamide compounds of formula (I) themselves and their combined application with other insecticides are known to have shown activity against certain crop damaging insect pests, the compounds of formula I and some of their selected mixtures with pesticidally active compounds (II) have not yet been described for solving discussed problems as mentioned above.

Especially, their surprisingly excellent applicability for soil application techniques as well as seed treatment, and their extraordinary activity against soil-living pests have not been described previously.

The compounds of formula (I) as well as the terms “compounds for methods according to the (present) invention”, “compounds according to the (present) invention” or “compounds of formula (I)” or “compound(s) II”, which all compound(s) are applied in methods and uses according to the present invention comprise the compound(s) as defined herein as well as a known stereoisomer, salt, tautomer or N-oxide thereof (including a polymorphic crystalline form, a co-crystal or a solvate of a compound or a stereoisomer, salt, tautomer or N-oxide thereof).

The term “composition(s) according to the invention” or “composition(s) of the present invention” encompasses composition(s) comprising at least one compound of formula (I) or mixtures of the compounds of formula (I) with other pesticidally active compound(s) II for being used and/or applied in methods according to the invention as defined above.

Depending on the substitution pattern, the compounds of the formula (I) may have one or more centers of chirality, in which case they are present as mixtures of enantiomers or diastereomers. The invention provides both the pure enantiomers or pure diastereomers of the compounds of formula (I), and their mixtures and the use according to the invention of the pure enantiomers or pure diastereomers of the compound of formula (I) or its mixtures. Suitable compounds of the formula (I) also include all possible geometrical stereoisomers (cis/trans isomers) and mixtures thereof. Cis/trans isomers may be present with respect to an alkene, carbon-nitrogen double-bond, nitrogen-sulfur double bond or amide group. The term “stereoisomer(s)” encompasses both optical isomers, such as enantiomers or diastereomers, the latter existing due to more than one center of chirality in the molecule, as well as geometrical isomers (cis/trans isomers).

Salts of the compounds of the present invention are preferably agriculturally and veterinarily acceptable salts. They can be formed in a customary method, e.g. by reacting the compound with an acid if the compound of the present invention has a basic functionality or by reacting the compound with a suitable base if the compound of the present invention has an acidic functionality.

In general, suitable “agriculturally useful salts” or “agriculturally acceptable salts” are especially the salts of those cations or the acid addition salts of those acids whose cations and anions, respectively, do not have any adverse effect on the action of the compounds according to the present invention. Suitable cations are in particular the ions of the alkali metals, preferably lithium, sodium and potassium, of the alkaline earth metals, preferably calcium, magnesium and barium, and of the transition metals, preferably manganese, copper, zinc and iron, and also ammonium (NH₄⁺) and substituted ammonium in which one to four of the hydrogen atoms are replaced by C₁-C₄-alkyl, C₁-C₄-hydroxyalkyl, C₁-C₄-alkoxy, C₁-C₄-alkoxy-C₁-C₄-alkyl, hydroxy-C₁-C₄-alkoxy-C₁-C₄-alkyl, phenyl or benzyl. Examples of substituted ammonium ions comprise methylammonium, isopropylammonium, dimethylammonium, diisopropylammonium, trimethylammonium, tetramethylammonium, tetraethylammonium, tetrabutylammonium, 2-hydroxyethylammonium, 2-(2-hydroxyethoxyl)ethyl-ammonium, bis(2-hydroxyethyl)ammonium, benzyltrimethylammonium and benzyltriethylammonium, furthermore phosphonium ions, sulfonium ions, preferably tri(C₁-C₄-alkyl)sulfonium, and sulfoxonium ions, preferably tri(C₁-C₄-alkyl)sulfoxonium.

Anions of useful acid addition salts are primarily chloride, bromide, fluoride, hydrogen sulfate, sulfate, dihydrogen phosphate, hydrogen phosphate, phosphate, nitrate, hydrogen carbonate, carbonate, hexafluorosilicate, hexafluorophosphate, benzoate, and the anions of C₁-C₄-alkanoic acids, preferably formate, acetate, propionate and butyrate. They can be formed by reacting the compounds of the formulae I with an acid of the corresponding anion, preferably of hydrochloric acid, hydrobromic acid, sulfuric acid, phosphoric acid or nitric acid.

The compounds of the formula (I) may be present in the form of their N-oxides. The term “N-oxide”includes any compound of the present invention which has at least one tertiary nitrogen atom that is oxidized to an N-oxide moiety. N-oxides of compounds (I) can in particular be prepared by oxidizing the ring nitrogen atom(s) of the pyridine ring and/or the pyrazole ring with a suitable oxidizing agent, such as peroxo carboxylic acids or other peroxides. The person skilled in the art knows if and in which positions compounds of the formula (I) of the present invention may form N-oxides.

The compounds of the present invention may be amorphous or may exist in one ore more different crystalline states (polymorphs) which may have different macroscopic properties such as stability or show different biological properties such as activities. The present invention includes both amorphous and crystalline compounds of formula (I), their enantiomers or diastereomers, mixtures of different crystalline states of the respective compound of formula (I), its enantiomers or diastereomers, as well as amorphous or crystalline salts thereof.

The term “co-crystal” denotes a complex of the compounds according to the invention or a stereoisomer, salt, tautomer or N-oxide thereof, with one or more other molecules (preferably one molecule type), wherein usually the ratio of the compound according to the invention and the other molecule is a stoichiometric ratio.

The term “solvate” denotes a co-complex of the compounds according to the invention, or a stereoisomer, salt, tautomer or N-oxide thereof, with solvent molecules. The solvent is usually liquid. Examples of solvents are methanol, ethanol, toluol, xylol. A preferred solvent which forms solvates is water, which solvates are referred to as “hydrates”. A solvate or hydrate is usually characterized by the presence of a fixed number of n molecules solvent per m molecules compound according to the invention.

The organic moieties mentioned in the above definitions of the variables are—like the term halogen—collective terms for individual listings of the individual group members. The prefix Cₙ-Cₘ indicates in each case the possible number of carbon atoms in the group.

The term halogen denotes in each case fluorine, bromine, chlorine or iodine, in particular fluorine, chlorine or bromine.

The term “partially or fully halogenated” will be taken to mean that 1 or more, e.g. 1, 2, 3, 4 or 5 or all of the hydrogen atoms of a given radical have been replaced by a halogen atom, in particular by fluorine or chlorine. A partially or fully halogenated radical is termed below also “haloradical”. For example, partially or fully halogenated alkyl is also termed haloalkyl.

The term “alkyl” as used herein (and in the alkyl moieties of other groups comprising an alkyl group, e.g. alkoxy, alkylcarbonyl, alkylthio, alkylsulfinyl, alkylsulfonyl and alkoxyalkyl) denotes in each case a straight-chain or branched alkyl group having usually from 1 to 12 or 1 to 10 carbon atoms, frequently from 1 to 6 carbon atoms, preferably 1 to 4 carbon atoms and in particular from 1 to 3 carbon atoms. Examples of C₁-C₄-alkyl are methyl, ethyl, n-propyl, isopropyl, n-butyl, 2-butyl (sec-butyl), isobutyl and tert-butyl. Examples for C₁-C₆-alkyl are, apart those mentioned for C₁-C₄-alkyl, n-pentyl, 1-methylbutyl, 2-methylbutyl, 3-methylbutyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl and 1-ethyl-2-methylpropyl. Examples for C₁-C₁₀-alkyl are, apart those mentioned for C₁-C₆-alkyl, n-heptyl, 1-methylhexyl, 2-methylhexyl, 3-methylhexyl, 4-methylhexyl, 5-methylhexyl, 1-ethylpentyl, 2-ethylpentyl, 3-ethylpentyl, n-octyl, 1-methyloctyl, 2-methylheptyl, 1-ethylhexyl, 2-ethylhexyl, 1,2-dimethylhexyl, 1-propylpentyl, 2-propylpentyl, nonyl, decyl, 2-propylheptyl and 3-propylheptyl.

The term “alkylene” (or alkanediyl) as used herein in each case denotes an alkyl radical as defined above, wherein one hydrogen atom at any position of the carbon backbone is replaced by one further binding site, thus forming a bivalent moiety.

The term “haloalkyl” as used herein (and in the haloalkyl moieties of other groups comprising a haloalkyl group, e.g. haloalkoxy, haloalkylthio, haloalkylcarbonyl, haloalkylsulfonyl and haloalkylsulfinyl) denotes in each case a straight-chain or branched alkyl group having usually from 1 to 10 carbon atoms (“C₁-C₁₀-haloalkyl”), frequently from 1 to 6 carbon atoms (“C₁-C₆-haloalkyl”), more frequently 1 to 4 carbon atoms (“C₁-C₁₀-haloalkyl”), wherein the hydrogen atoms of this group are partially or totally replaced with halogen atoms. Preferred haloalkyl moieties are selected from C₁-C₄-haloalkyl, more preferably from C₁-C₂-haloalkyl, more preferably from halomethyl, in particular from C₁-C₂-fluoroalkyl. Halomethyl is methyl in which 1, 2 or 3 of the hydrogen atoms are replaced by halogen atoms. Examples are bromomethyl, chloromethyl, dichloromethyl, trichloromethyl, fluoromethyl, difluoromethyl, trifluoromethyl, chlorofluoromethyl, dichlorofluoromethyl, chlorodifluoromethyl and the like. Examples for C₁-C₂-fluoroalkyl are fluoromethyl, difluoromethyl, trifluoromethyl, 1-fluoroethyl, 2-fluoroethyl, 2,2-difluoroethyl, 2,2,2-trifluoroethyl, pentafluoroethyl, and the like. Examples for C₁-C₂-haloalkyl are, apart those mentioned for C₁-C₂-fluoroalkyl, chloromethyl, dichloromethyl, trichloromethyl, bromomethyl, chlorofluoromethyl, dichlorofluoromethyl, chlorodifluoromethyl, 1-chloroethyl, 2-chloroethyl, 2,2,-dichloroethyl, 2,2,2-trichloroethyl, 2-chloro-2-fluoroethyl, 2-chloro-2,2-difluoroethyl, 2,2-dichloro-2-fluoroethyl, 1-bromoethyl, and the like. Examples for C₁-C₄-haloalkyl are, apart those mentioned for C₁-C₂-haloalkyl, 1-fluoropropyl, 2-fluoropropyl, 3-fluoropropyl, 3,3-difluoropropyl, 3,3,3-trifluoropropyl, heptafluoropropyl, 1,1,1-trifluoroprop-2-yl, 3-chloropropyl, 4-chlorobutyl and the like.

The term “cycloalkyl” as used herein (and in the cycloalkyl moieties of other groups comprising a cycloalkyl group, e.g. cycloalkoxy and cycloalkylalkyl) denotes in each case a mono- or bicyclic cycloaliphatic radical having usually from 3 to 10 carbon atoms (“C₃-C₁₀-cycloalkyl”), preferably 3 to 8 carbon atoms (“C₃-C₈-cycloalkyl”) or in particular 3 to 6 carbon atoms (“C₃-C₆-cycloalkyl”). Examples of monocyclic radicals having 3 to 6 carbon atoms comprise cyclopropyl, cyclobutyl, cyclopentyl and cyclohexyl. Examples of monocyclic radicals having 3 to 8 carbon atoms comprise cyclopropyl, cyclobutyl, cyclopentyl, cyclohexyl, cycloheptyl and cyclooctyl. Examples of bicyclic radicals having 7 or 8 carbon atoms comprise bicyclo[2.1.1]hexyl, bicyclo[2.2.1]heptyl, bicyclo[3.1.1]heptyl, bicyclo[2.2.1]heptyl, bicyclo[2.2.2]octyl and bicyclo[3.2.1]octyl.

The term “cycloalkylene” (or cycloalkanediyl) as used herein in each case denotes an cycloalkyl radical as defined above, wherein one hydrogen atom at any position of the carbon backbone is replaced by one further binding site, thus forming a bivalent moiety.

The term “halocycloalkyl” as used herein (and in the halocycloalkyl moieties of other groups comprising an halocycloalkyl group, e.g. halocycloalkylmethyl) denotes in each case a mono- or bicyclic cycloaliphatic radical having usually from 3 to 10 carbon atoms, preferably 3 to 8 carbon atoms or in particular 3 to 6 carbon atoms, wherein at least one, e.g. 1, 2, 3, 4 or 5 of the hydrogen atoms are replaced by halogen, in particular by fluorine or chlorine. Examples are 1- and 2-fluorocyclopropyl, 1,2-, 2,2- and 2,3-difluorocyclopropyl, 1,2,2-trifluorocyclopropyl, 2,2,3,3-tetrafluorocyclpropyl, 1- and 2-chlorocyclopropyl, 1,2-, 2,2- and 2,3-dichlorocyclopropyl, 1,2,2-trichlorocyclopropyl, 2,2,3,3-tetrachlorocyclpropyl, 1-, 2- and 3-fluorocyclopentyl, 1,2-, 2,2-, 2,3-, 3,3-, 3,4-, 2,5-difluorocyclopentyl, 1-,2- and 3-chlorocyclopentyl, 1,2-, 2,2-, 2,3-, 3,3-, 3,4-, 2,5-dichlorocyclopentyl and the like.

The term “cycloalkyl-alkyl” used herein denotes a cycloalkyl group, as defined above, which is bound to the remainder of the molecule via an alkylene group. The term “C₃-C₈-cycloalkyl-C₁-C₄-alkyl” refers to a C₃-C₈-cycloalkyl group as defined above which is bound to the remainder of the molecule via a C₁-C₄-alkyl group, as defined above. Examples are cyclopropylmethyl, cyclopropylethyl, cyclopropylpropyl, cyclobutylmethyl, cyclobutylethyl, cyclobutylpropyl, cyclopentylmethyl, cyclopentylethyl, cyclopentylpropyl, cyclohexylmethyl, cyclohexylethyl, cyclohexylpropyl, and the like.

The term “alkenyl” as used herein denotes in each case a monounsaturated straight-chain or branched hydrocarbon radical having usually 2 to 10 (“C₂-C₁₀-alkenyl”), preferably 2 to 6 carbon atoms (“C₂-C₆-alkenyl”), in particular 2 to 4 carbon atoms (“C₂-C₄-alkenyl”), and a double bond in any position, for example C₂-C₄-alkenyl, such as ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl or 2-methyl-2-propenyl; C₂-C₆-alkenyl, such as ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl, 1-ethyl-2-methyl-2-propenyl and the like, or C₂-C₁₀-alkenyl, such as the radicals mentioned for C₂-C₆-alkenyl and additionally 1-heptenyl, 2-heptenyl, 3-heptenyl, 1-octenyl, 2-octenyl, 3-octenyl, 4-octenyl, 1-nonenyl, 2-nonenyl, 3-nonenyl, 4-nonenyl, 1-decenyl, 2-decenyl, 3-decenyl, 4-decenyl, 5-decenyl and the positional isomers thereof.

The term “alkenylene” (or alkenediyl) as used herein in each case denotes an alkenyl radical as defined above, wherein one hydrogen atom at any position of the carbon backbone is replaced by one further binding site, thus forming a bivalent moiety.

The term “haloalkenyl” as used herein, which may also be expressed as “alkenyl which may be substituted by halogen”, and the haloalkenyl moieties in haloalkenyloxy, haloalkenylcarbonyl and the like refers to unsaturated straight-chain or branched hydrocarbon radicals having 2 to 10 (“C₂-C₁₀-haloalkenyl”) or 2 to 6 (“C₂-C₆-haloalkenyl”) or 2 to 4 (“C₂-C₄-haloalkenyl”) carbon atoms and a double bond in any position, where some or all of the hydrogen atoms in these groups are replaced by halogen atoms as mentioned above, in particular fluorine, chlorine and bromine, for example chlorovinyl, chloroallyl and the like.

The term “alkynyl” as used herein denotes unsaturated straight-chain or branched hydrocarbon radicals having usually 2 to 10 (“C₂-C₁₀-alkynyl”), frequently 2 to 6 (“C₂-C₆-alkynyl”), preferably 2 to 4 carbon atoms (“C₂-C₄-alkynyl”) and one or two triple bonds in any position, for example C₂-C₄-alkynyl, such as ethynyl, 1-propynyl, 2-propynyl, 1-butynyl, 2-butynyl, 3-butynyl, 1-methyl-2-propynyl and the like, C₂-C₆-alkynyl, such as ethynyl, 1-propynyl, 2-propynyl, 1-butynyl, 2-butynyl, 3-butynyl, 1-methyl-2-propynyl, 1-pentynyl, 2-pentynyl, 3-pentynyl, 4-pentynyl, 1-methyl-2-butynyl, 1-methyl-3-butynyl, 2-methyl-3-butynyl, 3-methyl-1-butynyl, 1,1-dimethyl-2-propynyl, 1-ethyl-2-propynyl, 1-hexynyl, 2-hexynyl, 3-hexynyl, 4-hexynyl, 5-hexynyl, 1-methyl-2-pentynyl, 1-methyl-3-pentynyl, 1-methyl-4-pentynyl, 2-methyl-3-pentynyl, 2-methyl-4-pentynyl, 3-methyl-1-pentynyl, 3-methyl-4-pentynyl, 4-methyl-1-pentynyl, 4-methyl-2-pentynyl, 1,1-dimethyl-2-butynyl, 1,1-dimethyl-3-butynyl, 1,2-dimethyl-3-butynyl, 2,2-dimethyl-3-butynyl, 3,3-dimethyl-1-butynyl, 1-ethyl-2-butynyl, 1-ethyl-3-butynyl, 2-ethyl-3-butynyl, 1-ethyl-1-methyl-2-propynyl and the like.

The term “alkynylene” (or alkynediyl) as used herein in each case denotes an alkynyl radical as defined above, wherein one hydrogen atom at any position of the carbon backbone is replaced by one further binding site, thus forming a bivalent moiety.

The term “haloalkynyl” as used herein, which is also expressed as “alkynyl which may be substituted by halogen”, refers to unsaturated straight-chain or branched hydrocarbon radicals having usually 3 to 10 carbon atoms (“C₂-C₁₀-haloalkynyl”), frequently 2 to 6 (“C₂-C₆-haloalkynyl”), preferably 2 to 4 carbon atoms (“C₂-C₄-haloalkynyl”), and one or two triple bonds in any position (as mentioned above), where some or all of the hydrogen atoms in these groups are replaced by halogen atoms as mentioned above, in particular fluorine, chlorine and bromine.

The term “alkoxy” as used herein denotes in each case a straight-chain or branched alkyl group usually having from 1 to 10 carbon atoms (“C₁-C₁₀-alkoxy”), frequently from 1 to 6 carbon atoms (“C₁-C₆-alkoxy”), preferably 1 to 4 carbon atoms (“C₁-C₄-alkoxy”), which is bound to the remainder of the molecule via an oxygen atom. C₁-C₂-Alkoxy is methoxy or ethoxy. C₁-C₄-Alkoxy is additionally, for example, n-propoxy, 1-methylethoxy (isopropoxy), butoxy, 1-methylpropoxy (sec-butoxy), 2-methylpropoxy (isobutoxy) or 1,1-dimethylethoxy (tert-butoxy). C₁-C₆-Alkoxy is additionally, for example, pentoxy, 1-methylbutoxy, 2-methylbutoxy, 3-methylbutoxy, 1,1-dimethylpropoxy, 1,2-dimethylpropoxy, 2,2-dimethylpropoxy, 1-ethylpropoxy, hexoxy, 1-methylpentoxy, 2-methylpentoxy, 3-methylpentoxy, 4-methylpentoxy, 1,1-dimethylbutoxy, 1,2-dimethylbutoxy, 1,3-dimethylbutoxy, 2,2-dimethylbutoxy, 2,3-dimethylbutoxy, 3,3-dimethylbutoxy, 1-ethylbutoxy, 2-ethylbutoxy, 1,1,2-trimethylpropoxy, 1,2,2-trimethylpropoxy, 1-ethyl-1-methylpropoxy or 1-ethyl-2-methylpropoxy. C₁-C₈-Alkoxy is additionally, for example, heptyloxy, octyloxy, 2-ethylhexyloxy and positional isomers thereof. C₁-C₁₀-Alkoxy is additionally, for example, nonyloxy, decyloxy and positional isomers thereof.

The term “haloalkoxy” as used herein denotes in each case a straight-chain or branched alkoxy group, as defined above, having from 1 to 10 carbon atoms (“C₁-C₁₀-haloalkoxy”), frequently from 1 to 6 carbon atoms (“C₁-C₆-haloalkoxy”), preferably 1 to 4 carbon atoms (“C₁-C₄-haloalkoxy”), more preferably 1 to 3 carbon atoms (“C₁-C₃-haloalkoxy”), wherein the hydrogen atoms of this group are partially or totally replaced with halogen atoms, in particular fluorine atoms. C₁-C₂-Haloalkoxy is, for example, OCH₂F, OCHF₂, OCF₃, OCH₂Cl, OCHCl₂, OCCl₃, chlorofluoromethoxy, dichlorofluoromethoxy, chlorodifluoromethoxy, 2-fluoroethoxy, 2-chloroethoxy, 2-bromoethoxy, 2-iodoethoxy, 2,2-difluoroethoxy, 2,2,2-trifluoroethoxy, 2-chloro-2-fluoroethoxy, 2-chloro-2,2-difluoroethoxy, 2,2-dichloro-2-fluoroethoxy, 2,2,2-trichloroethoxy or OC₂F₅. C₁-C₄-Haloalkoxy is additionally, for example, 2-fluoropropoxy, 3-fluoropropoxy, 2,2-difluoropropoxy, 2,3-difluoropropoxy, 2-chloropropoxy, 3-chloropropoxy, 2,3-dichloropropoxy, 2-bromopropoxy, 3-bromopropoxy, 3,3,3-trifluoropropoxy, 3,3,3-trichloropropoxy, OCH₂—C₂F₅, OCF₂—C₂F₅, 1-(CH₂F)-2-fluoroethoxy, 1-(CH₂Cl)-2-chloroethoxy, 1-(CH₂Br)-2-bromoethoxy, 4-fluorobutoxy, 4-chlorobutoxy, 4-bromobutoxy or nonafluorobutoxy. C₁-C₆-Haloalkoxy is additionally, for example, 5-fluoropentoxy, 5-chloropentoxy, 5-brompentoxy, 5-iodopentoxy, undecafluoropentoxy, 6-fluorohexoxy, 6-chlorohexoxy, 6-bromohexoxy, 6-iodohexoxy or dodecafluorohexoxy.

The term “alkoxyalkyl” as used herein denotes in each case alkyl usually comprising 1 to 6 carbon atoms, preferably 1 to 4 carbon atoms, wherein 1 carbon atom carries an alkoxy radical usually comprising 1 to 10, frequently 1 to 6, in particular 1 to 4, carbon atoms as defined above. “C₁-C₆-Alkoxy-C₁-C₆-alkyl” is a C₁-C₆-alkyl group, as defined above, in which one hydrogen atom is replaced by a C₁-C₆-alkoxy group, as defined above. Examples are CH₂OCH₃, CH₂—OC₂H₅, n-propoxymethyl, CH₂—OCH(CH₃)₂, n-butoxymethyl, (1-methylpropoxy)-methyl, (2-methylpropoxy)methyl, CH₂—OC(CH₃)₃, 2-(methoxy)ethyl, 2-(ethoxy)ethyl, 2-(n-propoxy)-ethyl, 2-(1-methylethoxy)-ethyl, 2-(n-butoxy)ethyl, 2-(1-methylpropoxy)-ethyl, 2-(2-methylpropoxy)-ethyl, 2-(1,1-dimethylethoxy)-ethyl, 2-(methoxy)-propyl, 2-(ethoxy)-propyl, 2-(n-propoxy)-propyl, 2-(1-methylethoxy)-propyl, 2-(n-butoxy)-propyl, 2-(1-methylpropoxy)-propyl, 2-(2-methylpropoxy)-propyl, 2-(1,1-dimethylethoxy)-propyl, 3-(methoxy)-propyl, 3-(ethoxy)-propyl, 3-(n-propoxy)-propyl, 3-(1-methylethoxy)-propyl, 3-(n-butoxy)-propyl, 3-(1-methylpropoxy)-propyl, 3-(2-methylpropoxy)-propyl, 3-(1,1-dimethylethoxy)-propyl, 2-(methoxy)-butyl, 2-(ethoxy)-butyl, 2-(n-propoxy)-butyl, 2-(1-methylethoxy)-butyl, 2-(n-butoxy)-butyl, 2-(1-methylpropoxy)-butyl, 2-(2-methylpropoxy)-butyl, 2-(1,1-dimethylethoxy)-butyl, 3-(methoxy)-butyl, 3-(ethoxy)-butyl, 3-(n-propoxy)-butyl, 3-(1-methylethoxy)-butyl, 3-(n-butoxy)-butyl, 3-(1-methylpropoxy)-butyl, 3-(2-methylpropoxy)-butyl, 3-(1,1-dimethylethoxy)-butyl, 4-(methoxy)-butyl, 4-(ethoxy)-butyl, 4-(n-propoxy)-butyl, 4-(1-methylethoxy)-butyl, 4-(n-butoxy)-butyl, 4-(1-methylpropoxy)-butyl, 4-(2-methylpropoxy)-butyl, 4-(1,1-dimethylethoxy)-butyl and the like.

The term “haloalkoxy-alkyl” as used herein denotes in each case alkyl as defined above, usually comprising 1 to 6 carbon atoms, preferably 1 to 4 carbon atoms, wherein 1 carbon atom carries an haloalkoxy radical as defined above, usually comprising 1 to 10, frequently 1 to 6, in particular 1 to 4, carbon atoms as defined above. Examples are fluoromethoxymethyl, difluoromethoxymethyl, trifluoromethoxymethyl, 1-fluoroethoxymethyl, 2-fluoroethoxymethyl, 1,1-difluoroethoxymethyl, 1,2-difluoroethoxymethyl, 2,2-difluoroethoxymethyl, 1,1,2-trifluoroethoxymethyl, 1,2,2-trifluoroethoxymethyl, 2,2,2-trifluoroethoxymethyl, pentafluoroethoxymethyl, 1-fluoroethoxy-1-ethyl, 2-fluoroethoxy-1-ethyl, 1,1-difluoroethoxy-1-ethyl, 1,2-difluoroethoxy-1-ethyl, 2,2-difluoroethoxy-1-ethyl, 1,1,2-trifluoroethoxy-1-ethyl, 1,2,2-trifluoroethoxy-1-ethyl, 2,2,2-trifluoroethoxy-1-ethyl, pentafluoroethoxy-1-ethyl, 1-fluoroethoxy-2-ethyl, 2-fluoroethoxy-2-ethyl, 1,1-difluoroethoxy-2-ethyl, 1,2-difluoroethoxy-2-ethyl, 2,2-difluoroethoxy-2-ethyl, 1,1,2-trifluoroethoxy-2-ethyl, 1,2,2-trifluoroethoxy-2-ethyl, 2,2,2-trifluoroethoxy-2-ethyl, pentafluoroethoxy-2-ethyl, and the like.

The term “alkylthio” (also alkylsulfanyl or alkyl-S—)” as used herein denotes in each case a straight-chain or branched saturated alkyl group as defined above, usually comprising 1 to 10 carbon atoms (“C₁-C₁₀-alkylthio”), frequently comprising 1 to 6 carbon atoms (“C₁-C₆-alkylthio”), preferably 1 to 4 carbon atoms (“C₁-C₄-alkylthio”), which is attached via a sulfur atom at any position in the alkyl group. C₁-C₂-Alkylthio is methylthio or ethylthio. C₁-C₄-Alkylthio is additionally, for example, n-propylthio, 1-methylethylthio (isopropylthio), butylthio, 1-methylpropylthio (secbutylthio), 2-methylpropylthio (isobutylthio) or 1,1-dimethylethylthio (tert-butylthio). C₁-C₆-Alkylthio is additionally, for example, pentylthio, 1-methylbutylthio, 2-methylbutylthio, 3-methylbutylthio, 1,1-dimethylpropylthio, 1,2-dimethylpropylthio, 2,2-dimethylpropylthio, 1-ethylpropylthio, hexylthio, 1-methylpentylthio, 2-methylpentylthio, 3-methylpentylthio, 4-methylpentylthio, 1,1-dimethylbutylthio, 1,2-dimethylbutylthio, 1,3-dimethylbutylthio, 2,2-dimethylbutylthio, 2,3-dimethylbutylthio, 3,3-dimethylbutylthio, 1-ethylbutylthio, 2-ethylbutylthio, 1,1,2-trimethylpropylthio, 1,2,2-trimethylpropylthio, 1-ethyl-1-methylpropylthio or 1-ethyl-2-methylpropylthio. C₁-C₈-Alkylthio is additionally, for example, heptylthio, octylthio, 2-ethylhexylthio and positional isomers thereof. C₁-C₁₀-Alkylthio is additionally, for example, nonylthio, decylthio and positional isomers thereof.

The term “haloalkylthio” as used herein refers to an alkylthio group as defined above wherein the hydrogen atoms are partially or fully substituted by fluorine, chlorine, bromine and/or iodine. C₁-C₂-Haloalkylthio is, for example, SCH₂F, SCHF₂, SCF₃, SCH₂Cl, SCHCl₂, SCCl₃, chlorofluoromethylthio, dichlorofluoromethylthio, chlorodifluoromethylthio, 2-fluoroethylthio, 2-chloroethylthio, 2-bromoethylthio, 2-iodoethylthio, 2,2-difluoroethylthio, 2,2,2-trifluoroethylthio, 2-chloro-2-fluoroethylthio, 2-chloro-2,2-difluoroethylthio, 2,2-dichloro-2-fluoroethylthio, 2,2,2-trichloroethylthio or SC₂F₅. C₁-C₄-Haloalkylthio is additionally, for example, 2-fluoropropylthio, 3-fluoropropylthio, 2,2-difluoropropylthio, 2,3-difluoropropylthio, 2-chloropropylthio, 3-chloropropylthio, 2,3-dichloropropylthio, 2-bromopropylthio, 3-bromopropylthio, 3,3,3-trifluoropropylthio, 3,3,3-trichloropropylthio, SCH₂—C₂F₅, SCF₂—C₂F₅, 1-(CH₂F)-2-fluoroethylthio, 1-(CH₂Cl)-2-chloroethylthio, 1-(CH₂Br)-2-bromoethylthio, 4-fluorobutylthio, 4-chlorobutylthio, 4-bromobutylthio or nonafluorobutylthio. C₁-C₆-Haloalkylthio is additionally, for example, 5-fluoropentylthio, 5-chloropentylthio, 5-brompentylthio, 5-iodopentylthio, undecafluoropentylthio, 6-fluorohexylthio, 6-chlorohexylthio, 6-bromohexylthio, 6-iodohexylthio or dodecafluorohexylthio.

The terms “alkylsulfinyl” and “S(O)ₙ-alkyl” (wherein n is 1) are equivalent and, as used herein, denote an alkyl group, as defined above, attached via a sulfinyl [S(O)] group. For example, the term “C₁-C₂-alkylsulfinyl” refers to a C₁-C₂-alkyl group, as defined above, attached via a sulfinyl [S(O)] group. The term “C₁-C₄-alkylsulfinyl” refers to a C₁-C₄-alkyl group, as defined above, attached via a sulfinyl [S(O)] group. The term “C₁-C₆-alkylsulfinyl” refers to a C₁-C₆-alkyl group, as defined above, attached via a sulfinyl [S(O)] group. C₁-C₂-alkylsulfinyl is methylsulfinyl or ethylsulfinyl. C₁-C₄-alkylsulfinyl is additionally, for example, n-propylsulfinyl, 1-methylethylsulfinyl (isopropylsulfinyl), butylsulfinyl, 1-methylpropylsulfinyl (sec-butylsulfinyl), 2-methylpropylsulfinyl (isobutylsulfinyl) or 1,1-dimethylethylsulfinyl (tert-butylsulfinyl). C₁-C₆-alkylsulfinyl is additionally, for example, pentylsulfinyl, 1-methylbutylsulfinyl, 2-methylbutylsulfinyl, 3-methylbutylsulfinyl, 1,1-dimethylpropylsulfinyl, 1,2-dimethylpropylsulfinyl, 2,2-dimethylpropylsulfinyl, 1-ethylpropylsulfinyl, hexylsulfinyl, 1-methylpentylsulfinyl, 2-methylpentylsulfinyl, 3-methylpentylsulfinyl, 4-methylpentylsulfinyl, 1,1-dimethylbutylsulfinyl, 1,2-dimethylbutylsulfinyl, 1,3-dimethylbutylsulfinyl, 2,2-dimethylbutylsulfinyl, 2,3-dimethylbutylsulfinyl, 3,3-dimethylbutylsulfinyl, 1-ethylbutylsulfinyl, 2-ethylbutylsulfinyl, 1,1,2-trimethylpropylsulfinyl, 1,2,2-trimethylpropylsulfinyl, 1-ethyl-1-methylpropylsulfinyl or 1-ethyl-2-methylpropylsulfinyl.

The terms “alkylsulfonyl” and “S(O)ₙ-alkyl” (wherein n is 2) are equivalent and, as used herein, denote an alkyl group, as defined above, attached via a sulfonyl [S(O)₂] group. The term “C₁-C₂-alkylsulfonyl” refers to a C₁-C₂-alkyl group, as defined above, attached via a sulfonyl [S(O)₂] group. The term “C₁-C₄-alkylsulfonyl” refers to a C₁-C₄-alkyl group, as defined above, attached via a sulfonyl [S(O)₂] group. The term “C₁-C₆-alkylsulfonyl” refers to a C₁-C₆-alkyl group, as defined above, attached via a sulfonyl [S(O)₂] group. C₁-C₂-alkylsulfonyl is methylsulfonyl or ethylsulfonyl. C₁-C₄-alkylsulfonyl is additionally, for example, n-propylsulfonyl, 1-methylethylsulfonyl (isopropylsulfonyl), butylsulfonyl, 1-methylpropylsulfonyl (sec-butylsulfonyl), 2-methylpropylsulfonyl (isobutylsulfonyl) or 1,1-dimethylethylsulfonyl (tert-butylsulfonyl). C₁-C₆-alkylsulfonyl is additionally, for example, pentylsulfonyl, 1-methylbutylsulfonyl, 2-methylbutylsulfonyl, 3-methylbutylsulfonyl, 1,1-dimethylpropylsulfonyl, 1,2-dimethylpropylsulfonyl, 2,2-dimethylpropylsulfonyl, 1-ethylpropylsulfonyl, hexylsulfonyl, 1-methylpentylsulfonyl, 2-methylpentylsulfonyl, 3-methylpentylsulfonyl, 4-methylpentylsulfonyl, 1,1-dimethylbutylsulfonyl, 1,2-dimethylbutylsulfonyl, 1,3-dimethylbutylsulfonyl, 2,2-dimethylbutylsulfonyl, 2,3-dimethylbutylsulfonyl, 3,3-dimethylbutylsulfonyl, 1-ethylbutylsulfonyl, 2-ethylbutylsulfonyl, 1,1,2-trimethylpropylsulfonyl, 1,2,2-trimethylpropylsulfonyl, 1-ethyl-1-methylpropylsulfonyl or 1-ethyl-2-methylpropylsulfonyl.

The term “alkylamino” as used herein denotes in each case a group —NHR, wherein R is a straight-chain or branched alkyl group usually having from 1 to 6 carbon atoms (“C₁-C₆-alkylamino”), preferably 1 to 4 carbon atoms (“C₁-C₄-alkylamino”). Examples of C₁-C₆-alkylamino are methylamino, ethylamino, n-propylamino, isopropylamino, n-butylamino, 2-butylamino, isobutylamino, tert-butylamino, and the like.

The term “dialkylamino” as used herein denotes in each case a group-NRR′, wherein R and R′, independently of each other, are a straight-chain or branched alkyl group each usually having from 1 to 6 carbon atoms (“di-(C₁-C₆-alkyl)-amino”), preferably 1 to 4 carbon atoms (“di-(C₁-C₄-alkyl)-amino”). Examples of a di-(C₁-C₆-alkyl)-amino group are dimethylamino, diethylamino, dipropylamino, dibutylamino, methyl-ethyl-amino, methyl-propyl-amino, methyl-isopropylamino, methyl-butyl-amino, methyl-isobutyl-amino, ethyl-propyl-amino, ethyl-isopropylamino, ethyl-butyl-amino, ethyl-isobutyl-amino, and the like.

The term “cycloalkylamino” as used herein denotes in each case a group —NHR, wherein R is a cycloalkyl group usually having from 3 to 8 carbon atoms (“C₃-C₈-cycloalkylamino”), preferably 3 to 6 carbon atoms (“C₃-C₆-cycloalkylamino”). Examples of C₃-C₈-cycloalkylamino are cyclopropylamino, cyclobutylamino, cyclopentylamino, cyclohexylamino, and the like.

The term “alkylaminosulfonyl” as used herein denotes in each case a straight-chain or branched alkylamino group as defined above, which is bound to the remainder of the molecule via a sulfonyl [S(O)₂] group. Examples of an alkylaminosulfonyl group are methylaminosulfonyl, ethylaminosulfonyl, n-propylaminosulfonyl, isopropylaminosulfonyl, n-butylaminosulfonyl, 2-butylaminosulfonyl, iso-butylaminosulfonyl, tert-butylaminosulfonyl, and the like. The term “dialkylaminosulfonyl” as used herein denotes in each case a straight-chain or branched alkylamino group as defined above, which is bound to the remainder of the molecule via a sulfonyl [S(O)₂] group. Examples of an dialkylaminosulfonyl group are dimethylaminosulfonyl, diethylaminosulfonyl, dipropylaminosulfonyl, dibutylaminosulfonyl, methyl-ethylaminosulfonyl, methyl-propyl-aminosulfonyl, methyl-isopropylaminosulfonyl, methyl-butyl-aminosulfonyl, methyl-isobutyl-aminosulfonyl, ethyl-propyl-aminosulfonyl, ethylisopropylaminosulfonyl, ethyl-butyl-aminosulfonyl, ethyl-isobutyl-aminosulfonyl, and the like.

The suffix “-carbonyl” in a group denotes in each case that the group is bound to the remainder of the molecule via a carbonyl C═O group. This is the case e.g. in alkylcarbonyl, haloalkylcarbonyl, aminocarbonyl, alkylaminocarbonyl, dialkylaminocarbonyl, alkoxycarbonyl, haloalkoxycarbonyl.

The term “aryl” as used herein refers to a mono-, bi- or tricyclic aromatic hydrocarbon radical such as phenyl or naphthyl, in particular phenyl.

The term “het(ero)aryl” as used herein refers to a mono-, bi- or tricyclic heteroaromatic hydrocarbon radical, preferably to a monocyclic heteroaromatic radical, such as pyridyl, pyrimidyl and the like.

A saturated, partially unsaturated or unsaturated 3- to 8-membered ring system which contains 1 to 4 heteroatoms selected from oxygen, nitrogen, sulfur, is a ring system wherein two oxygen atoms must not be in adjacent positions and wherein at least 1 carbon atom must be in the ring system e.g. thiophene, furan, pyrrole, thiazole, oxazole, imidazole, isothiazole, isoxazole, pyrazole, 1,3,4-oxadiazole, 1,3,4-thiadiazole, 1,3,4-triazole, 1,2,4-oxadiazole, 1,2,4-thiadiazole, 1,2,4-triazole, 1,2,3-triazole, 1,2,3,4-tetrazole, benzo[b]thiophene, benzo[b]furan, indole, benzo[c]thiophene, benzo[c]furan, isoindole, benzoxazole, benzthiazole, benzimidazole, benzisoxazole, benzisothiazole, benzopyrazole, benzothiadiazole, benztriazole, dibenzofuran, dibenzothiophene, carbazole, pyridine, pyrazine, pyrimidine, pyridazine, 1,3,5-triazine, 1,2,4-triazine, 1,2,4,5-tetrazine, quinoline, isoquinoline, quinoxaline, quinazoline, cinnoline, 1,8-naphthyridine, 1,5-naphthyridine, 1,6-naphthyridine, 1,7-naphthyridine, phthalazine, pyridopyrimidine, purine, pteridine, 4H-quinolizine, piperidine, pyrrolidine, oxazoline, tetrahydrofuran, tetrahydropyran, isoxazolidine or thiazolidine, oxirane or oxetane.

A saturated, partially unsaturated or unsaturated 3- to 8-membered ring system which contains 1 to 4 heteroatoms selected from oxygen, nitrogen, sulfur also is e.g.

a saturated, partially unsaturated or unsaturated 5- or 6-membered heterocycle which contains 1 to 4 heteroatoms selected from oxygen, nitrogen and sulfur, such as pyridine, pyrimidine, (1,2,4)-oxadiazole, (1,3,4)-oxadiazole, pyrrole, furan, thiophene, oxazole, thiazole, imidazole, pyrazole, isoxazole, 1,2,4-triazole, tetrazole, pyrazine, pyridazine, oxazoline, thiazoline, tetrahydrofuran, tetrahydropyran, morpholine, piperidine, piperazine, pyrroline, pyrrolidine, oxazolidine, thiazolidine; or
a saturated, partially unsaturated or unsaturated 5- or 6-membered heterocycle which contains 1 nitrogen atom and 0 to 2 further heteroatoms selected from oxygen, nitrogen and sulfur, preferably from oxygen and nitrogen, such as piperidine, piperazin and morpholine.

Preferably, this ring system is a saturated, partially unsaturated or unsaturated 3- to 6-membered ring system which contains 1 to 4 heteroatoms selected from oxygen, nitrogen, sulfur, wherein two oxygen atoms must not be in adjacent positions and wherein at least 1 carbon atom must be in the ring system.

Most preferably, this ring system is a radical of pyridine, pyrimidine, (1,2,4)-oxadiazole, 1,3,4-oxadiazole, pyrrole, furan, thiophene, oxazole, thiazole, imidazole, pyrazole, isoxazole, 1,2,4-triazole, tetrazole, pyrazine, pyridazine, oxazoline, thiazoline, tetrahydrofuran, tetrahydropyran, morpholine, piperidine, piperazine, pyrroline, pyrrolidine, oxazolidine, thiazolidine, oxirane or oxetane.

Preparation of the compounds of formula I can be accomplished according to standard methods of organic chemistry, e.g. by the methods or working examples described in WO 2007/006670, PCT/EP2012/065650 and PCT/EP2012/065651, without being limited to the routes given therein. The preparation of the compounds of formula I above may lead to them being obtained as isomer mixtures. If desired, these can be resolved by the methods customary for this purpose, such as crystallization or chromatography, also on optically active adsorbate, to give the pure isomers.

Agronomically acceptable salts of the compounds I can be formed in a customary manner, e.g. by reaction with an acid of the anion in question.

Preferences

The remarks made below as to preferred embodiments of the variables (substituents) of the compounds of formulae (I) are valid on their own as well as preferably in combination with each other, as well as in combination with the stereoisomers, tautomers, N-oxides or salts thereof, and, where applicable, as well as concerning the uses and methods according to the invention and the compositions according to the invention.

Preferred compounds according to the invention are compounds of formulae (I) or a stereoisomer, N-oxide or salt thereof, wherein the salt is an agriculturally or veterinarily acceptable salt. The compounds I of formula (I) and their examples include their tautomers, racemic mixtures, individual pure enantiomers and diastereomers and their optically active mixtures.

Preferred are methods and uses of compounds of formula (I), wherein the compound of formula I is a compound of formula IA:

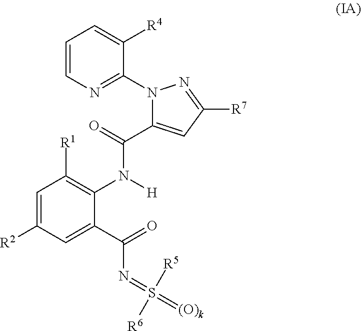

wherein
R⁴ is halogen, and
wherein the variables R¹, R², R⁷, R⁵, R⁶ and k are as defined herein.

Preferred are methods and uses of compounds of formula (I), in which the compound of formula I is a compound of formula IB:

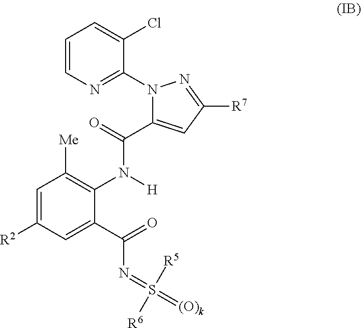

wherein
R² is selected from the group consisting of bromo, chloro, cyano;
R⁷ is selected from the group consisting of bromo, chloro, trifluoromethyl. OCHF₂, and wherein the variables R², R⁷, R⁵, R⁶ and k are as defined herein.

Preferred are methods and uses of compounds of formula (I), in which the compound of formula I is a compound of formula IC:

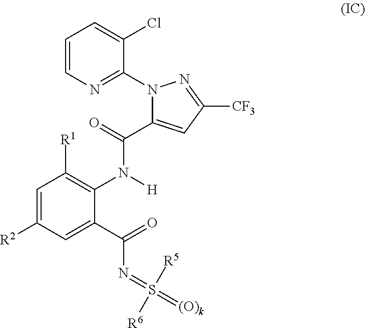

wherein
R¹ is selected from the group consisting of halogen and halomethyl;
R² is selected from the group consisting of bromo, chloro and cyano, and
wherein the variables R⁵, R⁶ and k are as defined herein.

Preferred are methods and uses of compounds of formula (I), in which the compound of formula I is a compound of formula ID:

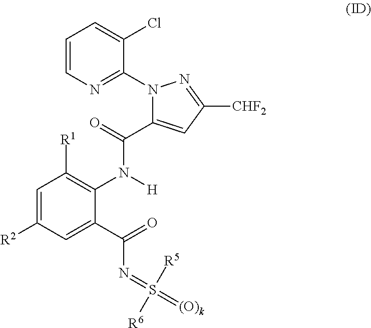

wherein
R¹ is selected from the group consisting of halogen, methyl and halomethyl;
R² is selected from the group consisting of bromo, chloro and cyano, and
wherein the variables R⁵, R⁶ and k are as defined herein.

Preferred are methods and uses of compounds of formula (I), in which R⁵, R⁶ are selected independently of one another from the group consisting of hydrogen, C₁-C₁₀-alkyl, C₃-C₈-cycloalkyl, wherein the aforementioned aliphatic and cycloaliphatic radicals may be substituted with 1 to 10 substituents R^{e}; or

R⁵ and R⁶ together represent a C₂-C₇-alkylene chain forming together with the sulfur atom to which they are attached a 3-, 4-, 5-, 6-, 7- or 8-membered saturated, partially unsaturated or fully unsaturated ring, wherein 1 to 4 of the CH₂ groups in the C₂-C₇-alkylene chain may be replaced by 1 to 4 groups independently selected from the group consisting of C═O, C═S, O, S, N, NO, SO, SO₂ and NH, and wherein the carbon and/or nitrogen atoms in the C₂-C₇-alkylene chain may be substituted with 1 to 5 substituents independently selected from the group consisting of halogen, cyano, C₁-C₆-alkyl, C₁-C₆-haloalkyl, C₁-C₆-alkoxy, C₁-C₆-haloalkoxy, C₁-C₆-alkylthio, C₁-C₆-haloalkylthio, C₃-C₈-cycloalkyl, C₃-C₈-halocycloalkyl, C₂-C₆-alkenyl, C₂-C₆-haloalkenyl, C₂-C₆-alkynyl and C₂-C₆-haloalkynyl; said substituents being identical or different from one another if more than one substituent is present.

Preferred are methods and uses of compounds of formula (I), in which R⁵, R⁶ are selected independently of one another from the group consisting of hydrogen, C₁-C₁₀-alkyl, C₃-C₈-cycloalkyl, wherein the aforementioned aliphatic and cycloaliphatic radicals may be substituted with 1 to 10 substituents R^{e}.

Preferred are methods and uses of compounds of formula (I), in which R⁷ is selected from the group consisting of bromo, difluoromethyl, trifluoromethyl, cyano, OCHF₂, OCH₂F and OCH₂CF₃,

Preferred are methods and uses of compounds of formula (I), in which R⁷ is selected from the group consisting of bromo, difluoromethyl, trifluoromethyl and OCHF₂.

Preferred are methods and uses of compounds of formula (I), in which Re is independently selected from the group consisting of halogen, cyano, —OH, —SH, —SCN, C₁-C₆-alkyl, C₂-C₆-alkenyl, C₂-C₆-alkinyl, C₃-C₈-cycloalkyl, wherein one or more CH₂ groups of the aforementioned radicals may be replaced by a C═O group, and/or the aliphatic and cycloaliphatic moieties of the aforementioned radicals may be unsubstituted, partially or fully halogenated and/or may carry 1 or 2 radicals selected from C₁-C₆-alkoxy, C₁-C₆-haloalkoxy, C₁-C₆-alkylthio, C₁-C₆-alkylsulfinyl, C₁-C₆-alkylsulfonyl, C₁-C₆-haloalkylthio, —OR^{a}, —NR^{c}R^{d}, —S(O)ₙR^{a}, —S(O)ₙNR^{c}R^{d}, —C(═O)R^{a}, —C(═O)NR^{c}R^{d}, —C(═O)OR^{b}, —C(═S)R^{a}, —C(═S)NR^{c}R^{d}, —C(═S)OR^{b}, —C(═S)SR^{b}, —C(═NR^{c})R^{b}, —C(═NR^{c})NR^{c}R^{d}, phenyl, benzyl, pyridyl and phenoxy, wherein the last four radicals may be unsubstituted, partially or fully halogenated and/or carry 1, 2 or 3 substituents selected from C₁-C₆-alkyl, C₁-C₆-haloalkyl, C₁-C₆-alkoxy and C₁-C₆-haloalkoxy.

Preferred are methods and uses of compounds of formula (I), in which Re is independently selected from the group consisting of halogen, cyano, —OH, —SH, —SCN, C₁-C₆-alkyl, C₂-C₆-alkenyl, C₂-C₆-alkinyl, C₃-C₈-cycloalkyl, wherein one or more CH₂ groups of the aforementioned radicals may be replaced by a C═O group, and/or the aliphatic and cycloaliphatic moieties of the aforementioned radicals may be unsubstituted, partially or fully halogenated.

Preferred are methods and uses of compounds of formula (I) as described herein, in which in the compound of formula I

R⁵ and R⁶ are selected from methyl, ethyl, isopropyl, n-propyl, n-butyl, isobutyl, tert-butyl, cyclopropyl, cyclopropylmethyl.

Preferred are methods and uses of compounds of formula (I) as described herein, in which in the compound of formula I R⁵ and R⁶ are identical.

In a particularly preferred embodiment, the methods and uses according to the invention comprise at least one compound of formula (IA)

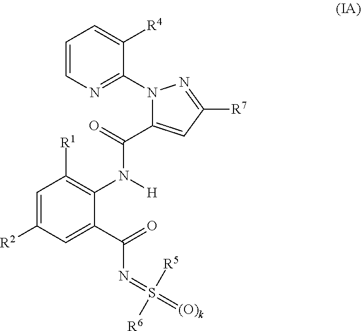

wherein

### R⁴ is Cl,

R¹ is selected from the group consisting of Cl, Br, and methyl;
R² is selected from the group consisting of bromo and chloro;
R⁵, R⁶ are selected independently of one another from the group consisting of methyl, ethyl, n-propyl, isopropyl, n-butyl, isobutyl, tert-butyl.
R⁷ is selected from the group consisting of difluoromethyl, trifluoromethyl.

Examples of especially preferred anthranilamide compounds I of the present invention are of formula (IA-1)

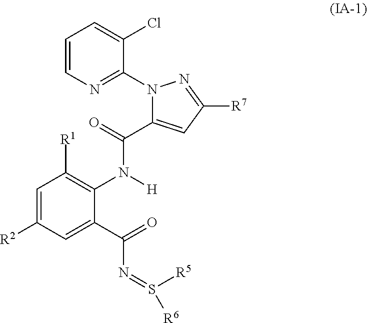

wherein R¹, R², R⁷, R⁵, R⁶ are as defined herein.

Examples of preferred compounds of formula I in the methods and uses according to the invention are compiled in tables 1 to 60 below. Moreover, the meanings mentioned below for the individual variables in the tables are per se, independently of the combination in which they are mentioned, a particularly preferred embodiment of the substituents in question.

Table 1 Compounds of the formula (IA-1) in which R¹ is F, R² is Cl, R⁷ is CF₃ and the combination of R⁵ and R⁶ for a compound corresponds in each case to one row of Table A;
Table 2 Compounds of the formula (IA-1) in which R¹ is Br, R² is Cl, R⁷ is CF₃ and the combination of R⁵ and R⁶ for a compound corresponds in each case to one row of Table A;
Table 3 Compounds of the formula (IA-1) in which R¹ is Cl, R² is Cl, R⁷ is CF₃ and the combination of R⁵ and R⁶ for a compound corresponds in each case to one row of Table A;
Table 4 Compounds of the formula (IA-1) in which R¹ is methyl, R² is Cl, R⁷ is CF₃ and the combination of R⁵ and R⁶ for a compound corresponds in each case to one row of Table A;
Table 5 Compounds of the formula (IA-1) in which R¹ is F, R² is Br, R⁷ is CF₃ and the combination of R⁵ and R⁶ for a compound corresponds in each case to one row of Table A;
Table 6 Compounds of the formula (IA-1) in which R¹ is Br, R² is Br, R⁷ is CF₃ and the combination of R⁵ and R⁶ for a compound corresponds in each case to one row of Table A;
Table 7 Compounds of the formula (IA-1) in which R¹ is Cl, R² is Br, R⁷ is CF₃ and the combination of R⁵ and R⁶ for a compound corresponds in each case to one row of Table A;
Table 8 Compounds of the formula (IA-1) in which R¹ is methyl, R² is Br, R⁷ is CF₃ and the combination of R⁵ and R⁶ for a compound corresponds in each case to one row of Table A;
Table 9 Compounds of the formula (IA-1) in which R¹ is F, R² is cyano, R⁷ is CF₃ and the combination of R⁵ and R⁶ for a compound corresponds in each case to one row of Table A;
Table 10 Compounds of the formula (IA-1) in which R¹ is Br, R² is cyano, R⁷ is CF₃ and the combination of R⁵ and R⁶ for a compound corresponds in each case to one row of Table A;
Table 11 Compounds of the formula (IA-1) in which R¹ is Cl, R² is cyano, R⁷ is CF₃ and the combination of R⁵ and R⁶ for a compound corresponds in each case to one row of Table A;
Table 12 Compounds of the formula (IA-1) in which R¹ is methyl, R² is cyano, R⁷ is CF₃ and the combination of R⁵ and R⁶ for a compound corresponds in each case to one row of Table A;
Table 13 Compounds of the formula (IA-1) in which R¹ is F, R² is Cl, R⁷ is CHF₂ and the combination of R⁵ and R⁶ for a compound corresponds in each case to one row of Table A;
Table 14 Compounds of the formula (IA-1) in which R¹ is Br, R² is Cl, R⁷ is CHF₂ and the combination of R⁵ and R⁶ for a compound corresponds in each case to one row of Table A;
Table 15 Compounds of the formula (IA-1) in which R¹ is Cl, R² is Cl, R⁷ is CHF₂ and the combination of R⁵ and R⁶ for a compound corresponds in each case to one row of Table A;
Table 16 Compounds of the formula (IA-1) in which R¹ is methyl, R² is Cl, R⁷ is CHF₂ and the combination of R⁵ and R⁶ for a compound corresponds in each case to one row of Table A;
Table 17 Compounds of the formula (IA-1) in which R¹ is F, R² is Br, R⁷ is CHF₂ and the combination of R⁵ and R⁶ for a compound corresponds in each case to one row of Table A;
Table 18 Compounds of the formula (IA-1) in which R¹ is Br, R² is Br, R⁷ is CHF₂ and the combination of R⁵ and R⁶ for a compound corresponds in each case to one row of Table A;
Table 19 Compounds of the formula (IA-1) in which R¹ is Cl, R² is Br, R⁷ is CHF₂ and the combination of R⁵ and R⁶ for a compound corresponds in each case to one row of Table A;
Table 20 Compounds of the formula (IA-1) in which R¹ is methyl, R² is Br, R⁷ is CHF₂ and the combination of R⁵ and R⁶ for a compound corresponds in each case to one row of Table A;
Table 21 Compounds of the formula (IA-1) in which R¹ is F, R² is cyano, R⁷ is CHF₂ and the combination of R⁵ and R⁶ for a compound corresponds in each case to one row of Table A;
Table 22 Compounds of the formula (IA-1) in which R¹ is Br, R² is cyano, R⁷ is CHF₂ and the combination of R⁵ and R⁶ for a compound corresponds in each case to one row of Table A;
Table 23 Compounds of the formula (IA-1) in which R¹ is Cl, R² is cyano, R⁷ is CHF₂ and the combination of R⁵ and R⁶ for a compound corresponds in each case to one row of Table A;
Table 24 Compounds of the formula (IA-1) in which R¹ is methyl, R² is cyano, R⁷ is CHF₂ and the combination of R⁵ and R⁶ for a compound corresponds in each case to one row of Table A;
Table 25 Compounds of the formula (IA-1) in which R¹ is F, R² is Cl, R⁷ is Br and the combination of R⁵ and R⁶ for a compound corresponds in each case to one row of Table A;
Table 26 Compounds of the formula (IA-1) in which R¹ is Br, R² is Cl, R⁷ is Br and the combination of R⁵ and R⁶ for a compound corresponds in each case to one row of Table A;
Table 27 Compounds of the formula (IA-1) in which R¹ is Cl, R² is Cl, R⁷ is Br and the combination of R⁵ and R⁶ for a compound corresponds in each case to one row of Table A;
Table 28 Compounds of the formula (IA-1) in which R¹ is methyl, R² is Cl, R⁷ is Br and the combination of R⁵ and R⁶ for a compound corresponds in each case to one row of Table A;
Table 29 Compounds of the formula (IA-1) in which R¹ is F, R² is Br, R⁷ is Br and the combination of R⁵ and R⁶ for a compound corresponds in each case to one row of Table A;
Table 30 Compounds of the formula (IA-1) in which R¹ is Br, R² is Br, R⁷ is Br and the combination of R⁵ and R⁶ for a compound corresponds in each case to one row of Table A;
Table 31 Compounds of the formula (IA-1) in which R¹ is Cl, R² is Br, R⁷ is Br and the combination of R⁵ and R⁶ for a compound corresponds in each case to one row of Table A;
Table 32 Compounds of the formula (IA-1) in which R¹ is methyl, R² is Br, R⁷ is Br and the combination of R⁵ and R⁶ for a compound corresponds in each case to one row of Table A;
Table 33 Compounds of the formula (IA-1) in which R¹ is F, R² is cyano, R⁷ is Br and the combination of R⁵ and R⁶ for a compound corresponds in each case to one row of Table A;
Table 34 Compounds of the formula (IA-1) in which R¹ is Br, R² is cyano, R⁷ is Br and the combination of R⁵ and R⁶ for a compound corresponds in each case to one row of Table A;
Table 35 Compounds of the formula (IA-1) in which R¹ is Cl, R² is cyano, R⁷ is Br and the combination of R⁵ and R⁶ for a compound corresponds in each case to one row of Table A;
Table 36 Compounds of the formula (IA-1) in which R¹ is methyl, R² is cyano, R⁷ is Br and the combination of R⁵ and R⁶ for a compound corresponds in each case to one row of Table A;
Table 37 Compounds of the formula (IA-1) in which R¹ is F, R² is Cl, R⁷ is Cl and the combination of R⁵ and R⁶ for a compound corresponds in each case to one row of Table A;
Table 38 Compounds of the formula (IA-1) in which R¹ is Br, R² is Cl, R⁷ is Cl and the combination of R⁵ and R⁶ for a compound corresponds in each case to one row of Table A;
Table 39 Compounds of the formula (IA-1) in which R¹ is Cl, R² is Cl, R⁷ is Cl and the combination of R⁵ and R⁶ for a compound corresponds in each case to one row of Table A;
Table 40 Compounds of the formula (IA-1) in which R¹ is methyl, R² is Cl, R⁷ is Cl and the combination of R⁵ and R⁶ for a compound corresponds in each case to one row of Table A;
Table 41 Compounds of the formula (IA-1) in which R¹ is F, R² is Br, R⁷ is Cl and the combination of R⁵ and R⁶ for a compound corresponds in each case to one row of Table A;
Table 42 Compounds of the formula (IA-1) in which R¹ is Br, R² is Br, R⁷ is Cl and the combination of R⁵ and R⁶ for a compound corresponds in each case to one row of Table A;
Table 43 Compounds of the formula (IA-1) in which R¹ is Cl, R² is Br, R⁷ is Cl and the combination of R⁵ and R⁶ for a compound corresponds in each case to one row of Table A;
Table 44 Compounds of the formula (IA-1) in which R¹ is methyl, R² is Br, R⁷ is Cl and the combination of R⁵ and R⁶ for a compound corresponds in each case to one row of Table A;
Table 45 Compounds of the formula (IA-1) in which R¹ is F, R² is cyano, R⁷ is Cl and the combination of R⁵ and R⁶ for a compound corresponds in each case to one row of Table A;
Table 46 Compounds of the formula (IA-1) in which R¹ is Br, R² is cyano, R⁷ is Cl and the combination of R⁵ and R⁶ for a compound corresponds in each case to one row of Table A;
Table 47 Compounds of the formula (IA-1) in which R¹ is Cl, R² is cyano, R⁷ is Cl and the combination of R⁵ and R⁶ for a compound corresponds in each case to one row of Table A;
Table 48 Compounds of the formula (IA-1) in which R¹ is methyl, R² is cyano, R⁷ is Cl and the combination of R⁵ and R⁶ for a compound corresponds in each case to one row of Table A;
Table 49 Compounds of the formula (IA-1) in which R¹ is F, R² is Cl, R⁷ is OCHF₂ and the combination of R⁵ and R⁶ for a compound corresponds in each case to one row of Table A;
Table 50 Compounds of the formula (IA-1) in which R¹ is Br, R² is Cl, R⁷ is OCHF₂ and the combination of R⁵ and R⁶ for a compound corresponds in each case to one row of Table A;
Table 51 Compounds of the formula (IA-1) in which R¹ is Cl, R² is Cl, R⁷ is OCHF₂ and the combination of R⁵ and R⁶ for a compound corresponds in each case to one row of Table A;
Table 52 Compounds of the formula (IA-1) in which R¹ is methyl, R² is Cl, R⁷ is OCHF₂ and the combination of R⁵ and R⁶ for a compound corresponds in each case to one row of Table A;
Table 53 Compounds of the formula (IA-1) in which R¹ is F, R² is Br, R⁷ is OCHF₂ and the combination of R⁵ and R⁶ for a compound corresponds in each case to one row of Table A;
Table 54 Compounds of the formula (IA-1) in which R¹ is Br, R² is Br, R⁷ is OCHF₂ and the combination of R⁵ and R⁶ for a compound corresponds in each case to one row of Table A;
Table 55 Compounds of the formula (IA-1) in which R¹ is Cl, R² is Br, R⁷ is OCHF₂ and the combination of R⁵ and R⁶ for a compound corresponds in each case to one row of Table A;
Table 56 Compounds of the formula (IA-1) in which R¹ is methyl, R² is Br, R⁷ is OCHF₂ and the combination of R⁵ and R⁶ for a compound corresponds in each case to one row of Table A;
Table 57 Compounds of the formula (IA-1) in which R¹ is F, R² is cyano, R⁷ is OCHF₂ and the combination of R⁵ and R⁶ for a compound corresponds in each case to one row of Table A;
Table 58 Compounds of the formula (IA-1) in which R¹ is Br, R² is cyano, R⁷ is OCHF₂ and the combination of R⁵ and R⁶ for a compound corresponds in each case to one row of Table A;
Table 59 Compounds of the formula (IA-1) in which R¹ is Cl, R² is cyano, R⁷ is OCHF₂ and the combination of R⁵ and R⁶ for a compound corresponds in each case to one row of Table A;
Table 60 Compounds of the formula (IA-1) in which R¹ is methyl, R² is cyano, R⁷ is OCHF₂ and the combination of R⁵ and R⁶ for a compound corresponds in each case to one row of Table A.

TABLE A

| | R⁵ | R⁶ |
|---|---|---|
| A-1 | CH₃ | CH₃ |
| A-2 | C₂H₅ | CH₃ |
| A-3 | CH═CH₂ | CH₃ |
| A-4 | CH₂CH₂CH₃ | CH₃ |
| A-5 | CH(CH₃)₂ | CH₃ |
| A-6 | CH₂CH₂CH₂CH₃ | CH₃ |
| A-7 | C(CH₃)₃ | CH₃ |
| A-8 | CH₂CH(CH₃)₂ | CH₃ |
| A-9 | CH(CH₃)CH₂CH₃ | CH₃ |
| A-10 | CH₂CH═CH₂ | CH₃ |
| A-11 | CH₂C≡CH | CH₃ |
| A-12 | CH(CH₃)CH═CH₂ | CH₃ |
| A-13 | CHF₂ | CH₃ |
| A-14 | CH₂Cl | CH₃ |
| A-15 | CH₂CH₂CN | CH₃ |
| A-16 | CH₂CH₂Cl | CH₃ |
| A-17 | c-C₃H₅ | CH₃ |
| A-18 | c-C₄H₇ | CH₃ |
| A-19 | c-C₅H₉ | CH₃ |
| A-20 | c-C₆H₁₁ | CH₃ |
| A-21 | CH₂-c-C₃H₅ | CH₃ |
| A-22 | CH(CH₃)-c-C₃H₅ | CH₃ |
| A-23 | CH₂-c-C₅H₉ | CH₃ |
| A-24 | CH₂-c-C₆H₁₁ | CH₃ |
| A-25 | C₆H₅ | CH₃ |
| A-26 | CH₃ | C₂H₅ |
| A-27 | C₂H₅ | C₂H₅ |
| A-28 | CH═CH₂ | C₂H₅ |
| A-29 | CH₂CH₂CH₃ | C₂H₅ |
| A-30 | CH(CH₃)₂ | C₂H₅ |
| A-31 | CH₂CH₂CH₂CH₃ | C₂H₅ |
| A-32 | C(CH₃)₃ | C₂H₅ |
| A-33 | CH₂CH(CH₃)₂ | C₂H₅ |
| A-34 | CH(CH₃)CH₂CH₃ | C₂H₅ |
| A-35 | CH₂CH═CH₂ | C₂H₅ |
| A-36 | CH₂C≡CH | C₂H₅ |
| A-37 | CH(CH₃)CH═CH₂ | C₂H₅ |
| A-38 | CHF₂ | C₂H₅ |
| A-39 | CH₂Cl | C₂H₅ |
| A-40 | CH₂CH₂CN | C₂H₅ |
| A-41 | CH₂CH₂Cl | C₂H₅ |
| A-42 | c-C₃H₅ | C₂H₅ |
| A-43 | c-C₄H₇ | C₂H₅ |
| A-44 | c-C₅H₉ | C₂H₅ |
| A-45 | c-C₆H₁₁ | C₂H₅ |
| A-46 | CH₂-c-C₃H₅ | C₂H₅ |
| A-47 | CH(CH₃)-c-C₃H₅ | C₂H₅ |
| A-48 | CH₂-c-C₅H₉ | C₂H₅ |
| A-49 | CH₂-c-C₆H₁₁ | C₂H₅ |
| A-50 | C₆H₅ | C₂H₅ |
| A-51 | CH₃ | CH═CH₂ |
| A-52 | C₂H₅ | CH═CH₂ |
| A-53 | CH═CH₂ | CH═CH₂ |
| A-54 | CH₂CH₂CH₃ | CH═CH₂ |
| A-55 | CH(CH₃)₂ | CH═CH₂ |
| A-56 | CH₂CH₂CH₂CH₃ | CH═CH₂ |
| A-57 | C(CH₃)₃ | CH═CH₂ |
| A-58 | CH₂CH(CH₃)₂ | CH═CH₂ |
| A-59 | CH(CH₃)CH₂CH₃ | CH═CH₂ |
| A-60 | CH₂CH═CH₂ | CH═CH₂ |
| A-61 | CH₂C≡CH | CH═CH₂ |
| A-62 | CH(CH₃)CH═CH₂ | CH═CH₂ |
| A-63 | CHF₂ | CH═CH₂ |
| A-64 | CH₂Cl | CH═CH₂ |
| A-65 | CH₂CH₂CN | CH═CH₂ |
| A-66 | CH₂CH₂Cl | CH═CH₂ |
| A-67 | c-C₃H₅ | CH═CH₂ |
| A-68 | c-C₄H₇ | CH═CH₂ |
| A-69 | c-C₅H₉ | CH═CH₂ |
| A-70 | c-C₆H₁₁ | CH═CH₂ |
| A-71 | CH₂-c-C₃H₅ | CH═CH₂ |
| A-72 | CH(CH₃)-c-C₃H₅ | CH═CH₂ |
| A-73 | CH₂-c-C₅H₉ | CH═CH₂ |
| A-74 | CH₂-c-C₆H₁₁ | CH═CH₂ |
| A-75 | C₆H₅ | CH═CH₂ |
| A-76 | CH₃ | CH₂CH₂CH₃ |
| A-77 | C₂H₅ | CH₂CH₂CH₃ |
| A-78 | CH═CH₂ | CH₂CH₂CH₃ |
| A-79 | CH₂CH₂CH₃ | CH₂CH₂CH₃ |
| A-80 | CH(CH₃)₂ | CH₂CH₂CH₃ |
| A-81 | CH₂CH₂CH₂CH₃ | CH₂CH₂CH₃ |
| A-82 | C(CH₃)₃ | CH₂CH₂CH₃ |
| A-83 | CH₂CH(CH₃)₂ | CH₂CH₂CH₃ |
| A-84 | CH(CH₃)CH₂CH₃ | CH₂CH₂CH₃ |
| A-85 | CH₂CH═CH₂ | CH₂CH₂CH₃ |
| A-86 | CH₂C≡CH | CH₂CH₂CH₃ |
| A-87 | CH(CH₃)CH═CH₂ | CH₂CH₂CH₃ |
| A-88 | CHF₂ | CH₂CH₂CH₃ |
| A-89 | CH₂Cl | CH₂CH₂CH₃ |
| A-90 | CH₂CH₂CN | CH₂CH₂CH₃ |
| A-91 | CH₂CH₂Cl | CH₂CH₂CH₃ |
| A-92 | c-C₃H₅ | CH₂CH₂CH₃ |
| A-93 | c-C₄H₇ | CH₂CH₂CH₃ |
| A-94 | c-C₅H₉ | CH₂CH₂CH₃ |
| A-95 | c-C₆H₁₁ | CH₂CH₂CH₃ |
| A-96 | CH₂-c-C₃H₅ | CH₂CH₂CH₃ |
| A-97 | CH(CH₃)-c-C₃H₅ | CH₂CH₂CH₃ |
| A-98 | CH₂-c-C₅H₉ | CH₂CH₂CH₃ |
| A-99 | CH₂-c-C₆H₁₁ | CH₂CH₂CH₃ |
| A-100 | C₆H₅ | CH₂CH₂CH₃ |
| A-101 | CH₃ | CH(CH₃)₂ |
| A-102 | C₂H₅ | CH(CH₃)₂ |
| A-103 | CH═CH₂ | CH(CH₃)₂ |
| A-104 | CH₂CH₂CH₃ | CH(CH₃)₂ |
| A-105 | CH(CH₃)₂ | CH(CH₃)₂ |
| A-106 | CH₂CH₂CH₂CH₃ | CH(CH₃)₂ |
| A-107 | C(CH₃)₃ | CH(CH₃)₂ |
| A-108 | CH₂CH(CH₃)₂ | CH(CH₃)₂ |
| A-109 | CH(CH₃)CH₂CH₃ | CH(CH₃)₂ |
| A-110 | CH₂CH═CH₂ | CH(CH₃)₂ |
| A-111 | CH₂C≡CH | CH(CH₃)₂ |
| A-112 | CH(CH₃)CH═CH₂ | CH(CH₃)₂ |
| A-113 | CHF₂ | CH(CH₃)₂ |
| A-114 | CH₂Cl | CH(CH₃)₂ |
| A-115 | CH₂CH₂CN | CH(CH₃)₂ |
| A-116 | CH₂CH₂Cl | CH(CH₃)₂ |
| A-117 | c-C₃H₅ | CH(CH₃)₂ |
| A-118 | c-C₄H₇ | CH(CH₃)₂ |
| A-119 | c-C₅H₉ | CH(CH₃)₂ |
| A-120 | c-C₆H₁₁ | CH(CH₃)₂ |
| A-121 | CH₂-c-C₃H₅ | CH(CH₃)₂ |
| A-122 | CH(CH₃)-c-C₃H₅ | CH(CH₃)₂ |
| A-123 | CH₂-c-C₅H₉ | CH(CH₃)₂ |
| A-124 | CH₂-c-C₆H₁₁ | CH(CH₃)₂ |
| A-125 | C₆H₅ | CH(CH₃)₂ |
| A-126 | CH₃ | CH₂CH₂CH₂CH₃ |
| A-127 | C₂H₅ | CH₂CH₂CH₂CH₃ |
| A-128 | CH═CH₂ | CH₂CH₂CH₂CH₃ |
| A-129 | CH₂CH₂CH₃ | CH₂CH₂CH₂CH₃ |
| A-130 | CH(CH₃)₂ | CH₂CH₂CH₂CH₃ |
| A-131 | CH₂CH₂CH₂CH₃ | CH₂CH₂CH₂CH₃ |
| A-132 | C(CH₃)₃ | CH₂CH₂CH₂CH₃ |
| A-133 | CH₂CH(CH₃)₂ | CH₂CH₂CH₂CH₃ |
| A-134 | CH(CH₃)CH₂CH₃ | CH₂CH₂CH₂CH₃ |
| A-135 | CH₂CH═CH₂ | CH₂CH₂CH₂CH₃ |
| A-136 | CH₂C≡CH | CH₂CH₂CH₂CH₃ |
| A-137 | CH(CH₃)CH═CH₂ | CH₂CH₂CH₂CH₃ |
| A-138 | CHF₂ | CH₂CH₂CH₂CH₃ |
| A-139 | CH₂Cl | CH₂CH₂CH₂CH₃ |
| A-140 | CH₂CH₂CN | CH₂CH₂CH₂CH₃ |
| A-141 | CH₂CH₂Cl | CH₂CH₂CH₂CH₃ |
| A-142 | c-C₃H₅ | CH₂CH₂CH₂CH₃ |
| A-143 | c-C₄H₇ | CH₂CH₂CH₂CH₃ |
| A-144 | c-C₅H₉ | CH₂CH₂CH₂CH₃ |
| A-145 | c-C₆H₁₁ | CH₂CH₂CH₂CH₃ |
| A-146 | CH₂-c-C₃H₅ | CH₂CH₂CH₂CH₃ |
| A-147 | CH(CH₃)-c-C₃H₅ | CH₂CH₂CH₂CH₃ |
| A-148 | CH₂-c-C₅H₉ | CH₂CH₂CH₂CH₃ |
| A-149 | CH₂-c-C₆H₁₁ | CH₂CH₂CH₂CH₃ |
| A-150 | C₆H₅ | CH₂CH₂CH₂CH₃ |
| A-151 | CH₃ | C(CH₃)₃ |
| A-152 | C₂H₅ | C(CH₃)₃ |
| A-153 | CH═CH₂ | C(CH₃)₃ |
| A-154 | CH₂CH₂CH₃ | C(CH₃)₃ |
| A-155 | CH(CH₃)₂ | C(CH₃)₃ |
| A-156 | CH₂CH₂CH₂CH₃ | C(CH₃)₃ |
| A-157 | C(CH₃)₃ | C(CH₃)₃ |
| A-158 | CH₂CH(CH₃)₂ | C(CH₃)₃ |
| A-159 | CH(CH₃)CH₂CH₃ | C(CH₃)₃ |
| A-160 | CH₂CH═CH₂ | C(CH₃)₃ |
| A-161 | CH₂C≡CH | C(CH₃)₃ |
| A-162 | CH(CH₃)CH═CH₂ | C(CH₃)₃ |
| A-163 | CHF₂ | C(CH₃)₃ |
| A-164 | CH₂Cl | C(CH₃)₃ |
| A-165 | CH₂CH₂CN | C(CH₃)₃ |
| A-166 | CH₂CH₂Cl | C(CH₃)₃ |
| A-167 | c-C₃H₅ | C(CH₃)₃ |
| A-168 | c-C₄H₇ | C(CH₃)₃ |
| A-169 | c-C₅H₉ | C(CH₃)₃ |
| A-170 | c-C₆H₁₁ | C(CH₃)₃ |
| A-171 | CH₂-c-C₃H₅ | C(CH₃)₃ |
| A-172 | CH(CH₃)-c-C₃H₅ | C(CH₃)₃ |
| A-173 | CH₂-c-C₅H₉ | C(CH₃)₃ |
| A-174 | CH₂-c-C₆H₁₁ | C(CH₃)₃ |
| A-175 | C₆H₅ | C(CH₃)₃ |
| A-176 | CH₃ | CH₂CH(CH₃)₂ |
| A-177 | C₂H₅ | CH₂CH(CH₃)₂ |
| A-178 | CH═CH₂ | CH₂CH(CH₃)₂ |
| A-179 | CH₂CH₂CH₃ | CH₂CH(CH₃)₂ |
| A-180 | CH(CH₃)₂ | CH₂CH(CH₃)₂ |
| A-181 | CH₂CH₂CH₂CH₃ | CH₂CH(CH₃)₂ |
| A-182 | C(CH₃)₃ | CH₂CH(CH₃)₂ |
| A-183 | CH₂CH(CH₃)₂ | CH₂CH(CH₃)₂ |
| A-184 | CH(CH₃)CH₂CH₃ | CH₂CH(CH₃)₂ |
| A-185 | CH₂CH═CH₂ | CH₂CH(CH₃)₂ |
| A-186 | CH₂C≡CH | CH₂CH(CH₃)₂ |
| A-187 | CH(CH₃)CH═CH₂ | CH₂CH(CH₃)₂ |
| A-188 | CHF₂ | CH₂CH(CH₃)₂ |
| A-189 | CH₂Cl | CH₂CH(CH₃)₂ |
| A-190 | CH₂CH₂CN | CH₂CH(CH₃)₂ |
| A-191 | CH₂CH₂Cl | CH₂CH(CH₃)₂ |
| A-192 | c-C₃H₅ | CH₂CH(CH₃)₂ |
| A-193 | c-C₄H₇ | CH₂CH(CH₃)₂ |
| A-194 | c-C₅H₉ | CH₂CH(CH₃)₂ |
| A-195 | c-C₆H₁₁ | CH₂CH(CH₃)₂ |
| A-196 | CH₂-c-C₃H₅ | CH₂CH(CH₃)₂ |
| A-197 | CH(CH₃)-c-C₃H₅ | CH₂CH(CH₃)₂ |
| A-198 | CH₂-c-C₅H₉ | CH₂CH(CH₃)₂ |
| A-199 | CH₂-c-C₆H₁₁ | CH₂CH(CH₃)₂ |
| A-200 | C₆H₅ | CH₂CH(CH₃)₂ |
| A-201 | CH₃ | CH(CH₃)CH₂CH₃ |
| A-202 | C₂H₅ | CH(CH₃)CH₂CH₃ |
| A-203 | CH═CH₂ | CH(CH₃)CH₂CH₃ |
| A-204 | CH₂CH₂CH₃ | CH(CH₃)CH₂CH₃ |
| A-205 | CH(CH₃)₂ | CH(CH₃)CH₂CH₃ |
| A-206 | CH₂CH₂CH₂CH₃ | CH(CH₃)CH₂CH₃ |
| A-207 | C(CH₃)₃ | CH(CH₃)CH₂CH₃ |
| A-208 | CH₂CH(CH₃)₂ | CH(CH₃)CH₂CH₃ |
| A-209 | CH(CH₃)CH₂CH₃ | CH(CH₃)CH₂CH₃ |
| A-210 | CH₂CH═CH₂ | CH(CH₃)CH₂CH₃ |
| A-211 | CH₂C≡CH | CH(CH₃)CH₂CH₃ |
| A-212 | CH(CH₃)CH═CH₂ | CH(CH₃)CH₂CH₃ |
| A-213 | CHF₂ | CH(CH₃)CH₂CH₃ |
| A-214 | CH₂Cl | CH(CH₃)CH₂CH₃ |
| A-215 | CH₂CH₂CN | CH(CH₃)CH₂CH₃ |
| A-216 | CH₂CH₂Cl | CH(CH₃)CH₂CH₃ |
| A-217 | c-C₃H₅ | CH(CH₃)CH₂CH₃ |
| A-218 | c-C₄H₇ | CH(CH₃)CH₂CH₃ |
| A-219 | c-C₅H₉ | CH(CH₃)CH₂CH₃ |
| A-220 | c-C₆H₁₁ | CH(CH₃)CH₂CH₃ |
| A-221 | CH₂-c-C₃H₅ | CH(CH₃)CH₂CH₃ |
| A-222 | CH(CH₃)-c-C₃H₅ | CH(CH₃)CH₂CH₃ |
| A-223 | CH₂-c-C₅H₉ | CH(CH₃)CH₂CH₃ |
| A-224 | CH₂-c-C₆H₁₁ | CH(CH₃)CH₂CH₃ |
| A-225 | C₆H₅ | CH(CH₃)CH₂CH₃ |
| A-226 | CH₃ | CH₂CH═CH₂ |
| A-227 | C₂H₅ | CH₂CH═CH₂ |
| A-228 | CH═CH₂ | CH₂CH═CH₂ |
| A-229 | CH₂CH₂CH₃ | CH₂CH═CH₂ |
| A-230 | CH(CH₃)₂ | CH₂CH═CH₂ |
| A-231 | CH₂CH₂CH₂CH₃ | CH₂CH═CH₂ |
| A-232 | C(CH₃)₃ | CH₂CH═CH₂ |
| A-233 | CH₂CH(CH₃)₂ | CH₂CH═CH₂ |
| A-234 | CH(CH₃)CH₂CH₃ | CH₂CH═CH₂ |
| A-235 | CH₂CH═CH₂ | CH₂CH═CH₂ |
| A-236 | CH₂C≡CH | CH₂CH═CH₂ |
| A-237 | CH(CH₃)CH═CH₂ | CH₂CH═CH₂ |
| A-238 | CHF₂ | CH₂CH═CH₂ |
| A-239 | CH₂Cl | CH₂CH═CH₂ |
| A-240 | CH₂CH₂CN | CH₂CH═CH₂ |
| A-241 | CH₂CH₂Cl | CH₂CH═CH₂ |
| A-242 | c-C₃H₅ | CH₂CH═CH₂ |
| A-243 | c-C₄H₇ | CH₂CH═CH₂ |
| A-244 | c-C₅H₉ | CH₂CH═CH₂ |
| A-245 | c-C₆H₁₁ | CH₂CH═CH₂ |
| A-246 | CH₂-c-C₃H₅ | CH₂CH═CH₂ |
| A-247 | CH(CH₃)-c-C₃H₅ | CH₂CH═CH₂ |
| A-248 | CH₂-c-C₅H₉ | CH₂CH═CH₂ |
| A-249 | CH₂-c-C₆H₁₁ | CH₂CH═CH₂ |
| A-250 | C₆H₅ | CH₂CH═CH₂ |
| A-251 | CH₃ | CH₂C≡CH |
| A-252 | C₂H₅ | CH₂C≡CH |
| A-253 | CH═CH₂ | CH₂C≡CH |
| A-254 | CH₂CH₂CH₃ | CH₂C≡CH |
| A-255 | CH(CH₃)₂ | CH₂C≡CH |
| A-256 | CH₂CH₂CH₂CH₃ | CH₂C≡CH |
| A-257 | C(CH₃)₃ | CH₂C≡CH |
| A-258 | CH₂CH(CH₃)₂ | CH₂C≡CH |
| A-259 | CH(CH₃)CH₂CH₃ | CH₂C≡CH |
| A-260 | CH₂CH═CH₂ | CH₂C≡CH |
| A-261 | CH2C≡CH | CH₂C≡CH |
| A-262 | CH(CH₃)CH═CH₂ | CH₂C≡CH |
| A-263 | CHF₂ | CH₂C≡CH |
| A-264 | CH₂Cl | CH₂C≡CH |
| A-265 | CH₂CH₂CN | CH₂C≡CH |
| A-266 | CH₂CH₂Cl | CH₂C≡CH |
| A-267 | c-C₃H₅ | CH₂C≡CH |
| A-268 | c-C₄H₇ | CH₂C≡CH |
| A-269 | c-C₅H₉ | CH₂C≡CH |
| A-270 | c-C₆H₁₁ | CH₂C≡CH |
| A-271 | CH₂-c-C₃H₅ | CH₂C≡CH |
| A-272 | CH(CH₃)-c-C₃H₅ | CH₂C≡CH |
| A-273 | CH₂-c-C₅H₉ | CH₂C≡CH |
| A-274 | CH₂-c-C₆H₁₁ | CH₂C≡CH |
| A-275 | C₆H₅ | CH₂C≡CH |
| A-276 | CH₃ | CH(CH₃)CH═CH₂ |
| A-277 | C₂H₅ | CH(CH₃)CH═CH₂ |
| A-278 | CH═CH₂ | CH(CH₃)CH═CH₂ |
| A-279 | CH₂CH₂CH₃ | CH(CH₃)CH═CH₂ |
| A-280 | CH(CH₃)₂ | CH(CH₃)CH═CH₂ |
| A-281 | CH₂CH₂CH₂CH₃ | CH(CH₃)CH═CH₂ |
| A-282 | C(CH₃)₃ | CH(CH₃)CH═CH₂ |
| A-283 | CH₂CH(CH₃)₂ | CH(CH₃)CH═CH₂ |
| A-284 | CH(CH₃)CH₂CH₃ | CH(CH₃)CH═CH₂ |
| A-285 | CH₂CH═CH₂ | CH(CH₃)CH═CH₂ |
| A-286 | CH₂C≡CH | CH(CH₃)CH═CH₂ |
| A-287 | CH(CH₃)CH═CH₂ | CH(CH₃)CH═CH₂ |
| A-288 | CHF₂ | CH(CH₃)CH═CH₂ |
| A-289 | CH₂Cl | CH(CH₃)CH═CH₂ |
| A-290 | CH₂CH₂CN | CH(CH₃)CH═CH₂ |
| A-291 | CH₂CH₂Cl | CH(CH₃)CH═CH₂ |
| A-292 | c-C₃H₅ | CH(CH₃)CH═CH₂ |
| A-293 | c-C₄H₇ | CH(CH₃)CH═CH₂ |
| A-294 | c-C₅H₉ | CH(CH₃)CH═CH₂ |
| A-295 | c-C₆H₁₁ | CH(CH₃)CH═CH₂ |
| A-296 | CH₂-c-C₃H₅ | CH(CH₃)CH═CH₂ |
| A-297 | CH(CH₃)-c-C₃H₅ | CH(CH₃)CH═CH₂ |
| A-298 | CH₂-c-C₅H₉ | CH(CH₃)CH═CH₂ |
| A-299 | CH₂-c-C₅H₉ | CH(CH₃)CH═CH₂ |
| A-300 | C₆H₅ | CH(CH₃)CH═CH₂ |
| A-301 | CH₃ | CHF₂ |
| A-302 | C₂H₅ | CHF₂ |
| A-303 | CH═CH₂ | CHF₂ |
| A-304 | CH₂CH₂CH₃ | CHF₂ |
| A-305 | CH(CH₃)₂ | CHF₂ |
| A-306 | CH₂CH₂CH₂CH₃ | CHF₂ |
| A-307 | C(CH₃)₃ | CHF₂ |
| A-308 | CH₂CH(CH₃)₂ | CHF₂ |
| A-309 | CH(CH₃)CH₂CH₃ | CHF₂ |
| A-310 | CH₂CH═CH₂ | CHF₂ |
| A-311 | CH₂C≡CH | CHF₂ |
| A-312 | CH(CH₃)CH═CH₂ | CHF₂ |
| A-313 | CHF₂ | CHF₂ |
| A-314 | CH₂Cl | CHF₂ |
| A-315 | CH₂CH₂CN | CHF₂ |
| A-316 | CH₂CH₂Cl | CHF₂ |
| A-317 | c-C₃H₅ | CHF₂ |
| A-318 | c-C₄H₇ | CHF₂ |
| A-319 | c-C₅H₉ | CHF₂ |
| A-320 | c-C₆H₁₁ | CHF₂ |
| A-321 | CH₂-c-C₃H₅ | CHF₂ |
| A-322 | CH(CH₃)-c-C₃H₅ | CHF₂ |
| A-323 | CH₂-c-C₅H₉ | CHF₂ |
| A-324 | CH₂-c-C₆H₁₁ | CHF₂ |
| A-325 | C₆H₅ | CHF₂ |
| A-326 | CH₃ | CH₂Cl |
| A-327 | C₂H₅ | CH₂Cl |
| A-328 | CH═CH₂ | CH₂Cl |
| A-329 | CH₂CH₂CH₃ | CH₂Cl |
| A-330 | CH(CH₃)₂ | CH₂Cl |
| A-331 | CH₂CH₂CH₂CH₃ | CH₂Cl |
| A-332 | C(CH₃)₃ | CH₂Cl |
| A-333 | CH₂CH(CH₃)₂ | CH₂Cl |
| A-334 | CH(CH₃)CH₂CH₃ | CH₂Cl |
| A-335 | CH₂CH═CH₂ | CH₂Cl |
| A-336 | CH₂C≡CH | CH₂Cl |
| A-337 | CH(CH₃)CH═CH₂ | CH₂Cl |
| A-338 | CHF₂ | CH₂Cl |
| A-339 | CH₂Cl | CH₂Cl |
| A-340 | CH₂CH₂CN | CH₂Cl |
| A-341 | CH₂CH₂Cl | CH₂Cl |
| A-342 | c-C₃H₅ | CH₂Cl |
| A-343 | c-C₄H₇ | CH₂Cl |
| A-344 | c-C₅H₉ | CH₂Cl |
| A-345 | c-C₆H₁₁ | CH₂Cl |
| A-346 | CH₂-c-C₃H₅ | CH₂Cl |
| A-347 | CH(CH₃)-c-C₃H₅ | CH₂Cl |
| A-348 | CH₂-c-C₅H₉ | CH₂Cl |
| A-349 | CH₂-c-C₆H₁₁ | CH₂Cl |
| A-350 | C₆H₅ | CH₂Cl |
| A-351 | CH₃ | CH₂CH₂CN |
| A-352 | C₂H₅ | CH₂CH₂CN |
| A-353 | CH═CH₂ | CH₂CH₂CN |
| A-354 | CH₂CH₂CH₃ | CH₂CH₂CN |
| A-355 | CH(CH₃)₂ | CH₂CH₂CN |
| A-356 | CH₂CH₂CH₂CH₃ | CH₂CH₂CN |
| A-357 | C(CH₃)₃ | CH₂CH₂CN |
| A-358 | CH₂CH(CH₃)₂ | CH₂CH₂CN |
| A-359 | CH(CH₃)CH₂CH₃ | CH₂CH₂CN |
| A-360 | CH₂CH═CH₂ | CH₂CH₂CN |
| A-361 | CH₂C≡CH | CH₂CH₂CN |
| A-362 | CH(CH₃)CH═CH₂ | CH₂CH₂CN |
| A-363 | CHF₂ | CH₂CH₂CN |
| A-364 | CH₂Cl | CH₂CH₂CN |
| A-365 | CH₂CH₂CN | CH₂CH₂CN |
| A-366 | CH₂CH₂Cl | CH₂CH₂CN |
| A-367 | c-C₃H₅ | CH₂CH₂CN |
| A-368 | c-C₄H₇ | CH₂CH₂CN |
| A-369 | c-C₅H₉ | CH₂CH₂CN |
| A-370 | c-C₆H₁₁ | CH₂CH₂CN |
| A-371 | CH₂-c-C₃H₅ | CH₂CH₂CN |
| A-372 | CH(CH₃)-c-C₃H₅ | CH₂CH₂CN |
| A-373 | CH₂-c-C₅H₉ | CH₂CH₂CN |
| A-374 | CH₂-c-C₅H₉ | CH₂CH₂CN |
| A-375 | C₆H₅ | CH₂CH₂CN |
| A-376 | CH₃ | CH₂CH₂Cl |
| A-377 | C₂H₅ | CH₂CH₂Cl |
| A-378 | CH═CH₂ | CH₂CH₂Cl |
| A-379 | CH₂CH₂CH₃ | CH₂CH₂Cl |
| A-380 | CH(CH₃)₂ | CH₂CH₂Cl |
| A-381 | CH₂CH₂CH₂CH₃ | CH₂CH₂Cl |
| A-382 | C(CH₃)₃ | CH₂CH₂Cl |
| A-383 | CH₂CH(CH₃)₂ | CH₂CH₂Cl |
| A-384 | CH(CH₃)CH₂CH₃ | CH₂CH₂Cl |
| A-385 | CH₂CH═CH₂ | CH₂CH₂Cl |
| A-386 | CH₂C≡CH | CH₂CH₂Cl |
| A-387 | CH(CH₃)CH═CH₂ | CH₂CH₂Cl |
| A-388 | CHF₂ | CH₂CH₂Cl |
| A-389 | CH₂Cl | CH₂CH₂Cl |
| A-390 | CH₂CH₂CN | CH₂CH₂Cl |
| A-391 | CH₂CH₂Cl | CH₂CH₂Cl |
| A-392 | c-C₃H₅ | CH₂CH₂Cl |
| A-393 | c-C₄H₇ | CH₂CH₂Cl |
| A-394 | c-C₅H₉ | CH₂CH₂Cl |
| A-395 | c-C₆H₁₁ | CH₂CH₂Cl |
| A-396 | CH₂-c-C₃H₅ | CH₂CH₂Cl |
| A-397 | CH(CH₃)-c-C₃H₅ | CH₂CH₂Cl |
| A-398 | CH₂-c-C₅H₉ | CH₂CH₂Cl |
| A-399 | CH₂-c-C₆H₁₁ | CH₂CH₂Cl |
| A-400 | C₆H₅ | CH₂CH₂Cl |
| A-401 | CH₃ | c-C₃H₅ |
| A-402 | C₂H₅ | c-C₃H₅ |
| A-403 | CH═CH₂ | c-C₃H₅ |
| A-404 | CH₂CH₂CH₃ | c-C₃H₅ |
| A-405 | CH(CH₃)₂ | c-C₃H₅ |
| A-406 | CH₂CH₂CH₂CH₃ | c-C₃H₅ |
| A-407 | C(CH₃)₃ | c-C₃H₅ |
| A-408 | CH₂CH(CH₃)₂ | c-C₃H₅ |
| A-409 | CH(CH₃)CH₂CH₃ | c-C₃H₅ |
| A-410 | CH₂CH═CH₂ | c-C₃H₅ |
| A-411 | CH₂C≡CH | c-C₃H₅ |
| A-412 | CH(CH₃)CH═CH₂ | c-C₃H₅ |
| A-413 | CHF₂ | c-C₃H₅ |
| A-414 | CH₂Cl | c-C₃H₅ |
| A-415 | CH₂CH₂CN | c-C₃H₅ |
| A-416 | CH₂CH₂Cl | c-C₃H₅ |
| A-417 | c-C₃H₅ | c-C₃H₅ |
| A-418 | c-C₄H₇ | c-C₃H₅ |
| A-419 | c-C₅H₉ | c-C₃H₅ |
| A-420 | c-C₆H₁₁ | c-C₃H₅ |
| A-421 | CH₂-c-C₃H₅ | c-C₃H₅ |
| A-422 | CH(CH₃)-c-C₃H₅ | c-C₃H₅ |
| A-423 | CH₂-c-C₅H₉ | c-C₃H₅ |
| A-424 | CH₂-c-C₆H₁₁ | c-C₃H₅ |
| A-425 | C₆H₅ | c-C₃H₅ |
| A-426 | CH₃ | c-C₄H₇ |
| A-427 | C₂H₅ | c-C₄H₇ |
| A-428 | CH═CH₂ | c-C₄H₇ |
| A-429 | CH₂CH₂CH₃ | c-C₄H₇ |
| A-430 | CH(CH₃)₂ | c-C₄H₇ |
| A-431 | CH₂CH₂CH₂CH₃ | c-C₄H₇ |
| A-432 | C(CH₃)₃ | c-C₄H₇ |
| A-433 | CH₂CH(CH₃)₂ | c-C₄H₇ |
| A-434 | CH(CH₃)CH₂CH₃ | c-C₄H₇ |
| A-435 | CH₂CH═CH₂ | c-C₄H₇ |
| A-436 | CH₂C≡CH | c-C₄H₇ |
| A-437 | CH(CH₃)CH═CH₂ | c-C₄H₇ |
| A-438 | CHF₂ | c-C₄H₇ |
| A-439 | CH₂Cl | c-C₄H₇ |
| A-440 | CH₂CH₂CN | c-C₄H₇ |
| A-441 | CH₂CH₂Cl | c-C₄H₇ |
| A-442 | c-C₃H₅ | c-C₄H₇ |
| A-443 | c-C₄H₇ | c-C₄H₇ |
| A-444 | c-C₅H₉ | c-C₄H₇ |
| A-445 | c-C₆H₁₁ | c-C₄H₇ |
| A-446 | CH₂-c-C₃H₅ | c-C₄H₇ |
| A-447 | CH(CH₃)-c-C₃H₅ | c-C₄H₇ |
| A-448 | CH₂-c-C₅H₉ | c-C₄H₇ |
| A-449 | CH₂-c-C₆H₁₁ | c-C₄H₇ |
| A-450 | C₆H₅ | c-C₄H₇ |
| A-451 | CH₃ | c-C₅H₉ |
| A-452 | C₂H₅ | c-C₅H₉ |
| A-453 | CH═CH₂ | c-C₅H₉ |
| A-454 | CH₂CH₂CH₃ | c-C₅H₉ |
| A-455 | CH(CH₃)₂ | c-C₅H₉ |
| A-456 | CH₂CH₂CH₂CH₃ | c-C₅H₉ |
| A-457 | C(CH₃)₃ | c-C₅H₉ |
| A-458 | CH₂CH(CH₃)₂ | c-C₅H₉ |
| A-459 | CH(CH₃)CH₂CH₃ | c-C₅H₉ |
| A-460 | CH₂CH═CH₂ | c-C₅H₉ |
| A-461 | CH₂C≡CH | c-C₅H₉ |
| A-462 | CH(CH₃)CH═CH₂ | c-C₅H₉ |
| A-463 | CHF₂ | c-C₅H₉ |
| A-464 | CH₂Cl | c-C₅H₉ |
| A-465 | CH₂CH₂CN | c-C₅H₉ |
| A-466 | CH₂CH₂Cl | c-C₅H₉ |
| A-467 | c-C₃H₅ | c-C₅H₉ |
| A-468 | c-C₄H₇ | c-C₅H₉ |
| A-469 | c-C₅H₉ | c-C₅H₉ |
| A-470 | c-C₆H₁₁ | c-C₅H₉ |
| A-471 | CH₂-c-C₃H₅ | c-C₅H₉ |
| A-472 | CH(CH₃)-c-C₃H₅ | c-C₅H₉ |
| A-473 | CH₂-c-C₅H₉ | c-C₅H₉ |
| A-474 | CH₂-c-C₆H₁₁ | c-C₅H₉ |
| A-475 | C₆H₅ | c-C₅H₉ |
| A-476 | CH₃ | c-C₆H₁₁ |
| A-477 | C₂H₅ | c-C₆H₁₁ |
| A-478 | CH═CH₂ | c-C₆H₁₁ |
| A-479 | CH₂CH₂CH₃ | c-C₆H₁₁ |
| A-480 | CH(CH₃)₂ | c-C₆H₁₁ |
| A-481 | CH₂CH₂CH₂CH₃ | c-C₆H₁₁ |
| A-482 | C(CH₃)₃ | c-C₆H₁₁ |
| A-483 | CH₂CH(CH₃)₂ | c-C₆H₁₁ |
| A-484 | CH(CH₃)CH₂CH₃ | c-C₆H₁₁ |
| A-485 | CH₂CH═CH₂ | c-C₆H₁₁ |
| A-486 | CH₂C≡CH | c-C₆H₁₁ |
| A-487 | CH(CH₃)CH═CH₂ | c-C₆H₁₁ |
| A-488 | CHF₂ | c-C₆H₁₁ |
| A-489 | CH₂Cl | c-C₆H₁₁ |
| A-490 | CH₂CH₂CN | c-C₆H₁₁ |
| A-491 | CH₂CH₂Cl | c-C₆H₁₁ |
| A-492 | c-C₃H₅ | c-C₆H₁₁ |
| A-493 | c-C₄H₇ | c-C₆H₁₁ |
| A-494 | c-C₅H₉ | c-C₆H₁₁ |
| A-495 | c-C₆H₁₁ | c-C₆H₁₁ |
| A-496 | CH₂-c-C₃H₅ | c-C₆H₁₁ |
| A-497 | CH(CH₃)-c-C₃H₅ | c-C₆H₁₁ |
| A-498 | CH₂-c-C₅H₉ | c-C₆H₁₁ |
| A-499 | CH₂-c-C₆H₁₁ | c-C₆H₁₁ |
| A-500 | C₆H₅ | c-C₆H₁₁ |
| A-501 | CH₃ | CH₂-c-C₃H₅ |
| A-502 | C₂H₅ | CH₂-c-C₃H₅ |
| A-503 | CH═CH₂ | CH₂-c-C₃H₅ |
| A-504 | CH₂CH₂CH₃ | CH₂-c-C₃H₅ |
| A-505 | CH(CH₃)₂ | CH₂-c-C₃H₅ |
| A-506 | CH₂CH₂CH₂CH₃ | CH₂-c-C₃H₅ |
| A-507 | C(CH₃)₃ | CH₂-c-C₃H₅ |
| A-508 | CH₂CH(CH₃)₂ | CH₂-c-C₃H₅ |
| A-509 | CH(CH₃)CH₂CH₃ | CH₂-c-C₃H₅ |
| A-510 | CH₂CH═CH₂ | CH₂-c-C₃H₅ |
| A-511 | CH₂C≡CH | CH₂-c-C₃H₅ |
| A-512 | CH(CH₃)CH═CH₂ | CH₂-c-C₃H₅ |
| A-513 | CHF₂ | CH₂-c-C₃H₅ |
| A-514 | CH₂Cl | CH₂-c-C₃H₅ |
| A-515 | CH₂CH₂CN | CH₂-c-C₃H₅ |
| A-516 | CH₂CH₂Cl | CH₂-c-C₃H₅ |
| A-517 | c-C₃H₅ | CH₂-c-C₃H₅ |
| A-518 | c-C₄H₇ | CH₂-c-C₃H₅ |
| A-519 | c-C₅H₉ | CH₂-c-C₃H₅ |
| A-520 | c-C₆H₁₁ | CH₂-c-C₃H₅ |
| A-521 | CH₂-c-C₃H₅ | CH₂-c-C₃H₅ |
| A-522 | CH(CH₃)-c-C₃H₅ | CH₂-c-C₃H₅ |
| A-523 | CH₂-c-C₅H₉ | CH₂-c-C₃H₅ |
| A-524 | CH₂-c-C₆H₁₁ | CH₂-c-C₃H₅ |
| A-525 | C₆H₅ | CH₂-c-C₃H₅ |
| A-526 | CH₃ | CH(CH₃)-c-C₃H₅ |
| A-527 | C₂H₅ | CH(CH₃)-c-C₃H₅ |
| A-528 | CH═CH₂ | CH(CH₃)-c-C₃H₅ |
| A-529 | CH₂CH₂CH₃ | CH(CH₃)-c-C₃H₅ |
| A-530 | CH(CH₃)₂ | CH(CH₃)-c-C₃H₅ |
| A-531 | CH₂CH₂CH₂CH₃ | CH(CH₃)-c-C₃H₅ |
| A-532 | C(CH₃)₃ | CH(CH₃)-c-C₃H₅ |
| A-533 | CH₂CH(CH₃)₂ | CH(CH₃)-c-C₃H₅ |
| A-534 | CH(CH₃)CH₂CH₃ | CH(CH₃)-c-C₃H₅ |
| A-535 | CH₂CH═CH₂ | CH(CH₃)-c-C₃H₅ |
| A-536 | CH₂C≡CH | CH(CH₃)-c-C₃H₅ |
| A-537 | CH(CH₃)CH═CH₂ | CH(CH₃)-c-C₃H₅ |
| A-538 | CHF₂ | CH(CH₃)-c-C₃H₅ |
| A-539 | CH₂Cl | CH(CH₃)-c-C₃H₅ |
| A-540 | CH₂CH₂CN | CH(CH₃)-c-C₃H₅ |
| A-541 | CH₂CH₂Cl | CH(CH₃)-c-C₃H₅ |
| A-542 | c-C₃H₅ | CH(CH₃)-c-C₃H₅ |
| A-543 | c-C₄H₇ | CH(CH₃)-c-C₃H₅ |
| A-544 | c-C₅H₉ | CH(CH₃)-c-C₃H₅ |
| A-545 | c-C₆H₁₁ | CH(CH₃)-c-C₃H₅ |
| A-546 | CH₂-c-C₃H₅ | CH(CH₃)-c-C₃H₅ |
| A-547 | CH(CH₃)-c-C₃H₅ | CH(CH₃)-c-C₃H₅ |
| A-548 | CH₂-c-C₅H₉ | CH(CH₃)-c-C₃H₅ |
| A-549 | CH₂-c-C₆H₁₁ | CH(CH₃)-c-C₃H₅ |
| A-550 | C₆H₅ | CH(CH₃)-c-C₃H₅ |
| A-551 | CH₃ | CH₂-c-C₅H₉ |
| A-552 | C₂H₅ | CH₂-c-C₅H₉ |
| A-553 | CH═CH₂ | CH₂-c-C₅H₉ |
| A-554 | CH₂CH₂CH₃ | CH₂-c-C₅H₉ |
| A-555 | CH(CH₃)₂ | CH₂-c-C₅H₉ |
| A-556 | CH₂CH₂CH₂CH₃ | CH₂-c-C₅H₉ |
| A-557 | C(CH₃)₃ | CH₂-c-C₅H₉ |
| A-558 | CH₂CH(CH₃)₂ | CH₂-c-C₅H₉ |
| A-559 | CH(CH₃)CH₂CH₃ | CH₂-c-C₅H₉ |
| A-560 | CH₂CH═CH₂ | CH₂-c-C₅H₉ |
| A-561 | CH₂C≡CH | CH₂-c-C₅H₉ |
| A-562 | CH(CH₃)CH═CH₂ | CH₂-c-C₅H₉ |
| A-563 | CHF₂ | CH₂-c-C₅H₉ |
| A-564 | CH₂Cl | CH₂-c-C₅H₉ |
| A-565 | CH₂CH₂CN | CH₂-c-C₅H₉ |
| A-566 | CH₂CH₂Cl | CH₂-c-C₅H₉ |
| A-567 | c-C₃H₅ | CH₂-c-C₅H₉ |
| A-568 | c-C₄H₇ | CH₂-c-C₅H₉ |
| A-569 | c-C₅H₉ | CH₂-c-C₅H₉ |
| A-570 | c-C₆H₁₁ | CH₂-c-C₅H₉ |
| A-571 | CH₂-c-C₃H₅ | CH₂-c-C₅H₉ |
| A-572 | CH(CH₃)-c-C₃H₅ | CH₂-c-C₅H₉ |
| A-573 | CH₂-c-C₅H₉ | CH₂-c-C₅H₉ |
| A-574 | CH₂-c-C₆H₁₁ | CH₂-c-C₅H₉ |
| A-575 | C₆H₅ | CH₂-c-C₅H₉ |
| A-576 | CH₃ | CH₂-c-C₆H₁₁ |
| A-577 | C₂H₅ | CH₂-c-C₆H₁₁ |
| A-578 | CH═CH₂ | CH₂-c-C₆H₁₁ |
| A-579 | CH₂CH₂CH₃ | CH₂-c-C₆H₁₁ |
| A-580 | CH(CH₃)₂ | CH₂-c-C₆H₁₁ |
| A-581 | CH₂CH₂CH₂CH₃ | CH₂-c-C₆H₁₁ |
| A-582 | C(CH₃)₃ | CH₂-c-C₆H₁₁ |
| A-583 | CH₂CH(CH₃)₂ | CH₂-c-C₆H₁₁ |
| A-584 | CH(CH₃)CH₂CH₃ | CH₂-c-C₆H₁₁ |
| A-585 | CH₂CH═CH₂ | CH₂-c-C₆H₁₁ |
| A-586 | CH₂C≡CH | CH₂-c-C₆H₁₁ |
| A-587 | CH(CH₃)CH═CH₂ | CH₂-c-C₆H₁₁ |
| A-588 | CHF₂ | CH₂-c-C₆H₁₁ |
| A-589 | CH₂Cl | CH₂-c-C₆H₁₁ |
| A-590 | CH₂CH₂CN | CH₂-c-C₆H₁₁ |
| A-591 | CH₂CH₂Cl | CH₂-c-C₆H₁₁ |
| A-592 | c-C₃H₅ | CH₂-c-C₆H₁₁ |
| A-593 | c-C₄H₇ | CH₂-c-C₆H₁₁ |
| A-594 | c-C₅H₉ | CH₂-c-C₆H₁₁ |
| A-595 | c-C₆H₁₁ | CH₂-c-C₆H₁₁ |
| A-596 | CH₂-c-C₃H₅ | CH₂-c-C₆H₁₁ |
| A-597 | CH(CH₃)-c-C₃H₅ | CH₂-c-C₆H₁₁ |
| A-598 | CH₂-c-C₅H₉ | CH₂-c-C₆H₁₁ |
| A-599 | CH₂-c-C₆H₁₁ | CH₂-c-C₆H₁₁ |
| A-600 | C₆H₅ | CH₂-c-C₆H₁₁ |
| A-601 | CH₃ | C₆H₅ |
| A-602 | C₂H₅ | C₆H₅ |
| A-603 | CH═CH₂ | C₆H₅ |
| A-604 | CH₂CH₂CH₃ | C₆H₅ |
| A-605 | CH(CH₃)₂ | C₆H₅ |
| A-606 | CH₂CH₂CH₂CH₃ | C₆H₅ |
| A-607 | C(CH₃)₃ | C₆H₅ |
| A-608 | CH₂CH(CH₃)₂ | C₆H₅ |
| A-609 | CH(CH₃)CH₂CH₃ | C₆H₅ |
| A-610 | CH₂CH═CH₂ | C₆H₅ |
| A-611 | CH₂C≡CH | C₆H₅ |
| A-612 | CH(CH₃)CH═CH₂ | C₆H₅ |
| A-613 | CHF₂ | C₆H₅ |
| A-614 | CH₂Cl | C₆H₅ |
| A-615 | CH₂CH₂CN | C₆H₅ |
| A-616 | CH₂CH₂Cl | C₆H₅ |
| A-617 | c-C₃H₅ | C₆H₅ |
| A-618 | c-C₄H₇ | C₆H₅ |
| A-619 | c-C₅H₉ | C₆H₅ |
| A-620 | c-C₆H₁₁ | C₆H₅ |
| A-621 | CH₂-c-C₃H₅ | C₆H₅ |
| A-622 | CH(CH₃)-c-C₃H₅ | C₆H₅ |
| A-623 | CH₂-c-C₅H₉ | C₆H₅ |
| A-624 | CH₂-c-C₅H₉ | C₆H₅ |
| A-625 | C₆H₅ | C₆H₅ |
| A-626 | CH₃ | CH₂-c-C₄H₇ |
| A-627 | C₂H₅ | CH₂-c-C₄H₇ |
| A-628 | CH═CH₂ | CH₂-c-C₄H₇ |
| A-629 | CH₂CH₂CH₃ | CH₂-c-C₄H₇ |
| A-630 | CH(CH₃)₂ | CH₂-c-C₄H₇ |
| A-631 | CH₂CH₂CH₂CH₃ | CH₂-c-C₄H₇ |
| A-632 | C(CH₃)₃ | CH₂-c-C₄H₇ |
| A-633 | CH₂CH(CH₃)₂ | CH₂-c-C₄H₇ |
| A-634 | CH(CH₃)CH₂CH₃ | CH₂-c-C₄H₇ |
| A-635 | CH₂CH═CH₂ | CH₂-c-C₄H₇ |
| A-636 | CH₂C≡CH | CH₂-c-C₄H₇ |
| A-637 | CH(CH₃)CH═CH₂ | CH₂-c-C₄H₇ |
| A-638 | CHF₂ | CH₂-c-C₄H₇ |
| A-639 | CH₂Cl | CH₂-c-C₄H₇ |
| A-640 | CH₂CH₂CN | CH₂-c-C₄H₇ |
| A-641 | CH₂CH₂Cl | CH₂-c-C₄H₇ |
| A-642 | c-C₃H₅ | CH₂-c-C₄H₇ |
| A-643 | c-C₄H₇ | CH₂-c-C₄H₇ |
| A-644 | c-C₅H₉ | CH₂-c-C₄H₇ |
| A-645 | c-C₆H₁₁ | CH₂-c-C₄H₇ |
| A-646 | CH₂-c-C₃H₅ | CH₂-c-C₄H₇ |
| A-647 | CH(CH₃)-c-C₃H₅ | CH₂-c-C₄H₇ |
| A-648 | CH₂-c-C₅H₉ | CH₂-c-C₄H₇ |
| A-649 | CH₂-c-C₆H₁₁ | CH₂-c-C₄H₇ |
| A-650 | C₆H₅ | CH₂-c-C₄H₇ |
| A-651 | CH₃ | CH₂CH₂-c-C₃H₅ |
| A-652 | C₂H₅ | CH₂CH₂-c-C₃H₅ |
| A-653 | CH═CH₂ | CH₂CH₂-c-C₃H₅ |
| A-654 | CH₂CH₂CH₃ | CH₂CH₂-c-C₃H₅ |
| A-655 | CH(CH₃)₂ | CH₂CH₂-c-C₃H₅ |
| A-656 | CH₂CH₂CH₂CH₃ | CH₂CH₂-c-C₃H₅ |
| A-657 | C(CH₃)₃ | CH₂CH₂-c-C₃H₅ |
| A-658 | CH₂CH(CH₃)₂ | CH₂CH₂-c-C₃H₅ |
| A-659 | CH(CH₃)CH₂CH₃ | CH₂CH₂-c-C₃H₅ |
| A-660 | CH₂CH═CH₂ | CH₂CH₂-c-C₃H₅ |
| A-661 | CH₂C≡CH | CH₂CH₂-c-C₃H₅ |
| A-662 | CH(CH₃)CH═CH₂ | CH₂CH₂-c-C₃H₅ |
| A-663 | CHF₂ | CH₂CH₂-c-C₃H₅ |
| A-664 | CH₂Cl | CH₂CH₂-c-C₃H₅ |
| A-665 | CH₂CH₂CN | CH₂CH₂-c-C₃H₅ |
| A-666 | CH₂CH₂Cl | CH₂CH₂-c-C₃H₅ |
| A-667 | c-C₃H₅ | CH₂CH₂-c-C₃H₅ |
| A-668 | c-C₄H₇ | CH₂CH₂-c-C₃H₅ |
| A-669 | c-C₅H₉ | CH₂CH₂-c-C₃H₅ |
| A-670 | c-C₆H₁₁ | CH₂CH₂-c-C₃H₅ |
| A-671 | CH₂-c-C₃H₅ | CH₂CH₂-c-C₃H₅ |
| A-672 | CH(CH₃)-c-C₃H₅ | CH₂CH₂-c-C₃H₅ |
| A-673 | CH₂-c-C₅H₉ | CH₂CH₂-c-C₃H₅ |
| A-674 | CH₂-c-C₆H₁₁ | CH₂CH₂-c-C₃H₅ |
| A-675 | C₆H₅ | CH₂CH₂-c-C₃H₅ |
| A-676 | CH₃ | CH₂(CH₂)₃CH₃ |
| A-677 | C₂H₅ | CH₂(CH₂)₃CH₃ |
| A-678 | CH═CH₂ | CH₂(CH₂)₃CH₃ |
| A-679 | CH₂CH₂CH₃ | CH₂(CH₂)₃CH₃ |
| A-680 | CH(CH₃)₂ | CH₂(CH₂)₃CH₃ |
| A-681 | CH₂CH₂CH₂CH₃ | CH₂(CH₂)₃CH₃ |
| A-682 | C(CH₃)₃ | CH₂(CH₂)₃CH₃ |
| A-683 | CH₂CH(CH₃)₂ | CH₂(CH₂)₃CH₃ |
| A-684 | CH(CH₃)CH₂CH₃ | CH₂(CH₂)₃CH₃ |
| A-685 | CH₂CH═CH₂ | CH₂(CH₂)₃CH₃ |
| A-686 | CH₂C≡CH | CH₂(CH₂)₃CH₃ |
| A-687 | CH(CH₃)CH═CH₂ | CH₂(CH₂)₃CH₃ |
| A-688 | CHF₂ | CH₂(CH₂)₃CH₃ |
| A-689 | CH₂Cl | CH₂(CH₂)₃CH₃ |
| A-690 | CH₂CH₂CN | CH₂(CH₂)₃CH₃ |
| A-691 | CH₂CH₂Cl | CH₂(CH₂)₃CH₃ |
| A-692 | c-C₃H₅ | CH₂(CH₂)₃CH₃ |
| A-693 | c-C₄H₇ | CH₂(CH₂)₃CH₃ |
| A-694 | c-C₅H₉ | CH₂(CH₂)₃CH₃ |
| A-695 | c-C₆H₁₁ | CH₂(CH₂)₃CH₃ |
| A-696 | CH₂-c-C₃H₅ | CH₂(CH₂)₃CH₃ |
| A-697 | CH(CH₃)-c-C₃H₅ | CH₂(CH₂)₃CH₃ |
| A-698 | CH₂-c-C₅H₉ | CH₂(CH₂)₃CH₃ |
| A-699 | CH₂-c-C₆H₁₁ | CH₂(CH₂)₃CH₃ |
| A-700 | C₆H₅ | CH₂(CH₂)₃CH₃ |
| A-701 | CH₃ | CH(CH₃)CH(CH₃)₂ |
| A-702 | C₂H₅ | CH(CH₃)CH(CH₃)₂ |
| A-703 | CH═CH₂ | CH(CH₃)CH(CH₃)₂ |
| A-704 | CH₂CH₂CH₃ | CH(CH₃)CH(CH₃)₂ |
| A-705 | CH(CH₃)₂ | CH(CH₃)CH(CH₃)₂ |
| A-706 | CH₂CH₂CH₂CH₃ | CH(CH₃)CH(CH₃)₂ |
| A-707 | C(CH₃)₃ | CH(CH₃)CH(CH₃)₂ |
| A-708 | CH₂CH(CH₃)₂ | CH(CH₃)CH(CH₃)₂ |
| A-709 | CH(CH₃)CH₂CH₃ | CH(CH₃)CH(CH₃)₂ |
| A-710 | CH₂CH═CH₂ | CH(CH₃)CH(CH₃)₂ |
| A-711 | CH₂C≡CH | CH(CH₃)CH(CH₃)₂ |
| A-712 | CH(CH₃)CH═CH₂ | CH(CH₃)CH(CH₃)₂ |
| A-713 | CHF₂ | CH(CH₃)CH(CH₃)₂ |
| A-714 | CH₂Cl | CH(CH₃)CH(CH₃)₂ |
| A-715 | CH₂CH₂CN | CH(CH₃)CH(CH₃)₂ |
| A-716 | CH₂CH₂Cl | CH(CH₃)CH(CH₃)₂ |
| A-717 | c-C₃H₅ | CH(CH₃)CH(CH₃)₂ |
| A-718 | c-C₄H₇ | CH(CH₃)CH(CH₃)₂ |
| A-719 | c-C₅H₉ | CH(CH₃)CH(CH₃)₂ |
| A-720 | c-C₆H₁₁ | CH(CH₃)CH(CH₃)₂ |
| A-721 | CH₂-c-C₃H₅ | CH(CH₃)CH(CH₃)₂ |
| A-722 | CH(CH₃)-c-C₃H₅ | CH(CH₃)CH(CH₃)₂ |
| A-723 | CH₂-c-C₅H₉ | CH(CH₃)CH(CH₃)₂ |
| A-724 | CH₂-c-C₆H₁₁ | CH(CH₃)CH(CH₃)₂ |
| A-725 | C₆H₅ | CH(CH₃)CH(CH₃)₂ |
| A-726 | CH₃ | CH₂(CH₂)₄CH₃ |
| A-727 | C₂H₅ | CH₂(CH₂)₄CH₃ |
| A-728 | C(CH₃)₃ | CH₂(CH₂)₄CH₃ |
| A-729 | CH₂(CH₂)₄CH₃ | CH₂(CH₂)₄CH₃ |
| A-730 | CH₃ | 2-EtHex |
| A-731 | C₂H₅ | 2-EtHex |
| A-732 | C(CH₃)₃ | 2-EtHex |
| A-733 | 2-EtHex | 2-EtHex |
| A-734 | CH₃ | CH₂CH₂OH |
| A-735 | C₂H₅ | CH₂CH₂OH |
| A-736 | C(CH₃)₃ | CH₂CH₂OH |
| A-737 | CH₂CH₂CH₂CH₃ | CH₂CH₂OH |
| A-738 | CH₂(CH₂)₃CH₃ | CH₂CH₂OH |
| A-739 | CH₂CH₂OH | CH₂CH₂OH |
| A-740 | CH₂-c-C₄H₇ | CH₂-c-C₄H₇ |
| A-741 | CH₂CH₂-c-C₃H₅ | CH₂CH₂-c-C₃H₅ |
| A-742 | CH(CH₃)CH(CH₃)₂ | CH(CH₃)CH(CH₃)₂ |
| A-743 | CH₂(CH₂)₃CH₃ | CH₂(CH₂)₃CH₃ |

| | |
|---|---|
| A-744 | (CH₂)₄ |
| A-745 | CH₂CH₂SCH₂ |

c-C₃H₅: cyclopropyl; c-C₄H₇: cyclobutyl; c-C₅H₉: cyclopentyl; c-C₆H₁₁: cyclohexyl; CH₂-c-C₃H₅: cyclopropylmethyl; CH(CH₃)-c-C₃H₅: 1-cyclopropylethyl; CH₂-c-C₅H₉: cyclopentylmethyl; CH₂-c-C₅H₉: cyclopentylmethyl; C₆H₅: phenyl; CH₂CH₂-c-C₃H₅: 2-cyclopropylethyl; CH₂-c-C₄H₇: 2-cyclobutylmethyl; 2-EtHex: CH₂CH(C₂H₅)(CH₂)₃CH3

A group of especially preferred compounds of formula I are compounds I-1 to I-40 of formula IA-1 which are listed in the table C in the example section.

In one embodiment, a compound selected from the compounds I-1 to I-40 as defined in Table C in the Example Section at the end of the description, are preferred in the methods and uses according to the invention.

In one embodiment, a compound selected from compounds I-11, I-16, I-21, I-26, I-31 is the compound I in the methods and uses according to the invention, which are defined in accordance with Table C of the example section:

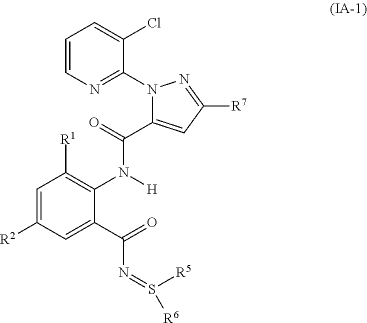

TABLE C′

| | R¹ | R² | R⁷ | R⁵ | R⁶ |
|---|---|---|---|---|---|
| I-11 | Me | Cl | CF₃ | C₂H₅ | C₂H₅ |
| I-16 | Cl | Cl | CF₃ | C₂H₅ | C₂H₅ |
| I-21 | Me | Cl | CF₃ | CH(CH₃)₂ | CH(CH₃)₂ |
| I-26 | Cl | Cl | CF₃ | CH(CH₃)₂ | CH(CH₃)₂ |
| I-31 | Br | Br | CF₃ | C₂H₅ | C₂H₅ |

In one embodiment, I-11 is the compound I in the methods and uses according to the invention. In one embodiment, I-16 is the compound I in the methods and uses according to the invention. In one embodiment, I-21 is the compound I in the methods and uses according to the invention. In one embodiment, I-26 is the compound I in the methods and uses according to the invention. In one embodiment, I-31 is the compound I in the methods and uses according to the invention.

Pests

In the methods according to the invention, the compounds of formula I are in particular suitable for efficiently controlling arthropodal pests such as arachnids, myriapedes and insects as well as nematodes. With regard to the present invention, the term pests embrace animal pests (such as insects, acarids or nematodes). The term animal pests include, but are not limited to the following genera and species:

insects from the order of the lepidopterans (Lepidoptera), for example Acronicta major, Adox-ophyes orana, Aedia leucomelas, Agrotis spp. such as Agrotis fucosa, Agrotis segetum, Agrotis ypsilon; Alabama argillacea, Anticarsia gemmatalis, Anticarsia spp., Argyresthia conjugella, Autographa gamma, Barathra brassicae, Bucculatrix thurberiella, Bupalus piniarius, Cacoecia murinana, Cacoecia podana, Capua reticulana, Carpocapsa pomonella, Cheimatobia brumata, Chilo spp. such as Chilo suppressalis; Choristoneura fumiferana, Choristoneura occidentalis, Cirphis unipuncta, Clysia ambiguella, Cnaphalocerus spp., Cydia pomonella, Dendrolimus pini, Diaphania nitidalis, Diatraea grandiosella, Earias insulana, Elasmopalpus lignosellus, Ephestia cautella, Ephestia kuehniella, Eupoecilia ambiguella, Euproctis chrysorrhoea, Euxoa spp., Evetria bouliana, Feltia spp. such as Feltia subterranean; Galleria mellonella, Grapholitha funebrana, Grapholitha molesta, Helicoverpa spp. such as Helicoverpa armigera, Helicoverpa zea; Heliothis spp. such as Heliothis armigera, Heliothis virescens, Heliothis zea; Hellula undalis, Hibernia defoliaria, Hofmannophila pseudospretella, Homona magnanima, Hyphantria cunea, Hyponomeuta padella, Hyponomeuta malinellus, Keiferia lycopersicella, Lambdina fiscellaria, Laphygma spp. such as Laphygma exigua; Leucoptera coffeella, Leucoptera scitella, Lithocolletis blancardella, Lithophane antennata, Lobesia botrana, Loxagrotis albicosta, Loxostege sticticalis, Lymantria spp. such as Lymantria dispar, Lymantria monacha; Lyonetia clerkella, Malacosoma neustria, Mamestra spp. such as Mamestra brassicae; Mocis repanda, Mythimna separata, Orgyia pseudotsugata, Oria spp., Ostrinia spp. such as Ostrinia nubilalis; Oulema oryzae, Panolis flammea, Pectinophora spp. such as Pectinophora gossypiella; Peridroma saucia, Phalera bucephala, Phthorimaea spp. such as Phthorimaea operculella; Phyllocnistis citrella, Pieris spp. such as Pieris brassicae, Pieris rapae; Plathypena scabra, Plutella maculipennis, Plutella xylostella, Prodenia spp., Pseudaletia spp., Pseudoplusia includens, Pyrausta nubilalis, Rhyacionia frustrana, Scrobipalpula absoluta, Sitotroga cerealella, Sparganothis pilleriana, Spodoptera spp. such as Spodoptera frugiperda, Spodoptera littoralis, Spodoptera litura; Thaumatopoea pityocampa, Thermesia gemmatalis, Tinea pellionella, Tineola bisselliella, Tortrix viridana, Trichoplusia spp. such as Trichoplusia ni; Tuta absoluta, and Zeiraphera canadensis,

beetles (Coleoptera), for example Acanthoscehdes obtectus, Adoretus spp., Agelastica alni, Agrilus sinuatus, Agriotes spp. such as Agriotes fuscicollis, Agriotes lineatus, Agriotes obscurus; Amphimallus solstitialis, Anisandrus dispar, Anobium punctatum, Anomala rufocuprea, Ano-plophora spp. such as Anoplophora glabripennis; Anthonomus spp. such as Anthonomus grandis, Anthonomus pomorum; Anthrenus spp., Aphthona euphoridae, Apogonia spp., Athous haemorrhoidalis, Atomaria spp. such as Atomaria linearis; Attagenus spp., Aulacophora femoralis, Blastophagus piniperda, Blitophaga undata, Bruchidius obtectus, Bruchus spp. such as Bruchus lentis, Bruchus pisorum, Bruchus rufimanus; Byctiscus betulae, Callosobruchus chinensis, Cassida nebulosa, Cerotoma trifurcata, Cetonia aurata, Ceuthorhynchus spp. such as Ceuthorrhynchus assimilis, Ceuthorrhynchus napi; Chaetocnema tibialis, Cleonus mendicus, Conoderus spp. such as Conoderus vespertinus; Cosmopolites spp., Costelytra zealandica, Crioceris asparagi, Cryptorhynchus lapathi, Ctenicera ssp. such as Ctenicera destructor; Curculio spp., Dectes texanus, Dermestes spp., Diabrotica spp. such as Diabrotica 12-punctata Diabrotica speciosa, Diabrotica longicornis, Diabrotica semipunctata, Diabrotica virgifera; Epilachna spp. such as Epilachna varivestis, Epilachna vigintioctomaculata; Epitrix spp. such as Epitrix hirtipennis; Eutinobothrus brasiliensis, Faustinus cubae, Gibbium psylloides, Heter-onychus arator, Hylamorpha elegans, Hylobius abietis, Hylotrupes bajulus, Hypera brunneipennis, Hypera postica, Hypothenemus spp., Ips typographus, Lachnosterna consanguinea, Lema bilineata, Lema melanopus, Leptinotarsa spp. such as Leptinotarsa decemlineata; Limonius californicus, Lissorhoptrus oryzophilus, Lissorhoptrus oryzophilus, Lixus spp., Lyctus spp. such as Lyctus bruneus; Melanotus communis, Meligethes spp. such as Meligethes aeneus; Melolontha hippocastani, Melolontha melolontha, Migdolus spp., Monochamus spp. such as Monochamus alternatus; Naupactus xanthographus, Niptus hololeucus, Oryctes rhinoceros, Oryzaephilus surinamensis, Otiorrhynchus sulcatus, Otiorrhynchus ovatus, Otiorrhynchus sulcatus, Oulema oryzae, Oxycetonia jucunda, Phaedon cochleariae, Phyllobius pyri, Phyllopertha horticola, Phyllophaga spp., Phyllotreta spp. such as Phyllotreta chrysocephala, Phyllotreta nemorum, Phyllotreta striolata; Phyllophaga spp., Phyllopertha horticola, Popillia japonica, Premnotrypes spp., Psylliodes chrysocephala, Ptinus spp., Rhizobius ventralis, Rhizopertha dominica, Sitona lineatus, Sitophilus spp. such as Sitophilus granaria, Sitophilus zeamais; Sphenophorus spp. such as Sphenophorus levis; Sternechus spp. such as Sternechus subsignatus; Symphyletes spp., Tenebrio molitor, Tribolium spp. such as Tribolium castaneum; Trogoderma spp., Tychius spp., Xylotrechus spp., and Zabrus spp. such as Zabrus tenebrioides,
flies, mosquitoes (Diptera), e.g. Aedes spp. such as Aedes aegypti, Aedes albopictus, Aedes vexans; Anastrepha ludens, Anopheles spp. such as Anopheles albimanus, Anopheles crucians, Anopheles freeborni, Anopheles gambiae, Anopheles leucosphyrus, Anopheles maculipennis, Anopheles minimus, Anopheles quadrimaculatus, Anopheles sinensis; Bibio hortulanus, Calliphora erythrocephala, Calliphora vicina, Cerafitis capitata, Ceratitis capitata, Chrysomyia spp. such as Chrysomya bezziana, Chrysomya hominivorax, Chrysomya macellaria; Chrysops atlanticus, Chrysops discalis, Chrysops silacea, Cochliomyia spp. such as Cochliomyia hominivorax; Contarinia spp. such as Contarinia sorghicola; Cordylobia anthropophaga, Culex spp. such as Culex nigripalpus, Culex pipiens, Culex quinquefasciatus, Culex tarsalis, Culex tritaeniorhynchus; Culicoides furens, Culiseta inornata, Culiseta melanura, Cuterebra spp., Dacus cucurbitae, Dacus oleae, Dasineura brassicae, Delia spp. such as Delia antique, Delia coarctata, Delia platura, Delia radicum; Dermatobia hominis, Drosophila spp., Fannia spp. such as Fannia canicularis; Gastraphilus spp. such as Gasterophilus intestinalis; Geomyza Tripunctata, Glossina fuscipes, Glossina morsitans, Glossina palpalis, Glossina tachinoides, Haematobia irritans, Haplodiplosis equestris, Hippelates spp., Hylemyia spp. such as Hylemyia platura; Hypoderma spp. such as Hypoderma lineata; Hyppobosca spp., Leptoconops torrens, Liriomyza spp. such as Liriomyza sativae, Liriomyza trifolii; Lucilia spp. such as Lucilia caprina, Lucilia cuprina, Lucilia sericata; Lycoria pectoralis, Mansonia titillanus, Mayetiola spp. such as Mayetiola destructor; Musca spp. such as Musca autumnalis, Musca domestica; Muscina stabulans, Oestrus spp. such as Oestrus ovis; Opomyza florum, Oscinella spp. such as Oscinella frit; Pegomya hysocyami, Phlebotomus argentipes, Phorbia spp. such as Phorbia antiqua, Phorbia brassicae, Phorbia coarctata; Prosimulium mixtum, Psila rosae, Psorophora columbiae, Psorophora discolor, Rhagoletis cerasi, Rhagoletis pomonella, Sarcophaga spp. such as Sarcophaga haemorrhoidalis; Simulium vittatum, Stomoxys spp. such as Stomoxys calcitrans; Tabanus spp. such as Tabanus atratus, Tabanus bovinus, Tabanus lineola, Tabanus similis; Tannia spp., Tipula oleracea, Tipula paludosa, and Wohlfahrtia spp.,
thrips (Thysanoptera), e.g. Baliothrips biformis, Dichromothrips corbetti, Dichromothrips ssp., Enneothrips flavens, Frankliniella spp. such as Frankliniella fusca, Frankliniella occidentalis, Frankliniella tritici; Heliothrips spp., Hercinothrips femoralis, Kakothrips spp., Rhipiphorothrips cruentatus, Scirtothrips spp. such as Scirtothrips citri; Taeniothrips cardamoni, Thrips spp. such as Thrips oryzae, Thrips palmi, Thrips tabaci;
termites (Isoptera), e.g. Calotermes flavicollis, Coptotermes formosanus, Heterotermes aureus, Heterotermes longiceps, Heterotermes tenuis, Leucotermes flavipes, Odontotermes spp., Reticulitermes spp. such as Reticulitermes speratus, Reticulitermes flavipes, Reticulitermes grassei, Reticulitermes lucifugus, Reticulitermes santonensis, Reticulitermes virginicus; Termes natalensis,
cockroaches (Blattaria-Blattodea), e.g. Acheta domesticus, Blatta orientalis, Blattella asahinae, Blattella germanica, Gryllotalpa spp., Leucophaea maderae, Locusta spp., Melanoplus spp., Periplaneta americana, Periplaneta australasiae, Periplaneta brunnea, Periplaneta fuligginosa, Periplaneta japonica,
bugs, aphids, leafhoppers, whiteflies, scale insects, cicadas (Hemiptera), e.g. Acrosternum spp. such as Acrosternum hilare; Acyrthosipon spp. such as Acyrthosiphon onobrychis, Acyrthosiphon pisum; Adelges laricis, Aeneolamia spp., Agonoscena spp., Aleurodes spp., Aleurolobus barodensis, Aleurothrixus spp., Amrasca spp., Anasa tristis, Antestiopsis spp., Anuraphis cardui, Aonidiella spp., Aphanostigma piri, Aphidula nasturtii, Aphis spp. such as Aphis fabae, Aphis forbesi, Aphis gossypii, Aphis grossulariae, Aphis pomi, Aphis sambuci, Aphis schneideri, Aphis spiraecola; Arboridia apicalis, Arilus critatus, Aspidiella spp., Aspidiotus spp., Atanus spp., Aulacorthum solani, Bemisia spp. such as Bemisia argentifolii, Bemisia tabaci; Blissus spp. such as Blissus leucopterus; Brachycaudus cardui, Brachycaudus helichrysi, Brachycaudus persicae, Brachycaudus prunicola, Brachycolus spp., Brevicoryne brassicae, Calligypona marginata, Calocoris spp., Campylomma livida, Capitophorus horni, Carneocephala fulgida, Cavelerius spp., Ceraplastes spp., Ceratovacuna lanigera, Cercopidae, Cerosipha gossypii, Chaetosiphon fragaefolii, Chionaspis tegalensis, Chlorita onukii, Chromaphis juglandicola, Chrysomphalus ficus, Cicadulina mbila, Cimex spp. such as Cimex hemipterus, Cimex lectularius; Coccomytilus halli, Coccus spp., Creontiades dilutus, Cryptomyzus ribis, Cryptomyzus ribis, Cyrtopeltis notatus, Dalbulus spp., Dasynus piperis, Dialeurades spp., Diaphorina spp., Diaspis spp., Dichelops furcatus, Diconocoris hewetti, Doralis spp., Dreyfusia nordmannianae, Dreyfusia piceae, Drosicha spp., Dysaphis spp. such as Dysaphis plantaginea, Dysaphis pyri, Dysaphis radicola; Dysaulacorthum pseudosolani, Dysdercus spp. such as Dysdercus cingulatus, Dysdercus intermedius; Dysmicoccus spp., Empoasca spp. such as Empoasca fabae, Empoasca solana; Eriosoma spp., Erythroneura spp., Eurygaster spp. such as Eurygaster integriceps; Euscelis bilobatus, Euschistus spp. such as Euschistuos heros, Euschistus impictiventris, Euschistus servus; Geococcus coffeae, Halyomorpha spp. such as Halyomorpha halys; Heliopeltis spp., Homalodisca coagulata, Horcias nobilellus, Hyalopterus pruni, Hyperomyzus lactucae, Icerya spp., Idiocerus spp., Idioscopus spp., Laodelphax striatellus, Lecanium spp., Lepidosaphes spp., Leptocorisa spp., Leptoglossus phyllopus, Lipaphis erysimi, Lygus spp. such as Lygus hesperus, Lygus lineolaris, Lygus pratensis; Macropes excavatus, Macrosiphum spp. such as Macrosiphum rosae, Macrosiphum avenae, Macrosiphum euphorbiae; Mahanarva fimbriolata, Megacopta cribraria, Megoura viciae, Melanaphis pyrarius, Melanaphis sacchari, Metcafiella spp., Metopolophium dirhodum, Miridae spp., Monellia costalis, Monelliopsis pecanis, Myzus spp. such as Myzus ascalonicus, Myzus cerasi, Myzus persicae, Myzus varians; Nasonovia ribis-nigri, Nephotettix spp. such as Nephotettix malayanus, Nephotettix nigropictus, Nephotettix parvus, Nephotettix virescens; Nezara spp. such as Nezara viridula; Nilaparvata lugens, Oebalus spp., Oncometopia spp., Orthezia praelonga, Parabemisia myricae, Paratrioza spp., Parlatoria spp., Pemphigus spp. such as Pemphigus bursarius; Pentomidae, Peregrinus maidis, Perkinsiella saccharicida, Phenacoccus spp., Phloeomyzus passerinii, Phorodon humuli, Phylloxera spp., Piesma quadrata, Piezodorus spp. such as Piezodorus guildinii, Pinnaspis aspidistrae, Planococcus spp., Protopulvinaria pyriformis, Psallus seriatus, Pseudacysta persea, Pseudaulacaspis pentagona, Pseudococcus spp. such as Pseudococcus comstocki; Psylla spp. such as Psylla mali, Psylla piri; Pteromalus spp., Pyrilla spp., Quadraspidiotus spp., Quesada gigas, Rastrococcus spp., Reduvius senilis, Rhodnius spp., Rhopalomyzus ascalonicus, Rhopalosiphum spp. such as Rhopalosiphum pseudobrassicas, Rhopalosiphum insertum, Rhopalosiphum maidis, Rhopalosiphum padi; Sagatodes spp., Sahlbergella singularis, Saissetia spp., Sappaphis mala, Sappaphis mali, Scaphoides titanus, Schizaphis graminum, Schizoneura lanuginosa, Scotinophora spp., Selenaspidus articulatus, Sitobion avenae, Sogata spp., Sogatella furcifera, Solubea insularis, Stephanitis nashi, Stictocephala festina, Tenalaphara malayensis, Thyanta spp. such as Thyanta perditor; Tibraca spp., Tinocallis caryaefoliae, Tomaspis spp., Toxoptera spp. such as Toxoptera aurantii; Trialeurodes spp. such as Trialeurodes vaporariorum; Triatoma spp., Trioza spp., Typhlocyba spp., Unaspis spp. such as Unaspis yanonensis; and Viteus vitifolii,
ants, bees, wasps, sawflies (Hymenoptera), e.g. Athalia rosae, Atta capiguara, Atta cephalotes, Atta cephalotes, Atta laevigata, Atta robusta, Atta sexdens, Atta texana, Bombus spp., Camponotus floridanus, Crematogaster spp., Dasymutilla occidentalis, Diprion spp., Dolichovespula maculata, Hoplocampa spp. such as Hoplocampa minuta, Hoplocampa testudinea; Lasius spp. such as Lasius niger, Linepithema humile, Monomorium pharaonis, Paravespula germanica, Paravespula pennsylvanica, Paravespula vulgaris, Pheidole megacephala, Pogonomyrmex barbatus, Pogonomyrmex californicus, Polistes rubiginosa, Solenopsis geminata, Solenopsis invicta, Solenopsis richteri, Solenopsis xyloni, Vespa spp. such as Vespa crabro, and Vespula squamosa,
crickets, grasshoppers, locusts (Orthoptera), e.g. Acheta domestica, Calliptamus italicus, Chortoicetes terminifera, Dociostaurus maroccanus, Gryllotalpa africana, Gryllotalpa gryllotalpa, Hieroglyphus daganensis, Kraussaria angulifera, Locusta migratoria, Locustana pardalina, Melanoplus bivittatus, Melanoplus femurrubrum, Melanoplus mexicanus, Melanoplus sanguinipes, Melanoplus spretus, Nomadacris septemfasciata, Oedaleus senegalensis, Schistocerca americana, Schistocerca gregaria, Tachycines asynamorus, and Zonozerus variegatus,
arachnids (Arachnida), such as acari, e.g. of the families Argasidae, Ixodidae and Sarcoptidae, such as Amblyomma spp. (e.g. Amblyomma americanum, Amblyomma variegatum, Amblyomma maculatum), Argas spp. (e.g. Argas persicus), Boophilus spp. (e.g. Boophilus annulatus, Boophilus decoloratus, Boophilus microplus), Dermacentor silvarum, Dermacentor andersoni, Dermacentor variabilis, Hyalomma spp. (e.g. Hyalomma truncatum), Ixodes spp. (e.g. Ixodes ricinus, Ixodes rubicundus, Ixodes scapularis, Ixodes holocyclus, Ixodes pacificus), Ornithodorus spp. (e.g. Ornithodorus moubata, Ornithodorus hermsi, Ornithodorus turicata), Ornithonyssus bacoti, Otobius megnini, Dermanyssus gallinae, Psoroptes spp. (e.g. Psoroptes ovis), Rhipicephalus spp. (e.g. Rhipicephalus sanguineus, Rhipicephalus appendiculatus, Rhipicephalus evertsi), Rhizoglyphus spp., Sarcoptes spp. (e.g. Sarcoptes scabiei), and Eriophyidae spp. such as Acaria sheldoni, Aculops spp. (e.g. Aculops pelekassi) Aculus spp. (e.g. Aculus schlechtendali), Epitrimerus pyri, Phyllocoptruta oleivora and Eriophyes spp. (e.g. Eriophyes sheldoni); Tarsonemidae spp. such as Hemitarsonemus spp., Phytonemus pallidus and Polyphagotarsonemus latus, Stenotarsonemus spp.; Tenuipalpidae spp. such as Brevipalpus spp. (e.g. Brevipalpus phoenicis); Tetranychidae spp. such as Eotetranychus spp., Eutetranychus spp., Oligonychus spp., Tetranychus cinnabarinus, Tetranychus kanzawai, Tetranychus pacificus, Tetranychus telarius and Tetranychus urticae; Bryobia praetiosa, Panonychus spp. (e.g. Panonychus ulmi, Panonychus citri), Metatetranychus spp. and Oligonychus spp. (e.g. Oligonychus pratensis), Vasates lycopersici; Araneida, e.g. Latrodectus mactans, and Loxosceles reclusa. And Acarus siro, Chorioptes spp., Scorpio maurus
fleas (Siphonaptera), e.g. Ceratophyllus spp., Ctenocephalides felis, Ctenocephalides canis, Xenopsylla cheopis, Pulex irritans, Tunga penetrans, and Nosopsyllus fasciatus,
silverfish, firebrat (Thysanura), e.g. Lepisma saccharina and Thermobia domestica,
centipedes (Chilopoda), e.g. Geophilus spp., Scutigera spp. such as Scutigera coleoptrata; millipedes (Diplopoda), e.g. Blaniulus guttulatus, Narceus spp.,
Earwigs (Dermaptera), e.g. forficula auricularia,
lice (Phthiraptera), e.g. Damalinia spp., Pediculus spp. such as Pediculus humanus capitis, Pediculus humanus corporis; Pthirus pubis, Haematopinus spp. such as Haematopinus eurysternus, Haematopinus suis; Linognathus spp. such as Linognathus vituli; Bovicola bovis, Menopon gallinae, Menacanthus stramineus and Solenopotes capillatus, Trichodectes spp.,
springtails (Collembola), e.g. Onychiurus ssp. such as Onychiurus armatus,

They are also suitable for controlling nematodes: plant parasitic nematodes such as root knot nematodes, Meloidogyne hapla, Meloidogyne incognita, Meloidogyne javanica, and other Meloidogyne species; cyst-forming nematodes, Globodera rostochiensis and other Globodera species; Heterodera avenae, Heterodera glycines, Heterodera schachtii, Heterodera trifolii, and other Heterodera species; Seed gall nematodes, Anguina species; Stem and foliar nematodes, Aphelenchoides species such as Aphelenchoides besseyi; Sting nematodes, Belonolaimus longicaudatus and other Belonolaimus species; Pine nematodes, Bursaphelenchus lignicolus Mamiya et Kiyohara, Bursaphelenchus xylophilus and other Bursaphelenchus species; Ring nematodes, Criconema species, Criconemella species, Criconemoides species, Mesocriconema species; Stem and bulb nematodes, Ditylenchus destructor, Ditylenchus dipsaci and other Ditylenchus species; Awl nematodes, Dolichodorus species; Spiral nematodes, Heliocotylenchus multicinctus and other Helicotylenchus species; Sheath and sheathoid nematodes, Hemicycliophora species and Hemicriconemoides species; Hirshmanniella species; Lance nematodes, Hoploaimus species; false rootknot nematodes, Nacobbus species; Needle nematodes, Longidorus elongatus and other Longidorus species; Lesion nematodes, Pratylenchus brachyurus, Pratylenchus neglectus, Pratylenchus penetrans, Pratylenchus curvitatus, Pratylenchus goodeyi and other Pratylenchus species; Burrowing nematodes, Radopholus similis and other Radopholus species; Reniform nematodes, Rotylenchus robustus, Rotylenchus reniformis and other Rotylenchus species; Scutellonema species; Stubby root nematodes, Trichodorus primitivus and other Trichodorus species, Paratrichodorus species; Stunt nematodes, Tylenchorhynchus claytoni, Tylenchorhynchus dubius and other Tylenchorhynchus species; Citrus nematodes, Tylenchulus species such as Tylenchulus semipenetrans; Dagger nematodes, Xiphinema species; and other plant parasitic nematode species.

Examples of further pest species which may be controlled by compounds of formula (I) include: from the class of the Bivalva, for example, Dreissena spp.; from the class of the Gastropoda, for example, Anion spp., Biomphalaria spp., Bulinus spp., Deroceras spp., Galba spp., Lymnaea spp., Oncomelania spp., Succinea spp.; from the class of the helminths, for example, Ancylostoma duodenale, Ancylostoma ceylanicum, Acylostoma braziliensis, Ancylostoma spp., Ascaris lumbricoides, Ascaris spp., Brugia malayi, Brugia timori, Bunostomum spp., Chabertia spp., Clonorchis spp., Cooperia spp., Dicrocoelium spp., Dictyocaulus filaria, Diphyllobothrium latum, Dracunculus medinensis, Echinococcus granulosus, Echinococcus multilocularis, Enterobius vermicularis, Faciola spp., Haemonchus spp. such as Haemonchus contortus; Heterakis spp., Hymenolepis nana, Hyostrongulus spp., Loa Loa, Nematodirus spp., Oesophagostomum spp., Opisthorchis spp., Onchocerca volvulus, Ostertagia spp., Paragonimus spp., Schistosomen spp., Strongyloides fuelleborni, Strongyloides stercora lis, Stronyloides spp., Taenia saginata, Taenia solium, Trichinella spiralis, Trichinella nativa, Trichinella britovi, Trichinella nelsoni, Trichinella pseudopsiralis, Trichostrongulus spp., Trichuris trichiura, Wuchereria bancrofti; from the order of the Isopoda, for example, Armadillidium vulgare, Oniscus asellus, Porcellio scaber; from the order of the Symphyla, for example, Scutigerella immaculata.

Further examples of pest species which may be controlled by compounds of formula (I) include: Anisoplia austriaca, Apamea spp., Austroasca viridigrisea, Baliothrips biformis, Caenorhabditis elegans, Cephus spp., Ceutorhynchus napi, Chaetocnema aridula, Chilo auricilius, Chilo indicus, Chilo polychrysus, Chortiocetes terminifera, Cnaphalocroci medinalis, Cnaphalocrosis spp., Colias eurytheme, Collops spp., Cornitermes cumulans, Creontiades spp., Cyclocephala spp., Dalbulus maidis, Deraceras reticulatum, Diatrea saccharalis, Dichelops furcatus, Dicladispa armigera, Diloboderus spp. such as Diloboderus abderus; Edessa spp., Epinotia spp., Formicidae, Geocoris spp., Globitermes sulfureus, Gryllotalpidae, Halotydeus destructor, Hipnodes bicolor, Hydrellia philippina, Julus spp., Laodelphax spp., Leptocorsia acuta, Leptocorsia oratorius, Liogenys fuscus, Lucillia spp., Lyogenys fuscus, Mahanarva spp., Maladera matrida, Marasmia spp., Mastotermes spp., Mealybugs, Megascelis ssp, Metamasius hemipterus, Microtheca spp., Mocis latipes, Murgantia spp., Mythemina separata, Neocapritermes opacus, Neo-capritermes parvus, Neomegalotomus spp., Neotermes spp., Nymphula depunctalis, Oebalus pugnax, Orseolia spp. such as Orseolia oryzae; Oxycaraenus hyalinipennis, Plusia spp., Pomacea canaliculata, Procornitermes ssp, Procornitermes triacifer, Psylloides spp., Rachiplusia spp., Rhodopholus spp., Scaptocoris castanea, Scaptocoris spp., Scirpophaga spp. such as Scirpophaga incertulas, Scirpophaga innotata; Scotinophara spp. such as Scotinophara coarctata; Sesamia spp. such as Sesamia inferens, Sogaella frucifera, Solenapsis geminata, Spissistilus spp., Stalk borer, Stenchaetothrips biformis, Steneotarsonemus spinki, Sylepta derogata, Telehin licus, Trichostrongylus spp.

Mixtures of the present invention are particularly useful for controlling insects, preferably sucking or piercing insects such as insects from the genera Thysanoptera, Diptera and Hemiptera, and chewing-biting pests such as insects from the genera of Lepidoptera and Coleoptera, in particular the following species: Thysanoptera: Frankliniella fusca, Frankliniella occidentalis, Frankliniella tritici, Scirtothrips citri, Thrips oryzae, Thrips palmi and Thrips tabaci,

Diptera, e.g. Aedes aegypti, Aedes albopictus, Aedes vexans, Anastrepha ludens, Anopheles maculipennis, Anopheles crucians, Anopheles albimanus, Anopheles gambiae, Anopheles freeborni, Anopheles leucosphyrus, Anopheles minimus, Anopheles quadrimaculatus, Calliphora vicina, Ceratitis capitata, Chrysomya bezziana, Chrysomya hominivorax, Chrysomya macellana, Chrysops discalis, Chrysops silacea, Chrysops atlanticus, Cochliomyia hominivorax, Contarinia sorghicola Cordylobia anthropophaga, Culicoides furens, Culex pipiens, Culex nigripalpus, Culex quinquefasciatus, Culex tarsalis, Culiseta inornata, Culiseta melanura, Dacus cucurbitae, Dacus oleae, Dasineura brassicae, Delia antique, Delia coarctata, Delia platura, Delia radicum, Dermatobia hominis, Fannia canicularis, Geomyza Tripunctata, Gasterophilus intestinalis, Glossina morsitans, Glossina palpalis, Glossina fuscipes, Glossina tachinoides, Haematobia irritans, Haplodiplosis equestris, Hippelates spp., Hylemyia platura, Hypoderma lineata, Leptoconops torrens, Liriomyza sativae, Liriomyza trifolii, Lucilia caprin, Lucilia cuprina, Lucilia sericata, Lycoria pectoralis, Mansonia titillanus, Mayetiola destructor, Musca autumnalis, Musca domestica, Muscina stabulans, Oestrus ovis, Opomyza forum, Oscinella frit, Pegomya hysocyami, Phorbia antiqua, Phorbia brassicae, Phorbia coarctata, Phlebotomus argentipes, Psorophora columbiae, Psila rosae, Psorophora discolor, Prosimulium mixtum, Rhagoletis cerasi, Rhagoletis pomonella, Sarcophaga haemorrhoidalis, Sarcophaga spp., Simulium vittatum, Stomoxys calcitrans, Tabanus bovinus, Tabanus atratus, Tabanus lineola, and Tabanus similis, Tipula oleracea, and Tipula paludosa;

Hemiptera, in particular aphids: Acyrthosiphon onobrychis, Adelges laricis, Aphidula nasturtii, Aphis fabae, Aphis forbesi, Aphis pomi, Aphis gossypii, Aphis grossulanae, Aphis schneideri, Aphis spiraecola, Aphis sambuci, Acyrthosiphon pisum, Aulacorthum solani, Brachycaudus cardui, Brachycaudus helichrysi, Brachycaudus persicae, Brachycaudus prunicola, Brevicoryne brassicae, Capitophorus horni, Cerosipha gossypii, Chaetosiphon fragaefolil Cryptomyzus ribis, Dreyfusia nordmannianae, Dreyfusia piceae, Dysaphis radicola, Dysaulacorthum pseudosolani, Dysaphis plantaginea, Dysaphis gyri, Empoasca fabae, Hyalopterus pruni, Hyperomyzus lactucae, Macrosiphum avenae, Macrosiphum euphorbiae, Macrosiphon rosae, Megoura viciae, Melanaphis pyrarius, Metopolophium dirhodum, Myzodes persicae, Myzus ascalonicus, Myzus cerasi, Myzus varians, Nasonovia ribis-nigri, Nilaparvata lugens, Pemphigus bursarius, Perkinsiella saccharicida, Phorodon humuil Psylla mail Psylla piri, Rhopalomyzus ascalonicus, Rhopalosiphum maidis, Rhopalosiphum padi, Rhopalosiphum insertum, Sappaphis mala, Sappaphis mali, Schizaphis graminum, Schizoneura lanuginosa, Sitobion avenae, Tnaleurodes vaporariorum, Toxoptera aurantiiand, and Viteus vitifolii.

Lepidoptera, in particular: Agrotis ypsilon, Agrotis segetum, Alabama argillacea, Anticarsia gemmatalis, Argyresthia conjugella, Autographa gamma, Bupalus piniarius, Cacoecia murinana, Capua reticulana, Cheimatobia brumata, Choristoneura fumiferana, Choristoneura occidentalis, Cirphis unipuncta, Cydia pomonella, Dendrolimus pini, Diaphania nitidalis, Diatraea grandiosella, Earias insulana, Elasmopalpus lignosellus, Eupoecilia ambiguella, Evetria bouliana, Feltia subterranea, Galleria mellonella, Grapholitha funebrana, Grapholitha molesta, Heliothis armigera, Heliothis virescens, Heliothis zea, Hellula undalis, Hibernia defoliaria, Hyphantria cunea, Hyponomeuta malinellus, Keiferia lycopersicella, Lambdina gscellaria, Laphygma exigua, Leucoptera coffeella, Leucoptera scitella, Lithocolletis blancardella, Lobesia botrana, Loxostege sticticalis, Lymantria dispar, Lymantria monacha, Lyonetia clerkella, Malacosoma neustria, Mamestra brassicae, Orgyia pseudotsugata, Ostrinia nubilalis, Panolis flammea, Pectinophora gossypiella, Peridroma saucia, Phalera bucephala, Phthorimaea operculella, Phyllocnistis citrella, Pieris brassicae, Plathypena scabra, Plutella xylostella, Pseudoplusia includens, Rhyacionia frustrana, Scrobipalpula absoluta, Sitotroga cerealella, Sparganothis pillenana, Spodoptera frugiperda, Spodoptera littoralis, Spodoptera litura, Thaumatopoea pityocampa, TortriX viridana, Trichoplusia ni and Zeiraphera canadensis.

Mixtures of the present invention are particularly useful for controlling insects from the order of Coleoptera, in particular Agrilus sinuatus, Agriotes lineatus, Agriotes obscurus, Amphimallus solstitialis, Anisandrus dispar, Anthonomus grandis, Anthonomus pomorum, Aphthona euphoridae, Athous haemorrhoidalis, Atomaria linearis, Blastophagus piniperda, Blitophaga undata, Bruchus rufimanus, Bruchus pisorum, Bruchus lentis, Byctiscus betulae, Cassida nebulosa, Cerotoma trifurcata, Cetonia aurata, Ceuthorrhynchus assimilis, Ceuthorrhynchus napi, Chaetocnema tibialis, Conoderus vespertinus, Crioceris asparagi, Ctenicera ssp., Diabrotica longicornis, Diabrotica semipunctata, Diabrotica 12-punctata Diabrotica speciosa, Diabrotica virgifera, Epilachna varivestis, Epitrix hirtipennis, Eutinobothrus brasiilensis, Hylobius abietis, Hypera brunneipennis, Hypera postica, Ips typographus, Lema bilineata, Lema melanopus, Leptinotarsa decemlineata, Limonius californicus, Lissorhoptrus olyzophilus, Melanotus communis, Meligethes aeneus, Melolontha hippocastani, Melolontha melolontha, Oulema oryzae, Otiorrhynchus sulcatus, Otiorrhynchus ovatus, Phaedon cochleariae, Phyllobius pyri, Phyllotreta chrysocephala, Phyllophaga sp., Phyllopertha horticola, Phyllotreta nemorum, Phyllotreta striolata, Popillia japonica, Sitona lineatus and Sitophilus granaria.

Mixtures of the present invention are particularly useful for controlling insects of the orders Lepidoptera, Coleoptera, Hemiptera and Thysanoptera.

The mixtures of the present invention are especially suitable for efficiently combating pests like insects from the order of the lepidopterans (Lepidoptera), beetles (Coleoptera), flies and mosquitoes (Diptera), thrips (Thysanoptera), termites (Isoptera), bugs, aphids, leafhoppers, whiteflies, scale insects, cicadas (Hemiptera), ants, bees, wasps, sawflies (Hymenoptera), crickets, grasshoppers, locusts (Orthoptera), and also Arachnoidea, such as arachnids (Acarina).

Compounds (II)

In one embodiment of the invention, the compounds of formula I are employed as a solo product.

One typical problem arising in the field of pest control lies in the need to reduce the dosage rates of the active ingredient in order to reduce or avoid unfavorable environmental or toxicological effects whilst still allowing effective pest control.

The present invention also relates to methods for controlling pests and/or increasing the plant health of a cultivated plant, comprising in the application of a mixture of a compound of formula I and a pesticide II to a cultivated plant, parts of such plant, plant propagation material, or at its locus of growth.

Therefore, in another embodiment of the invention, the compounds of formula I are employed in combination (e.g. a mixture) with one or more compounds II which is a preferably a further insecticide or a fungicide.

The pesticidally active compounds II with which the compounds of formula I are combined with for the methods according to present invention are the following:

The compound (II) pesticides, together with which the compounds of formula I may be used according to the purpose of the present invention, and with which potential synergistic effects with regard to the method of uses might be produced, are selected and grouped according to the Mode of Action Classification from the Insecticide Resistance Action Committee (IRAC) and are

selected from group M consisting of
II-M.1 Acetylcholine esterase (AChE) inhibitors from the class of
II-M.1A carbamates, including aldicarb, alanycarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, trimethacarb, XMC, xylylcarb and triazamate; or from the class of
II-M.1B organophosphates, including acephate, azamethiphos, azinphos-ethyl, azinphosmethyl, cadusafos, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O-(methoxyaminothio-phosphoryl) salicylate, isoxathion, malathion, mecarbam, methamidophos, methidathion, mevinphos, monocrotophos, naled, omethoate, oxydemetonmethyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon and vamidothion;
II-M.2 GABA-gated chloride channel antagonists such as:
II-M.2A cyclodiene organochlorine compounds, including endosulfan or chlordane; or
II-M.2B fiproles (phenylpyrazoles), including ethiprole, fipronil, flufiprole, pyrafluprole and pyriprole;
II-M.3 Sodium channel modulators from the class of
II-M.3A pyrethroids, including acrinathrin, allethrin, d-cis-trans allethrin, d-trans allethrin, bifenthrin, bioallethrin, bioallethrin S-cylclopentenyl, bioresmethrin, cycloprothrin, cyfluthrin, beta-cyfluthrin, cyhalothrin, lambda-cyhalothrin, gammacyhalothrin, cypermethrin, alpha-cypermethrin, beta-cypermethrin, thetacypermethrin, zeta-cypermethrin, cyphenothrin, deltamethrin, empenthrin, esfenvalerate, etofenprox, fenpropathrin, fenvalerate, flucythrinate, flumethrin, tau-fluvalinate, halfenprox, imiprothrin, meperfluthrin, metofluthrin, momfluorothrin, permethrin, phenothrin, prallethrin, profluthrin, pyrethrin (pyrethrum), resmethrin, silafluofen, tefluthrin, tetramethylfluthrin, tetramethrin, tralomethrin and transfluthrin; or
II-M.3B sodium channel modulators such as DDT or methoxychlor;
II-M.4 Nicotinic acetylcholine receptor agonists (nAChR) from the class of
II-M.4A neonicotinoids, including acetamiprid, chlothianidin, dinotefuran, imidacloprid, nitenpyram, thiacloprid and thiamethoxam; or the compounds
II-M.4A.1: 1-[(6-chloro-3-pyridinyl)methyl]-2,3,5,6,7,8-hexahydro-9-nitro-(5S,8R)-5,8-Epoxy-1H-imidazo[1,2-a]azepine; or
II-M.4A.2: 1-[(6-chloro-3-pyridyl)methyl]-2-nitro-1-[(E)-pentylideneamino]guanidine; or
II-M4A.3: 1-[(6-chloro-3-pyridyl)methyl]-7-methyl-8-nitro-5-propoxy-3,5,6,7-tetrahydro-2H-imidazo[1,2-a]pyridine; or
II-M.4B nicotine.
II-M.5 Nicotinic acetylcholine receptor allosteric activators from the class of spinosyns, including spinosad or spinetoram;
II-M.6 Chloride channel activators from the class of avermectins and milbemycins, including abamectin, emamectin benzoate, ivermectin, lepimectin or milbemectin;
II-M.7 Juvenile hormone mimics, such as
II-M.7A juvenile hormone analogues as hydroprene, kinoprene and methoprene; or others as
II-M.7B fenoxycarb, or
II-M.7C pyriproxyfen;
II-M.8 miscellaneous non-specific (multi-site) inhibitors, including
II-M.8A alkyl halides as methyl bromide and other alkyl halides, or
II-M.8B chloropicrin, or
II-M.8C sulfuryl fluoride, or
II-M.8D borax, or
II-M.8E tartar emetic;
II-M.9 Selective homopteran feeding blockers, including
II-M.9B pymetrozine, or
II-M.9C flonicamid;
II-M.10 Mite growth inhibitors, including
II-M.10A clofentezine, hexythiazox and diflovidazin, or
II-M.10B etoxazole;
II-M.11 Microbial disruptors of insect midgut membranes, including bacillus thuringiensis or bacillus sphaericus and the insecticdal proteins they produce such as bacillus thuringiensis subsp. israelensis, bacillus sphaericus, bacillus thuringiensis subsp. aizawai, bacillus thuringiensis subsp. kurstaki and bacillus thuringiensis subsp. tenebrionis, or the Bt crop proteins: Cry1Ab, Cry1Ac, Cry1Fa, Cry2Ab, mCry3A, Cry3Ab, Cry3Bb and Cry34/35Ab1;
II-M.12 Inhibitors of mitochondrial ATP synthase, including
II-M.12A diafenthiuron, or
II-M.12B organotin miticides such as azocyclotin, cyhexatin or fenbutatin oxide, or
II-M.12C propargite, or
II-M.12D tetradifon;
II-M.13 Uncouplers of oxidative phosphorylation via disruption of the proton gradient, including chlorfenapyr, DNOC or sulfluramid;
II-M.14 Nicotinic acetylcholine receptor (nAChR) channel blockers, including nereistoxin analogues as bensultap, cartap hydrochloride, thiocyclam or thiosultap sodium;
II-M.15 Inhibitors of the chitin biosynthesis type 0, such as benzoylure including bistrifluron, chlorfluazuron, diflubenzuron, flucycloxuron, flufenoxuron, hexaflumuron, lufenuron, novaluron, noviflumuron, teflubenzuron or triflumuron;
II-M.16 Inhibitors of the chitin biosynthesis type 1, including buprofezin;
II-M.17 Moulting disruptors, Dipteran, including cyromazine;
II-M.18 Ecdyson receptor agonists such as diacylhydrazines, including methoxyfenozide, tebufenozide, halofenozide, fufenozide or chromafenozide;
II-M.19 Octopamin receptor agonists, including amitraz;
II-M.20 Mitochondrial complex III electron transport inhibitors, including
II-M.20A hydramethylnon, or
II-M.20B acequinocyl, or
II-M.20C fluacrypyrim;
II-M.21 Mitochondrial complex I electron transport inhibitors, including
II-M.21A METI acaricides and insecticides such as fenazaquin, fenpyroximate, pyrimidifen, pyridaben, tebufenpyrad or tolfenpyrad, or
II-M.21B rotenone;
II-M.22 Voltage-dependent sodium channel blockers, including
II-M.22A indoxacarb, or
II-M.22B metaflumizone; or
II-M.22C 1-[(E)-[2-(4-cyanophenyl)-1-[3-(trifluoromethyl)phenyl]ethylidene]amino]-3-[4-(difluoromethoxy)phenyl]urea;
II-M.23 Inhibitors of the acetyl CoA carboxylase, including Tetronic and Tetramic acid derivatives, including spirodiclofen, spiromesifen or spirotetramat;
II-M.24 Mitochondrial complex IV electron transport inhibitors, including
II-M.24A phosphine such as aluminium phosphide, calcium phosphide, phosphine or zinc phosphide, or
II-M.24B cyanide.
II-M.25 Mitochondrial complex II electron transport inhibitors, such as beta-ketonitrile derivatives, including cyenopyrafen or cyflumetofen;
II-M.26 Ryanodine receptor-modulators from the class of diamides, including flubendiamide, chlorantraniliprole (Rynaxypyr®), cyantraniliprole (Cyazypyr®), or the phthalamide compounds
II-M.26.1: (R)-3-Chlor-N1-{2-methyl-4-[1,2,2,2-tetrafluor-1-(trifluormethyl)ethyl]phenyl}-N2-(1-methyl-2-methylsulfonylethyl)phthalamid and
II-M.26.2: (S)-3-Chlor-N1-{2-methyl-4-[1,2,2,2-tetrafluor-1-(trifluormethyl)ethyl]phenyl}-N2-(1-methyl-2-methylsulfonylethyl)phthalamid, or the compound
II-M.26.3: 3-bromo-N-{2-bromo-4-chloro-6-[(1-cyclopropylethyl)carbamoyl]phenyl}-1-(3-chlorpyridin-2-yl)-1H-pyrazole-5-carboxamide (proposed ISO name: cyclaniliprole), or the compound,
II-M.26.4: methyl-2-[3,5-dibromo-2-({[3-bromo-1-(3-chlorpyridin-2-yl)-1H-pyrazol-5-yl]carbonyl}amino)benzoyl]-1,2-dimethylhydrazinecarboxylate; or a compound selected from II-M.26.5a) to II-M.26.5d):
II-M.26.5a: N-[2-(5-amino-1,3,4-thiadiazol-2-yl)-4-chloro-6-methyl-phenyl]-5-bromo-2-(3-chloro-2-pyridyl)pyrazole-3-carboxamide;
II-M.26.5b: 5-chloro-2-(3-chloro-2-pyridyl)-N-[2,4-dichloro-6-[(1-cyano-1-methyl-ethyl)carbamoyl]phenyl]pyrazole-3-carboxamide;
II-M.26.5c: 5-bromo-N-[2,4-dichloro-6-(methylcarbamoyl)phenyl]-2-(3,5-dichloro-2-pyridyl)pyrazole-3-carboxamide;
II-M.26.5d: N-[2-(tert-butylcarbamoyl)-4-chloro-6-methyl-phenyl]-2-(3-chloro-2-pyridyl)-5-(fluoromethoxy)pyrazole-3-carboxamide; or
II-M.26.6: N2-(1-cyano-1-methyl-ethyl)-N1-(2,4-dimethylphenyl)-3-iodo-phthalamide; or
II-M.26.7: 3-chloro-N2-(1-cyano-1-methyl-ethyl)-N1-(2,4-dimethylphenyl)phthalamide;
II-M.X insecticidal active compounds of unknown or uncertain mode of action, including afidopyropen, azadirachtin, amidoflumet, benzoximate, bifenazate, bromopropylate, chinomethionat, cryolite, dicofol, flufenerim, flometoquin, fluensulfone, flupyradifurone, piperonyl butoxide, pyridalyl, pyrifluquinazon, sulfoxaflor, pyflubumide, or the compounds
II-M.X.1: 4-[5-(3,5-Dichloro-phenyl)-5-trifluoromethyl-4,5-dihydro-isoxazol-3-yl]-2-methyl-N-[(2,2,2-trifluoro-ethylcarbamoyl)-methyl]-benzamide, or the compound
II-M.X.2: cyclopropaneacetic acid, 1,1′-[(3S,4R,4aR,6S,6aS,12R,12aS,12bS)-4-[[(2-cyclopropylacetyl)oxy]methyl]-1,3,4,4a,5,6,6a,12,12a,12b-decahydro-12-hydroxy-4,6a,12b-trimethyl-11-oxo-9-(3-pyridinyl)-2H,11H-naphtho[2,1-b]pyrano[3,4-e]pyran-3,6-diyl] ester, or the compound
II-M.X.3: 11-(4-chloro-2,6-dimethylphenyl)-12-hydroxy-1,4-dioxa-9-azadispiro[4.2.4.2]-tetradec-11-en-10-one, or the compound
II-M.X.4 3-(4′-fluoro-2,4-dimethylbiphenyl-3-yl)-4-hydroxy-8-oxa-1-azaspiro[4.5]dec-3-en-2-one, or the compound
II-M.X.5: 1-[2-fluoro-4-methyl-5-[(2,2,2-trifluoroethyl)sulfinyl]phenyl]-3-(trifluoromethyl)-1H-1,2,4-triazole-5-amine, or actives on basis of bacillus firmus (Votivo, I-1582), or
II-M.X.6: a compound selected from the group of
II-M.X.6a: (E/Z)-N-[1-[(6-chloro-3-pyridyl)methyl]-2-pyridylidene]-2,2,2-trifluoro-acetamide;
II-M.X.6b: (E/Z)-N-[1-[(6-chloro-5-fluoro-3-pyridyl)methyl]-2-pyridylidene]-2,2,2-trifluoro-acetamide;
II-M.X.6c: (E/Z)-2,2,2-trifluoro-N-[1-[(6-fluoro-3-pyridyl)methyl]-2-pyridylidene]acetamide;
II-M.X.6d: (E/Z)—N-[1-[(6-bromo-3-pyridyl)methyl]-2-pyridylidene]-2,2,2-trifluoro-acetamide;
II-M.X.6e: (E/Z)-N-[1-[1-(6-chloro-3-pyridyl)ethyl]-2-pyridylidene]-2,2,2-trifluoro-acetamide;
II-M.X.6f: (E/Z)-N-[1-[(6-chloro-3-pyridyl)methyl]-2-pyridylidene]-2,2-difluoro-acetamide;
II-M.X.6g: (E/Z)-2-chloro-N-[1-[(6-chloro-3-pyridyl)methyl]-2-pyridylidene]-2,2-difluoro-acetamide;
II-M.X.6h: (E/Z)-N-[1-[(2-chloropyrimidin-5-yl)methyl]-2-pyridylidene]-2,2,2-trifluoro-acetamide and II-M.X.6i: (E/Z)-N-[1-[(6-chloro-3-pyridyl)methyl]-2-pyridylidene]-2,2,3,3,3-pentafluoro-propanamide); or
II-M.X.7: triflumezopyrim; or
II-M.X.8: 4-[5-[3-chloro-5-(trifluoromethyl)phenyl]-5-(trifluoromethyl)-4H-isoxazol-3-yl]-N-[2-oxo-2-(2,2,2-trifluoroethylamino)ethyl]naphthalene-1-carboxamide, or
II-M.X.9: 3-[3-chloro-5-(trifluoromethyl)phenyl]-4-oxo-1-(pyrimidin-5-ylmethyl)pyrido[1,2-a]pyrimidin-1-ium-2-olate; or
II-M.X.10: 8-chloro-N-[2-chloro-5-methoxyphenyl)sulfonyl]-6-trifluoromethyl)-imidazo[1,2-a]pyridine-2-carboxamide; or
II-M.X.11: 4-[5-(3,5-dichlorophenyl)-5-(trifluoromethyl)-4H-isoxazol-3-yl]-2-methyl-N-(1-oxothietan-3-yl)benzamide; or
II-M.X.12: 5-[3-[2,6-dichloro-4-(3,3-dichloroallyloxyl)phenoxy]propoxy]-1H-pyrazole; or
II-M.Y Biopesticides, e.g.
II-M.Y-1: Microbial pesticides with insecticidal, acaricidal, molluscidal and/or nematicidal activity: Bacillus firmus, B. thuringiensis ssp. israelensis, B. t. ssp. galleriae, B. t. ssp. kurstaki, Beauveria bassiana, Burkholderia sp., Chromobacterium subtsugae, Cydia pomonella granulosis virus, Isaria fumosorosea, Lecanicillium longisporum, L. muscarium (formerly Verticillium lecanii), Metarhizium anisopliae, M. anisopliae var. acridum, Paecilomyces fumosoroseus, P. lilacinus, Paenibacillus poppiliae, Pasteuria spp., P. nishizawae, P. reneformis, P. usagae, Pseudomonas fluorescens, Steinernema feltiae, Streptomces galbus;
II-M.Y-2) Biochemical pesticides with insecticidal, acaricidal, molluscidal, pheromone and/or nematicidal activity: L-carvone, citral, (E,Z)-7,9-dodecadien-1-yl acetate, ethyl formate, (E,Z)-2,4-ethyl decadienoate (pear ester), (Z,Z,E)-7,11,13-hexadecatrienal, heptyl butyrate, isopropyl myristate, lavanulylsenecioate, 2-methyl 1-butanol, methyl eugenol, methyl jasmonate, (E,Z)-2,13-octadecadien-1-ol, (E,Z)-2,13-octadecadien-1-ol acetate, (E,Z)-3,13-octadecadien-1-ol, R-1-octen-3-ol, pentatermanone, potassium silicate, sorbitol actanoate, (E,Z,Z)-3,8,11-tetradecatrienyl acetate, (Z,E)-9,12-tetradecadien-1-ylacetate, Z-7-tetradecen-2-one, Z-9-tetradecen-1-ylacetate, Z-11-tetradecenal, Z-11-tetradecen-1-ol, Acacia negra extract, extract of grapefruit seeds and pulp, extract of Chenopodium ambrosiodae, Catnip oil, Neem oil, Quillay extract, Tagetes oil;

The commercially available compounds II of the group M listed above may be found in The Pesticide Manual, 15th Edition, C. D. S. Tomlin, British Crop Protection Council (2011) among other publications.

The quinoline derivative flometoquin is shown in WO2006/013896. The aminofuranone compounds flupyradifurone is known from WO 2007/115644. The sulfoximine compound sulfoxaflor is known from WO2007/149134. The pyrethroid momfluorothrin is known from U.S. Pat. No. 6,908,945. The pyrazole acaricide pyflubumide is known from WO2007/020986. The isoxazoline compound 11-M.X.1 has been described in WO2005/085216, II-M.X.8 in WO2009/002809 and in WO2011/149749 and the isoxazoline II-M.X.11 in WO2013/050317. The pyripyropene derivative II-M.X.2 has been described in WO 2006/129714. The spiroketal-substituted cyclic ketoenol derivative II-M.X.3 is known from WO2006/089633 and the biphenyl-substituted spirocyclic ketoenol derivative II-M.X.4 from WO2008/067911. Triazoylphenylsulfide like II-M.X.5 have been described in WO2006/043635 and biological control agents on basis of bacillus firmus in WO2009/124707. The neonicotionids M4A.1 is known from W020120/069266 and W02011/06946, the II-M.4A.2 from WO2013/003977, the M4A.3. from WO2010/069266. The metaflumizone analogue II-M.22C is described in CN 10171577.

Cyantraniliprole (Cyazypyr) is known from e.g. WO 2004/067528. The phthalamides II-M.26.1 and II-M.26.2 are both known from WO 2007/101540. The anthranilamide II-M.26.3 has been described in WO 2005/077934. The hydrazide compound II-M.26.4 has been described in WO 2007/043677. The anthranilamide II-M.26.5a) is described in WO2011/085575, the II-M.26.5b) in WO2008/134969, the II-M.26.5c) in US2011/046186 and the II-M.26.5d in WO2012/034403. The diamide compounds II-M.26.6 and II-M.26.7 can be found in CN102613183.

The compounds II-M.X.6a) to II-M.X.6i) listed in II-M.X.6 have been described in WO2012/029672.

The mesoionic antagonist compound II-M.X.9 was described in WO2012/092115, the nematicide II-M.X.10 in WO2013/055584 and the Pyridalyl-type analogue II-M.X.12 in WO2010/060379.

Biopesticides

The biopesticides from group II-M.Y, and from group F.XIII) as described below, their preparation and their biological activity e.g. against harmful fungi, pests is known (e-Pesticide Manual V 5.2 (ISBN 978 1 901396 85 0) (2008-2011); http://www.epa.gov/opp00001/biopesticides/, see product lists therein; http://www.omri.org/omri-lists, see lists therein; Bio-Pesticides Database BPDB http://sitem.herts.ac.uk/aeru/bpdb/, see A to Z link therein). Many of these biopesticides are registered and/or are commercially available: aluminium silicate (SCREEN™ DUO from Certis LLC, USA), Ampelomyces quisqualis M-10 (e.g. AQ 10C) from Intrachem Bio GmbH & Co. KG, Germany), Ascophyllum nodosum (Norwegian kelp, Brown kelp) extract (e.g. ORKA GOLD from Becker Underwood, South Africa), Aspergillus flavus NRRL 21882 (e.g. AFLA-GUARD® from Syngenta, CH), Aureobasidium pullulans (e.g. BOTECTOR® from bio-ferm GmbH, Germany), Azospirillum brasilense XOH (e.g. AZOS from Xtreme Gardening, USA USA or RTI Reforestation Technologies International; USA), Bacillus amyloliquefaciens IT-45 (CNCM I 3800, NCBI 1091041) (e.g. RHIZOCELL C from ITHEC, France), B. amyloliquefaciens subsp. plantarum MBI600 (NRRL B-50595, deposited at United States Department of Agriculture) (e.g. INTEGRAL®, CLARITY, SUBTILEX NG from Becker Underwood, USA), B. pumilus QST 2808 (NRRL Accession No. B 30087) (e.g. SONATA® and BALLAD® Plus from AgraQuest Inc., USA), B. subtilis GB03 (e.g. KODIAK from Gustafson, Inc., USA), B. subtilis GB07 (EPIC from Gustafson, Inc., USA), B. subtilis QST-713 (NRRL-Nr. B 21661 in RHAPSODY®, SERENADE® MAX and SERENADE® ASO from Agra-Quest Inc., USA), B. subtilis var. amylolique [symbol] faciens FZB24 (e.g. TAEGRO® from Novozyme Biologicals, Inc., USA), B. subtilis var. amyloliquefaciens D747 (e.g. Double Nickel 55 from Certis LLC, USA), Bacillus thuringiensis ssp. kurstaki SB4 (e.g. BETA PRO® from Becker Underwood, South Africa), Beauveria bassiana GHA (BOTANIGARD® 22WGP from Laverlam Int. Corp., USA), B. bassiana 12256 (e.g. BIOEXPERT® SC from Live Sytems Technology S.A., Colombia), B. bassiana PRPI 5339 (ARSEF number 5339 in the USDA ARS collection of entomopathogenic fungal cultures) (e.g. BROAD [symbol] BAND® from Becker Underwood, South Africa), Bradyrhizobium sp. (e.g. VAULT® from Becker Underwood, USA), B. japonicum (e.g. VAULT® from Becker Underwood, USA), Candida oleophila I-82 (e.g. ASPIRE® from Ecogen Inc., USA), Candida saitoana (e.g. B10-CURE® (in mixture with lysozyme) and BIOCOAT® from Micro Flo Company, USA (BASF SE) and Arysta), Chitosan (e.g. ARMOUR-ZEN from BotriZen Ltd., NZ), Clonostachys rosea f. catenulata, also named Gliocladium catenulatum (e.g. isolate J1446: PRESTOP® from Verdera, Finland), Coniothyrium minitans CON/M/91-08 (e.g. Contans® WG from Prophyta, Germany), Cryphonectria parasitica (e.g. Endothia parasitica from CNICM, France), Cryptococcus albidus (e.g. YIELD PLUS® from Anchor Bio-Technologies, South Africa), Ecklonia maxima (kelp) extract (e.g. KELPAK SL from Kelp Products Ltd, South Africa), Fusarium oxysporum (e.g. B10-FOX® from S.I.A.P.A., Italy, FUSACLEAN® from Natural Plant Protection, France), Glomus intraradices (e.g. MYC 4000 from ITHEC, France), Glomus intraradices RTI-801 (e.g. MYKOS from Xtreme Gardening, USA or RTI Reforestation Technologies International; USA), grapefruit seeds and pulp extract (e.g. BC-1000 from Chemie S.A., Chile), Isaria fumosorosea Apopka-97 (ATCC 20874) (PFR-97™ from Certis LLC, USA), Lecanicillium muscarium (formerly Verticillium lecanii) (e.g. MYCOTAL from Koppert BV, Netherlands), Lecanicillium longisporum KV42 and KV71 (e.g. VERTALEC® from Koppert BV, Netherlands), Metarhizium anisopliae var. acridum IMI 330189 (deposited in European Culture Collections CABI) (e.g. GREEN MUSCLE® from Becker Underwood, South Africa), M. anisopliae F₁-1045 (e.g. BIOCANE® from Becker Underwood Pty Ltd, Australia), M. anisopliae var. acridum F₁-985 (e.g. GREEN GUARD® SC from Becker Underwood Pty Ltd, Australia), M. anisopliae F₅₂ (e.g. MET52® Novozymes Biologicals BioAg Group, Canada), M. anisopliae ICIPE 69 (e.g. METATHRI [symbol] POL from ICIPE, Kenya), Metschnikowia fructicola (e.g. SHEMER® from Agrogreen, Israel), Microdochium dimerum (e.g. ANTIBOT® from Agrauxine, France), Neem oil (e.g. TRILOGY®, TRIACT® 70 EC from Certis LLC, USA), Paecilomyces fumosoroseus strain FE 9901 (e.g. NO FLY™ from Natural Industries, Inc., USA), P. lilacinus DSM 15169 (e.g. NEMATA® SC from Live Systems Technology S.A., Colombia), P. lilacinus BCP2 (e.g. PL GOLD from Becker Underwood BioAg SA Ltd, South Africa), mixture of Paenibacillus alvei NAS6G6 and Bacillus pumilis (e.g. BAC-UP from Becker Underwood South Africa), Penicillium bilaiae (e.g. JUMP START® from Novozymes Biologicals BioAg Group, Canada), Phlebiopsis gigantea (e.g. ROTSTOP® from Verdera, Finland), potassium silicate (e.g. Sil-MATRIX™ from Certis LLC, USA), Pseudozyma flocculosa (e.g. SPORODEX® from Plant Products Co. Ltd., Canada), Pythium oligandrum DV74 (e.g. POLYVERSUM® from Remeslo SSRO, Biopreparaty, Czech Rep.), Reynoutria sachlinensis extract (e.g. REGALIA® from Marrone Biolnnovations, USA), Rhizobium leguminosarum bv. phaseolii (e.g. RHIZO-STICK from Becker Underwood, USA), R. l. trifolii (e.g. DORMAL from Becker Underwood, USA), R. l. bv. viciae (e.g. NODULATOR from Becker Underwood, USA), Sinorhizobium meliloti (e.g. DORMAL ALFALFA from Becker Underwood, USA; NITRAGIN® Gold from Novozymes Biologicals BioAg Group, Canada), Steinernema feltiae (NEMA [symbol] SHIELD® from BioWorks, Inc., USA), Streptomyces lydicus WYEC 108 (e.g. Actinovate® from Natural Industries, Inc., USA, U.S. Pat. No. 5,403,584), S. violaceusniger YCED-9 (e.g. DT-9® from Natural Industries, Inc., USA, U.S. Pat. No. 5,968,503), Talaromyces flavus V117b (e.g. PROTUS® from Prophyta, Germany), Trichoderma asperellum SKT-1 (e.g. ECO-HOPE® from Kumiai Chemical Industry Co., Ltd., Japan), T. atroviride LC52 (e.g. SENTINEL® from Agrimm Technologies Ltd, NZ), T. fertile JM41R (e.g. RICHPLUS™ from Becker Underwood Bio Ag SA Ltd, South Africa), T. harzianum T-22 (e.g. PLANTSHIELD® der Firma BioWorks Inc., USA), T. harzianum TH 35 (e.g. ROOT PRO® from Mycontrol Ltd., Israel), T. harzianum T-39 (e.g. TRICHODEX® and TRICHODERMA 2000® from Mycontrol Ltd., Israel and Makhteshim Ltd., Israel), T. harzianum and T. viride (e.g. TRICHOPEL from Agrimm Technologies Ltd, NZ), T. harzianum ICC012 and T. viride ICC080 (e.g. REMEDIER® WP from Isagro Ricerca, Italy), T. polysporum and T. harzianum (e.g. BINAB® from BINAB Bio-Innovation AB, Sweden), T. stromaticum (e.g. TRICOVAB® from C.E.P.L.A.C., Brazil), T. virens GL-21 (also named Gliocladium virens) (e.g. SOILGARDO from Certis LLC, USA), T. viride (e.g. TRIECO® from Ecosense Labs. (India) Pvt. Ltd., Indien, BIO-CURE® F from T. Stanes & Co. Ltd., Indien), T. viride TV1 (e.g. T. viride TV1 from Agribiotec srl, Italy), Ulocladium oudemansii HRU3 (e.g. BOTRY-ZEN® from Botry-Zen Ltd, NZ), Bacillus amyloliquefaciens AP-136 (NRRL B-50614), B. amyloliquefaciens AP-188 (NRRL B-50615), B. amyloliquefaciens AP-218 (NRRL B-50618), B. amyloliquefaciens AP-219 (NRRL B-50619), B. amyloliquefaciens AP-295 (NRRL B-50620), B. mojavensis AP-209 (No. NRRL B-50616), B. solisalsi AP-217 (NRRL B-50617), B. pumilus strain INR-7 (otherwise referred to as BU-F₂₂ (NRRL B-50153) and BU-F₃₃ (NRRL B-50185)), B. simplex ABU 288 (NRRL B-50340) and B. amyloliquefaciens subsp. plantarum MBI600 (NRRL B-50595) have been mentioned i.a. in US patent appl. 20120149571, WO 2012/079073. Beauveria bassiana DSM 12256 is known from US200020031495. Bradyrhizobium japonicum USDA is known from U.S. Pat. No. 7,262,151. Sphaerodes mycoparasitica IDAC 301008-01 (IDAC=International Depositary Authority of Canada Collection) is known from WO 2011/022809.

Bacillus amyloliquefaciens subsp. plantarum MBI600 having the accession number NRRL B-50595 is deposited with the United States Department of Agriculture on Nov. 10, 2011 under the strain designation Bacillus subtilis 1430. It has also been deposited at The National Collections of Industrial and Marine Bacteria Ltd. (NCIB), Torry Research Station, P.O. Box 31, 135 Abbey Road, Aberdeen, AB9 8DG, Scotland. under accession number 1237 on Dec. 22, 1986. Bacillus amyloliquefaciens MBI600 is known as plant growth-promoting rice seed treatment from Int. J. Microbiol. Res. ISSN 0975-5276, 3(2) (2011), 120-130 and further described e.g. in US 2012/0149571 A1. This strain MBI600 is commercially available as liquid formulation product Integral® (Becker-Underwood Inc., USA). Recently, the strain MBI 600 has been re-classified as Bacillus amyloliquefaciens subsp. plantarum based on polyphasic testing which combines classical microbiological methods relying on a mixture of traditional tools (such as culture-based methods) and molecular tools (such as genotyping and fatty acids analysis). Thus, Bacillus subtilis MBI600 (or MBI 600 or MBI-600) is identical to Bacillus amyloliquefaciens subsp. plantarum MBI600, formerly Bacillus subtilis MBI600.

Metarhizium anisopliae IMI33 is commercially available from Becker Underwood as product Green Guard. M. anisopliae var acridium strain IMI 330189 (NRRL-50758) is commercially available from Becker Underwood as product Green Muscle.

Bacillus subtilis strain FB17 was originally isolated from red beet roots in North America (System Appl. Microbiol 27 (2004) 372-379). This Bacillus subtilis strain promotes plant health (US 2010/0260735 A1; WO 2011/109395 A2). B. subtilis FB17 has also been deposited at American Type Culture Collection (ATCC), Manassas, Va., USA, under accession number PTA-11857 on Apr. 26, 2011. Bacillus subtilis strain FB17 may also be referred to as UD1022 or UD10-22.

According to one embodiment of the inventive mixtures, the at least one biopesticide II is selected from the groups II-M.Y-1 to II-M.Y-2:
II-M.Y-1:Microbial pesticides with insecticidal, acaricidal, molluscidal and/or nematicidal activity: Bacillus firmus St 1582, B. thuringiensis ssp. israelensis SUM-6218, B. t. ssp. galleriae SDS-502, B. t. ssp. kurstaki, Beauveria bassiana GHA, B. bassiana H123, B. bassiana DSM 12256, B. bassiana PRPI 5339, Burkholderia sp. A396, Chromobacterium subtsugae PRAA4-1T, Cydia pomonella granulosis virus isolate V22, Isaria fumosorosea Apopka-97, Lecanicillium longisporum KV42, L. longisporum KV71, L. muscarium (formerly Verticillium lecanii), Metarhizium anisopliae F1-985, M. anisopliae F1-1045, M. anisopliae F52, M. anisopliae ICIPE 69, M. anisopliae var. acridum IMI 330189, Paecilomyces fumosoroseus FE 9901, P. lilacinus DSM 15169, P. lilacinus BCP2, Paenibacillus poppiliae Dutky-1940 (NRRL B-2309=ATCC 14706), P. poppiliae KLN 3, P. poppiliae Dutky 1, Pasteuria spp. Ph3, P. nishizawae PN-1, P. reneformis Pr-3, P. usagae, Pseudomonas fluorescens CL 145A, Steinernema feltiae, Streptomces galbus;
II-M.Y-2:Biochemical pesticides with insecticidal, acaricidal, molluscidal, pheromone and/or nematicidal activity: L-carvone, citral, (E,Z)-7,9-dodecadien-1-ylacetate, ethyl formate, (E,Z)-2,4-ethyl decadienoate (pear ester), (Z,Z,E)-7,11,13-hexadecatrienal, heptyl butyrate, isopropyl myristate, lavanulyl senecioate, 2-methyl 1-butanol, methyl eugenol, methyl jasmonate, (E,Z)-2,13-octadecadien-1-ol, (E,Z)-2,13-octadecadien-1-ol acetate, (E,Z)-3,13-octadecadien-1-ol, R-1-octen-3-ol, pentatermanone, potassium silicate, sorbitol actanoate, (E,Z,Z)-3,8,11-tetradecatrienyl acetate, (Z,E)-9,12-tetradecadien-1-yl acetate, Z-7-tetradecen-2-one, Z-9-tetradecen-1-yl acetate, Z-11-tetradecenal, Z-11-tetradecen-1-ol, Acacia negra extract, extract of grapefruit seeds and pulp, extract of Chenopodium ambrosiodae, Catnip oil, Neem oil, Quillay extract, Tagetes oil;

According to one embodiment of the inventive mixtures, the at least one biopesticide II is selected from group II-M.Y-1.

According to one embodiment of the inventive mixtures, the at least one biopesticide II is selected from II-M.Y-2.

According to one embodiment of the inventive mixtures, the at least one biopesticide II is Bacillus amyloliquefaciens subsp. plantarum MBI600. These mixtures are particularly suitable in soybean.

According to another embodiment of the inventive mixtures, the at least one biopesticide II is B. pumilus strain INR-7 (otherwise referred to as BU-F22 (NRRL B-50153) and BU-F33 (NRRL B-50185; see WO 2012/079073). These mixtures are particularly suitable in soybean and corn. According to another embodiment of the inventive mixtures, the at least one biopesticide II is Bacillus pumilus, preferably B. pumilis strain INR-7 (otherwise referred to as BU-F22 (NRRL B-50153) and BU-F33 (NRRL B-50185). These mixtures are particularly suitable in soybean and corn.

According to another embodiment of the inventive mixtures, the at least one biopesticide II is Bacillus simplex, preferably B. simplex strain ABU 288 (NRRL B-50340). These mixtures are particularly suitable in soybean and corn.

According to another embodiment of the inventive mixtures, the at least one biopesticide II is selected from Trichoderma asperellum, T. atroviride, T. fertile, T. gamsii, T. harmatum; mixture of T. harzia [symbol] num and T. viride; mixture of T. polysporum and T. harzianum; T. stromaticum, T. virens (also named Gliocladium virens) and T. viride; preferably Trichoderma fertile, in particular T. fertile strain JM41R. These mixtures are particularly suitable in soybean and corn.

According to another embodiment of the inventive mixtures, the at least one biopesticide II is Sphaerodes mycoparasitica, preferably Sphaerodes mycoparasitica strain 1DAC 301008-01 (also referred to as strain SMCD2220-01). These mixtures are particularly suitable in soybean and corn.

According to another embodiment of the inventive mixtures, the at least one biopesticide II is Beauveria bassiana, preferably Beauveria bassiana strain PPRI5339. These mixtures are particularly suitable in soybean and corn.

According to another embodiment of the inventive mixtures, the at least one biopesticide II is Metarhizium anisopliae or M. anisopliae var. acridium, preferably selected from M anisolpiae strain IMI33 and M. anisopliae var. acridium strain IMI 330189. These mixtures are particularly suitable in soybean and corn.

According to another embodiment of the inventive mixtures, Bradyrhizobium sp. (meaning any Bradyrhizobium species and/or strain) as biopesticide II is Bradyrhizobium japonicum (B. japonicum). These mixtures are particularly suitable in soybean. Preferably B. japonicum is not one of the strains TA-11 or 532c. B. japonicum strains were cultivated using media and fermentation techniques known in the art, e.g. in yeast extract-mannitol broth (YEM) at 27° C. for about 5 days.

References for various B. japonicum strains are given e.g. in U.S. Pat. No. 7,262,151 (B. japonicum strains USDA 110 (=IITA 2121, SEMIA 5032, RCR 3427, ARS I-110, Nitragin 61A89; isolated from Glycine max in Florida in 1959, Serogroup 110; Appl Environ Microbiol 60, 940-94, 1994), USDA 31 (=Nitragin 61A164; isolated from Glycine max in Wisoconsin in 1941, USA, Serogroup 31), USDA 76 (plant passage of strain USDA 74 which has been isolated from Glycine max in California, USA, in 1956, Serogroup 76), USDA 121 (isolated from Glycine max in Ohio, USA, in 1965), USDA 3 (isolated from Glycine max in Virginia, USA, in 1914, Serogroup 6) and USDA 136 (=CB 1809, SEMIA 586, Nitragin 61A136, RCR 3407; isolated from Glycine max in Beltsville, Md. in 1961; Appl Environ Microbiol 60, 940-94, 1994). USDA refers to United States Department of Agriculture Culture Collection, Beltsville, Md., USA (see e.g. Beltsville Rhizobium Culture Collection Catalog March 1987 ARS-30). Further suitable B. japonicum strain G49 (INRA, Angers, France) is described in Fernandez-Flouret, D. & Cleyet-Marel, J. C. (1987) C R Acad Agric Fr 73, 163-171), especially for soybean grown in Europe, in particular in France. Further suitable B. japonicum strain TA-11 (TA11 NOD+) (NRRL B-18466) is i.a. described in U.S. Pat. No. 5,021,076; Appl Environ Microbiol (1990) 56, 2399-2403 and commercially available as liquid inoculant for soybean (VAULT® NP, Becker Underwood, USA). Further B. japonicum strains as example for biopesticide II are described in US2012/0252672A. Further suitable and especially in Canada commercially available strain 532c (The Nitragin Company, Milwaukee, Wis., USA, field isolate from Wisconsin; Nitragin strain collection No. 61A152; Can J Plant Sci 70 (1990), 661-666).

Other suitable and commercially available B. japonicum strains (see e.g. Appl Environ Microbiol 2007, 73(8), 2635) are SEMIA 566 (isolated from North American inoculant in 1966 and used in Brazilian commercial inoculants from 1966 to 1978), SEMIA 586 (=CB 1809; originally isolated in Maryland, USA but received from Australia in 1966 and used in Brazilian inoculants in 1977), CPAC 15 (=SEMIA 5079; a natural variant of SEMIA 566 used in commercial inoculants since 1992) and CPAC 7 (=SEMIA 5080; a natural variant of SEMIA 586 used in commercial inoculants since 1992). These strains are especially suitable for soybean grown in Australia or South America, in particular in Brazil. Some of the abovementioned strains have been re-classified as a novel species Bradyrhizobium elkanii, e.g. strain USDA 76 (Can. J. Microbiol., 1992, 38, 501-505).

Another suitable and commercially available B. japonicum strain is E-109 (variant of strain USDA 138, see e.g. Eur. J. Soil Biol. 45 (2009) 28-35; Biol Fertil Soils (2011) 47:81-89, deposited at Agriculture Collection Laboratory of the Instituto de Microbiologia y Zoologia Agricola (IMYZA), Instituto Nacional de Tecnologi'a Agropecuaria (INTA), Castelar, Argentina). This strain is especially suitable for soybean grown in South America, in particular in Argentina.

The present invention also relates to mixtures, wherein the at least one biopesticide II is selected from Bradyrhizobium elkanii and Bradyrhizobium liaoningense (B. elkanii and B. liaoningense), more preferably from B. elkanii. These mixtures are particularly suitable in soybean. B. elkanii and liaoningense were cultivated using media and fermentation techniques known in the art, e.g. in yeast extract-mannitol broth (YEM) at 27° C. for about 5 days.

Suitable and commercially available B. elkanii strains are SEMIA 587 and SEMIA 5019 (=29W) (see e.g. Appl Environ Microbiol 2007, 73(8), 2635) and USDA 3254 and USDA 76 and USDA 94. Further commercially available B. elkanii strains are U-1301 and U-1302 (e.g. product Nitroagin® Optimize from Novozymes Bio As S.A., Brazil or NITRASEC for soybean from LAGE y Cia, Brazil). These strains are especially suitable for soybean grown in Australia or South America, in particular in Brazil.

The present invention also relates to mixtures, wherein the at least one biopesticide II is selected from Bradyrhizobium japonicum (B. japonicum) and further comprisies a compound III, wherein compound III is selected from jasmonic acid or salts or derivatives thereof including cis-jasmone, preferably methyl-jasmonate or cis-jasmone.

The present invention also relates to mixtures, wherein biopesticide II is selected from Bradyrhizobium sp. (Arachis) (B. sp. Arachis) which shall describe the cowpea miscellany cross-inoculation group which includes inter alia indigenous cowpea bradyrhizobia on cowpea (Vigna unguiculata), siratro (Macroptilium atropurpureum), lima bean (Phaseolus lunatus), and peanut (Arachis hypogaea). This mixture comprising as biopesticide II B. sp. Arachis is especially suitable for use in peanut, Cowpea, Mung bean, Moth bean, Dune bean, Rice bean, Snake bean and Creeping vigna, in particular peanut.

Suitable and commercially available B. sp. (Arachis) strain is CB1015 (=IITA 1006, USDA 3446 presumably originally collected in India; from Australian Inoculants Research Group; see e.g. http://www.qaseeds.com.au/inoculant_applic.php; Beltsville Rhizobium Culture Collection Catalog March 1987 USDA-ARS ARS-30). These strains are especially suitable for peanut grown in Australia, North America or South America, in particular in Brazil. Further suitable strain is bradyrhizobium sp. PNL01 (Becker Underwood; ISO Rep Marita McCreary, QC Manager Padma Somasageran; IDENTIFICATION OF RHIZOBIA SPECIES THAT CAN ESTABLISH NITROGEN-FIXING NODULES IN CROTALARIA LONGIROSTRATA. Apr. 29, 2010, University of Massachusetts Amherst: http://www.wpi.edu/Pubs/E-project/Available/E-project-042810-163614/unrestricted/Bisson.Mason._Identification_of_{—}Rhizobia_Species_That_can_Establish_Nit rogen-Fixing_Nodules_in_{—}Crotalia_{—}Longirostrata. pdf).

Suitable and commercially available Bradyrhizobium sp. (Arachis) strains especially for cowpea and peanut but also for soybean are Bradyrhizobium SEMIA 6144, SEMIA 6462 (=BR 3267) and SEMIA 6464 (=BR 3262) (deposited at FEPAGRO-MIRCEN, R. Gonsalves Dias, 570 Porto Alegre—RS, 90130-060, Brazil; see e.g. FEMS Microbiology Letters (2010) 303(2), 123-131; Revista Brasileira de Ciencia do Solo (2011) 35(3); 739-742, ISSN 0100-0683).

The present invention also relates to mixtures wherein the at least one biopesticide II is selected from Bradyrhizobium sp. (Arachis) and further comprises a compound III, wherein compound III is selected from jasmonic acid or salts or derivatives thereof including cis-jasmone, preferably methyl-jasmonate or cis-jasmone.

The present invention also relates to mixtures, wherein the at least one biopesticide II is selected from Bradyrhizobium sp. (Lupine) (also called B. lupini, B. lupines or Rhizobium lupini). This mixture is especially suitable for use in dry beans and lupins.

Suitable and commercially available B. lupini strain is LL13 (isolated from Lupinus iuteus nodules from French soils; deposited at INRA, Dijon and Angers, France; http://agriculture.gouv.fr/IMG/pdf/ch20060216.pdf). This strain is especially suitable for lupins grown in Australia, North America or Europe, in particular in Europe.

Further suitable and commercially available B. lupini strains WU425 (isolated in Esperance, Western Australia from a non-Australian legume Ornthopus compressus), WSM4024 (isolated from lupins in Australia by CRS during a 2005 survey) and WSM471 (isolated from Ornithopus pinnatus in Oyster Harbour, Western Australia) are described e.g. in Palta J. A. and Berger J. B. (eds), 2008, Proceedings 12th International Lupin Conference, 14-18 Sep. 2008, Fremantle, Western Australia. International Lupin Association, Canterbury, New Zealand, 47-50, ISBN 0-86476-153-8: http://www.lupins.org/pdf/conference/2008/Agronomy %20and %20Production/John %20Howieso n %20and %20G %200Hara.pdf; Appl Environ Microbiol (2005) 71, 7041-7052 and Australian J. Exp. Agricult. (1996) 36(1), 63-70.

The present invention also relates to mixtures wherein the at least one biopesticide II is selected from Bradyrhizobium sp. (Lupine) (B. lupini) and further comprises a compound III, wherein compound III is selected from jasmonic acid or salts or derivatives thereof including cis-jasmone, preferably methyl-jasmonate or cis-jasmone.

The present invention also relates to mixtures, wherein the at least one biopesticide II is selected from Mesorhizobium sp. (meaning any Mesorhizobium species and/or strain), more preferably Mesorhizobium ciceri. These mixtures are particularly suitable in cowpea.

Suitable and commercially available M. sp. strains are e.g. M. ciceri CC₁₁₉₂ (=UPM 848, CECT 5549; from Horticultural Research Station, Gosford, Australia; collected in Israel from Cicer arietinum nodules; Can J Microbial (2002) 48, 279-284) and Mesorhizobium sp. strains WSM1271 (collected in Sardinia, Italy, from plant host Biserrula pelecinus), WSM 1497 (collected in Mykonos, Greece, from plant host Biserrula pelecinus), M. loti strains CC829 (commercial inoculant for Lotus pedunculatus and L. ulginosus in Australia, isolated from L. ulginosus nodules in USA) and SU343 (commercial inoculant for Lotus corniculatus in Australia; isolated from host nodules in USA) all of which are deposited at Western Australian Soil Microbiology (WSM) culture collection, Australia and/or CSIRO collection (CC), Canberra, Australian Capirtal Territory (see e.g. Soil Biol Biochem (2004) 36(8), 1309-1317; Plant and Soil (2011) 348(I-2), 231-243). Suitable and commercially available M. loti strains are e.g. M. loti CC829 for Lotus pedunculatus.

The present invention also relates to mixtures wherein the at least one biopesticide II is selected from Bradyrhizobium sp. (Lupine) (B. lupini) and further comprises a compound III, wherein compound III is selected from jasmonic acid or salts or derivatives thereof including cis-jasmone, preferably methyl-jasmonate or cis-jasmone.

The present invention also relates to mixtures wherein the at least one biopesticide II is selected from Mesorhizobium huakuii, also referred to as Rhizobium huakuii (see e.g. Appl. Environ. Microbiol. 2011, 77(15), 5513-5516). These mixtures are particularly suitable in Astralagus, e.g. Astalagus sinicus (Chinese milkwetch), Thermopsis, e.g. Thermopsis luinoides (Goldenbanner) and alike.

Suitable and commercially available M. huakuii strain is HN3015 which was isolated from Astralagus sinicus in a rice-growing field of Southern China (see e.g. World J. Microbiol. Biotechn. (2007) 23(6), 845-851, ISSN 0959-3993).

The present invention also relates to mixtures wherein the at least one biopesticide II is selected from Mesorhizobium huakuii and further comprises a compound III, wherein compound III is selected from jasmonic acid or salts or derivatives thereof including cis-jasmone, preferably methyl-jasmonate or cis-jasmone.

The present invention also relates to mixtures, wherein the at least one biopesticide II is selected from Azospirillum amazonense, A. brasilense, A. lipoferum, A. irakense, A. halopraeferens, more preferably from A. brasilense, in particular selected from A. brasilense strains BR 11005 (SP 245) and AZ39 which are both commercially used in Brazil and are obtainable from EMBRAPA, Brazil. These mixtures are particularly suitable in soybean.

Humates are humic and fulvic acids extracted from a form of lignite coal and clay, known as leonardite. Humic acids are organic acids that occur in humus and other organically derived materials such as peat and certain soft coal. They have been shown to increase fertilizer efficiency in phosphate and micro-nutrient uptake by plants as well as aiding in the development of plant root systems.

Salts of jasmonic acid (jasmonate) or derivatives include without limitation the jasmonate salts potassium jasmonate, sodium jasmonate, lithium jasmonate, ammonium jasmonate, dimethylammonium jasmonate, isopropylammonium jasmonate, diolammonium jasmonate, diethtriethanolammonium jasmonate, jasmonic acid methyl ester, jasmonic acid amide, jasmonic acid methylamide, jasmonic acid-L-amino acid (amide-linked) conjugates (e.g., conjugates with L-isoleucine, L-valine, L-leucine, or L-phenylalanine), 12-oxo-phytodienoic acid, coronatine, coronafacoyl-L-serine, coronafacoyl-L-threonine, methyl esters of 1-oxo-indanoyl-isoleucine, methyl esters of 1-oxo-indanoyl-leucine, coronalon (2-[(6-ethyl-1-oxo-indane-4-carbonyl)-amino]-3-methyl-pentanoic acid methyl ester), linoleic acid or derivatives thereof and cis-jasmone, or combinations of any of the above.

According to one embodiment, the microbial pesticides embrace not only the isolated, pure cultures of the respective micro-organism as defined herein, but also its cell-free extract, its suspensions in a whole broth culture or as a metabolite-containing supernatant or a purified metabolite obtained from a whole broth culture of the microorganism or microorganism strain. According to a further embodiment, the microbial pesticides embrace not only the isolated, pure cultures of the respective micro-organism as defined herein, but also a cell-free extract thereof or at least one metabolite thereof, and/or a mutant of the respective micro-organism having all the identifying characteristics thereof and also a cell-free extract or at least one metabolite of the mutant.

“Whole broth culture” refers to a liquid culture containing both cells and media.

“Supernatant” refers to the liquid broth remaining when cells grown in broth are removed by centrifugation, filtration, sedimentation, or other means well known in the art.

The term “metabolite” refers to any compound, substance or byproduct produced by a microorganism (such as fungi and bacteria) that has improves plant growth, water use efficiency of the plant, plant health, plant appearance, or the population of beneficial microorganisms in the soil around the plant activity.

The term “mutant” refers a microorganism obtained by direct mutant selection but also includes microorganisms that have been further mutagenized or otherwise manipulated (e.g., via the introduction of a plasmid). Accordingly, embodiments include mutants, variants, and or derivatives of the respective microorganism, both naturally occurring and artificially induced mutants.

For example, mutants may be induced by subjecting the microorganism to known mutagens, such as N-methyl-nitrosoguanidine, using conventional methods.

According to the invention, the solid material (dry matter) of the biopesticides (with the exception of oils such as Neem oil, Tagetes oil, etc.) are considered as active components (e.g. to be obtained after drying or evaporation of the extraction medium or the suspension medium in case of liquid formulations of the microbial pesticides).

In accordance with the present invention, the weight ratios and percentages used herein for biological extract such as Quillay extract are based on the total weight of the dry content (solid material) of the respective extract(s).

For microbial pesticides, weight ratios and/or percentages refer to the total weight of a preparation of the respective biopesticide with at least 1×106 CFU/g (“colony forming units per gram total weight”), preferably with at least 1×108 CFU/g, even more preferably from 1×108 to 1×1012 CFU/g dry matter. Colony forming unit is measure of viable microbial cells, in particular fungal and bacterial cells. In addition, here CFU may also be understood as number of (juvenile) individual nematodes in case of (entomo-ipathogenic) nematode biopesticides, such as Steinernema feltiae.

Herein, microbial pesticides may be supplied in any physiological state such as active or dormant. Such dormant active component may be supplied for example frozen, dried, or lyophilized or partly desiccated (procedures to produce these partly desiccated organisms are given in WO2008/002371) or in form of spores.

Microbial pesticides used as organism in an active state can be delivered in a growth medium without any additional additives or materials or in combination with suitable nutrient mixtures.

According to a further embodiment, microbial pesticides are delivered and formulated in a dormant stage, more preferably in form of spores.

The total weight ratios of compositions, which comprise a microbial pesticide as component 2, can be determined based on the total weight of the solid material (dry matter) of component 1) and using the amount of CFU of component 2) to calculate the total weight of component 2) with the following equation that 1×10⁹ CFU equals one gram of total weight of component 2). According to one embodiment, the compositions, which comprise a microbial pesticide, comprise between 0.01 and 90% (w/w) of dry matter (solid material) of component 1) and from 1×10⁵ CFU to 1×10¹² CFU of component 2) per gram total weight of the composition. According to another embodiment, the compositions, which comprise a microbial pesticide, comprise between 5 and 70% (w/w) of dry matter (solid material) of component 1) and from 1×10⁶ CFU to 1×10¹⁰ CFU of component 2) per gram total weight of the composition. According to another embodiment, the compositions, wherein one component is a microbial pesticide, comprise between 25 and 70% (w/w) of dry matter (solid material) of component 1) and from 1×10⁷ CFU to 1×10⁹ CFU of component 2) per gram total weight of the composition. In the case of mixtures comprising a microbial pesticide, the application rates preferably range from about 1×10⁶ to 5×10¹⁵ (or more) CFU/ha. Preferably, the spore concentration is about 1×107 to about 1×1011 CFU/ha. In the case of (entomopathogenic) nematodes as microbial pesticides (e.g. Steinernema feltiae), the application rates preferably range inform about 1×10⁵ to 1×10¹² (or more), more preferably from 1×10⁸ to 1×10¹¹, even more preferably from 5×10⁸ to 1×10¹⁰ individuals (e.g. in the form of eggs, juvenile or any other live stages, preferably in an infective juvenile stage) per ha.

In the case of mixtures comprising microbial pesticides, the application rates with respect to plant propagation material preferably range from about 1×10⁶ to 1×10¹² (or more) CFU/seed. Preferably, the concentration is about 1×10⁶ to about 1×10¹¹ CFU/seed. In the case of microbial pesticides, the application rates with respect to plant propagation material also preferably range from about 1×10⁷ to 1×10¹⁴ (or more) CFU per 100 kg of seed, preferably from 1×10⁹ to about 1×10¹¹ CFU per 100 kg of seed.

The following mixtures are preferred:

With regard to the use in a pesticidal mixture of the present invention, a compound II selected from group II-M.2 (GABA-gated chloride channel antagonists) as defined above is preferred, in particular group II-M.2B (fiproles), especially preferred ethiprole and fipronil.

Mixtures of compounds of formula I as individualized herein, e.g. in Table C, with fipronil as compound II are particularly preferred.

With regard to the use in a pesticidal mixture of the present invention, a compound II selected from group II-M.3 (Sodium channel modulators) as defined above is preferred, in particular group II-M.3A (pyrethroids), especially preferred alpha-cypermethrin and cyhalothrin.

Mixtures of compounds of formula I as individualized herein, e.g. in Table C, with alpha-cypermethrin as compound II are particularly preferred.

Mixtures of compounds of formula I as individualized herein, e.g. in Table C, with cyhalothrin as compound II are particularly preferred.

With regard to the use in a pesticidal mixture of the present invention, a compound II selected from group II-M.4A (Neonicotinoids) as defined above is preferred, in particular clothianidin, dinotefuran, imidacloprid, thiacloprid, or thiamethoxam.

Mixtures of compounds of formula I as individualized herein, e.g. in Table C, with thiamethoxam as compound II are especially preferred.

Mixtures of compounds of formula I as individualized herein, e.g. in Table C, with clothianidin as compound II are also preferred. Mixtures of compounds of formula I as individualized herein, e.g. in Table C, with dinotefuran as compound II are also preferred. Mixtures of compounds of formula I as individualized herein, e.g. in Table C, with imidacloprid as compound II are also preferred. Mixtures of compounds of formula I as individualized herein, e.g. in Table C, with thiacloprid as compound II are also preferred. Mixtures of compounds of formula I with sulfoxaflor as compound II are also preferred.

With regard to the use in a pesticidal mixture of the present invention, in an embodiment of the invention, the compound II is selected from group II-M.5 (Nicotinic acetylcholine receptor allosteric activators) and is preferably spinosad or spinetoram.

With regard to the use in a pesticidal mixture of the present invention, in an embodiment of the invention, the compound II is selected from group II-M.6 (Chloride channel activators) and is preferably an avermectin.

Mixtures of compounds of formula I as individualized herein, e.g. in Table C, with abamectin as compound II are especially preferred.

With regard to the use in a pesticidal mixture of the present invention, in an embodiment of the invention, the compound II is selected from group II-M.9 (Selective homopteran feeding blockers) and is preferably pymetrozine or flonicamid. Mixtures of compounds of formula I as individualized herein, e.g. in Table C, with pymetrozine as compound II are especially preferred. Mixtures of compounds of formula I as individualized herein, e.g. in Table C, with flonicamid as compound II are especially preferred.

With regard to the use in a pesticidal mixture of the present invention, in an embodiment of the invention, the compound II is selected from group II-M.13 (Uncouplers of oxidative phosphorylation via disruption of the proton gradient) and is preferably chlorfenapyr. Mixtures of compounds of formula I as individualized herein, e.g. in Table C, with chlorfenapyr as compound II are especially preferred.

With regard to the use in a pesticidal mixture of the present invention, in an embodiment of the invention, the compound II is selected from group II-M.16 (Inhibitors of the chitin biosynthesis type 1) and is preferably buprofezin.

With regard to the use in a pesticidal mixture of the present invention, in an embodiment of the invention, the compound II is selected from group II-M.22 (Voltage-dependent sodium channel blockers) and is preferably metaflumizone.

With regard to the use in a pesticidal mixture of the present invention, in an embodiment of the invention, the compound II is selected from group II-M.23 (Inhibitors of the of acetyl CoA carboxylase) and is preferably a Tetronic or Tetramic acid derivative, spirodiclofen, spiromesifen or spirotetramat.

Mixtures of compounds of formula I as individualized herein, e.g. in Table C, with Tetronic Acid as compound II are preferred. Mixtures of compounds of formula I as individualized herein, e.g. in Table C, with Tetramic Acid as compound II are also preferred. Mixtures of compounds of formula I as individualized herein, e.g. in Table C, with Tetramic Acid as compound II are also preferred.

With regard to the use in a pesticidal mixture of the present invention, in an embodiment of the invention, the compound II is selected from group II-M.26 (Ryanodine receptor-modulators) and is preferably chloranthraniliprole or cyananthraniliprole. Mixtures of compounds of formula I as individualized herein, e.g. in Table C, with chloranthraniliprole as compound II are especially preferred.

Mixtures of compounds of formula I as individualized herein, e.g. in Table C, with cyananthraniliprole as compound II are especially preferred.

With regard to the use in a pesticidal mixture of the present invention, in an embodiment of the invention, the compound II is sulfoxaflor. Mixtures of compounds of formula I as individualized herein, e.g. in Table C, with sulfoxaflor as compound II are especially preferred.

In another embodiment of the invention, the compound II is compound II-M.X.2. Mixtures of compounds of formula I as individualized herein, e.g. in Table C, with compound II-M.X.2 as compound II are especially preferred.

Compound II-M.X.2 is cyclopropaneacetic acid, 1,1′-[(3S,4R,4aR,6S,6aS,12R,12aS,12bS)-4-[[(2-cyclopropylacetyl)oxy]methyl]-1,3,4,4a,5,6,6a,12,12a,12b-decahydro-12-hydroxy-4,6a,12b-trimethyl-11-oxo-9-(3-pyridinyl)-2H,11H-naphtho[2,1-b]pyrano[3,4-e]pyran-3,6-diyl] ester:

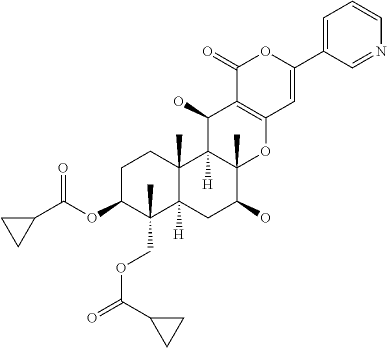

In another embodiment of the invention, the compound (II) pesticides, together with which the compounds of formula I may be used according to the purpose of the present invention, and with which potential synergistic effects with regard to the method of uses might be produced, are selected from group F consisting of
F.I) Respiration Inhibitors
F.I-1) Inhibitors of complex III at Qo site selected from the group of strobilurins including azoxystrobin, coumethoxystrobin, coumoxystrobin, dimoxystrobin, enestroburin, fluoxastrobin, kresoxim-methyl, mandestrobin, metominostrobin, orysastrobin, picoxystrobin, pyraclostrobin, pyrametostrobin, pyraoxystrobin, pyribencarb, triclopyricarb/chlorodincarb, trifloxystrobin, 2-[2-(2,5-dimethyl-phenoxymethyl)-phenyl]-3-methoxy-acrylic acid methyl ester and 2 (2-(3-(2,6-dichlorophenyl)-1-methyl-allylideneaminooxymethyl)-phenyl)-2-methoxyimino-N methyl-acetamide; oxazolidinediones and imidazolinones selected from famoxadone, fenamidone;
F.I-2) Inhibitors of complex II selected from the group of carboxamides,
   including carboxanilides selected from benodanil, benzovindiflupyr, bixafen, boscalid, carboxin, fenfuram, fenhexamid, fluopyram, flutolanil, furametpyr, isofetamid, isopyrazam, isotianil, mepronil, oxycarboxin, penflufen, penthiopyrad, sedaxane, tecloftalam, thifluzamide, tiadinil, 2-amino-4 methyl-thiazole-5-carboxanilide, N-(3′,4′,5′ trifluorobiphenyl-2 yl)-3-difluoromethyl-1-methyl-1H-pyrazole-4 carboxamide (fluxapyroxad), N-(4′-trifluoromethylthiobiphenyl-2-yl)-3 difluoromethyl-1-methyl-1H pyrazole-4-carboxamide, N-(2-(1,3,3-trimethyl-butyl)-phenyl)-1,3-dimethyl-5 fluoro-1H-pyrazole-4 carboxamide, 3-(difluoromethyl)-1-methyl-N-(1,1,3-trimethylindan-4-yl)pyrazole-4-carboxamide, 3-(trifluoromethyl)-1-methyl-N-(1,1,3-trimethylindan-4-yl)pyrazole-4-carboxamide, 1,3-dimethyl-N-(1,1,3-trimethylindan-4-yl)pyrazole-4-carboxamide, 3-(trifluoromethyl)-1,5-dimethyl-N-(1,1,3-trimethylindan-4-yl)pyrazole-4-carboxamide, 3-(difluoromethyl)-1,5-dimethyl-N-(1,1,3-trimethylindan-4-yl)pyrazole-4-carboxamide, 3-(trifluorometh [symbol] yl)-1,5-dimethyl-N-(1,1,3-trimethylindan-4-yl) [symbol] pyrazole-4-carboxamide, 1,3,5-trimethyl-N-(1,1,3-trimethylindan-4-yl)pyrazole-4-carboxamide, N-(7-fluoro-1,1,3-trimethyl-indan-4-yl)-1,3-dimethyl-pyrazole-4-carbox [symbol] iamide, N-[2-(2,4-dichlorophenyl)-2-methoxy-1-methyl-ethyl]-3-(difluoromethyl)-1-methyl-pyrazole-4-carboxamide;
F.I-3) Inhibitors of complex III at Qi site including cyazofamid, amisulbrom, [(3S,6S,7R,8R)-8-benzyl-3-[(3-acetoxy-4-methoxy-pyridine-2-carbonyl)amino]-6-methyl-4,9-dioxo-1,5-dioxonan-7-yl] 2-methylpropanoate, [(3S,6S,7R,8R)-8-benzyl-3-[[3-(acetoxymethoxy)-4-methoxy-pyridine-2-carbonyl]amino]-6-methyl-4,9-dioxo-1,5-dioxonan-7-yl] 2-methylpropanoate, [(3S,6S,7R,8R)-8-benzyl-3-[(3-isobutoxycarbonyloxy-4-methoxy-pyridine-2-carbonyl)amino]-6-methyl-4,9-dioxo-1,5-dioxonan-7-yl] 2-methylpropanoate, [(3S,6S,7R,8R)-8-benzyl-3-[[3-(1,3-benzodioxol-5-ylmethoxy)-4-methoxy-pyridine-2-carbonyl]amino]-6-methyl-4,9-dioxo-1,5-dioxonan-7-yl] 2-methylpropanoate; (3S,6S,7R,8R)-3-[[(3-hydroxy-4-methoxy-2-pyridinyl)carbonyl]amino]-6-methyl-4,9-dioxo-8-(phenylmethyl)-1,5-dioxonan-7-yl 2-methylpropanoate;
F.I-4) Other respiration inhibitors (complex I uncouplers), including diflumetorim; (5,8-difluoroquinazolin-4-yl)-{2-[2-fluoro-4-(4-trifluoromethylpyridin-2-yloxy)-phenyl]-ethyl}-amine; tecnazen; ametoctradin; silthiofam;
   and including nitrophenyl derivates selected from binapacryl, dinobuton, dinocap, fluazinam, ferimzone, nitrthal-isopropyl,
   and including organometal compounds selected from fentin salts, including fentin-acetate, fentin chloride or fentin hydroxide;
F.II) Sterol biosynthesis inhibitors (SBI fungicides)
F.II-1) C₁₄ demethylase inhibitors,
   including triazoles selected from azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, paclobutrazole, penconazole, propiconazole, prothioconazole, simeconazole, tebuconazole, tetraconazole, triadimefon, triadimenol, triticonazole, uniconazole, 1-[rel-(2S;3R)-3-(2-chlorophenyl)-2-(2,4-difluorophenyl)-oxiranylmethyl]-5-thiocyanato-1H-[1,2,4]triazole, 2-[rel-(2S,3R)-3-(2-chlorophenyl)-2-(2,4-difluorophenyl)-oxiranylmethyl]-2H-[1,2,4]triazole-3-thiol, 2-[2-chloro-4-(4-chlorophenoxyl)phenyl]-1-(1,2,4-triazol-1-yl)pentan-2-ol, 1-[4-(4-chlorophenoxy)-2-(trifluoromethyl)phenyl]-1-cyclopropyl-2-(1,2,4-triazol-1-yl)ethanol, 2-[4-(4-chlorophenoxy)-2-(trifluoromethyl)phenyl]-1-(1,2,4-triazol-1-yl)butan-2-ol, 2-[2-chloro-4-(4-chlorophenoxyl)phenyl]-1-(1,2,4-triazol-1-yl)butan-2-ol, 2-[4-(4-chlorophenoxy)-2-(trifluoromethyl)phenyl]-3-methyl-1-(1,2,4-triazol-1-yl)butan-2-ol, 2-[4-(4-chlorophenoxy)-2-(trifluoromethyl)phenyl]-1-(1,2,4-triazol-1-yl)propan-2-ol, 2-[2-chloro-4-(4-chlorophenoxyl)phenyl]-3-methyl-1-(1,2,4-triazol-1-yl)butan-2-ol, 2-[4-(4-chlorophenoxy)-2-(trifluoromethyl)phenyl]-1-(1,2,4-triazol-1-yl)pentan-2-ol, 2-[4-(4-fluorophenoxy)-2-(trifluoromethyl)phenyl]-1-(1,2,4-triazol-1-yl)propan-2-ol;
   and including imidazoles selected from imazalil, pefurazoate, oxpoconazole, prochloraz, triflumizole;
   and including pyrimidines, pyridines and piperazines selected from fenarimol, nuarimol, pyrifenox, triforine, [3-(4-chloro-2-fluoro-phenyl)-5-(2,4-difluorophenyl)isoxazol-4-yl]-(3-pyridyl)methanol;
F.II-2) Delta14-reductase inhibitors,
   including morpholines selected from aldimorph, dodemorph, dodemorph-acetate, fenpropimorph, tridemorph;
   and including piperidines selected from fenpropidin, piperalin;
   and including spiroketalamines selected from spiroxamine;
F.II-3) Inhibitors of 3-keto reductase including hydroxyanilides selected from fenhexamid;
F.III) Nucleic acid synthesis inhibitors
F.III-1) RNA, DNA synthesis inhibitors,
   including phenylamides or acyl amino acid fungicides selected from benalaxyl, benalaxyl-M, kiralaxyl, metalaxyl, metalaxyl-M (mefenoxam), ofurace, oxadixyl;
   and including isoxazoles and iosothiazolones selected from hymexazole, octhilinone;
F.III-2) DNA topisomerase inhibitors selected from oxolinic acid;
F.III-3) Nucleotide metabolism inhibitors including hydroxy (2-amino)-pyrimidines selected from bupirimate;
F.IV) Inhibitors of cell division and or cytoskeleton
F.IV-1) Tubulin inhibitors:
   including benzimidazoles and thiophanates selected from benomyl, carbendazim, fuberidazole, thiabendazole, thiophanate-methyl;
   and including triazolopyrimidines selected from 5-chloro-7 (4-methylpiperidin-1-yl)-6-(2,4,6-trifluorophenyl)-[1,2,4]triazolo[1,5 a]pyrimidine
F.IV-2) Other cell division inhibitors including benzamides and phenyl acetamides selected from diethofencarb, ethaboxam, pencycuron, fluopicolide, zoxamide;
F.IV-3) Actin inhibitors including benzophenones selected from metrafenone; pyriofenone;
F.V) Inhibitors of amino acid and protein synthesis
F.V-1) Methionine synthesis inhibitors including anilino-pyrimidines selected from cyprodinil, mepanipyrim, nitrapyrin, pyrimethanil;
F.V-2) Protein synthesis inhibitors including antibiotics selected from blasticidin-S, kasugamycin, kasugamycin hydrochloride-hydrate, mildiomycin, streptomycin, oxytetracyclin, polyoxine, validamycin A;
F.VI) Signal transduction inhibitors
F.VI-1) MAP/Histidine kinase inhibitors including dicarboximides selected from fluoroimid, iprodione, procymidone, vinclozolin;
   and including phenylpyrroles selected from fenpiclonil, fludioxonil;
F.VI-2) G protein inhibitors including quinolines selected from quinoxyfen;
F.VII) Lipid and membrane synthesis inhibitors
F.VII-1) Phospholipid biosynthesis inhibitors including organophosphorus compounds selected from edifenphos, iprobenfos, pyrazophos;
   and including dithiolanes selected from isoprothiolane;
F.VII-2) Lipid peroxidation
   including aromatic hydrocarbons selected from dicloran, quintozene, tecnazene, tolclofos-methyl, biphenyl, chloroneb, etridiazole;
F.VII-3) Carboxyl acid amides (CAA fungicides)
   including cinnamic or mandelic acid amides selected from dimethomorph, flumorph, mandiproamid, pyrimorph;
   and including valinamide carbamates selected from benthiavalicarb, iprovalicarb, pyribencarb, valifenalate and N-(1-(1-(4-cyano-phenyl)ethanesulfonyl)-but-2-yl) carbamic acid-(4-fluorophenyl) ester;
F.VII-4) Compounds affecting cell membrane permeability and fatty acides including carbamates selected from propamocarb, propamocarb-hydrochlorid
F.VII-5) fatty acid amide hydrolase inhibitors: 1-[4-[4-[5-(2,6-difluorophenyl)-4,5-dihydro-3-isoxazolyl]-2-thiazolyl]-1-piperidinyl]-2-[5-methyl-3-(trifluoromethyl)-1H-pyrazol-1-yl]ethanone;
F.VIII) Inhibitors with Multi Site Action
F.VIII-1) Inorganic active substances selected from Bordeaux mixture, copper acetate, copper hydroxide, copper oxychloride, basic copper sulfate, sulfur;
F.VIII-2) Thio- and dithiocarbamates selected from ferbam, mancozeb, maneb, metam, methasulphocarb, metiram, propineb, thiram, zineb, ziram;
F.VIII-3) Organochlorine compounds including phthalimides, sulfamides, chloronitriles selected from anilazine, chlorothalonil, captafol, captan, folpet, dichlofluanid, dichlorophen, flusulfamide, hexachlorobenzene, pentachlorphenole and its salts, phthalide, tolylfluanid, N-(4-chloro-2-nitro-phenyl)-N-ethyl-4-methyl-benzenesulfonamide;
F.VIII-4) Guanidines selected from guanidine, dodine, dodine free base, guazatine, guazatine-acetate, iminoctadine, iminoctadine-triacetate, iminoctadine-tris(albesilate); dithianon, 2,6-dimethyl-1H,5H-[1,4]dithiino[2,3-c:5,6-c′]dipyrrole-1,3,5,7(2H,6H)-tetraone;
F.VIII-5) Ahtraquinones selected from dithianon;
F.IX) Cell wall synthesis inhibitors
F.IX-1) Inhibitors of glucan synthesis selected from validamycin, polyoxin B;
F.IX-2) Melanin synthesis inhibitors selected from pyroquilon, tricyclazole, carpropamide, dicyclomet, fenoxanil;
F.X) Plant defense inducers
F.X-1) Salicylic acid pathway selected from acibenzolar-S-methyl;
F.X-2) Others selected from probenazole, isotianil, tiadinil, prohexadione-calcium; including phosphonates selected from fosetyl, fosetyl-aluminum, phosphorous acid and its salts;
F.XI) Unknown mode of action:
   bronopol, chinomethionat, cyflufenamid, cymoxanil, dazomet, debacarb, diclomezine, difenzoquat, difenzoquat-methylsulfate, diphenylamin, fenpyrazamine, flumetover, flusulfamide, flutianil, methasulfocarb, nitrapyrin, nitrothal-isopropyl, oxathiapiprolin, oxin-copper, proquinazid, tebufloquin, tecloftalam, triazoxide, 2-butoxy-6-iodo-3-propylchromen-4-one, N-(cyclopropylmethoxyimino-(6-difluoromethoxy-2,3-difluoro-phenyl)-methyl)-2-phenyl acetamide, N′-(4-(4-chloro-3-trifluoromethyl-phenoxy)-2,5-dimethyl-phenyl)-N-ethyl-N methyl formamidine, N′ (4-(4-fluoro-3-trifluoromethyl-phenoxy)-2,5-dimethyl-phenyl)-N-ethyl-N-methyl formamidine, N′-(2-methyl-5-trifluoromethyl-4-(3-trimethylsilanyl-propoxy)-phenyl)-N-ethyl-N-methyl formamidine, N′-(5-difluoromethyl-2 methyl-4-(3-trimethylsilanyl-propoxy)-phenyl)-N-ethyl-N-methyl formamidine, 2-{1-[2-(5-methyl-3-trifluoromethyl-pyrazole-1-yl)-acetyl]-piperidin-4-yl}-thiazole-4-carboxylic acid methyl-(1,2,3,4-tetrahydro-naphthalen-1-yl)-amide, 2-{1-[2-(5-methyl-3-trifluoromethyl-pyrazole-1-yl)-acetyl]-piperidin-4-yl}-thiazole-4-carboxylic acid methyl-(R)-1,2,3,4-tetrahydro-naphthalen-1-yl-amide, methoxy-acetic acid 6-tert-butyl-8-fluoro-2,3-dimethyl-quinolin-4-yl ester and N-Methyl-2-{1-[(5-methyl-3-trifluoromethyl-1H-pyrazol-1-yl)-acetyl]-piperidin-4-yl}-N-[(1R)-1,2,3,4-tetrahydronaphthalen-1-yl]-4-thiazolecarboxamide, 3-[5-(4-chloro-phenyl)-2,3-dimethyl-isoxazolidin-3 yl]-pyridine, pyrisoxazole, 5-amino-2-isopropyl-3-oxo-4-ortho-tolyl-2,3-dihydro-pyrazole-1 carbothioic acid S-allyl ester, N-(6-methoxy-pyridin-3-yl) cyclopropanecarboxylic acid amide, 5-chloro-1 (4,6-dimethoxy-pyrimidin-2-yl)-2-methyl-1H-benzoimidazole, 2-(4-chloro-phenyl)-N-[4-(3,4-dimethoxy-phenyl)-isoxazol-5-yl]-2-prop-2-ynyloxy-acetamide, ethyl (Z) 3 amino-2-cyano-3-phenyl-prop-2-enoate, tert-butyl N-[6-[[(Z)-[(1-methyltetrazol-5-yl)-phenyl-methylene]amino]oxymethyl]-2-pyridyl]carbamate, pentyl N-[6-[[(Z)-[(1-methyltetrazol-5-yl)-phenyl-methylene]amino]oxymethyl]-2-pyridyl]carbamate, 2-[2-[(7,8-difluoro-2-methyl-3-quinolyl)oxy]-6-fluoro-phenyl]propan-2-ol, 2-[2-fluoro-6-[(8-fluoro-2-methyl-3-quinolyl)oxy]phenyl]propan-2-ol, 3-(5-fluoro-3,3,4,4-tetramethyl-3,4-dihydroiso [symbol] quinolin-1-yl)quinoline, 3-(4,4-difluoro-3,3-dimethyl-3,4-dihydroisoquinolin-1-yl)′quinoline, 3-(4,4,5-trifluoro-3,3-dimethyl-3,4-dihydroisoquinolin-1-yl)quinoline;
F.XII) Growth regulators:
   abscisic acid, amidochlor, ancymidol, 6-benzylaminopurine, brassinolide, butralin, chlormequat (chlormequat chloride), choline chloride, cyclanilide, daminozide, dikegulac, dimethipin, 2,6-dimethylpuridine, ethephon, flumetralin, flurprimidol, fluthiacet, forchlorfenuron, gibberellic acid, inabenfide, indole-3-acetic acid, maleic hydrazide, mefluidide, mepiquat (mepiquat chloride), naphthaleneacetic acid, N 6 benzyladenine, paclobutrazol, prohexadione (prohexadione-calcium), prohydrojasmon, thidiazuron, triapenthenol, tributyl phosphorotrithioate, 2,3,5 tri iodobenzoic acid, trinexapac-ethyl and uniconazole;
F.XIII) Biopesticides
F.XIII-1) Microbial pesticides with fungicidal, bactericidal, viricidal and/or plant defense activator activity: Ampelomyces quisqualis, Aspergillus flavus, Aureobasidium pullulans, Bacillus amyloliquefaciens, B. mojavensis, B. pumilus, B. simplex, B. solisalsi, B. subtilis, B. subtilis var. amyloliquefaciens, Candida oleophila, C. saitoana, Clavibacter michiganensis (bacteriophages), Coniothyrium minitans, Cryphonectria parasitica, Cryptococcus albidus, Fusarium oxysporum, Clonostachys rosea f. catenulate (also named Gliocladium catenulatum), Gliocladium roseum, Mebschnikowia fructicola, Microdochium dimerum, Paeni-bacillus polymyxa, Pantoea agglomerans, Phlebiopsis gigantea, Pseudozyma flocculosa, Pythium oligandrum, Sphaerodes mycoparasitica, Streptomyces lydicus, S. violaceusniger, Talaromyces flavus, Trichoderma asperellum, T. atroviride, T. fertile, T. gamsii, T. harmatum; mixture of T. harzia [symbol] num and T. viride; mixture of T. polysporum and T. harzianum; T. stromaticum, T. virens (also named Gliocladium virens), T. viride, Typhula phacorrhiza, Ulocladium oudema, U. oudemansii, Verticillium dahlia, zucchini yellow mosaic virus (avir-ulent strain);
F.XIII-2) Biochemical pesticides with fungicidal, bactericidal, viricidal and/or plant defense activator activity: chitosan (hydrolysate), jasmonic acid or salts or de-rivatives thereof, laminarin, Menhaden fish oil, natamycin, Plum pox virus coat protein, Reynoutria sachlinensis extract, salicylic acid, tea tree oil;
F.XIII-3) Microbial pesticides with plant stress reducing, plant growth regulator, plant growth promoting and/or yield enhancing activity: Azospirillum amazonense A. brasilense, A. lipoferum, A. irakense, A. shalopraeferens, Bradyrhizobium sp., B. japonicum, Glomus intraradices, Mesorhizobium sp., Paenibacillus alvei, Penicillium bilaiae, Rhizobium leguminosarum bv. phaseolii, R. l. trifolii, R. l. bv. viciae, Sinorhizobium meliloti;
F.XIII-4) Biochemical pesticides with plant stress reducing, plant growth regulator and/or plant yield enhancing activity: abscisic acid, aluminium silicate (kaolin), 3-decen-2-one, homobrassinlide, humates, lysophosphatidyl ethanolamine, polymeric polyhydroxy acid, Ascophyllum nodosum (Norwegian kelp, Brown kelp) extract and Ecklonia maxima (kelp) extract.

The commercially available compounds II of the group F listed above may be found in The Pesticide Manual, 15th Edition, C. D. S. Tomlin, British Crop Protection Council (2011) among other publications. Their preparation and their activity against harmful fungi is known (cf.: http://www.alanwood.net/pesticides/); these substances are commercially available. The compounds described by IUPAC nomenclature, their preparation and their fungicidal activity are also known (cf. Can. J. Plant Sci. 48(6), 587-94, 1968; EPA 141 317; EP-A 152 031; EP-A 226 917; EPA 243 970; EPA 256 503; EP-A 428 941; EP-A 532 022; EP-A 1 028 125; EP-A 1 035 122; EPA 1 201 648; EPA 1 122 244, JP 2002316902; DE 19650197; DE 10021412; DE 102005009458; U.S. Pat. No. 3,296,272; U.S. Pat. No. 3,325,503; WO 98/46608; WO 99/14187; WO 99/24413; WO 99/27783; WO 00/29404; WO 00/46148; WO 00/65913; WO 01/54501; WO 01/56358; WO 02/22583; WO 02/40431; WO 03/10149; WO 03/11853; WO 03/14103; WO 03/16286; WO 03/53145; WO 03/61388; WO 03/66609; WO 03/74491; WO 04/49804; WO 04/83193; WO 05/120234; WO 05/123689; WO 05/123690; WO 05/63721; WO 05/87772; WO 05/87773; WO 06/15866; WO 06/87325; WO 06/87343; WO 07/82098; WO 07/90624, WO 11/028657).

The biopesticides of group F.XIII are disclosed above in the paragraphs about biopesticides from group II-M.Y.

The following compounds are preferred in mixtures with compounds of formula (I):

With respect to their use in the pesticidal mixtures of the present invention, particular preference is given to the compounds II as listed in the paragraphs below.

With regard to the use in a pesticidal mixture of the present invention, a compound II selected from the group of the azoles is preferred, especially prochloraz, prothioconazole, tebuconazole and triticonazole, especially prothioconazole and triticonazole.

Mixtures of compounds of formula I as individualized herein, e.g. in Table C, with triticonazole as compound II are particularly preferred. Mixtures of compounds of formula I as individualized herein, e.g. in Table C, with prothioconazole as compound II are particularly preferred.

With regard to the use in a pesticidal mixture of the present invention, preferred is a compound II selected from the group of benomyl, carbendazim, epoxiconazole, fluquinconazole, flutriafol, flusilazole, metconazole, prochloraz, prothioconazole, tebuconazole, triticonazole, pyraclostrobin, trifloxystrobin, boscalid, dimethomorph, penthiopyrad, dodemorph, famoxadone, fenpropimorph, proquinazid, pyrimethanil, tridemorph, compound II-TFPTAP (5-chloro-7-(4-methylpiperidin-1-yl)-6-(2,4,6-trifluorophenyl)-[1,2,4]triazolo[1,5-a]pyrimidine), maneb, mancozeb, metiram, thiram, chlorothalonil, dithianon, flusulfamide, metrafenone, fluxapyroxad (N-(3′,4′,5′ trifluorobiphenyl-2 yl)-3-difluoromethyl-1-methyl-1H-pyrazole-4 carboxamide), bixafen, penflufen, sedaxane, isopyrazam. Especially preferred is pyraclostrobin and fluxapyroxad.

Surprisingly, it has now been found that the use of compounds of formula I and their mixtures as defined herein in cultivated plants displays a synergistic effect between the trait of the cultivated plant and the applied compounds of formula I and their mixtures.

In a particular preferred embodiment, the mixtures comprise as an additional component which is the compound against which the cultivated plant is resistant.

Ratios:

In general, the ratios by weight for the respective mixtures comprising the insecticidal compound I and compound II are from 1:500 to 500:1, preferably from 1:100 to 100:1, more preferably from 1:25 to 25:1.

We have found that the application of compounds of formula I and their mixtures (in case of the mixtures, the simultaneous, that is joint or separate, application of the compound I and compound II or successive application of the compound I and compound II) on cultivated plants allows enhanced control of animal pests, compared to the control rates that are possible by application of compounds of formula I and their mixtures on non-cultivated plants.

Plant Health

Another problem underlying the present invention is the desire for compositions that improve the health of a plant, a process which is commonly and hereinafter referred to as “plant health”.

It was therefore an objective of the present invention to provide a method, which solves the problems as outlined above and which especially reduces the dosage rate and/or promotes the health of a plant, in particular the yield of a plant.

We have also found that the application of compounds of formula I and their mixtures (in case of the mixtures, the simultaneous, that is joint or separate, application of the compound I and compound II or successive application of the compound I and compound II) on cultivated plants provides enhanced plant health effects, compared to the plant health effects that are possible by application of compounds of formula I and their mixtures on non-cultivated plants.

The term “health of a plant” or “plant health” is defined as a condition of the plant and/or its products which is determined by several aspects alone or in combination with each other such as yield, plant vigor, quality and tolerance to abiotic and/or biotic stress.

It has to be emphasized that the above mentioned plant health effects are also present when the cultivated plant is not under biotic stress and in particular when the cultivated plant is not under pest pressure. It is evident that a cultivated plant suffering from fungal or insecticidal attack produces a smaller biomass and leads to a reduced yield as compared to a cultivated plant which has been subjected to curative or preventive treatment against the pathogenic fungus or any other relevant pest and which can grow without the damage caused by the biotic stress factor. However, the methods according to the invention lead to an enhanced plant health even in the absence of any biotic stress. This means that increased plant health cannot be explained just by the insecticidal (or herbicidal) activities of the compounds of formula I and their mixtures, but are based on further activity profiles. Thus, the method of the present invention also be carried out in the absence of pest pressure.

Each listed plant health indicator listed below, and which is selected from the groups consisting of yield, plant vigor, quality and tolerance to abiotic and/or biotic stress, is to be understood as a preferred embodiment of the present invention either each on its own or preferably in combination with each other.

According to the present invention, “increased yield” of a cultivated plant means that the yield of a product of the respective cultivated plant is increased via application of compounds of formula I and their mixtures by a measurable amount over the yield of the same product of the respective control plant produced under the same conditions and also under application of compounds of formula I and their mixtures.

Increased yield can be characterized, among others, by the following improved properties of the cultivated plant: increased plant weight, increased plant height, increased biomass such as higher overall fresh weight (FW), increased number of flowers per plant, higher grain and/or fruit yield, more tillers or side shoots (branches), larger leaves, increased shoot growth, increased protein content, increased oil content, increased starch content, increased pigment content, increased chlorophyll content (chlorophyll content has a positive correlation with the plant's photosynthesis rate and accordingly, the higher the chlorophyll content the higher the yield of a plant)

“Grain” and “fruit” are to be understood as any cultivated plant product which is further utilized after harvesting, e.g. fruits in the proper sense, vegetables, nuts, grains, seeds, wood (e.g. in the case of silviculture plants), flowers (e.g. in the case of gardening plants, ornamentals) etc., that is anything of economic value that is produced by the plant.

According to the present invention, the yield is increased by at least 4%, preferable by 5 to 10%, more preferable by 10 to 20%, or even 20 to 30%. In general, the yield increase may even be higher.

Another indicator for the condition of the cultivated plant is the plant vigor. The plant vigor becomes manifest in several aspects such as the general visual appearance.

Improved plant vigor can be characterized, among others, by the following improved properties of the cultivated plant: improved vitality of the cultivated plant, improved plant growth, improved plant development, improved visual appearance, improved plant stand (less plant verse/lodging), improved emergence, enhanced root growth and/or more developed root system, enhanced nodulation, in particular rhizobial nodulation, bigger leaf blade, bigger size, increased plant height, increased tiller number, increased number of side shoots, increased number of flowers per plant, increased shoot growth, enhanced photosynthetic activity (e.g. based on increased stomatal conductance and/or increased CO₂ assimilation rate), enhanced pigment content-, earlier flowering, earlier fruiting, earlier and improved germination, earlier grain maturity, less non-productive tillers, less dead basal leaves, less input needed (such as fertilizers or water), greener leaves, complete maturation under shortened vegetation periods, less seeds needed, easier harvesting, faster and more uniform ripening, longer shelf-life, longer panicles, delay of senescence, stronger and/or more productive tillers, better extractability of ingredients, improved quality of seeds (for being seeded in the following seasons for seed production) and/or reduced production of ethylene and/or the inhibition of its reception by the cultivated plant.

Another indicator for the condition of the cultivated plant is the “quality” of a cultivated plant and/or its products. According to the present invention, enhanced quality means that certain plant characteristics such as the content or composition of certain ingredients are increased or improved by a measurable or noticeable amount over the same factor of the control plant produced under the same conditions. Enhanced quality can be characterized, among others, by following improved properties of the cultivated plant or its product: increased nutrient content, increased protein content, increased content of fatty acids, increased metabolite content, increased carotenoid content, increased sugar content, increased amount of essential amino acids, improved nutrient composition, improved protein composition, improved composition of fatty acids, improved metabolite composition, improved carotenoid composition, improved sugar composition, improved amino acids composition, improved or optimal fruit color, improved leaf color, higher storage capacity, higher processability of the harvested products.

Another indicator for the condition of the cultivated plant is the plant's tolerance or resistance to biotic and/or abiotic stress factors. Biotic and abiotic stress, especially over longer terms, can have harmful effects on cultivated plants. Biotic stress is caused by living organisms while abiotic stress is caused for example by environmental extremes. According to the present invention, “enhanced tolerance or resistance to biotic and/or abiotic stress factors” means (1.) that certain negative factors caused by biotic and/or abiotic stress are diminished in a measurable or noticeable amount as compared to control plants exposed to the same conditions and (2.) that the negative effects are not diminished by a direct action of the Compounds of formula I and their mixtures mixture on the stress factors, e.g. by its insecticidal action, but rather by a stimulation of the cultivated plants' own defensive reactions against said stress factors.

Negative factors caused by biotic stress such as pathogens and pests are widely known and range from dotted leaves to total destruction of the cultivated plant. Biotic stress can be caused by living organisms, such as competing plants (for example weeds), microorganisms (such as phythopathogenic fungi and/or bacteria) and/or viruses.

Negative factors caused by abiotic stress are also well-known and can often be observed as reduced plant vigor (see above), for example: dotted leaves, “burned leaves”, reduced growth, less flowers, less biomass, less crop yields, reduced nutritional value of the crops, later crop maturity, to give just a few examples. Abiotic stress can be caused for example by: extremes in temperature such as heat or cold (heat stress/cold stress), strong variations in temperature, temperatures unusual for the specific season, drought (drought stress), extreme wetness, high salinity (salt stress), radiation (for example by increased UV radiation due to the decreasing ozone layer), increased ozone levels (ozone stress), organic pollution (for example by phythotoxic amounts of pesticides), inorganic pollution (for example by heavy metal contaminants).

As a result of biotic and/or abiotic stress factors, the quantity and the quality of the stressed cultivated plants, their crops and fruits decrease. As far as quality is concerned, reproductive development is usually severely affected with consequences on the crops which are important for fruits or seeds. Synthesis, accumulation and storage of proteins are mostly affected by temperature; growth is slowed by almost all types of stress; polysaccharide synthesis, both structural and storage is reduced or modified: these effects result in a decrease in biomass (yield) and in changes in the nutritional value of the product.

Advantageous properties, obtained especially from treated seeds, are e.g. improved germination and field establishment, better vigor and/or a more homogen field establishment.

As pointed out above, the above identified indicators for the health condition of a cultivated plant may be interdependent and may result from each other. For example, an increased resistance to biotic and/or abiotic stress may lead to a better plant vigor, e.g. to better and bigger crops, and thus to an increased yield. Inversely, a more developed root system may result in an increased resistance to biotic and/or abiotic stress. However, these interdependencies and interactions are neither all known nor fully understood and therefore the different indicators are described separately.

In one embodiment the methods of the present invention effectuate an increased yield of a cultivated plant or its product.

In another embodiment the methods of the present invention effectuate an increased vigor of a cultivated plant or its product.

In another embodiment the methods of the present invention effectuate in an increased quality of a cultivated plant or its product.

In yet another embodiment the methods of the present invention effectuate an increased tolerance and/or resistance of a cultivated plant or its product against biotic stress.

In yet another embodiment the methods of the present invention effectuate an increased tolerance and/or resistance of a cultivated plant or its product against abiotic stress.

In a preferred embodiment of the invention, the methods of the present invention increase the yield of cultivated plants.

In a preferred embodiment of the invention, embodiment of the invention, the methods of the present invention increase the yield of cultivated plants such as the plant weight and/or the plant biomass (e.g. overall fresh weight) and/or the grain yield and/or the number of tillers.

In another preferred embodiment of the invention, embodiment of the invention, the methods of the present invention increase the plant vigor of cultivated plants.

In a more preferred embodiment of the invention, the methods of the present invention increase the yield of cultivated plants.

In a most preferred embodiment of the invention, the methods of the present invention increase the yield of cultivated plants such as the plant weight and/or the plant biomass (e.g. overall fresh weight) and/or the grain yield and/or the number of tillers.

Thus, the present invention relates to methods for controlling pests of a cultivated plant as compared to the respective non-modified control plant, comprising the application of compounds of formula I and their mixtures to a cultivated plant, parts of such plant, plant propagation material, or at its locus of growth.

Thus, the present invention also relates to methods increasing the plant health, in particular the yield of a cultivated plant as compared to the respective non-modified control plant, comprising the application of compounds of formula I and their mixtures to a cultivated plant, parts of such plant, plant propagation material, or at its locus of growth.

The term “plant propagation material” is to be understood to denote all the generative parts of a plant such as seeds and vegetative plant material such as cuttings and tubers (e.g. potatoes), which can be used for the multiplication of the plant. This includes seeds, roots, fruits, tubers, bulbs, rhizomes, shoots, sprouts and other parts of plants, including seedlings and young plants, which are to be transplanted after germination or after emergence from soil. These young plants may also be protected before transplantation by a total or partial treatment by immersion or pouring. Preferably, the term plant propagation material denotes seeds.

In a preferred embodiment, the present invention relates to a method of controlling harmful insects and/or increasing the health of a cultivated plant, in particular the yield of a cultivated plant, by treating plant propagation material, preferably seeds with compounds of formula I and their mixtures.

The present invention also comprises plant propagation material, preferably seed, of a cultivated plant treated with compounds of formula I and their mixtures

In another preferred embodiment, the present invention relates to a method of controlling harmful insects and/or increasing the health of a cultivated plant, in particular the yield of a cultivated plant by treating the cultivated plant, part(s) of such plant or at its locus of growth with compounds of formula I and their mixtures. compounds of formula I or their mixtures

The term cultivated plant(s) includes to “modified plant(s)” and “transgenic plant(s)”.

In one embodiment of the invention, the term “cultivated plants” refers to “modified plants”. In one embodiment of the invention, the term “cultivated plants” refers to “transgenic plants”. “Modified plants” are those which have been modified by conventional breeding techniques. The term “modification” means in relation to modified plants a change in the genome, epigenome, transcriptome or proteome of the modified plant, as compared to the control, wild type, mother or parent plant whereby the modification confers a trait (or more than one trait) or confers the increase of a trait (or more than one trait) as listed below.

The modification may result in the modified plant to be a different, for example a new plant variety than the parental plant.

“Transgenic plants” are those, which genetic material has been modified by the use of recombinant DNA techniques that under natural circumstances can not readily be obtained by cross breeding, mutations or natural recombination, whereby the modification confers a trait (or more than one trait) or confers the increase of a trait (or more than one trait) as listed below as compared to the wild-type plant.

In one embodiment, one or more genes have been integrated into the genetic material of a genetically modified plant in order to improve certain properties of the plant, preferably increase a trait as listed below as compared to the wild-type plant. Such genetic modifications also include but are not limited to targeted post-translational modification of protein(s), or to posttranscriptional modifications of oligo- or polypeptides e.g. by glycosylation or polymer additions such as prenylated, acetylated, phosphorylated or farnesylated moieties or PEG moieties.

In one embodiment under the term “modification” when referring to a transgenic plant or parts thereof is understood that the activity, expression level or amount of a gene product or the metabolite content is changed, e.g. increased or decreased, in a specific volume relative to a corresponding volume of a control, reference or wild-type plant or plant cell, including the de novo creation of the activity or expression.

In one embodiment the activity of a polypeptide is increased or generated by expression or overexpression of the gene coding for said polypeptide which confers a trait or confers the increase of a trait as listed below as compared to the control plant. The term “expression” or “gene expression” means the transcription of a specific gene or specific genes or specific genetic construct. The term “expression” or “gene expression” in particular means the transcription of a gene or genes or genetic construct into structural RNA (rRNA, tRNA), regulatory RNA (e.g. miRNA, RNAi, RNAa) or mRNA with or without subsequent translation of the latter into a protein. In another embodiment the term “expression” or “gene expression” in particular means the transcription of a gene or genes or genetic construct into structural RNA (rRNA, tRNA) or mRNA with or without subsequent translation of the latter into a protein. In yet another embodiment it means the transcription of a gene or genes or genetic construct into mRNA.

The process includes transcription of DNA and processing of the resulting mRNA product. The term “increased expression” or “overexpression” as used herein means any form of expression that is additional to the original wild-type expression level.

The term “expression of a polypeptide” is understood in one embodiment to mean the level of said protein or polypeptide, preferably in an active form, in a cell or organism.

In one embodiment the activity of a polypeptide is decreased by decreased expression of the gene coding for said polypeptide which confers a trait or confers the increase of a trait as listed below as compared to the control plant. Reference herein to “decreased expression” or “reduction or substantial elimination” of expression is taken to mean a decrease in endogenous gene expression and/or polypeptide levels and/or polypeptide activity relative to control plants. It comprises further reducing, repressing, decreasing or deleting of an expression product of a nucleic acid molecule.

The terms “reduction”, “repression”, “decrease” or “deletion” relate to a corresponding change of a property in an organism, a part of an organism such as a tissue, seed, root, tuber, fruit, leave, flower etc. or in a cell. Under “change of a property” it is understood that the activity, expression level or amount of a gene product or the metabolite content is changed in a specific volume or in a specific amount of protein relative to a corresponding volume or amount of protein of a control, reference or wild type. Preferably, the overall activity in the volume is reduced, decreased or deleted in cases if the reduction, decrease or deletion is related to the reduction, decrease or deletion of an activity of a gene product, independent whether the amount of gene product or the specific activity of the gene product or both is reduced, decreased or deleted or whether the amount, stability or translation efficacy of the nucleic acid sequence or gene encoding for the gene product is reduced, decreased or deleted.

The terms “reduction”, “repression”, “decrease” or “deletion” include the change of said property in only parts of the subject of the present invention, for example, the modification can be found in compartment of a cell, like an organelle, or in a part of a plant, like tissue, seed, root, leave, tuber, fruit, flower etc. but is not detectable if the overall subject, i.e. complete cell or plant, is tested. Preferably, the “reduction”, “repression”, “decrease” or “deletion” is found cellular, thus the term “reduction, decrease or deletion of an activity” or “reduction, decrease or deletion of a metabolite content” relates to the cellular reduction, decrease or deletion compared to the wild type cell. In addition the terms “reduction”, “repression”, “decrease” or “deletion” include the change of said property only during different growth phases of the organism used in the inventive process, for example the reduction, repression, decrease or deletion takes place only during the seed growth or during blooming. Furthermore the terms include a transitional reduction, decrease or deletion for example because the used method, e.g. the antisense, RNAi, snRNA, dsRNA, siRNA, miRNA, ta-siRNA, cosuppression molecule, or ribozyme, is not stable integrated in the genome of the organism or the reduction, decrease, repression or deletion is under control of a regulatory or inducible element, e.g. a chemical or otherwise inducible promoter, and has therefore only a transient effect.

Methods to achieve said reduction, decrease or deletion in an expression product are known in the art, for example from the international patent application WO 2008/034648, particularly in paragraphs [0020.1.1.1], [0040.1.1.1], [0040.2.1.1] and [0041.1.1.1].

Reducing, repressing, decreasing or deleting of an expression product of a nucleic acid molecule in modified plants is known. Examples are canola i.e. double nill oilseed rape with reduced amounts of erucic acid and sinapins.

Such a decrease can also be achieved for example by the use of recombinant DNA technology, such as antisense or regulatory RNA (e.g. miRNA, RNAi, RNAa) or siRNA approaches. In particular RNAi, snRNA, dsRNA, siRNA, miRNA, ta-siRNA, cosuppression molecule, ribozyme, or antisense nucleic acid molecule, a nucleic acid molecule conferring the expression of a dominant-negative mutant of a protein or a nucleic acid construct capable to recombine with and silence, inactivate, repress or reduces the activity of an endogenous gene may be used to decrease the activity of a polypeptide in a transgenic plant or parts thereof or a plant cell thereof used in one embodiment of the methods of the invention. Examples of transgenic plants with reduced, repressed, decreased or deleted expression product of a nucleic acid molecule are Carica papaya (Papaya plants) with the event name X17-2 of the University of Florida, Prunus domestica (Plum) with the event name C5 of the United States Department of Agriculture—Agricultural Research Service, or those listed in rows T9-48 and T9-49 of table 9 below. Also known are plants with increased resistance to nematodes for example by reducing, repressing, decreasing or deleting of an expression product of a nucleic acid molecule, e.g. from the PCT publication WO 2008/095886.

The reduction or substantial elimination is in increasing order of preference at least 10%, 20%, 30%, 40% or 50%, 60%, 70%, 80%, 85%, 90%, or 95%, 96%, 97%, 98%, 99% or more reduced compared to that of control plants. Reference herein to an “endogenous” gene not only refers to the gene in question as found in a plant in its natural form (i.e., without there being any human intervention), but also refers to that same gene (or a substantially homologous nucleic acid/gene) in an isolated form subsequently (re)introduced into a plant (a transgene). For example, a transgenic plant containing such a transgene may encounter a substantial reduction of the transgene expression and/or substantial reduction of expression of the endogenous gene.

The terms “control” or “reference” are exchangeable and can be a cell or a part of a plant such as an organelle like a chloroplast or a tissue, in particular a plant, which was not modified or treated according to the herein described process according to the invention. Accordingly, the plant used as control or reference corresponds to the plant as much as possible and is as identical to the subject matter of the invention as possible. Thus, the control or reference is treated identically or as identical as possible, saying that only conditions or properties might be different which do not influence the quality of the tested property other than the treatment of the present invention.

It is possible that control or reference plants are wild-type plants. However, “control” or “reference” may refer to plants carrying at least one genetic modification, when the plants employed in the process of the present invention carry at least one genetic modification more than said control or reference plants. In one embodiment control or reference plants may be transgenic but differ from transgenic plants employed in the process of the present invention only by said modification contained in the transgenic plants employed in the process of the present invention.

The term “wild type” or “wild-type plants” refers to a plant without said genetic modification. These terms can refer to a cell or a part of a plant such as an organelle like a chloroplast or a tissue, in particular a plant, which lacks said genetic modification but is otherwise as identical as possible to the plants with at least one genetic modification employed in the present invention. In a particular embodiment the “wild-type” plant is not transgenic.

Preferably, the wild type is identically treated according to the herein described process according to the invention. The person skilled in the art will recognize if wild-type plants will not require certain treatments in advance to the process of the present invention, e.g. non-transgenic wild-type plants will not need selection for transgenic plants for example by treatment with a selecting agent such as a herbicide.

The control plant may also be a nullizygote of the plant to be assessed. The term “nullizygotes” refers to a plant that has undergone the same production process as a transgenic, yet has lost the once aquired genetic modification (e.g. due to mendelian segregation) as the corresponding transgenic. If the starting material of said production process is transgenic, then nullizygotes are also transgenic but lack the additional genetic modification introduced by the production process. In the process of the present invention the purpose of wild-type and nullizygotes is the same as the one for control and reference or parts thereof. All of these serve as controls in any comparison to provide evidence of the advantageous effect of the present invention.

Preferably, any comparison is carried out under analogous conditions. The term “analogous conditions” means that all conditions such as, for example, culture or growing conditions, soil, nutrient, water content of the soil, temperature, humidity or surrounding air or soil, assay conditions (such as buffer composition, temperature, substrates, pathogen strain, concentrations and the like) are kept identical between the experiments to be compared. The person skilled in the art will recognize if wild-type, control or reference plants will not require certain treatments in advance to the process of the present invention, e.g. non-transgenic wild-type plants will not need selection for transgenic plants for example by treatment with herbicide.

In case that the conditions are not analogous the results can be normalized or standardized based on the control.

The “reference”, “control”, or “wild type” is preferably a plant, which was not modified or treated according to the herein described process of the invention and is in any other property as similar to a plant, employed in the process of the present invention of the invention as possible. The reference, control or wild type is in its genome, transcriptome, proteome or metabolome as similar as possible to a plant, employed in the process of the present invention of the present invention. Preferably, the term “reference-” “control-” or “wild-type-” plant, relates to a plant, which is nearly genetically identical to the organelle, cell, tissue or organism, in particular plant, of the present invention or a part thereof preferably 90% or more, e.g. 95%, more preferred are 98%, even more preferred are 99.00%, in particular 99.10%, 99.30%, 99.50%, 99.70%, 99.90%, 99.99%, 99.999% or more. Most preferable the “reference”, “control”, or “wild type” is a plant, which is genetically identical to the plant, cell, a tissue or organelle used according to the process of the invention except that the responsible or activity conferring nucleic acid molecules or the gene product encoded by them have been amended, manipulated, exchanged or introduced in the organelle, cell, tissue, plant, employed in the process of the present invention.

Preferably, the reference and the subject matter of the invention are compared after standardization and normalization, e.g. to the amount of total RNA, DNA, or protein or activity or expression of reference genes, like housekeeping genes, such as ubiquitin, actin or ribosomal proteins.

The genetic modification carried in the organelle, cell, tissue, in particular plant used in the process of the present invention is in one embodiment stable e.g. due to a stable transgenic integration or to a stable mutation in the corresponding endogenous gene or to a modulation of the expression or of the behaviour of a gene, or transient, e.g. due to an transient transformation or temporary addition of a modulator such as an agonist or antagonist or inducible, e.g. after transformation with a inducible construct carrying a nucleic acid molecule under control of a inducible promoter and adding the inducer, e.g. tetracycline.

In one embodiment preferred plants, from which “modified plants” and/or “transgenic plants” are be selected from the group consisting of cereals, such as maize (corn), wheat, barley sorghum, rice, rye, millet, triticale, oat, pseudocereals (such as buckwheat and quinoa), alfalfa, apples, banana, beet, broccoli, Brussels sprouts, cabbage, canola (rapeseed), carrot, cauliflower, cherries, chickpea, Chinese cabbage, Chinese mustard, collard, cotton, cranberries, creeping bentgrass, cucumber, eggplant, flax, grape, grapefruit, kale, kiwi, kohlrabi, melon, mizuna, mustard, papaya, peanut, pears, pepper, persimmons, pigeonpea, pineapple, plum, potato, raspberry, rutabaga, soybean, squash, strawberries, sugar beet, sugarcane, sunflower, sweet corn, tobacco, tomato, turnip, walnut, watermelon and winter squash,

more preferably from the group consisting of alfalfa, canola (rapeseed), cotton, rice, maize, cerals (such as wheat, barley, rye, oat), soybean, fruits and vegetables (such as potato, tomato, melon, papaya), pome fruits (such as apple and pear), vine, sugarbeet, sugarcane, rape, citrus fruits (such as citron, lime, orange, pomelo, grapefruit, and mandarin) and stone fruits (such as cherry, apricot and peach), most preferably from cotton, rice, maize, cerals (such as wheat, barley, rye, oat), sorghum, squash, soybean, potato, vine, pome fruits (such as apple), citrus fruits (such as citron and orange), sugarbeet, sugarcane, rape, oilseed rape and tomatoes, utmost preferably from cotton, rice, maize, wheat, barley, rye, oat, soybean, potato, vine, apple, pear, citron and orange.

In another embodiment of the invention the cultivated plant is a gymnosperm plant, especially a spruce, pine or fir.

In one embodiment, the cultivated plant is selected from the families Aceraceae, Anacardiaceae, Apiaceae, Asteraceae, Brassicaceae, Cactaceae, Cucurbitaceae, Euphor-biaceae, Fabaceae, Malvaceae, Nymphaeaceae, Papa veraceae, Rosaceae, Salicaceae, Solanaceae, Arecaceae, Bromeliaceae, Cyperaceae, Iridaceae, Liliaceae, Orchidaceae, Gentianaceae, Labiaceae, Magnoliaceae, Ranunculaceae, Carifolaceae, Rubiaceae, Scrophulanaceae, Caryophyllaceae, Ericaceae, Polygonaceae, Violaceae, Juncaceae or Poaceae and preferably from a plant selected from the group of the families Apiaceae, As-teraceae, Brassicaceae, Cucurbitaceae, Fabaceae, Papaveraceae, Rosaceae, Solanaceae, Liliaceae or Poaceae.

Preferred are crop plants and in particular plants selected from the families and genera mentioned above for example preferred the species Anacardium occidentale, Calendula officinalis, Carthamus tinctorius, Cichorium intybus, Cynara scolymus, Helianthus annus, Tagetes lucida, Tagetes erecta, Tagetes tenuifolia; Daucus carota; Corylus avellana, Corylus colurna, Borago officinalis; Brassica napus, Brassica rapa ssp., Sinapis arvensis Brassica juncea, Brassica juncea var. juncea, Brassica juncea var. crispifolia, Brassica juncea var. foliosa, Brassica nigra, Brassica sinapioides, Melanosinapis communis, Brassica oleracea, Arabidopsis thaliana, Anana comosus, Ananas ananas, Bromelia comosa, Carica papaya, Cannabis sative, Ipomoea batatus, Ipomoea pandurata, Convolvulus batatas, Convolvulus tiliaceus, Ipomoea fas-tigiata, Ipomoea tiliacea, Ipomoea triloba, Convolvulus panduratus, Beta vulgaris, Beta vul-garis var. altissima, Beta vulgaris var. vulgaris, Beta maritima, Beta vulgaris var. perennis, Beta vulgaris var. conditiva, Beta vulgaris var. esculenta, Cucurbita maxima, Cucurbita miXta, Cucurbita pepo, Cucurbita moschata, Olea europaea, Manihot utilissima, Janipha manihot, Jatropha manihot., Manihot aipil, Manihot dulcis, Manihot manihot, Manihot melanobasis, Manihot esculenta, Ricinus communis, Pisum sativum, Pisum arvense, Pisum humile, Medicago sativa, Medicago falcata, Medicago varia, Glycine max Dolichos soja, Glycine gracilis, Glycine hispida, Phaseolus max, Soja hispida, Soja max, Cocos nucifera, Pelargonium grossularioides, Oleum cocoas, Laurus nobilis, Persea americana, Arachis hypogaea, Linum usitatissimum, Linum humile, Linum austriacum, Linum bienne, Linum augustifolium, Linum catharticum, Linum flavum, Linum grandiflorum, Adenolinum grandiflo-rum, Linum lewisii, Linum narbonense, Linum perenne, Linum perenne var. lewisii, Linum pratense, Linum trigynum, Punica granatum, Gossypium hirsutum, Gossypium arboreum, Gossypium barbadense, Gossypium herbaceum, Gossypium thurben, Musa nana, Musa acuminata, Musa paradisiaca, Musa spp., Elaeis guineensis, Papaver orientate, Papaver rhoeas, Papaver dubium, Sesamum indicum, Piper aduncum, Piper amalago, Piper angus-tifolium, Piper auritum, Piper betel, Piper cubeba, Piper longum, Piper nigrum, Piper ret-rofractum, Artanthe adunca, Artanthe elongata, Peperomia elongata, Piper elongatum, Steffensia elongata, Hordeum vulgare, Hordeum jubatum, Hordeum murinum, Hordeum secalinum, Hordeum distichon Hordeum aegiceras, Hordeum hexastichon, Hordeum hexa-stichum, Hordeum irregulare, Hordeum sativum, Hordeum secalinum, Avena sativa, Avena fatua, Avena byzantina, Avena fatua var. sativa, Avena hybrida, Sorghum bicolor, Sorghum halepense, Sorghum saccharatum, Sorghum vulgare, Andropogon drummondii, Holcus bi-color, Holcus sorghum, Sorghum aethiopicum, Sorghum arundinaceum, Sorghum caf-frorum, Sorghum cernuum, Sorghum dochna, Sorghum drummondii, Sorghum durra, Sor-ghum guineense, Sorghum lanceolatum, Sorghum nervosum, Sorghum saccharatum, Sorghum subglabrescens, Sorghum verticilliflorum, Sorghum vulgare, Holcus halepensis, Sorghum miliaceum millet, Panicum militaceum, Zea mays, Triticum aestivum, Triticum durum, Triticum turgidum, Triticum hybernum, Triticum macha, Triticum sativum or Triticum vulgare, Cofea spp., Coffea arabica, Coffea canephora, Coffea liberica, Capsicum annuum, Capsi-cum annuum var. glabriusculum, Capsicum frutescens, Capsicum annuum, Nicotiana tabacum, Solanum tuberosum, Solanum melongena, Lycopersicon esculentum, Lycopersicon lycopersicum, Lycopersicon pyriforme, Solanum integrifolium, Solanum lycopersicum Theobroma cacao and Camellia sinensis. Anacardiaceae such as the genera Pistacia, Mangifera, Anacardium e.g. the species Pistacia vera [pistachios, Pistazie], Mangifer indica [Mango] or Anacardium occi-dentale [Cashew], Asteraceae such as the genera Calendula, Carthamus, Centaurea, Cichorium, Cynara, Helianthus, Lactuca, Locusta, Tagetes, Valeriana e.g. the species Calendula officinalis [Marigold], Carthamus tinctorius [safflower], Centaurea cyanus [corn-flower], Cichorium intybus [blue daisy], Cynara scolymus [Artichoke], Helianthus annus [sunflower], Lactuca sativa, Lactuca crispa, Lactuca esculenta, Lactuca scariola L. ssp. sativa, Lactuca scariola L. var. integrata, Lactuca scariola L. var. integrifolia, Lactuca sativa subsp. roman, Locusta communis, Valeriana locusta [lettuce], Tagetes lucida, Tagetes erecta or Tagetes tenuifolia [Marigold]; Apiaceae such as the genera Daucus e.g. the species Daucus carota [carrot]; Betulaceae such as the genera Corylus e.g. the species Corylus avellana or Corylus colurea [hazelnut]; Boraginaceae such as the genera Borago e.g. the species Borago officinalis [borage]; Brassicaceae such as the genera Brassica, Melanosinapis, Sinapis, Arabadopsis e.g. the species Brassica napus, Brassica rapa ssp. [canola, oilseed rape, turnip rape], Sinapis arvensis Brassica juncea, Brassica juncea var. juncea, Brassica juncea var. crispifolia, Brassica juncea var. foliosa, Brassica nigra, Brassica sinapiodes, Melanosinapis communis [mustard], Brassica oleracea [fodder beet] or Arabidopsis thaliana; Bromeliaceae such as the genera Anana, Bromelia e.g. the species Anana comosus, Ananas ananas or Bromelia comosa [pineapple]; Caricaceae such as the genera Carica e.g. the species Carica papaya [papaya]; Cannabaceae such as the genera Cannabis e.g. the species Cannabis sative [hemp], Convolvulaceae such as the genera Ipomea, Convolvulus e.g. the species Ipomoea batatus, Ipomoea pandurata, Convolvulus batatas, Convolvulus tiliaceus, Ipomoea fastigiata, Ipomoea tiliacea, Ipomoea trlloba or Convolvulus panduratus [sweet potato, Man of the Earth, wild potato], Chenopodiaceae such as the genera Beta, i.e. the species Beta vulgaris, Beta vulganis var. altissima, Beta vulgaris var. Vulgaris, Beta maritima, Beta vulganis var. perennis, Beta vulganis var conditiva or Beta vulganis var. esculenta [sugar beet]; Cucurbitaceae such as the genera Cucubita e.g. the species Cucurbita maxima, Cucurbita mixta, Cucurbita pepo or Cucurbita mo-schata [pumpkin, squash]; Elaeagnaceae such as the genera Elaeagnus e.g. the species Olea europaea [olive]; Ericaceae such as the genera Kalmia e.g. the species Kalmia latifolia, Kalmia angustifolia, Kalmia microphylla, Kalmia polifolia, Kalmia occidentalis, Cistus chamaerhodendros or Kalmia lucida [American laurel, broad-leafed laurel, calico bush, spoon wood, sheep laurel, alpine laurel, bog laurel, western bog-laurel, swamp-laurel]; Euphorbiaceae such as the genera Manihot, Janipha, Jatropha, Ricinus e.g. the species Manihot utllissima, Janipha manihot, Jatropha manihot, Manihot aipil, Manihot dulcis, Manihot manihot, Manihot melanobasis, Manihot esculenta [manihot, arrowroot, tapioca, cassava] or Ricinus communis [castor bean, Castor Oil Bush, Castor Oil Plant, Palma Christi, Wonder Tree]; Fabaceae such as the genera Pisum, Albizia, Cathormion, Feuillea, Inga, Pithecolobium, Acacia, Mimosa, Medicajo, Glycine, Dolichos, Phaseolus, Soja e.g. the species Pisum sativum, Pisum arvense, Pisum humile [pea], Albizia bertenana, Albizia julibrissin, Albizia lebbeck, Acacia bertenana, Acacia littoralis, Albizia berteriana, Albizzia bertenana, Cathormion bertenana, Feuillea bertenana, Inga fragrans, Pithecellobium bertenanum, Pithecellobium fragrans, Pithecolobium berterianum, Pseudalbizzia berteriana, Acacia julibrissin, Acacia nemu, Albizia nemu, Feudleea julibrissin, Mimosa julibrissin, Mimosa speciosa, Sericanrda julibrissin, Acacia lebbeck, Acacia macrophylla, Albizia lebbek, Feuilleea lebbeck, Mimosa lebbeck, Mimosa speciosa [bastard logwood, silk tree, East Indian Walnut], Medicago sativa, Medicago falcata, Medicago varia [alfalfa] Glycine max Dolichos soja, Glycine gracilis, Glycine hispida, Phaseolus max, Soja hispida or Soja max [soy-bean]; Geraniaceae such as the genera Pelargonium, Cocos, Oleum e.g. the species Cocos nucifera, Pelargonium grossulariodes or Oleum cocois [coconut]; Gramineae such as the genera Saccharum e.g. the species Saccharum officinarum; Juglandaceae such as the genera Juglans, Wallia e.g. the species Juglans regia, Juglans allanthifolia, Juglans sieboldiana, Juglans cinerea, Wallia cinerea, Juglans bixbyl Juglans californiCa, Juglans hind-sii, Juglans intermedia, Juglansjamaicensis, Juglans major, Juglans macrocarpa, Juglans nigra or Wallia nigra [walnut, black walnut, common walnut, persian walnut, white walnut, butternut, black walnut]; Lauraceae such as the genera Persea, Laurus e.g. the species laurel Laurus nobilis [bay, laurel, bay laurel, sweet bay], Persea americana, Persea gratissima or Persea persea [avocado]; Leguminosae such as the genera Arachis e.g. the species Arachis hypogaea [peanut]; Linaceae such as the genera Linum, Adenolinum e.g. the species Linum usitatissimum, Linum humile, Linum austriacum, Linum bienne, Linum angustifolium, Linum catharticum, Linum flavum, Linum grandiflorum, Adeno-linum grandiflorum, Linum lewisii, Linum narbonense, Linum perenne, Linum perenne var. Linum pratense or Linum trigynum [flax, linseed]; Lythrarieae such as the genera Punica e.g. the species Punica granatum [pomegranate]; Malvaceae such as the genera Gossypium e.g. the species Gossypium hirsutum, Gossypium arboreum, Gossypium barbadense, Gossypium herbaceum or Gossypium thurberi [cotton]; Musaceae such as the genera Musa e.g. the species Musa nana, Musa acuminata, Musa paradisiaca, Musa spp. [banana]; Onagraceae such as the genera Camissonia, Oenothera e.g. the species Oeno-thera biennis or Camissonia brevipes [primrose, evening primrose]; Palmae such as the genera E/ac/s e.g. the species Elaeis guineensis [oil plam]; Papaveraceae such as the genera Papaver e.g. the species Papaver orientate, Papaver rhoeas, Papaver dubium [poppy, oriental poppy, corn poppy, field poppy, shirley poppies, field poppy, long-headed poppy, long-pod poppy]; Pedaliaceae such as the genera Sesamum e.g. the species Sesamum indicum [sesame]; Piperaceae such as the genera Piper, Artanthe, Peperomia, Steffensia e.g. the species Piper aduncum, Piper amalago, Piper angustifolium, Piper auritum, Piper betel, Piper cubeba, Piper longum, Piper nigrum, Piper retrofractum, Artanthe adunca, Ar-tanthe elongata, Peperomia elongata, Piper elongatum, Steffensia elongata. [Cayenne pepper, wild pepper]; Poaceae such as the genera Hordeum, Secale, Avena, Sorghum, Andropogon, Holcus, Panicum, Oryza, Zea, Triticum e.g. the species Hordeum vulgare, Hordeum jubatum, Hordeum murinum, Hordeum secalinum, Hordeum distichon Hordeum aegiceras, Hordeum hexastichon., Hordeum hexastichum, Hordeum irregulare, Hordeum sativum, Hordeum secalinum [barley, pearl barley, foxtail barley, wall barley, meadow bar-ley], Secale cereale [rye], Avena sativa, Avena fatua, Avena byzantina, Avena fatua var. sativa, Avena hybrida [oat], Sorghum bicolor, Sorghum halepense, Sorghum saccharatum, Sorghum vulgare, Andropogon drummondii, Holcus bicolor, Holcus sorghum, Sorghum aethiopicum, Sorghum arundinaceum, Sorghum caffrorum, Sorghum cernuum, Sorghum dochna, Sorghum drummondii, Sorghum durra, Sorghum guineense, Sorghum lanceola-tum, Sorghum nervosum, Sorghum saccharatum, Sorghum subglabrescens, Sorghum ver-ticillfflorum, Sorghum vulgare, Holcus halepensis, Sorghum mlliaceum millet, Panicum mili-taceum [Sorghum, millet], Oryza sativa, Oryza latifolia [rice], Zea mays [corn, maize] Triticum aestivum, Triticum durum, Triticum turgidum, Triticum hybernum, Triticum macha, Triti-cum sativum or Triticum vulgare [wheat, bread wheat, common wheat], Proteaceae such as the genera Macadamia e.g. the species Macadamia intergrifolia [macadamia]; Rubiaceae such as the genera Coffea e.g. the species Cofea spp., Coffea arabica, Coffea canephora or Coffea liberica [coffee]; Scrophulanaceae such as the genera Verbascum e.g. the species Verbascum blattana, Verbascum Verbascum densfflorum, Verbascum lagurus, Verbascum longifolium, Verbascum lychnitis, Verbascum nigrum, Verbascum olympicum, Verbascum phlomoides, Verbascum phoenicum, Verbascum pulverulentum or Verbascum thapsus [mullein, white moth mullein, nettle-leaved mullein, dense-flowered mullein, silver mullein, long-leaved mullein, white mullein, dark mullein, greek mullein, orange mullein, purple mullein, hoary mullein, great mullein]; Solanaceae such as the genera Capsicum, Nicotiana, Solanum, Lycopersicon e.g. the species Capsicum annuum, Capsicum annuum var. glabriusculum, Capsicum frutescens [pepper], Capsicum annuum [paprika], Nicotiana tabacum, Nicotiana alata, Nicotiana attenuata, Nicotiana glauca, Nicotiana langsdorffii, Nicotiana obtusifolia, Nicotiana quadrivalvis, Nicotiana repanda, Nicotiana rustica, Nicotiana sylvestris [tobacco], Solanum tuberosum [potato], Solanum melongena [egg-plant], Lycopersicon esculentum, Lycopersicon lycopersicum, Lycopersicon pyriforme, Solanum in-tegrifolium or Solanum lycopersicum [tomato]; Sterculiaceae such as the genera Theobroma e.g. the species Theobroma cacao [cacao]; Theaceae such as the genera Camellia e.g. the species Camellia sinensis [tea].

In one embodiment, the cultivated plant is selected from the superfamily Viridiplantae, in particular monocotyledonous and dicotyledonous plants including fodder or forage legumes, ornamental plants, food crops, trees or shrubs selected from the list comprising Acer spp., Actinidia spp., Abelmoschus spp., Agave sisalana, Agropyron spp., Agrostis stolonifera, Allium spp., Amaranthus spp., Ammophlla arenaria, Annona spp., Apium graveolens, Arachis spp, Artocarpusspp., Asparagus officinalis, Avena spp., Averrhoa carambola, Bambusa sp., Benincasa hispida, Bertholletia excelsea, Beta vulgaris, Brassica spp. Cadaba farinosa, Canna indica, Capsicum spp., Carex elata, Carissa macrocarpa, Carya spp., Castanea spp., Ceiba pentandra, Cichorium endivia, Cinnamomum spp., Citrullus lanatus, Citrus spp., Cocos spp., Coffea spp., Colocasia esculenta, Cola spp., Corchorus sp., Coriandrum sativum, Crataegus spp., Crocus sativus, Cucurbita spp., Cucumis spp., Cynara spp., Daucus carota, Desmodium spp., Dimocarpus longan, Dioscorea spp., Diospyros spp., Echinochloa spp., (e.g. Elaeis oleifera), Eleusine coracana, Eragrostis tef, Erianthus sp., Eriobotrya japonica, Eucalyptus sp., Eugenia uniflora, Fagopyrum spp., Fagus spp., Festuca arundinacea, Ficus carica, Fortunella spp., Fragaria spp., Ginkgo biloba, Glycine spp. (e.g. Glycine max, Soja hispida or Soja max), Hemerocallis fulva, Hibiscus spp., Hordeum spp., Lathyrus spp., Lens culinaris, Litchi chinensis, Lotus spp., Luffa acutangula, Lupinus spp., Luzula sylvatica, Lycopersicon spp. Macrotyloma spp., Malus spp., Malpighia emarginata, Mammea americana, Manilkara zapota, Medicago sativa, Melilotus spp., Mentha spp., Miscanthus sinensis, Momordica spp., Morus nigra, Musa spp., Nicotiana spp., Olea spp., Opuntia spp., Ornithopus spp., Oryza spp, Panicum virgatum, Passiflora edulis, Pastinaca sativa, Pennisetum sp., Persea spp., Petroselinum crispum, Phalaris arundinacea, Phaseolus spp., Phleum pratense, Phoenix spp., Phragmites australis, Physalis spp., Pinus spp., Pisum spp., Poa spp., Populus spp., Prosopis spp., Prunus spp., Psidium spp., Pyrus communis, Quercus spp., Raphanus sativus, Rheum rhabarbarum, Ribes spp., Rubus spp., Saccharum spp., Salix sp., Sambucus spp., Secale cereale, Sesamum spp., Sinapis sp., Solanum spp., Spinacia spp., Syzygium spp., Tagetes spp., Tamarindus indica, Theobroma cacao, Trifolium spp., Tripsacum dactyloides, Triticosecale rimpaui, Triticum spp. (e.g. Triticum monococcum), Tropaeolum minus, Tropaeolum majus, Vaccinium spp., Vicia spp., Vigna spp., Viola odorata, Vitis spp., Zizania palustris, Ziziphus spp., amongst others.

In some embodiments, the invention relates to methods and uses, wherein a compound of formula IA as defined herein, is applied in an application type which corresponds in each case to one row of Table AP-T.

In some embodiments, the invention relates to methods and uses, wherein a compound of formula IA-1 as defined herein, is applied in an application type which corresponds in each case to one row of Table AP-T.

In some embodiments, the invention relates to methods and uses, wherein a compound of formula IB as defined herein, is applied in an application type which corresponds in each case to one row of Table AP-T.

In some embodiments, the invention relates to methods and uses, wherein a compound of formula IC as defined herein, is applied in an application type which corresponds in each case to one row of Table AP-T.

In some embodiments, the invention relates to methods and uses, wherein a compound of formula ID as defined herein, is applied in an application type which corresponds in each case to one row of Table AP-T.

In some embodiments, the invention relates to methods and uses, wherein a compound selected from the compounds I-1 to I-40 as defined in Table C in the Example Section, is applied in an application type which corresponds in each case to one row of Table AP-T.

In some embodiments, the invention relates to methods and uses, wherein a compound of formula I-11, is applied in an application type which corresponds in each case to one row of Table AP-T.

In some embodiments, the invention relates to methods and uses, wherein a compound of formula I-16, is applied in an application type which corresponds in each case to one row of Table AP-T.

In some embodiments, the invention relates to methods and uses, wherein a compound of formula I-21, is applied in an application type which corresponds in each case to one row of Table AP-T.

In some embodiments, the invention relates to methods and uses, wherein a compound of formula I-26, is applied in an application type which corresponds in each case to one row of Table AP-T.

In some embodiments, the invention relates to methods and uses, wherein a compound of formula I-31, is applied in an application type which corresponds in each case to one row of Table AP-T.

Also preferred is the application of the compounds and mixtures according to the invention, especially the compounds as individualized herein, e.g. in Table AP-T, on specialty crops like fruits and vegetables. In one embodiment thereof, the application is on fruiting vegetables, and especially on tomato, on pepper or on eggplant.

In another embodiment thereof, the application is on leafy vegetables, and especially on cabbage or on lettuce.

In still another embodiment thereof, the application is on tubers (tuber vegetables), and especially on potato or on onion.

In one embodiment, in the methods and uses according to the invention, the following application types are used:

TABLE AP-T
(Abbreviations: SPC = specialty crops; SPC-FV = fruiting vegetable;
SPC-LV = leafy vegetable; SPC-T: tubers; ST = seed treatment)

| Appl. | | |
|---|---|---|
| type | Crop | Pest |
| AP-T-1 | Soybeans | Spodoptera |
| | | littoralis |
| AP-T-2 | Soybeans | Anticarsia |
| | | gemmatalis |
| AP-T-3 | Soybeans | Spodoptera |
| | | exigua |
| AP-T-4 | Soybeans | Stinkbug |
| AP-T-5 | Soybeans | Helicoverpa sp. |
| AP-T-6 | Soybeans | Spodoptera |
| | | eridania |
| AP-T-7 | Corn | Spodoptera Frugiperta |
| AP-T-8 | Corn | Spodoptera exigua |
| AP-T-9 | Rice | Sesamia inferens |
| AP-T-10 | Rice | Cnaphalocerus |
| | | medinalis |
| AP-T-11 | Rice | Chilo |
| | | suppressalis |
| AP-T-12 | Rice | Leptocorisa |
| | | oratorius |
| AP-T-13 | Rice | Brown plant |
| | | hopper |
| AP-T-14 | Cotton | Spodoptera |
| | | littoralis |
| AP-T-15 | Cotton | Thrips spp. |
| AP-T-16 | Cotton | Spodoptera |
| | | eridania |
| AP-T-17 | Cotton | Helicoverpa sp. |
| AP-T-18 | Canola | Pollen beetle |
| AP-T-19 | SPC | Tuta Absoluta |
| AP-T-20 | SPC | Fruit Borer |
| AP-T-21 | SPC | Spodoptera |
| | | littoralis |
| AP-T-22 | SPC | Plusia gamma |
| AP-T-23 | SPC | Plutella xylostella |
| AP-T-24 | SPC | Frankliniella |
| | | occidentalis |
| AP-T-25 | SPC | Trichoplusia ni |
| AP-T-26 | SPC | Pieris rapae |
| AP-T-27 | SPC | Spodoptera sp. |
| AP-T-28 | SPC | Crocidolomia |
| | | pavonana |
| AP-T-29 | SPC | Pyrausta |
| | | furnacalis |
| AP-T-30 | SPC | Liromyza trifolii |
| AP-T-31 | SPC | Cydia pomonella |
| AP-T-32 | SPC | Epitrix sp. |
| AP-T-33 | SPC | Leptinotarsa |
| | | decemlineata |
| AP-T-34 | SPC | Bemisia tabaci |
| AP-T-35 | SPC | Thrips tabaci |
| AP-T-36 | SPC | Spodoptera |
| | | eridania |
| AP-T-37 | SPC | Lobesia botrana |
| AP-T-38 | SPC | Altica chapybea |
| AP-T-39 | SPC | Phyllocnistis |
| | | citrella |
| AP-T-40 | SPC-FV | Tuta Absoluta |
| AP-T-41 | SPC-FV | Fruit Borer |
| AP-T-42 | SPC-FV | Spodoptera |
| | | littoralis |
| AP-T-43 | SPC-FV | Plusia gamma |
| AP-T-44 | SPC-FV | Plutella xylostella |
| AP-T-45 | SPC-FV | Frankliniella |
| | | occidentalis |
| AP-T-46 | SPC-FV | Trichoplusia ni |
| AP-T-47 | SPC-FV | Pieris rapae |
| AP-T-48 | SPC-FV | Spodoptera sp. |
| AP-T-49 | SPC-FV | Crocidolomia |
| | | pavonana |
| AP-T-50 | SPC-FV | Pyrausta |
| | | furnacalis |
| AP-T-51 | SPC-FV | Liromyza trifolii |
| AP-T-52 | SPC-FV | Cydia pomonella |
| AP-T-53 | SPC-FV | Epitrix sp. |
| AP-T-54 | SPC-FV | Leptinotarsa |
| | | decemlineata |
| AP-T-55 | SPC-FV | Bemisia tabaci |
| AP-T-56 | SPC-FV | Thrips tabaci |
| AP-T-57 | SPC-FV | Spodoptera |
| | | eridania |
| AP-T-58 | SPC-FV | Lobesia botrana |
| AP-T-59 | SPC-FV | Altica chapybea |
| AP-T-60 | SPC-FV | Phyllocnistis |
| | | citrella |
| AP-T-61 | Tomato | Tuta Absoluta |
| AP-T-62 | Tomato | Fruit Borer |
| AP-T-63 | Tomato | Spodoptera |
| | | littoralis |
| AP-T-64 | Tomato | Plusia gamma |
| AP-T-65 | Tomato | Plutella xylostella |
| AP-T-66 | Tomato | Frankliniella |
| | | occidentalis |
| AP-T-67 | Tomato | Trichoplusia ni |
| AP-T-68 | Tomato | Pieris rapae |
| AP-T-69 | Tomato | Spodoptera sp. |
| AP-T-70 | Tomato | Crocidolomia |
| | | pavonana |
| AP-T-71 | Tomato | Pyrausta |
| | | furnacalis |
| AP-T-72 | Tomato | Liromyza trifolii |
| AP-T-73 | Tomato | Cydia pomonella |
| AP-T-74 | Tomato | Epitrix sp. |
| AP-T-75 | Tomato | Leptinotarsa |
| | | decemlineata |
| AP-T-76 | Tomato | Bemisia tabaci |
| AP-T-77 | Tomato | Thrips tabaci |
| AP-T-78 | Tomato | Spodoptera |
| | | eridania |
| AP-T-79 | Tomato | Lobesia botrana |
| AP-T-80 | Tomato | Altica chapybea |
| AP-T-81 | Tomato | Phyllocnistis |
| | | citrella |
| AP-T-82 | Pepper | Tuta Absoluta |
| AP-T-83 | Pepper | Fruit Borer |
| AP-T-84 | Pepper | Spodoptera |
| | | littoralis |
| AP-T-85 | Pepper | Plusia gamma |
| AP-T-86 | Pepper | Plutella xylostella |
| AP-T-87 | Pepper | Frankliniella |
| | | occidentalis |
| AP-T-88 | Pepper | Trichoplusia ni |
| AP-T-89 | Pepper | Pieris rapae |
| AP-T-90 | Pepper | Spodoptera sp. |
| AP-T-91 | Pepper | Crocidolomia |
| | | pavonana |
| AP-T-92 | Pepper | Pyrausta |
| | | furnacalis |
| AP-T-93 | Pepper | Liromyza trifolii |
| AP-T-94 | Pepper | Cydia pomonella |
| AP-T-95 | Pepper | Epitrix sp. |
| AP-T-96 | Pepper | Leptinotarsa |
| | | decemlineata |
| AP-T-97 | Pepper | Bemisia tabaci |
| AP-T-98 | Pepper | Thrips tabaci |
| AP-T-99 | Pepper | Spodoptera |
| | | eridania |
| AP-T-100 | Pepper | Lobesia botrana |
| AP-T-101 | Pepper | Altica chapybea |
| AP-T-102 | Pepper | Phyllocnistis |
| | | citrella |
| AP-T-103 | Eggplant | Tuta Absoluta |
| AP-T-104 | Eggplant | Fruit Borer |
| AP-T-105 | Eggplant | Spodoptera |
| | | littoralis |
| AP-T-106 | Eggplant | Plusia gamma |
| AP-T-107 | Eggplant | Plutella xylostella |
| AP-T-108 | Eggplant | Frankliniella |
| | | occidentalis |
| AP-T-109 | Eggplant | Trichoplusia ni |
| AP-T-110 | Eggplant | Pieris rapae |
| AP-T-111 | Eggplant | Spodoptera sp. |
| AP-T-112 | Eggplant | Crocidolomia |
| | | pavonana |
| AP-T-113 | Eggplant | Pyrausta |
| | | furnacalis |
| AP-T-114 | Eggplant | Liromyza trifolii |
| AP-T-115 | Eggplant | Cydia pomonella |
| AP-T-116 | Eggplant | Epitrix sp. |
| AP-T-117 | Eggplant | Leptinotarsa |
| | | decemlineata |
| AP-T-118 | Eggplant | Bemisia tabaci |
| AP-T-119 | Eggplant | Thrips tabaci |
| AP-T-120 | Eggplant | Spodoptera |
| | | eridania |
| AP-T-121 | Eggplant | Lobesia botrana |
| AP-T-122 | Eggplant | Altica chapybea |
| AP-T-123 | Eggplant | Phyllocnistis |
| | | citrella |
| AP-T-124 | SPC-LV | Tuta Absoluta |
| AP-T-125 | SPC-LV | Fruit Borer |
| AP-T-126 | SPC-LV | Spodoptera |
| | | littoralis |
| AP-T-127 | SPC-LV | Plusia gamma |
| AP-T-128 | SPC-LV | Plutella xylostella |
| AP-T-129 | SPC-LV | Frankliniella |
| | | occidentalis |
| AP-T-130 | SPC-LV | Trichoplusia ni |
| AP-T-131 | SPC-LV | Pieris rapae |
| AP-T-132 | SPC-LV | Spodoptera sp. |
| AP-T-133 | SPC-LV | Crocidolomia |
| | | pavonana |
| AP-T-134 | SPC-LV | Pyrausta |
| | | furnacalis |
| AP-T-135 | SPC-LV | Liromyza trifolii |
| AP-T-136 | SPC-LV | Cydia pomonella |
| AP-T-137 | SPC-LV | Epitrix sp. |
| AP-T-138 | SPC-LV | Leptinotarsa |
| | | decemlineata |
| AP-T-139 | SPC-LV | Bemisia tabaci |
| AP-T-140 | SPC-LV | Thrips tabaci |
| AP-T-141 | SPC-LV | Spodoptera |
| | | eridania |
| AP-T-142 | SPC-LV | Lobesia botrana |
| AP-T-143 | SPC-LV | Altica chapybea |
| AP-T-144 | SPC-LV | Phyllocnistis |
| | | citrella |
| AP-T-145 | Cabbage | Tuta Absoluta |
| AP-T-146 | Cabbage | Fruit Borer |
| AP-T-147 | Cabbage | Spodoptera |
| | | littoralis |
| AP-T-148 | Cabbage | Plusia gamma |
| AP-T-149 | Cabbage | Plutella xylostella |
| AP-T-150 | Cabbage | Frankliniella |
| | | occidentalis |
| AP-T-151 | Cabbage | Trichoplusia ni |
| AP-T-152 | Cabbage | Pieris rapae |
| AP-T-153 | Cabbage | Spodoptera sp. |
| AP-T-154 | Cabbage | Crocidolomia |
| | | pavonana |
| AP-T-155 | Cabbage | Pyrausta |
| | | furnacalis |
| AP-T-156 | Cabbage | Liromyza trifolii |
| AP-T-157 | Cabbage | Cydia pomonella |
| AP-T-158 | Cabbage | Epitrix sp. |
| AP-T-159 | Cabbage | Leptinotarsa |
| | | decemlineata |
| AP-T-160 | Cabbage | Bemisia tabaci |
| AP-T-161 | Cabbage | Thrips tabaci |
| AP-T-162 | Cabbage | Spodoptera |
| | | eridania |
| AP-T-163 | Cabbage | Lobesia botrana |
| AP-T-164 | Cabbage | Altica chapybea |
| AP-T-165 | Cabbage | Phyllocnistis |
| | | citrella |
| AP-T-166 | Lettuce | Tuta Absoluta |
| AP-T-167 | Lettuce | Fruit Borer |
| AP-T-168 | Lettuce | Spodoptera |
| | | littoralis |
| AP-T-169 | Lettuce | Plusia gamma |
| AP-T-170 | Lettuce | Plutella xylostella |
| AP-T-171 | Lettuce | Frankliniella |
| | | occidentalis |
| AP-T-172 | Lettuce | Trichoplusia ni |
| AP-T-173 | Lettuce | Pieris rapae |
| AP-T-174 | Lettuce | Spodoptera sp. |
| AP-T-175 | Lettuce | Crocidolomia |
| | | pavonana |
| AP-T-176 | Lettuce | Pyrausta |
| | | furnacalis |
| AP-T-177 | Lettuce | Liromyza trifolii |
| AP-T-178 | Lettuce | Cydia pomonella |
| AP-T-179 | Lettuce | Epitrix sp. |
| AP-T-180 | Lettuce | Leptinotarsa |
| | | decemlineata |
| AP-T-181 | Lettuce | Bemisia tabaci |
| AP-T-182 | Lettuce | Thrips tabaci |
| AP-T-183 | Lettuce | Spodoptera |
| | | eridania |
| AP-T-184 | Lettuce | Lobesia botrana |
| AP-T-185 | Lettuce | Altica chapybea |
| AP-T-186 | Lettuce | Phyllocnistis |
| | | citrella |
| AP-T-187 | SPC-T | Tuta Absoluta |
| AP-T-188 | SPC-T | Fruit Borer |
| AP-T-189 | SPC-T | Spodoptera |
| | | littoralis |
| AP-T-190 | SPC-T | Plusia gamma |
| AP-T-191 | SPC-T | Plutella xylostella |
| AP-T-192 | SPC-T | Frankliniella |
| | | occidentalis |
| AP-T-193 | SPC-T | Trichoplusia ni |
| AP-T-194 | SPC-T | Pieris rapae |
| AP-T-195 | SPC-T | Spodoptera sp. |
| AP-T-196 | SPC-T | Crocidolomia |
| | | pavonana |
| AP-T-197 | SPC-T | Pyrausta |
| | | furnacalis |
| AP-T-198 | SPC-T | Liromyza trifolii |
| AP-T-199 | SPC-T | Cydia pomonella |
| AP-T-200 | SPC-T | Epitrix sp. |
| AP-T-201 | SPC-T | Leptinotarsa |
| | | decemlineata |
| AP-T-202 | SPC-T | Bemisia tabaci |
| AP-T-203 | SPC-T | Thrips tabaci |
| AP-T-204 | SPC-T | Spodoptera |
| | | eridania |
| AP-T-205 | SPC-T | Lobesia botrana |
| AP-T-206 | SPC-T | Altica chapybea |
| AP-T-207 | SPC-T | Phyllocnistis |
| | | citrella |
| AP-T-208 | Potatoes | Tuta Absoluta |
| AP-T-209 | Potatoes | Fruit Borer |
| AP-T-210 | Potatoes | Spodoptera |
| | | littoralis |
| AP-T-211 | Potatoes | Plusia gamma |
| AP-T-212 | Potatoes | Plutella xylostella |
| AP-T-213 | Potatoes | Frankliniella |
| | | occidentalis |
| AP-T-214 | Potatoes | Trichoplusia ni |
| AP-T-215 | Potatoes | Pieris rapae |
| AP-T-216 | Potatoes | Spodoptera sp. |
| AP-T-217 | Potatoes | Crocidolomia |
| | | pavonana |
| AP-T-218 | Potatoes | Pyrausta |
| | | furnacalis |
| AP-T-219 | Potatoes | Liromyza trifolii |
| AP-T-220 | Potatoes | Cydia pomonella |
| AP-T-221 | Potatoes | Epitrix sp. |
| AP-T-222 | Potatoes | Leptinotarsa |
| | | decemlineata |
| AP-T-223 | Potatoes | Bemisia tabaci |
| AP-T-224 | Potatoes | Thrips tabaci |
| AP-T-225 | Potatoes | Spodoptera |
| | | eridania |
| AP-T-226 | Potatoes | Lobesia botrana |
| AP-T-227 | Potatoes | Altica chapybea |
| AP-T-228 | Potatoes | Phyllocnistis |
| | | citrella |
| AP-T-229 | Potatoes | wireworm |
| AP-T-230 | Onions | Tuta Absoluta |
| AP-T-231 | Onions | Fruit Borer |
| AP-T-232 | Onions | Spodoptera |
| | | littoralis |
| AP-T-233 | Onions | Plusia gamma |
| AP-T-234 | Onions | Plutella xylostella |
| AP-T-235 | Onions | Frankliniella |
| | | occidentalis |
| AP-T-236 | Onions | Trichoplusia ni |
| AP-T-237 | Onions | Pieris rapae |
| AP-T-238 | Onions | Spodoptera sp. |
| AP-T-239 | Onions | Crocidolomia |
| | | pavonana |
| AP-T-240 | Onions | Pyrausta |
| | | furnacalis |
| AP-T-241 | Onions | Liromyza trifolii |
| AP-T-242 | Onions | Cydia pomonella |
| AP-T-243 | Onions | Epitrix sp. |
| AP-T-244 | Onions | Leptinotarsa |
| | | decemlineata |
| AP-T-245 | Onions | Bemisia tabaci |
| AP-T-246 | Onions | Thrips tabaci |
| AP-T-247 | Onions | Spodoptera |
| | | eridania |
| AP-T-248 | Onions | Lobesia botrana |
| AP-T-249 | Onions | Altica chapybea |
| AP-T-250 | Onions | Phyllocnistis |
| | | citrella |
| AP-T-251 | ST | Agrotis ipsilon |
| AP-T-252 | ST | Spodoptera |
| | | frugiperta |
| AP-T-253 | ST | Phyllotreta sp. |
| AP-T-254 | ST | Stem Girdler |
| AP-T-255 | ST | Agriotes sp. |
| AP-T-256 | ST | Delia platura |

The cultivated plants are plants, which comprise at least one trait. The term “trait” refers to a property, which is present in the plant either by genetic engineering or by conventional breeding techniques. Each trait has to be assessed in relation to its respective control. Examples of traits are:
herbicide tolerance,
insect resistance by expression of bacterial toxins,
fungal resistance or viral resistance or bacterial resistance,
antibiotic resistance,
stress tolerance,
maturation alteration,
content modification of chemicals present in the cultivated plant, preferably increasing the content of fine chemicals advantageous for applications in the field of the food and/or feed industry, the cosmetics industry and/or the pharmaceutical industry,
modified nutrient uptake, preferably an increased nutrient use efficiency and/or resistance to conditions of nutrient deficiency,
improved fiber quality,
plant vigor,
modified colour,
fertility restoration,
   and male sterility.

Principally, cultivated plants may also comprise combinations of the aforementioned traits, e.g. they may be tolerant to the action of herbicides and express bacterial toxins.

Principally, all cultivated plants may also provide combinations of the aforementioned properties, e.g. they may be tolerant to the action of herbicides and express bacterial toxins.

In the detailed description below, the term “plant” refers to a cultivated plant.

Tolerance to herbicides can be obtained by creating insensitivity at the site of action of the herbicide by expression of a target enzyme which is resistant to herbicide; rapid metabolism (conjugation or degradation) of the herbicide by expression of enzymes which inactivate herbicide; or poor uptake and translocation of the herbicide. Examples are the expression of enzymes which are tolerant to the herbicide in comparison to wild type enzymes, such as the expression of 5-enolpyruvylshikimate-3-phosphate synthase (EPSPS), which is tolerant to glyphosate (see e.g. Heck et. al, Crop Sci. 45, 2005, 329-339; Funke et. al, PNAS 103, 2006, 13010-13015; U.S. Pat. No. 5,188,642, U.S. Pat. No. 4,940,835, U.S. Pat. No. 5,633,435, U.S. Pat. No. 5,804,425, U.S. Pat. No. 5,627,061), the expression of glutamine synthase which is tolerant to glufosinate and bialaphos (see e.g. U.S. Pat. No. 5,646,024, U.S. Pat. No. 5,561,236) and DNA constructs coding for dicamba-degrading enzymes (see e.g. U.S. Pat. No. 7,105,724). Gene constructs can be obtained, for example, from micro-organism or plants, which are tolerant to said herbicides, such as the Agrobacterium strain CP4 EPSPS which is resistant to glyphosate; Streptomyces bacteria which are resistance to glufosinate; Arabidopsis, Daucus carota, Pseudomonoas spp. or Zea mais with chimeric gene sequences coding for HDDP (see e.g. WO 1996/38567, WO 2004/55191); Arabidopsis thaliana which is resistant to protox inhibitors (see e.g. US 2002/0073443).

Preferaby, the herbicide tolerant plant can be selected from cereals such as wheat, barley, rye, oat; canola, sorghum, soybean, rice, oil seed rape, sugar beet, sugarcane, grapes, lentils, sunflowers, alfalfa, pome fruits; stone fruits; peanuts; coffee; tea; strawberries; turf; vegetables, such as tomatoes, potatoes, cucurbits and lettuce, more preferably, the plant is selected from soybean, maize (corn), rice, cotton, oilseed rape in particular canola, tomatoes, potatoes, sugarcane, vine, apple, pear, citron, orange and cereals such as wheat, barley, rye and oat.

Examples of commercial available transgenic plants with tolerance to herbicides, are the corn varieties “Roundup Ready Corn”, “Roundup Ready 2” (Monsanto), “Agrisure GT”, “Agrisure GT/CB/LL”, “Agrisure GT/RW”, “Agrisure 3000GT” (Syngenta), “YieldGard VT Rootworm/RR2” and “YieldGard VT Triple” (Monsanto) with tolerance to glyphosate; the corn varieties “Liberty Link” (Bayer), “Herculex I”, “Herculex RW”, “Herculex Xtra” (Dow, Pioneer), “Agrisure GT/CB/LL” and “Agrisure CB/LL/RW” (Syngenta) with tolerance to glufosinate; the soybean varieties “Roundup Ready Soybean” (Monsanto) and “Optimum GAT” (DuPont, Pioneer) with tolerance to glyphosate; the cotton varieties “Roundup Ready Cotton” and “Roundup Ready Flex” (Monsanto) with tolerance to glyphosate; the cotton variety “FiberMax Liberty Link” (Bayer) with tolerance to glufosinate; the cotton variety “BXN” (Calgene) with tolerance to bromoxynil; the canola varieties “Navigator” and “Compass” (Rhone-Poulenc) with bromoxynil tolerance; the canola variety“Roundup Ready Canola” (Monsanto) with glyphosate tolerance; the canola variety “InVigor” (Bayer) with glufosinate tolerance; the rice variety “Liberty Link Rice” (Bayer) with glufosinate tolerance and the alfalfa variety “Roundup Ready Alfalfa” with glyphosate tolerance. Further transgenic plants with herbicide tolerance are commonly known, for instance alfalfa, apple, eucalyptus, flax, grape, lentils, oil seed rape, peas, potato, rice, sugar beet, sunflower, tobacco, tomatom turf grass and wheat with tolerance to glyphosate (see e.g. U.S. Pat. No. 5,188,642, U.S. Pat. No. 4,940,835, U.S. Pat. No. 5,633,435, U.S. Pat. No. 5,804,425, U.S. Pat. No. 5,627,061); beans, soybean, cotton, peas, potato, sunflower, tomato, tobacco, corn, sorghum and sugarcane with tolerance to dicamba (see e.g. U.S. Pat. No. 7,105,724 and U.S. Pat. No. 5,670,454); pepper, apple, tomato, millet, sunflower, tobacco, potato, corn, cucumber, wheat and sorghum with tolerance to 2,4-D (see e.g. U.S. Pat. No. 6,153,401, U.S. Pat. No. 6,100,446, WO 2005107437, U.S. Pat. No. 5,608,147 and U.S. Pat. No. 5,670,454); sugarbeet, potato, tomato and tobacco with tolerance to glufosinate (see e.g. U.S. Pat. No. 5,646,024, U.S. Pat. No. 5,561,236); canola, barley, cotton, lettuce, melon, millet, oats, potato, rice, rye, sorghum, soybean, sugarbeet, sunflower, tobacco, tomato and wheat with tolerance to acetolactate synthase (ALS) inhibiting herbicides, such as triazolopyrimidine sulfonamides, sulfonylureas and imidazolinones (see e.g. U.S. Pat. No. 5,013,659, WO 2006060634, U.S. Pat. No. 4,761,373, U.S. Pat. No. 5,304,732, U.S. Pat. No. 6,211,438, U.S. Pat. No. 6,211,439 and U.S. Pat. No. 6,222,100); cereals, sugar cane, rice, corn, tobacco, soybean, cotton, rapeseed, sugar beet and potato with tolerance to HPPD inhibitor herbicides (see e.g. WO 2004/055191, WO 199638567, WO 1997049816 and U.S. Pat. No. 6,791,014); wheat, soybean, cotton, sugar beet, rape, rice, sorghum and sugar cane with tolerance to protoporphyrinogen oxidase (PPO) inhibitor herbicides (see e.g. US 2002/0073443, US 20080052798, Pest Management Science, 61, 2005, 277-285). The methods of producing such transgenic plants are generally known to the person skilled in the art and are described, for example, in the publications mentioned above.

Plants, which are capable of synthesising one or more selectively acting bacterial toxins, comprise for example at least one toxin from toxin-producing bacteria, especially those of the genus Bacillus, in particular plants capable of synthesising one or more insecticidal proteins from Bacillus cereus or Bacillus popliae; or insecticidal proteins from Bacillus thuringiensis, such as delta.-endotoxins, e.g. CryIA(b), CryIA(c), CryIF, CryIF(a2), CryIIA(b), CryIIIA, CryIIIB(b1) or Cry9c, or vegetative insecticidal proteins (VIP), e.g. VIP1, VIP2, VIP3 or VIP3A; or insecticidal proteins of bacteria colonising nematodes, for example Photorhabdus spp. or Xenorhabdus spp., such as Photorhabdus luminescens, Xenorhabdus nematophilus; toxins produced by animals, such as scorpion toxins, arachnid toxins, wasp toxins and other insect-specific neurotoxins; toxins produced by fungi, such as Streptomycetes toxins, plant lectins, such as pea lectins, barley lectins or snowdrop lectins; agglutinins; proteinase inhibitors, such as trypsine inhibitors, serine protease inhibitors, patatin, cystatin, papain inhibitors; ribosome-inactivating proteins (RIP), such as ricin, maize-RIP, abrin, luffin, saporin or bryodin; steroid metabolism enzymes, such as 3-hydroxysteroidoxidase, ecdysteroid-UDP-glycosyl-transferase, cholesterol oxidases, ecdysone inhibitors, HMG-COA-reductase, ion channel blockers, such as blockers of sodium or calcium channels, juvenile hormone esterase, diuretic hormone receptors, stilbene synthase, bibenzyl synthase, chitinases and glucanases.

In one embodiment a plant is capable of producing a toxin, lectin or inhibitor if it contains at least one cell comprising a nucleic acid sequence encoding said toxin, lectin, inhibitor or inhibitor producing enzyme, and said nucleic acid sequence is transcribed and translated and if appropriate the resulting protein processed and/or secreted in a constitutive manner or subject to developmental, inducible or tissue-specific regulation.

In the context of the present invention there are to be understood delta.-endotoxins, for example CryIA(b), CryIA(c), CryIF, CryIF(a2), CryIIA(b), CryIIIA, CryIIIB(b1) or Cry9c, or vegetative insecticidal proteins (VIP), for example VIP1, VIP2, VIP3 or VIP3A, expressly also hybrid toxins, truncated toxins and modified toxins. Hybrid toxins are produced recombinantly by a new combination of different domains of those proteins (see, for example, WO 02/15701). An example for a truncated toxin is a truncated CryIA(b), which is expressed in the Bt11 maize from Syngenta Seed SAS, as described below. In the case of modified toxins, one or more amino acids of the naturally occurring toxin are replaced. In such amino acid replacements, preferably non-naturally present protease recognition sequences are inserted into the toxin, such as, for example, in the case of CryIIIA055, a cathepsin-D-recognition sequence is inserted into a CryIIIA toxin (see WO 2003/018810).

Examples of such toxins or transgenic plants capable of synthesising such toxins are disclosed, for example, in EP-A-0 374 753, WO 93/07278, WO 95/34656, EP-A-0 427 529, EP-A-451 878 and WO 2003/052073.

The processes for the preparation of such transgenic plants are generally known to the person skilled in the art and are described, for example, in the publications mentioned above. CryI-type deoxyribonucleic acids and their preparation are known, for example, from WO 95/34656, EP-A0 367 474, EP-A-0 401 979 and WO 1990/13651.

The toxin contained in the transgenic plants imparts to the plants tolerance to harmful insects. Such insects can occur in any taxonomic group of insects, but are especially commonly found in the beetles (Coleoptera), two-winged insects (Diptera) and butterflies (Lepidoptera).

Preferably, the plant capable of expression of bacterial toxins is selected from cereals such as wheat, barley, rye, oat; canola, cotton, eggplant, lettuce, sorghum, soybean, rice, oil seed rape, sugar beet, sugarcane, grapes, lentils, sunflowers, alfalfa, pome fruits; stone fruits; peanuts; coffee; tea; strawberries; turf; vegetables, such as tomatoes, potatoes, cucurbits and lettuce, more preferably, the plant is selected from cotton, soybean, maize (corn), rice, tomatoes, potatoes, oilseed rape and cereals such as wheat, barley, rye and oat, most preferably from cotton, soybean, maize, vine, apple, pear, citron, orange and cereals such as wheat, barley, rye and oat.

Examples of commercial available transgenic plants capable of expression of bacterial toxins are the corn varieties “YieldGard corn rootworm” (Monsanto), “YieldGard VT” (Monsanto), “Herculex RW” (Dow, Pioneer), “Herculex Rootworm” (Dow, Pioneer) and “Agrisure CRW” (Syngenta) with resistance against corn rootworm; the corn varieties “YieldGard corn borer” (Monsanto), “YieldGard VT Pro” (Monsanto), “Agrisure CB/LL” (Syngenta), “Agrisure 3000GT” (Syngenta), “Hercules I”, “Hercules II” (Dow, Pioneer), “KnockOut” (Novartis), “NatureGard” (Mycogen) and “StarLink” (Aventis) with resistance against corn borer, the corn varieties “Herculex I” (Dow, Pioneer) and “Herculex Xtra” (Dow, Pioneer) with resistance against western bean cutworm, corn borer, black cutworm and fall armyworm; the corn variety “YieldGard Plus” (Monsanto) with resistance against corn borer and corn rootworm; the cotton variety “Bollgard I”” (Monsanto) with resistance against tobacco budworm; the cotton varieties “Bollgard II” (Monsanto), “WideStrike” (Dow) and “VipCot” (Syngenta) with resistance against tobacco budworm, cotton bollworm, fall armyworm, beet armyworm, cabbage looper, soybean lopper and pink bollworm; the potato varieties “NewLeaf”, “NewLeaf Y” and “NewLeaf Plus” (Monsanto) with tobacco hornworm resistance and the eggplant varieties “Bt brinjal”, “Dumaguete Long Purple”, “Mara” with resistance against brinjal fruit and shoot borer, bruit borer and cotton bollworm (see e.g. U.S. Pat. No. 5,128,130). Further transgenic plants with insect resistance are commonly known, such as yellow stemborer resistant rice (see e.g. Molecular Breeding, Volume 18, 2006, Number 1), lepidopteran resistant lettuce (see e.g. U.S. Pat. No. 5,349,124), resistant soybean (see e.g. U.S. Pat. No. 7,432,421) and rice with resistance against Lepidopterans, such as rice stemborer, rice skipper, rice cutworm, rice caseworm, rice leaffolder and rice armyworm (see e.g. WO 2001021821). The methods of producing such transgenic plants are generally known to the person skilled in the art and are described, for example, in the publications mentioned above.

Preferably, plants, which are capable of synthesising antipathogenic substances are selected from soybean, maize (corn), rice, tomatoes, potato, banana, papaya, tobacco, grape, plum and cereals such as wheat, barley, rye and oat, most preferably from soybean, maize (corn), rice, cotton, tomatoes, potato, banana, papaya, oil seed rape, vine, apple, pear, citron, orange and cereals such as wheat, barley, rye and oat.

Plants, which are capable of synthesising antipathogenic substances having a selective action are for example plants expressing the so-called “pathogenesis-related proteins” (PRPs, see e.g. EP-A-0 392 225) or so-called “antifungal proteins” (AFPs, see e.g. U.S. Pat. No. 6,864,068). A wide range of antifungal proteins with activity against plant pathogenic fungi have been isolated from certain plant species and are common knowledge. Examples of such antipathogenic substances and transgenic plants capable of synthesising such antipathogenic substances are known, for example, from EP-A-0 392 225, WO 93/05153, WO 95/33818, and EP-A-0 353 191. Transgenic plants which are resistant against fungal, viral and bacterial pathogens are produced by introducing plant resistance genes. Numerous resistant genes have been identified, isolated and were used to improve plant resistant, such as the N gene which was introduced into tobacco lines that are susceptible to Tobacco Mosaic Virus (TMV) in order to produce TMV-resistant tobacco plants (see e.g. U.S. Pat. No. 5,571,706), the Prf gene, which was introduced into plants to obtain enhanced pathogen resistance (see e.g. WO 199802545) and the Rps2 gene from Arabidopsis thaliana, which was used to create resistance to bacterial pathogens including Pseudomonas syringae (see e.g. WO 199528423). Plants exhibiting systemic acquired resistance response were obtained by introducing a nucleic acid molecule encoding the TIR domain of the N gene (see e.g. U.S. Pat. No. 6,630,618). Further examples of known resistance genes are the Xa21 gene, which has been introduced into a number of rice cultivars (see e.g. U.S. Pat. No. 5,952,485, U.S. Pat. No. 5,977,434, WO 1999/09151, WO 1996/22375), the Rcg1 gene for colletotrichum resistance (see e.g. US 2006/225152), the prp1 gene (see e.g. U.S. Pat. No. 5,859,332, WO 2008/017706), the ppv-cp gene to introduce resistance against plum pox virus (see e.g. US PP15,154Ps), the P1 gene (see e.g. U.S. Pat. No. 5,968,828), genes such as Blb1, Blb2, Blb3 and RB2 to introduce resistance against Phytophthora infestans in potato (see e.g. U.S. Pat. No. 7,148,397), the LRPKml gene (see e.g. WO1999064600), the P1 gene for potato virus Y resistance (see e.g. U.S. Pat. No. 5,968,828), the HA5-1 gene (see e.g. U.S. Pat. No. 5,877,403 and U.S. Pat. No. 6,046,384), the PIP gene to introduce a broad resistant to viruses, such as potato virus X (PVX), potato virus Y (PVY), potato leafroll virus (PLRV) (see e.g. EP 0707069) and genes such as Arabidopsis N116, ScaM4 and ScaM5 genes to obtain fungal resistance (see e.g. U.S. Pat. No. 6,706,952 and EP 1018553). The methods of producing such transgenic plants are generally known to the person skilled in the art and are described, for example, in the publications mentioned above.

Antipathogenic substances which can be expressed by such transgenic plants include, for example, ion channel blockers, such as blockers for sodium and calcium channels, for example the viral KP1, KP4 or KP6 toxins; stilbene synthases; bibenzyl synthases; chitinases; glucanases; the so-called “pathogenesis-related proteins” (PRPs; see e.g. EP-A-0 392 225); antipathogenic substances produced by microorganisms, for example peptide antibiotics or heterocyclic antibiotics (see e.g. WO 1995/33818) or protein or polypeptide factors involved in plant pathogen defense (so-called “plant disease resistance genes”, as described in WO 2003/000906).

Antipathogenic substances produced by the plants are able to protect the plants against a variety of pathogens, such as fungi, viruses and bacteria. Useful plants of elevated interest in connection with present invention are cereals, such as wheat, barley, rye and oat; soybean; maize; rice; alfalfa, cotton, sugar beet, sugarcane, tobacco, potato, banana, oil seed rape; pome fruits; stone fruits; peanuts; coffee; tea; strawberries; turf; vines and vegetables, such as tomatoes, potatoes, cucurbits, papaya, melon, lenses and lettuce, more preferably selected from soybean, maize (corn), alfalfa, cotton, potato, banana, papaya, rice, tomatoes and cereals such as wheat, barley, rye and oat, most preferably from soybean, maize (corn), rice, cotton, potato, tomato, oilseed rape, vine, apple, pear, citron, orange and cereals such as wheat, barley, rye and oat.

Transgenic plants with resistance against fungal pathogens, are, for examples, soybeans with resistance against Asian soybean rust (see e.g. WO 2008/017706); plants such as alfalfa, corn, cotton, sugar beet, oileed, rape, tomato, soybean, wheat, potato and tobacco with resistance against Phytophtora infestans (see e.g. U.S. Pat. No. 5,859,332, U.S. Pat. No. 7,148,397, EP 1334979); corn with resistance against leaf blights, ear rots and stalk rots (such as anthracnose leaf bligh, anthracnose stalk rot, diplodia ear rot, Fusarium verticiliodes, Gibberella zeae and top dieback, see e.g. US 2006/225152); apples with resistance against apple scab (Venturia inaequalis, see e.g. WO 1999064600); plants such as rice, wheat, barley, rye, corn, oats, potato, melon, soybean and sorghum with resistance against fusarium diseases, such as Fusarium graminearum, Fusarium sporotrichiodes, Fusarium lateritium, Fusarium pseudograminearum Fusarium sambucinum, Fusarium culmorum, Fusarium poae, Fusarium acuminatum, Fusarium equiseti (see e.g. U.S. Pat. No. 6,646,184, EP 1477557); plants, such as corn, soybean, cereals (in particular wheat, rye, barley, oats, rye, rice), tobacco, sorghum, sugarcane and potatoes with broad fungal resistance (see e.g. U.S. Pat. No. 5,689,046, U.S. Pat. No. 6,706,952, EP 1018553 and U.S. Pat. No. 6,020,129).

Transgenic plants with resistance against bacterial pathogens and which are covered by the present invention, are, for examples, rice with resistance against Xylella fastidiosa (see e.g. U.S. Pat. No. 6,232,528); plants, such as rice, cotton, soybean, potato, sorghum, corn, wheat, barley, sugarcane, tomato and pepper, with resistance against bacterial blight (see e.g. WO 2006/42145, U.S. Pat. No. 5,952,485, U.S. Pat. No. 5,977,434, WO 1999/09151, WO 1996/22375); tomato with resistance against Pseudomonas syringae (see e.g. Can. J. Plant Path., 1983, 5: 251-255).

Transgenic plants with resistance against viral pathogens, are, for examples, stone fruits, such as plum, almond, apricot, cherry, peach, nectarine, with resistance against plum pox virus (PPV, see e.g. US PP15,154Ps, EP 0626449); potatoes with resistance against potato virus Y (see e.g. U.S. Pat. No. 5,968,828); plants such as potato, tomato, cucumber and leguminosaes which are resistant against tomato spotted wilt virus (TSWV, see e.g. EP 0626449, U.S. Pat. No. 5,973,135); corn with resistance against maize streak virus (see e.g. U.S. Pat. No. 6,040,496); papaya with resistance against papaya ring spot virus (PRSV, see e.g. U.S. Pat. No. 5,877,403, U.S. Pat. No. 6,046,384); cucurbitaceae, such as cucumber, melon, watermelon and pumpkin, and solanaceae, such as potato, tobacco, tomato, eggplant, paprika and pepper, with resistance against cucumber mosaic virus (CMV, see e.g. U.S. Pat. No. 6,849,780); cucurbitaceae, such as cucumber, melon, watermelon and pumpkin, with resistance against watermelon mosaic virus and zucchini yellow mosaic virus (see e.g. U.S. Pat. No. 6,015,942); potatoes with resistance against potato leafroll virus (PLRV, see e.g. U.S. Pat. No. 5,576,202); potatoes with a broad resistance to viruses, such as potato virus X (PVX), potato virus Y (PVY), potato leafroll virus (PLRV) (see e.g. EP 0707069).

Further examples of deregulated or commercially available transgenic plants with modified genetic material capable of expression of antipathogenic substances are the following plants: Carica papaya (papaya), Event: 55-1/63-1; Cornell University, Carica papaya (Papaya); Event: (X17-2); University of Florida, Cucurbita pepo (Squash); Event: (CZW-3); Asgrow (USA); Seminis Vegetable Inc. (Canada), Cucurbita pepo (Squash); Event: (ZW20); Upjohn (USA); Seminis Vegetable Inc. (Canada), Prunus domestica (Plum); Event: (C5); United States Department of Agriculture—Agricultural Research Service, Solanum tuberosum L. (Potato); Event: (RBMT15-101, SEMT15-02, SEMT15-15); Monsanto Company and Solanum tuberosum L. (Potato); Event: (RBMT21-129, RBMT21-350, RBMT22-082); Monsanto Company.

Transgenic plants with resistance against nematodes and which may be used in the methods of the present invention are, for examples, soybean plants with resistance to soybean cyst nematodes.

Methods have been proposed for the genetic transformation of plants in order to confer increased resistance to plant parasitic nematodes. U.S. Pat. Nos. 5,589,622 and 5,824,876 are directed to the identification of plant genes expressed specifically in or adjacent to the feeding site of the plant after attachment by the nematode.

Also known in the art are transgenic plants with reduced feeding structures for parasitic nematodes, e.g. plants resistant to herbicides except of those parts or those cells that are nematode feeding sites and treating such plant with a herbicide to prevent, reduce or limit nematode feeding by damaging or destroying feeding sites (e.g. U.S. Pat. No. 5,866,777).

Use of RNAi to target essential nematode genes has been proposed, for example, in PCT Publication WO 2001/96584, WO 2001/17654, US 2004/0098761, US 2005/0091713, US 2005/0188438, US 2006/0037101, US 2006/0080749, US 2007/0199100, and US 2007/0250947.

Transgenic nematode resistant plants have been disclosed, for example in the PCT publications WO 2008/095886 and WO 2008/095889.

Plants which are resistant to antibiotics, such as kanamycin, neomycin and ampicillin. The naturally occurring bacterial nptll gene expresses the enzyme that blocks the effects of the antibiotics kanamycin and neomycin. The ampicillin resistance gene ampR (also known as bIaTEM1) is derived from the bacterium Salmonella paratyphi and is used as a marker gene in the transformation of micro-organisms and plants. It is responsible for the synthesis of the enzyme betalactamase, which neutralises antibiotics in the penicillin group, including ampicillin. Transgenic plants with resistance against antibiotics, are, for examples potato, tomato, flax, canola, oilseed rape and corn (see e.g. Plant Cell Reports, 20, 2001, 610-615. Trends in Plant Science, 11, 2006, 317-319. Plant Molecular Biology, 37, 1998, 287-296. Mol Gen Genet., 257, 1998, 606-13.). Plant Cell Reports, 6, 1987, 333-336. Federal Register (USA), Vol. 60, No. 113, 1995, page 31139. Federal Register (USA), Vol. 67, No. 226, 2002, page 70392. Federal Register (USA), Vol. 63, No. 88, 1998, page 25194. Federal Register (USA), Vol. 60, No. 141, 1995, page 37870. Canadian Food Inspection Agency, FD/OFB-095-264-A, October 1999, FD/OFB-099-127-A, October 1999. Preferably, the plant is selected from soybean, maize (corn), rice, cotton, oilseed rape, potato, sugarcane, alfalfa, tomatoes and cereals, such as wheat, barley, rye and oat, most preferably from soybean, maize (corn), rice, cotton, oilseed rape, tomato, potato, vine, apple, pear, citron, orange and cereals such as wheat, barley, rye and oat.

Plants which are tolerant to stress conditions (see e.g. WO 2000/04173, WO 2007/131699, CA 2521729 and US 2008/0229448) are plants, which show increased tolerance to abiotic stress conditions such as drought, high salinity, high light intensities, high UV irradiation, chemical pollution (such as high heavy metal concentration), low or high temperatures, limited supply of nutrients (i.e. nitrogen, phosphorous) and population stress. Preferably, transgenic plants with resistance to stress conditions, are selected from rice, corn, soybean, sugarcane, alfalfa, wheat, tomato, potato, barley, rapeseed, beans, oats, sorghum and cotton with tolerance to drought (see e.g. WO 2005/048693, WO 2008/002480 and WO 2007/030001); corn, soybean, wheat, cotton, rice, rapeseed and alfalfa with tolerance to low temperatures (see e.g. U.S. Pat. No. 4,731,499 and WO 2007/112122); rice, cotton, potato, soybean, wheat, barley, rye, sorghum, alfalfa, grape, tomato, sunflower and tobacco with tolerance to high salinity (see e.g. U.S. Pat. No. 7,256,326, U.S. Pat. No. 7,034,139, WO 2001/030990). The methods of producing such transgenic plants are generally known to the person skilled in the art and are described, for example, in the publications mentioned above. Preferably, the plant is selected from soybean, maize (corn), rice, cotton, sugarcane, alfalfa, sugar beet, potato, oilseed rape, tomatoes and cereals such as wheat, barley, rye and oat, most preferably from soybean, maize (corn), rice, cotton, oilseed rape, tomato, potato, sugarcane, vine, apple, pear, citron, orange and cereals such as wheat, barley, rye and oat.

Altered maturation properties, are for example delayed ripening, delayed softening and early maturity. Preferably, transgenic plants with modified maturation properties, are, selected from tomato, melon, raspberry, strawberry, muskmelon, pepper and papaya with delayed ripening (see e.g. U.S. Pat. No. 5,767,376, U.S. Pat. No. 7,084,321, U.S. Pat. No. 6,107,548, U.S. Pat. No. 5,981,831, WO 1995035387, U.S. Pat. No. 5,952,546, U.S. Pat. No. 5,512,466, WO 1997001952, WO 1992/008798, Plant Cell. 1989, 53-63. Plant Molecular Biology, 50, 2002). The methods of producing such transgenic plants are generally known to the person skilled in the art and are described, for example, in the publications mentioned above. Preferably, the plant is selected from fruits, such as tomato, vine, melon, papaya, banana, pepper, raspberry and strawberry; stone fruits, such as cherry, apricot and peach; pome fruits, such as apple and pear; and citrus fruits, such as citron, lime, orange, pomelo, grapefruit, and mandarin; more preferably from tomato, vine, apple, banana, orange and strawberry, most preferably tomatoes.

Content modification is synthesis of modified chemical compounds (if compared to the corresponding control plant) or synthesis of enhanced amounts of chemical (if compounds compared to the corresponding control plant) and corresponds to an increased or reduced amount of vitamins, amino acids, proteins and starch, different oils and a reduced amount of nicotine. Commercial examples are the soybean varieties “Vistive II” and “Visitive III” with low-linolenic/medium oleic content; the corn variety “Mavera high-value corn” with increased lysine content; and the soybean variety “Mavera high value soybean” with yielding 5% more protein compared to conventional varieties when processed into soybean meal. Further transgenic plants with altered content are, for example, potato and corn with modified amylopectin content (see e.g. U.S. Pat. No. 6,784,338, US 20070261136); canola, corn, cotton, grape, catalpa, cattail, rice, soybean, wheat, sunflower, balsam pear and vernonia with a modified oil content (see e.g. U.S. Pat. No. 7,294,759, U.S. Pat. No. 7,157,621, U.S. Pat. No. 5,850,026, U.S. Pat. No. 6,441,278, U.S. Pat. No. 6,380,462, U.S. Pat. No. 6,365,802, U.S. Pat. No. 6,974,898, WO 2001/079499, US 2006/0075515 and U.S. Pat. No. 7,294,759); sunflower with increased fatty acid content (see e.g. U.S. Pat. No. 6,084,164); soybeans with modified allergens content (so called “hypoallergenic soybean, see e.g. U.S. Pat. No. 6,864,362); tobacco with reduced nicotine content (see e.g. US 20060185684, WO 2005000352 and WO 2007064636); canola and soybean with increased lysine content (see e.g. Bio/Technology 13, 1995, 577-582); corn and soybean with altered composition of methionine, leucine, isoleucine and valine (see e.g. U.S. Pat. No. 6,946,589, U.S. Pat. No. 6,905,877); soybean with enhanced sulfur amino acid content (see e.g. EP 0929685, WO 1997041239); tomato with increased free amino acid contents, such as asparagine, aspartic acid, serine, threonine, alanine, histidine and glutamic acid (see e.g. U.S. Pat. No. 6,727,411); corn with enhanced amino acid content (see e.g. WO 05077117); potato, corn and rice with modified starch content (see e.g. WO 1997044471 and U.S. Pat. No. 7,317,146); tomato, corn, grape, alfalfa, apple, beans and peas with modified flavonoid content (see e.g. WO 2000/04175); corn, rice, sorghum, cotton, soybeans with altered content of phenolic compounds (see e.g. US 20080235829). The methods of producing such transgenic plants are generally known to the person skilled in the art and are described, for example, in the publications mentioned above. Preferably, the plant is selected from soybean, maize (corn), rice, cotton, sugarcane, potato, tomato, oilseed rape, flax and cereals such as wheat, barley, rye and oat, most preferably soybean, maize (corn), rice, oilseed rape, potato, tomato, cotton, vine, apple, pear, citron, orange and cereals such as wheat, bar-ley, rye and oat.

Enhanced nutrient utilization is e.g. assimilation or metabolism of nitrogen or phosphorous. Preferably, transgenic plants with enhanced nitrogen assimilatory and utilization capacities are selected from for example, canola, corn, wheat, sunflower, rice, tobacco, soybean, cotton, alfalfa, tomato, wheat, potato, sugar beet, sugar cane and rapeseed (see e.g. WO 1995/009911, WO 1997/030163, U.S. Pat. No. 6,084,153, U.S. Pat. No. 5,955,651 and U.S. Pat. No. 6,864,405). Plants with improved phosphorous uptake are, for example, tomato and potato (see e.g. U.S. Pat. No. 7,417,181). The methods of producing such transgenic plants are generally known to the person skilled in the art and are described, for example, in the publications mentioned above. Preferably, the plant is selected from soybean, maize (corn), rice, cotton, sugarcane, alfalfa, potato, oilseed rape and cereals such as wheat, barley, rye and oat, most preferably from soybean, maize (corn), rice, cotton, oilseed rape, tomato, potato, vine, apple, pear, citron, orange and cereals such as wheat, barley.

Transgenic plants with male sterility are preferably selected from canola, corn, tomato, rice, Indian mustard, wheat, soybean and sunflower (see e.g. U.S. Pat. No. 6,720,481, U.S. Pat. No. 6,281,348, U.S. Pat. No. 5,659,124, U.S. Pat. No. 6,399,856, U.S. Pat. No. 7,345,222, U.S. Pat. No. 7,230,168, U.S. Pat. No. 6,072,102, EP1 135982, WO 2001/092544 and WO 1996/040949). The methods of producing such transgenic plants are generally known to the person skilled in the art and are described, for example, in the publications mentioned above.

Preferably, the plant is selected from soybean, maize (corn), rice, cotton, oilseed rape, tomato, potato, vine, apple, pear, citron, orange and cereals such as wheat, barley.

Further examples of deregulated or commercially available transgenic plants with modified genetic material being male sterile are Brassica napus (Argentine Canola: (Event: MS1, RF1=>PGS1; Bayer CropScience (formerly Plant Genetic Systems); Brassica napus (Event: MS1, RF2=>PGS2; Bayer CropScience (formerly Plant Genetic Systems); Brassica napus (Event: MS8×RF3; Bayer CropScience (Aventis CropScience(AgrEvo)); Brassica napus (Event: PHY14, PHY35; Bayer CropScience (formerly Plant Genetic Systems); Brassica napus (Event: PHY36; Bayer CropScience (formerly Plant Genetic Systems); Cichorium intybus (Chicory: (Event: RM3-3, RM3-4, RM3-6; Bejo Zaden BV; Zea mays L. (Maize: (Event: 676, 678, 680; Pioneer Hi-Bred International Inc.; Zea mays L. (Event: MS3; Bayer CropScience (Aventis CropScience(AgrEvo)) and Zea mays L. (Event: MS6; Bayer CropScience (Aventis CropScience(AgrEvo)).

Plants, which produce higher quality fiber are e.g. transgenic cotton plants. The such improved quality of the fiber is related to improved micronaire of the fiber, increased strength, improved staple length, improved length uniformity and color of the fibers (see e.g. WO 1996/26639, U.S. Pat. No. 7,329,802, U.S. Pat. No. 6,472,588 and WO 2001/17333). The methods of producing such transgenic plants are generally known to the person skilled in the art and are described, for example, in the publications mentioned above.

As set forth above, cultivated plants may comprise one or more traits, e.g. selected from the group consisting of herbicide tolerance, insect resistance, fungal resistance, viral resistance, bacterial resistance, stress tolerance, maturation alteration, content modification, modified nutrient uptake and male sterility (see e.g. WO 2005033319 and U.S. Pat. No. 6,376,754).

Examples of commercial available transgenic plants with two combined properties are the corn varieties “YieldGard Roundup Ready” and YieldGard Roundup Ready 2″ (Monsanto) with glyphosate tolerance and resistance to corn borer; the corn variety “Agrisure CB/LL” (Syntenta) with glufosinate tolerance and corn borer resistance; the corn variety “Yield Gard VT Rootworm/RR2” with glyphosate tolerance and corn rootworm resistance; the corn variety “Yield Gard VT Triple” with glyphosate tolerance and resistance against corn rootworm and corn borer; the corn variety “Herculex I” with glufosinate tolerance and lepidopteran resistance (Cry1F), i.e. against western bean cutworm, corn borer, black cutworm and fall armyworm; the corn variety “YieldGard Corn Rootworm/Roundup Ready 2” (Monsanto) with glyphosate tolerance and corn rootworm resistance; the corn variety “Agrisure GT/RW” (Syngenta) with gluphosinate tolerance and lepidopteran resistance (Cry3A), i.e. against western corn rootworm, northern corn rootworm and Mexican corn rootworm; the corn variety “Herculex RW” (Dow, Pioneer) with glufosinate tolerance and lepidopteran resistance (Cry34/35Ab1), i.e. against western corn rootworm, northern corn rootworm and Mexican corn rootworm; the corn variety “Yield Gard VT Rootworm/RR2” with glyphosate tolerance and corn rootworm resistance; the soybean variety “Optimum GAT” (DuPont, Pioneer) with glyphosate tolerance and ALS herbicide tolerance; the corn variety “Mavera high-value corn” with glyphosate tolerance, resistance to corn rootworm and European corn borer and high lysine trait.

Examples of commercial available transgenic plants with three traits are the corn variety “Herculex I/Roundup Ready 2” with glyphosate tolerance, gluphosinate tolerance and lepidopteran resistance (Cry1F), i.e. against western bean cutworm, corn borer, black cutworm and fall armyworm; the corn variety “YieldGard Plus/Roundup Ready 2” (Monsanto) with glyphosate tolerance, corn rootworm resistance and corn borer resistance; the corn variety “Agrisure GT/CB/LL” (Syngenta) with tolerance to glyphosate tolerance, tolerance to gluphosinate and corn borer resistance; the corn variety “Herculex Xtra” (Dow, Pioneer) with glufosinate tolerance and lepidopteran resistance (Cry1F+Cry34/35Ab1), i.e. against western corn rootworm, northern corn rootworm, Mexican corn rootworm, western bean cutworm, corn borer, black cutworm and fall armyworm; the corn varieties “Agrisure CB/LL/RW” (Syngenta) with glufosinate tolerance, corn borer resistance (Cry1Ab) and lepidopteran resistance (Cry3A), i.e. against western corn rootworm, northern corn rootworm and Mexican corn rootworm; the corn variety “Agrisure 3000GT” (Syngenta) with glyphosate tolerance+corn borer resistance (Cry1Ab) and lepidopteran resistance (Cry3A), i.e. against western corn rootworm, northern corn rootworm and Mexican corn rootworm. The methods of producing such transgenic plants are generally known to the person skilled in the art.

An example of a commercial available transgenic plant with four traits is “Hercules Quad-Stack” with glyphosate tolerance, glufosinate tolerance, corn borer resistance and corn rootworm resistance.

Preferably, the cultivated plants are plants, which comprise at least one trait selected from herbicide tolerance,

insect resistance by expression of bacterial toxins,
fungal resistance or viral resistance or bacterial resistance by expression of antipathogenic substances
stress tolerance,
content modification of chemicals present in the cultivated plant compared to the corresponding control plant.

Most preferably, the cultivated plants are plants, which are tolerant to the action of herbicides and plants, which express bacterial toxins, which provides resistance against animal pests (such as insects or arachnids or nematodes), wherein the bacterial toxin is preferably a toxin from Bacillus thuriginensis. Herein, the plant is preferably selected from cotton, rice, maize, wheat, barley, rye, oat, soybean, potato, vine, apple, pear, citron and orange.

In one embodiment, the plant is soybean.

In one embodiment, the invention relates to a method for controlling pests and/or increasing the plant health of a cultivated plant with at least one modification as compared to the respective non-modified control plant, wherein the plant is soybean, which method comprises applying a compound of formula I, which is selected from the compounds I-1 to I-40 as defined in Table C. More specifically, the compound I is selected from compounds I-11, I-16, I-21, I-26, I-31 which are defined in accordance with Table C of the example section, more specifically compound I-11, more specifically compound I-16, more specifically compound I-21, more specifically compound I-26, more specifically compound I-31.

In an utmost preferred embodiment, the cultivated plants are plants, which are tolerant to the action of herbicides. Further guidance for specific combinations within this utmost preferred embodiment can be found in tables 1, 2, 14 and tables A, B and C.

If such plants are used in the methods according to the present invention, compounds of formula I and their mixtures may additionally comprise a herbicide III, to which the plant is tolerant.

For example, if the cultivated plant is a cultivated plant tolerant to glyphosate, compounds of formula I and their mixtures may additionally comprise glyphosate.

For example, if the cultivated plant is a cultivated plant tolerant to glufonsinate, compounds of formula I and their mixtures may additionally comprise glufonisate.

For example, if the cultivated plant is a cultivated plant tolerant to a imidazolione herbicide, compounds of formula I and their mixtures may additionally comprise at least one imidazolioneherbicide. Herein, the imidazolionone-herbicide is selected from imazamox, imazethapyr, imazapic, imazapyr, imazamethabenz or imazaquin.

For example, if the cultivated plant is a cultivated plant tolerant to dicamba, compounds of formula I and their mixtures may additionally comprise dicamba.

For example, if the cultivated plant is a cultivated plant tolerant to sethoxidim, compounds of formula I and their mixtures may additionally comprise sethoxidim.

For example, if the cultivated plant is a cultivated plant tolerant to cycloxidim, compounds of formula I and their mixtures may additionally comprise cyloxidim.

Thus, the present invention also relates to ternary mixtures, comprising a compound of formula I, an insecticide II and a herbicide III. In particular, the present invention also relates to ternary mixtures comprising two insecticides and a fungicide.

In another particular embodiment, the present invention also relates to ternary mixtures comprising two fungicides and one insecticide.

In another particular embodiment, the present invention also relates to ternary mixtures comprising an insecticide, a fungicides and a herbicide.

In one embodiment of the invention the cultivated plant is selected from the group of plants as mentioned in the paragraphs and tables of this disclosure, preferably as mentioned above. Preferably, the cultivated plants are plants, which comprise at least one trait selected from herbicide tolerance, insect resistance for example by expression of one or more bacterial toxins, fungal resistance or viral resistance or bacterial resistance by expression of one or more antipathogenic substances, stress tolerance, nutrient uptake, nutrient use efficiency, content modification of chemicals present in the cultivated plant compared to the corresponding control plant.

More preferably, the cultivated plants are plants, which comprise at least one trait selected from herbicide tolerance, insect resistance by expression of one or more bacterial toxins, fungal resistance or viral resistance or bacterial resistance by expression of one or more antipathogenic substances, stress tolerance, content modification of one or more chemicals present in the cultivated plant compared to the corresponding control plant.

Most preferably, the cultivated plants are plants, which are tolerant to the action of herbicides and plants, which express one or more bacterial toxins, which provides resistance against one or more animal pests (such as insects or arachnids or nematodes), wherein the bacterial toxin is preferably a toxin from Bacillus thuriginensis. Herein, the cultivated plant is preferably selected from soybean, maize (corn), rice, cotton, sugarcane, alfalfa, potato, oilseed rape, tomatoes and cereals such as wheat, barley, rye and oat, most preferably from soybean, maize (corn), cotton, rice and cereals such as wheat, barley, rye and oat.

Utmost preference is given to cultivated plants, which are tolerant to the action of herbicides.

In another utmost preference, the cultivated plants are plants, which are given in table A. Sources: AgBios database and GMO-compass database (AG BIOS, P.O. Box 475, 106 St. John St. Merrickville, Ontario KOG1NO, Canada, access: http://cera-gmc.org/, also see BioTechniques, Volume 35, No. 3, September 2008, p. 213, and http://www.gmo-compass.org/eng/gmo/db/). Thus, in one preferred embodiment, the present invention relates to a method of controlling harmful insects and/or increasing the health of cultivated plants by treating cultivated plants, parts of such plants, plant propagation materials, or at their locus of growth with compounds of formula I and their mixtures, wherein the plant is a plant, which is rendered tolerant to herbicides, more preferably to herbicides such as glutamine synthetase inhibitors, 5-enol-pyrovylshikimate-3-phosphate-synthase inhibitors, acetolactate synthase (ALS) inhibitors, protoporphyrinogen oxidase (PPO) inhibitors, auxine type herbicides, most preferably to herbicides such as glyphosate, glufosinate, imazapyr, imazapic, imazamox, imazethapyr, imazaquin, imazamethabenz methyl, dicamba and 2,4-D.

In a more preferred embodiment, the present invention relates to a method of controlling harmful insects and/or increasing the health of cultivated plants by treating cultivated plants, parts of such plants, plant propagation materials, or at their locus of growth with compounds of formula I and their mixtures compounds of formula I or their mixtures, wherein the plant corresponds to a row of table 1.

In a more preferred embodiment, the present invention relates to a method of controlling harmful insects and/or increasing the health of cultivated plants by treating plant propagation materials, preferably seeds with compounds of formula I and their mixtures compounds of formula I or their mixtures selected from endosulfan, ethiprole and fipronil, wherein the plant corresponds to row of table 1.

In another more preferred embodiment, the present invention relates to a method of controlling harmful insects and/or increasing the health of cultivated plants by treating cultivated plants, parts of such plants or their locus of growth with a compound of formula I, which is selected from the compounds I-1 to I-40 as defined in Table C, wherein the plant corresponds to row of table A1. In this embodiment the compound of formula I is more specifically selected from compounds I-11, I-16, I-21, I-26, I-31 which are defined in accordance with Table C of the example section.

In a most preferred embodiment, the present invention relates to a method of controlling harmful insects and/or increasing the health of plants by treating cultivated plants, parts of such plants or their locus of growth with compounds of formula I, wherein the plant corresponds to a row of table A1, wherein the compound of formula I is compound I-11.

In a most preferred embodiment, the present invention relates to a method of controlling harmful insects and/or increasing the health of plants by treating cultivated plants, parts of such plants or their locus of growth with compounds of formula I, wherein the plant corresponds to a row of table A1, wherein the compound of formula I is compound I-16.

In a most preferred embodiment, the present invention relates to a method of controlling harmful insects and/or increasing the health of plants by treating cultivated plants, parts of such plants or their locus of growth with compounds of formula I, wherein the plant corresponds to a row of table A1, wherein the compound of formula I is compound I-26.

In a most preferred embodiment, the present invention relates to a method of controlling harmful insects and/or increasing the health of plants by treating cultivated plants, parts of such plants or their locus of growth with compounds of formula I, wherein the plant corresponds to a row of table A1, wherein the compound of formula I is compound I-31.

TABLE A1

| | | transgenic | | literature/commercial |
|---|---|---|---|---|
| No | description | event | plant | plants |
| A1-1 | Glyphosate | ASR368 | Agrostis stolonifera | available, Scotts Seeds |
| | tolerance | | (creeping bentgrass) | |
| A1-2 | Glyphosate | A5-15 | Beta vulgaris (sugar | available, Danisco |
| | tolerance | | beet) | Seeds/DLF Trifolium |
| A1-3 | Glyphosate | GTSB77 | Beta vulgaris (sugar | available, Novartis |
| | tolerance | | beet) | Seeds; Monsanto |
| | | | | Company |
| A1-4 | Glyphosate | H7-1 | Beta vulgaris (sugar | available, Monsanto |
| | tolerance | | beet) | Company |
| A1-5 | Glyphosate | T120-7 | Beta vulgaris (sugar | available, Bayer |
| | tolerance | | beet) | CropScience (Aventis |
| | | | | CropScience(AgrEvo)) |
| A1-6 | Glyphosate | GT200 | Brassica napus | available, Monsanto |
| | tolerance | | (Argentine canola) | Company |
| A1-7 | Glyphosate | GT73, | Brassica napus | available, Monsanto |
| | tolerance | RT73 | (Argentine canola) | Company |
| A1-8 | Glyphosate | HCN10 | Brassica napus | available, Aventis |
| | tolerance | | (Argentine canola) | CropScience |
| A1-9 | Glyphosate | HCN92 | Brassica napus | available, Bayer |
| | tolerance | | (Argentine canola) | CropScience (Aventis |
| | | | | CropScience(AgrEvo)) |
| A1-10 | Glyphosate | T45 | Brassica napus | available, Bayer |
| | tolerance | (HCN28) | (Argentine canola) | CropScience (Aventis |
| | | | | CropScience(AgrEvo)) |
| A1-11 | Glyphosate | ZSR500/502 | Brassica rapa | available, Monsanto |
| | tolerance | | (Polish canola) | Company |
| A1-12 | Glyphosate | GTS 40-3-2 | Glycine max L. | available, Monsanto |
| | tolerance | | (soybean) | Company |
| A1-13 | Glyphosate | MON40-3-2 | Glycine max L. | available, Monsanto |
| | tolerance | | (soybean) | Company |
| A1-14 | Glyphosate | MON89788 | Glycine max L. | available, Monsanto |
| | tolerance | | (soybean) | Company |
| A1-15 | Glyphosate | GHB614 | Gossypium hirsutum | available, Bayer Crop- |
| | tolerance | | L. (cotton) | Science USA LP |
| A1-16 | Glyphosate | MON1445 | Gossypium hirsutum | available, Monsanto |
| | tolerance | | L. (cotton) | Company |
| A1-17 | Glyphosate | MON1445/ | Gossypium hirsutum | available, Monsanto |
| | tolerance | 1698 | L. (cotton) | Company |
| A1-18 | Glyphosate | MON88913 | Gossypium hirsutum | available, Monsanto |
| | tolerance | | L. (cotton) | Company |
| A1-19 | Glyphosate | MON- | Medicago sativa | available, Monsanto |
| | tolerance | ØØ1Ø1-8, | (alfalfa) | and Forage Genetics |
| | | MON- | | International |
| | | ØØ163-7 | | |
| | | (J101, | | |
| | | J163) | | |
| A1-20 | Glyphosate | MON71800 | Triticum aestivum | available, Monsanto |
| | tolerance | | (wheat) | Company |
| A1-21 | Glyphosate | NK603 | Zea mays L. (corn, | available, Monsanto |
| | tolerance | | maize) | Company |
| A1-22 | Glyphosate | GA21 | Zea mays L. (corn, | available, Syngenta |
| | tolerance | | maize) | Seeds, Inc. (formerly |
| A1-23 | Glyphosate | MON832 | Zea mays L. (corn, | Monsanto Company |
| | tolerance | | maize) | |
| A1-24 | Glufosinate | GS40/ | Brassica napus | available, Bayer Crop- |
| | tolerance | 90pHoe6/ | (Argentine canola) | Science |
| | | Ac | | |
| A1-25 | Glufosinate | Liberator | Brassica napus | available, Bayer Crop- |
| | tolerance | pHoe6/Ac | (Argentine canola) | Science |
| A1-26 | Glufosinate | TOPAS19/2 | Brassica napus | available, Bayer Crop- |
| | tolerance | | (Argentine canola) | Science |
| A1-27 | Glufosinate | T14, T25 | Zea mays L. (corn, | Bayer CropScience |
| | tolerance | (ACS- | maize) | (Aventis |
| | | ZMØØ2-1/ | | CropScience(AgrEvo)) |
| | | ACS- | | |
| A1-28 | Glufosinate | PHY14, | Brassica napus | available, Aventis |
| | ammonium tolerance | PHY35 | (Argentine canola) | CropScience (formerly |
| | | | | Plant Genetic Systems) |
| A1-29 | Glufosinate | PHY36 | Brassica napus | available, Aventis |
| | ammonium tolerance | | (Argentine canola) | CropScience (formerly |
| | | | | Plant Genetic Systems) |
| A1-30 | Glufosinate | HCR-1 | Brassica rapa | available, Bayer |
| | ammonium tolerance | | (Polish canola) | CropScience (Aventis |
| | | | | CropScience(AgrEvo)) |
| A1-31 | Glufosinate | RM3-3, | Cichorium intybus | available, Bejo Zaden |
| | ammonium tolerance | RM3-4, | (Chicory) | BV |
| | | RM3-6 | | |
| A1-32 | Glufosinate | A2704-12, | Glycine max L. | available, Bayer |
| | ammonium tolerance | A2704-21, | (soybean) | CropScience (Aventis |
| | | A5547-35 | | CropScience(AgrEvo)) |
| A1-33 | Glufosinate | A5547- | Glycine max L. | available, Bayer |
| | ammonium tolerance | 127 | (soybean) | CropScience (Aventis |
| | | | | CropScience(AgrEvo)) |
| A1-34 | Glufosinate | GU262 | Glycine max L. | available, Bayer |
| | ammonium tolerance | | (soybean) | CropScience (Aventis |
| | | | | CropScience(AgrEvo)) |
| A1-35 | Glufosinate | W62, W98 | Glycine max L. | available, Bayer |
| | ammonium tolerance | | (soybean) | CropScience (Aventis |
| | | | | CropScience(AgrEvo)) |
| A1-36 | Glufosinate | LLCotton25 | Gossypium hirsutum | available, Bayer |
| | ammonium tolerance | | L. (cotton) | CropScience (Aventis |
| | | | | CropScience(AgrEvo)) |
| A1-37 | Glufosinate | LL RICE | Oryza sativa (rice) | available, Bayer Crop- |
| | ammonium tolerance | 62 | | Science |
| A1-38 | Glufosinate | LLrice06 | Oryza sativa (rice) | available, Bayer Crop- |
| | ammonium tolerance | LLrice 62 | | Science |
| A1-39 | Glufosinate | LLrice601 | Oryza sativa (rice) | available, Bayer Crop- |
| | ammonium tolerance | | | Science |
| A1-40 | Glufosinate | 676, 678, | Zea mays L. (corn, | available, Pioneer Hi- |
| | ammonium tol- | 680 | maize) | Bred International Inc. |
| A1-41 | Glufosinate | B16 | Zea mays L. (corn, | available, Dekalb Genetics |
| | ammonium tol- | (DLL25) | maize) | Corporation |
| A1-42 | Imidazolinone | NS738, | Brassica napus | available, Pioneer Hi- |
| | tolerance | NS1471, | (Argentine canola) | Bred International Inc. |
| A1-43 | Imidazolinone | X81359 | Helianthus annuus | available, BASF |
| | tolerance | | (sunflower) | |
| A1-44 | Imidazolinone | RH44 | Lens culinaris (lentil) | available, BASF |
| | tolerance | | | |
| A1-45 | Imidazolinone | CFX51 | Oryza sativa (rice) | available, BASF |
| | tolerance | | | |
| A1-46 | Imidazolinone | IMINTA-1, | Oryza sativa (rice) | available, BASF |
| | tolerance | IMINTA-4 | | |
| A1-47 | Imidazolinone | PWC16 | Oryza sativa (rice) | available, BASF |
| | tolerance | | | |
| A1-48 | Imidazolinone | AP205CL | Triticum aestivum | available, BASF Inc. |
| | tolerance | | (wheat) | |
| A1-49 | Imidazolinone | AP602CL | Triticum aestivum | available, BASF Inc. |
| | tolerance | | (wheat) | |
| A1-50 | Imidazolinone | BW255-2, | Triticum aestivum | available, BASF Inc. |
| | tolerance | BW238-3 | (wheat) | |
| A1-51 | Imidazolinone | BW7 | Triticum aestivum | available, BASF Inc. |
| | tolerance | | (wheat) | |
| A1-52 | Imidazolinone | SWP965001 | Triticum aestivum | available, Cyanamid |
| | tolerance | | (wheat) | Crop Protection |
| A1-53 | Imidazolinone | Teal 11A | Triticum aestivum | available, BASF Inc. |
| | tolerance | | (wheat) | |
| A1-54 | Imidazolinone | 3751IR | Zea mays L. (corn, | available, Pioneer Hi- |
| | tolerance | | maize) | Bred International Inc. |
| A1-55 | Imidazolinone | EXP1910IT | Zea mays L. (corn, | available, Syngenta |
| | tolerance | | maize) | Seeds, Inc. (formerly |
| A1-56 | Imidazolinone | IT | Zea mays L. (corn, | available, Pioneer Hi- |
| | tolerance | | maize) | Bred International Inc. |
| A1-57 | sulfonyl urea | 19-51A | Gossypium hirsutum | available, DuPont |
| | tolerance | | L. (cotton) | Canada Agricultural |
| A1-58 | sulfonyl urea | CDC- | University of Saskatchewan, | available, Linum usitatissimum |
| | tolerance | FL001-2 | Crop | L. (flax, linseed) |
| | | (FP967) | Dev. Centre | |
| A1-59 | Bromoxynil and | OXY-235 | Brassica napus | available, Aventis |
| | loxynil | | (Argentine canola) | CropScience (formerly |
| | tolerance | | | Rhône Poulenc Inc.) |
| A1-60 | Bromoxynil and | BXN | Gossypium hirsutum | available, Calgene Inc. |
| | loxynil | | L. (cotton) | |
| A1-61 | Bromoxynil and | C/F/93/08- | Nicotiana tabacum | available, Societe National |
| | loxynil | 02 | L. (tobacco) | d'Exploitation |
| | tolerance | | | des Tabacs et Allumettes |
| A1-62 | Cyclohexanone | DK404SR | Zea mays L. (corn, | available, BASF Inc. |
| | tolerance | | maize) | |

In a most preferred embodiment, the present invention relates to a method of controlling harmful insects and/or increasing the health of plants by treating cultivated plants, parts of such plants or their locus of growth with compounds of formula I, wherein the plant corresponds to a row of table 1, wherein the compound of formula I is compound I-11.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 1, wherein the compound of formula I is compound I-16.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 1, wherein the compound of formula I is compound I-26.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 1, wherein the compound of formula I is compound I-31.

TABLE 1

| | | | | Literature/commercial |
|---|---|---|---|---|
| No | detailed description [Event] | | plant | plants |
| T1-1 | imidazolinone tolerance | | canola | B* |
| T1-2 | imidazolinone tolerance | | maize | A*, B* |
| T1-3 | imidazolinone tolerance | | rice | A*, C* |
| T1-4 | imidazolinone tolerance | | millet | A* |
| T1-5 | imidazolinone tolerance | | barley | A* |
| T1-6 | imidazolinone tolerance | | wheat | A* |
| T1-7 | imidazolinone tolerance | | Sorghum | A* |
| T1-8 | imidazolinone tolerance | | oats | A* |
| T1-9 | imidazolinone tolerance | | rye | A* |
| T1-10 | imidazolinone tolerance | | sugar beet | WO 1998/02526/WO |
| | | | | 1998/02527 |
| T1-11 | imidazolinone tolerance | | lentils | US2004/0187178 |
| T1-12 | imidazolinone tolerance | | sunflowers | B* |
| T1-13 | imidazolinone tolerance | | wheat | D* |
| T1-14 | glyphosate tolerance | | alfalfa | E*; “Roundup Ready |
| | | | | Alfalfa” |
| T1-15 | glyphosate tolerance | | apple | E* |
| T1-16 | glyphosate tolerance | | barley | E* |
| T1-17 | glyphosate tolerance | | canola | E*; V* |
| T1-18 | glyphosate tolerance | | maize | E*; W* |
| T1-19 | glyphosate tolerance | | cotton | E*; X* |
| T1-20 | glyphosate tolerance | | flax | E* |
| T1-21 | glyphosate tolerance | | grape | E* |
| T1-22 | glyphosate tolerance | | lentil | E* |
| T1-23 | glyphosate tolerance | | oil seed rape | E* |
| T1-24 | glyphosate tolerance | | pea | E* |
| T1-25 | glyphosate tolerance | | potato | E* |
| T1-26 | glyphosate tolerance | | rice | “Roundup Ready |
| | | | | Rice” (Monsanto) |
| T1-27 | glyphosate tolerance | | soybean | E*; Y* |
| T1-28 | glyphosate tolerance | | sugar beet | E* |
| T1-29 | glyphosate tolerance | | sunflower | E* |
| T1-30 | glyphosate tolerance | | tobacco | E* |
| T1-31 | glyphosate tolerance | | tomato | E* |
| T1-32 | glyphosate tolerance | | turf grass | E* |
| T1-33 | glyphosate tolerance | | wheat | E* |
| T1-34 | gluphosinate tolerance | | canola | F*; U* |
| T1-35 | gluphosinate tolerance | | maize | F*; Z* |
| T1-36 | gluphosinate tolerance | | cotton | F*; “FiberMax Liberty |
| | | | | Link” (Bayer), |
| T1-37 | gluphosinate tolerance | | potato | F* |
| T1-38 | gluphosinate tolerance | | rice | F*, G*; “Liberty Link |
| | | | | Rice” (Bayer), |
| T1-39 | gluphosinate tolerance | | sugar beet | F* |
| T1-40 | gluphosinate tolerance | | soybean | U.S. Pat. No. 6,376,754 |
| T1-41 | gluphosinate tolerance | | tobacco | F* |
| T1-42 | gluphosinate tolerance | | tomato | F* |
| T1-43 | dicamba tolerance | | bean | U.S. Pat. No. 7,105,724 |
| T1-44 | dicamba tolerance | | maize | U.S. Pat. No. 7,105,724, |
| | | | | WO2008051633 |
| T1-45 | dicamba tolerance | | cotton | U.S. Pat. No. 7,105,724, |
| | | | | U.S. Pat. No. 5,670,454 |
| T1-46 | dicamba tolerance | | pea | U.S. Pat. No. 7,105,724 |
| T1-47 | dicamba tolerance | | potato | U.S. Pat. No. 7,105,724 |
| T1-48 | dicamba tolerance | | Sorghum | U.S. Pat. No. 7,105,724 |
| T1-49 | dicamba tolerance | | soybean | U.S. Pat. No. 7,105,724, |
| | | | | U.S. Pat. No. 5,670,454 |
| T1-50 | dicamba tolerance | | sunflower | U.S. Pat. No. 7,105,724 |
| T1-51 | dicamba tolerance | | tobacco | U.S. Pat. No. 7,105,724 |
| T1-52 | dicamba tolerance | | tomato | U.S. Pat. No. 7,105,724, |
| | | | | U.S. Pat. No. 5,670,454 |
| T1-53 | bromoxynil tolerance | | canola | “Navigator”, “Compass” |
| | | | | (Rhone- |
| | | | | Poulenc) |
| T1-54 | bromoxynil tolerance | | cotton | “BXN” (calgene) |
| T1-55 | 2,4-D tolerance | | apple | H* |
| T1-56 | 2,4-D tolerance | | maize | H* |
| T1-57 | 2,4-D tolerance | | cotton | U.S. Pat. No. 5,670,454 |
| T1-58 | 2,4-D tolerance | | cucumber | H* |
| T1-59 | 2,4-D tolerance | | pepper | H* |
| T1-60 | 2,4-D tolerance | | potato | H* |
| T1-61 | 2,4-D tolerance | | Sorghum | H* |
| T1-62 | 2,4-D tolerance | | soybean | H* |
| T1-63 | 2,4-D tolerance | | sunflower | H* |
| T1-64 | 2,4-D tolerance | | tobacco | H* |
| T1-65 | 2,4-D tolerance | | tomato | H* |
| T1-66 | 2,4-D tolerance | | wheat | H* |
| T1-67 | HPPD inhibitor tolerance (K*) | | barley | I* |
| T1-68 | HPPD inhibitor tolerance (K*) | | maizef | I* |
| T1-69 | HPPD inhibitor tolerance (K*) | | cotton | I* |
| T1-70 | HPPD inhibitor tolerance (K*) | | potato | I* |
| T1-71 | HPPD inhibitor tolerance (K*) | | rapeseed | I* |
| T1-72 | HPPD inhibitor tolerance (K*) | | rice | I* |
| T1-73 | HPPD inhibitor tolerance (K*) | | soybean | I* |
| T1-74 | HPPD inhibitor tolerance (K*) | | sutarbeet | I* |
| T1-75 | HPPD inhibitor tolerance (K*) | | sugarcane | I* |
| T1-76 | HPPD inhibitor tolerance (K*) | | tobacco | I* |
| T1-77 | HPPD inhibitor tolerance (K*) | | wheat | I* |
| T1-78 | Protox inhibitor tolerance (L*) | | cotton | M* |
| T1-79 | Protox inhibitor tolerance (L*) | | rape | M* |
| T1-80 | Protox inhibitor tolerance (L*) | | rice | M* |
| T1-81 | Protox inhibitor tolerance (L*) | | Sorghum | M* |
| T1-82 | Protox inhibitor tolerance (L*) | | soybean | M* |
| T1-83 | Protox inhibitor tolerance (L*) | | sugarbeet | M* |
| T1-84 | Protox inhibitor tolerance (L*) | | sugar cane | M* |
| T1-85 | Protox inhibitor tolerance (L*) | | wheat | M* |
| T1-86 | imidazolinone tolerance | | soybean | N* |
| | description | Event | | |
| T1-87 | Glyphosate tolerance | ASR368 | Agrostis stolonifera | available, Scotts |
| | | | (creeping bentgrass) | Seeds |
| T1-88 | Glyphosate tolerance | A5-15′ | Beta vulgaris (sugar | available, Danisco |
| | | | beet) | Seeds/DLF Trifolium |
| T1-89 | Glyphosate tolerance | GTSB77 | Beta vulgaris (sugar | available, Novartis |
| | | | beet) | Seeds; Monsanto |
| | | | | Company |
| T1-90 | Glyphosate tolerance | H7-1 | Beta vulgaris (sugar | available, Monsanto |
| | | | beet) | Company |
| T1-91 | Glyphosate tolerance | T120-7 | Beta vulgaris (sugar | available, Bayer |
| | | | beet) | CropScience (Aventis |
| | | | | CropScience(AgrEvo)) |
| T1-92 | Glyphosate tolerance | GT200 | Brassica napus | available, Monsanto |
| | | | (Argentine canola) | Company |
| T1-93 | Glyphosate tolerance | GT73, | Brassica napus | available, Monsanto |
| | | RT73 | (Argentine canola) | Company |
| T1-94 | Glyphosate tolerance | HCN10 | Brassica napus | available, Aventis |
| | | | (Argentine canola) | CropScience |
| T1-95 | Glyphosate tolerance | HCN92 | Brassica napus | available, Bayer |
| | | | (Argentine canola) | CropScience (Aventis |
| | | | | CropScience(AgrEvo)) |
| T1-96 | Glyphosate tolerance | T45 | Brassica napus | available, Bayer |
| | | (HCN28) | (Argentine canola) | CropScience (Aventis |
| | | | | CropScience(AgrEvo)) |
| T1-97 | Glyphosate tolerance | ZSR500/ | Brassica rapa (Polish | available, Monsanto |
| | | 502 | canola) | Company |
| T1-98 | Glyphosate tolerance | GTS 40- | Glycine max L. (soybean) | available, Monsanto |
| | | 3-2 | | Company |
| T1-99 | Glyphosate tolerance | MON40- | Glycine max L. | available, Monsanto |
| | | 3-2 | (soybean) | Company |
| T1-100 | Glyphosate tolerance | MON89788 | Glycine max L. | available, Monsanto |
| | | | (soybean) | Company |
| T1-101 | Glyphosate tolerance | GHB614 | Gossypium hirsutum | available, Bayer |
| | | | L. (cotton) | CropScience USA LP |
| T1-102 | Glyphosate tolerance | MON1445 | Gossypium hirsutum | available, Monsanto |
| | | | L. (cotton) | Company |
| T1-103 | Glyphosate tolerance | MON1445/ | Gossypium hirsutum | available, Monsanto |
| | | 1698 | L. (cotton) | Company |
| T1-104 | Glyphosate tolerance | MON88913 | Gossypium hirsutum | available, Monsanto |
| | | | L. (cotton) | Company |
| T1-105 | Glyphosate tolerance | MON- | Medicago sativa (alfalfa) | available, Monsanto |
| | | ØØ1Ø1- | | and Forage Genetics |
| | | 8, MON- | | International |
| | | ØØ163- | | |
| | | 7 (J101, | | |
| | | J163) | | |
| T1-106 | Glyphosate tolerance | MON71800 | Triticum aestivum | available, Monsanto |
| | | | (wheat) | Company |
| T1-107 | Glyphosate tolerance | NK603 | Zea mays L. (corn, | available, Monsanto |
| | | | maize) | Company |
| T1-108 | Glyphosate tolerance | GA21 | Zea mays L. (corn, | available, Syngenta |
| | | | maize) | Seeds, Inc. (formerly |
| T1-109 | Glyphosate tolerance | MON832 | Zea mays L. (corn, | Monsanto Company |
| | | | maize) | |
| T1-110 | Glufosinate tolerance | GS40/ | Brassica napus | available, Bayer |
| | | 90pHoe6/ | (Argentine canola) | CropScience |
| | | Ac | | |
| T1-111 | Glufosinate tolerance | Liberator | Brassica napus | available, Bayer |
| | | pHoe6/ | (Argentine canola) | CropScience |
| | | Ac | | |
| T1-112 | Glufosinate tolerance | TOPAS19/2 | Brassica napus | available, Bayer |
| | | | (Argentine canola) | CropScience |
| T1-113 | Glufosinate tolerance | T14, | Zea mays L. (corn, | Bayer CropScience |
| | | T25 | maize) | (Aventis |
| | | (ACS- | | CropScience(AgrEvo)) |
| | | ZMØØ2 | | |
| T1-114 | Glufosinate ammonium | PHY14, | Brassica napus | available, Aventis |
| | tolerance | PHY35 | (Argentine canola) | CropScience (formerly |
| | | | | Plant Genetic Systems) |
| T1-115 | Glufosinate ammonium | PHY36 | Brassica napus | available, Aventis |
| | tolerance | | (Argentine canola) | CropScience (formerly |
| | | | | Plant Genetic Systems) |
| T1-116 | Glufosinate ammonium | HCR-1 | Brassica raga (Polish | available, Bayer |
| | tolerance | | canola) | CropScience (Aventis |
| | | | | CropScience(AgrEvo)) |
| T1-117 | Glufosinate ammonium | RM3-3, | Cichorium intybus | available, Bejo Zaden |
| | tolerance | RM3-4, | (Chicory) | BV |
| | | RM3-6 | | |
| T1-118 | Glufosinate ammonium | A2704- | Glycine max L. (soybean) | available, Bayer |
| | tolerance | 12, | | CropScience (Aventis |
| | | A2704- | | CropScience(AgrEvo)) |
| | | 21, | | |
| | | A5547- | | |
| | | 35 | | |
| T1-119 | Glufosinate ammonium | A5547- | Glycine max L. (soybean) | available, Bayer |
| | tolerance | 127 | | CropScience (Aventis |
| | | | | CropScience(AgrEvo)) |
| T1-120 | Glufosinate ammonium | GU262 | Glycine max L. (soybean) | available, Bayer |
| | tolerance | | | CropScience (Aventis |
| | | | | CropScience(AgrEvo)) |
| T1-121 | Glufosinate ammonium | W62, | Glycine max L. (soybean) | available, Bayer |
| | tolerance | W98 | | CropScience (Aventis |
| | | | | CropScience(AgrEvo)) |
| T1-122 | Glufosinate ammonium | LLCotton | Gossypium hirsutum L. | available, Bayer |
| | tolerance | 25 | (cotton) | CropScience (Aventis |
| | | | | CropScience(AgrEvo)) |
| T1-123 | Glufosinate ammonium | LL RICE | Oryza sativa (rice) | available, Bayer |
| | tolerance | 62 | | CropScience |
| T1-124 | Glufosinate ammonium | LLrice06 | Oryza sativa (rice) | available, Bayer |
| | tolerance | LLrice | | CropScience |
| | | 62 | | |
| T1-125 | Glufosinate ammonium | LLrice601 | Oryza sativa (rice) | available, Bayer |
| | tolerance | | | CropScience |
| T1-126 | Glufosinate ammonium | 676, | Zea mays L. (corn, | available, Pioneer Hi- |
| | tolerance | 678, | maize) | Bred International Inc. |
| T1-127 | Glufosinate ammonium | B16 | Zea mays L. (corn, | available, Dekalb Genetics |
| | tolerance | (DLL25) | maize) | Corporation |
| T1-128 | Imidazolinone tolerance | NS738, | Brassica napus | available, Pioneer Hi- |
| | | NS1471 | (Argentine canola) | Bred International Inc. |
| T1-129 | Imidazolinone tolerance | X81359 | Helianthus annuus | available, BASF |
| | | | (sunflower) | |
| T1-130 | Imidazolinone tolerance | RH44 | Lens culinaris (lentil) | available, BASF |
| T1-131 | Imidazolinone tolerance | CFX51 | Oryza sativa (rice) | available, BASF |
| T1-132 | Imidazolinone tolerance | IMINTA- | Oryza sativa (rice) | available, BASF |
| | | 1, | | |
| | | IMINTA-4 | | |
| T1-133 | Imidazolinone tolerance | PWC16 | Oryza sativa (rice) | available, BASF |
| T1-134 | Imidazolinone tolerance | AP205CL | Triticum aestivum | available, BASF Inc. |
| | | | (wheat) | |
| T1-135 | Imidazolinone tolerance | AP602CL | Triticum aestivum | available, BASF Inc. |
| | | | (wheat) | |
| T1-136 | Imidazolinone tolerance | BW255- | Triticum aestivum | available, BASF Inc. |
| | | 2, | (wheat) | |
| T1-137 | Imidazolinone tolerance | BW7 | Triticum aestivum | available, BASF Inc. |
| | | | (wheat) | |
| T1-138 | Imidazolinone tolerance | SWP965001 | Triticum aestivum | available, Cyanamid |
| | | | (wheat) | Crop Protection |
| T1-139 | Imidazolinone tolerance | Teal | Triticum aestivum | available, BASF Inc. |
| | | 11A | (wheat) | |
| T1-140 | Imidazolinone tolerance | 3751IR | Zea mays L. (corn, | available, Pioneer Hi- |
| | | | maize) | Bred International Inc. |
| T1-141 | Imidazolinone tolerance | EXP1910IT | Zea mays L. (corn, | available, Syngenta |
| | | | maize) | Seeds, Inc. (formerly |
| T1-142 | Imidazolinone tolerance | IT | Zea mays L. (corn, | available, Pioneer Hi- |
| | | | maize) | Bred International Inc. |
| T1-143 | sulfonyl urea tolerance | 19-51A | Gossypium hirsutum | available, DuPont |
| | | | L. (cotton) | Canada Agricultural |
| T1-144 | sulfonyl urea tolerance | CDC- | University of Saskatchewan, | available, Linum usitatissimum |
| | | FL001-2 | Crop Dev. | L. (flax, |
| | | (FP967) | Centre | linseed) |
| T1-145 | Bromoxynil and | OXY- | Brassica napus | available, Aventis |
| | loxynil tolerance | 235 | (Argentine canola) | CropScience (formerly |
| | | | | Rhône Poulenc |
| | | | | Inc.) |
| T1-146 | Bromoxynil and | BXN | Gossypium hirsutum | available, Calgene |
| | loxynil tolerance | | L. (cotton) | Inc. |
| T1-147 | Bromoxynil and | C/F/93/08- | Nicotiana tabacum L. | available, Societe |
| | loxynil tolerance | 02 | (tobacco) | National d'Exploitationdes |
| | | | | Tabacs et Allumettes |
| T1-148 | Cyclohexanone | DK404SR | Zea mays L. (corn, | available, BASF Inc. |
| | | | maize) | |

A* refers to U.S. Pat. No. 4,761,373, U.S. Pat. No. 5,304,732, U.S. Pat. No. 5,331,107, U.S. Pat. No. 5,718,079, U.S. Pat. No. 6,211,438, U.S. Pat. No. 6,211,439 and U.S. Pat. No. 6,222,100.
B* refers to Tan et. al, Pest Manag. Sci 61, 246-257 (2005).
C* refers to imidazolinone-herbicide resistant rice plants with specific mutation of the acetohydroxyacid synthase gene: S653N (see e.g. US 2003/0217381), S654K (see e.g. US 2003/0217381), A122T (see e.g. WO 2004/106529) S653(At)N, S654(At)K, A122(At)T and other resistant rice plants as described in WO 2000/27182, WO 2005/20673 and WO 2001/85970 or US patents U.S. Pat. No. 5,545,822, U.S. Pat. No. 5,736,629, U.S. Pat. No. 5,773,703, U.S. Pat. No. 5,773,704, U.S. Pat. No. 5,952,553, U.S. Pat. No. 6,274,796, wherein plants with mutation S653A and A122T are most preferred.
D* refers to WO 2004/106529, WO 2004/16073, WO 2003/14357, WO 2003/13225 and WO 2003/14356.
E* refers to U.S. Pat. No. 5,188,642, U.S. Pat. No. 4,940,835, U.S. Pat. No. 5,633,435, U.S. Pat. No. 5,804,425 and U.S. Pat. No. 5,627,061.
F* refers to U.S. Pat. No. 5,646,024 and U.S. Pat. No. 5,561,236.
G* refers to U.S. Pat. No. 6,333,449, U.S. Pat. No. 6,933,111 and U.S. Pat. No. 6,468,747.
H* refers to U.S. Pat. No. 6,153,401, U.S. Pat. No. 6,100,446, WO 2005/107437, U.S. Pat. No. 5,670,454 and U.S. Pat. No. 5,608,147.
I* refers to WO 2004/055191, WO 199638567 and U.S. Pat. No. 6,791,014.
K* refers to HPPD inhibitor herbicides, such as isoxazoles (e.g. isoxaflutole), diketonitriles, trikeones (e.g. sulcotrione and mesotrione), pyrazolinates.
L* refers to protoporphyrinogen oxidase (PPO) inhibiting herbicides.
M* refers to US 2002/0073443, US 20080052798, Pest Management Science, 61, 2005, 277-285.
N* refers to the herbicide tolerant soybean plants presented under the name of Cultivance on the XVI Congresso Brasileiro de Sementes, 31st Augusta to 3^{rd} September 2009 at Estacão Embratel Convention Center - Curitiba/PR, Brazil
U* “InVigor” (Bayer)
V* “Roundup Ready Canola” (Monsanto)
W* “Roundup Ready Corn”, “Roundup Ready 2” (Monsanto), “Agrisure GT“, “Agrisure GT/CB/LL”, “Agrisure GT/RW”, “Agrisure 3000GT” (Syngenta), “YieldGard VT Rootworm/RR2”, “YieldGard VT Triple” (Monsanto)
X* “Roundup Ready Cotton”, “Roundup Ready Flex” (Monsanto)
Y* “Roundup Ready Soybean” (Monsanto), “Optimum GAT” (DuPont, Pioneer)
Z* “Liberty Link” (Bayer), “Herculex I”, “Herculex RW”, “Herculex Xtra”(Dow, Pioneer), “Agrisure GT/CB/LL”, “Agrisure CB/LL/RW” (Syngenta),

A subset of especially preferred herbicide tolerant plants is given in table 2. In this subset, there are further preferred embodiments: In a more preferred embodiment, the present invention relates to a method of controlling harmful insects and/or increasing the health of cultivated plants by treating plant propagation materials, preferably seeds with compounds of formula I and their mixtures compounds of formula I or their mixtures selected from endosulfan, ethiprole and fipronil, wherein the plant corresponds to row of table 2.

In another more preferred embodiment, the present invention relates to a method of controlling harmful insects and/or increasing the health of cultivated plants by treating cultivated plants, parts of such plants or at their locus of growth with compounds of formula I and their mixtures, wherein the plant corresponds to row of table 2.

In a most preferred embodiment, the present invention relates to a method of controlling harmful insects and/or increasing the health of plants by treating cultivated plants, parts of such plants or at their locus of growth with compounds of formula I and their mixtures, wherein the plant corresponds to a row of table 2.

In a most preferred embodiment, the present invention relates to a method of controlling harmful insects and/or increasing the health of plants by treating plant propagation materials, preferably seeds of cultivated plants of cultivated crops with compounds of formula I and their mixtures, wherein the plant corresponds to a row of table 2.

In a utmost preferred embodiment, the present invention relates to a method of controlling harmful insects and/or increasing the health of plants by treating cultivated plants, parts of such plants or at their locus of growth with compounds of formula I and their mixtures, wherein the plant is selected from T2-3, T2-8, T2-9, T2-10, T2-11, T2-13, T2-15, T2-16, T2-17, T2-18, T2-19 and T2-23.

In a utmost preferred embodiment, the present invention relates to a method of controlling harmful insects and/or increasing the health of plants by treating plant propagation materials, preferably seeds of cultivated plants of cultivated crops with compounds of formula I and their mixtures, wherein the plant is selected from T2-3, T2-8, T2-9, T2-10, T2-11, T2-13, T2-15, T2-16, T2-17, T2-18, T2-19 and T2-23.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 2, wherein the compound of formula I is compound I-11.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 2, wherein the compound of formula I is compound I-16.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 2, wherein the compound of formula I is compound I-26.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 2, wherein the compound of formula I is compound I-31.

TABLE 2

| No | detailed description | plant | Literature/commercial plants |
|---|---|---|---|
| T2-1 | imidazolinone tolerance | canola | B* |
| T2-2 | imidazolinone tolerance | maize | A*, B* |
| T2-3 | imidazolinone tolerance | rice | C* |
| T2-4 | imidazolinone tolerance | sunflowers | B* |
| T2-5 | imidazolinone tolerance | wheat | D* |
| T2-6 | glyphosate tolerance | alfalfa | E*; “Roundup Ready Alfalfa” |
| T2-7 | glyphosate tolerance | canola | E*; U* |
| T2-8 | glyphosate tolerance | maize | E*; V* |
| T2-9 | glyphosate tolerance | cotton | E*; W* |
| T2-10 | glyphosate tolerance | rice | E*; “Roundup Ready Rice” |
| | | | (Monsanto) |
| T2-11 | glyphosate tolerance | soybean | E*; X* |
| T2-12 | glyphosate tolerance | sugar beet | E* |
| T2-13 | glufosinate tolerance | canola | F*; “InVigor” (Bayer) |
| T2-14 | glufosinate tolerance | maize | F*; Y* |
| T2-15 | glufosinate tolerance | cotton | F*; “FiberMax Liberty Link” (Bayer), |
| T2-16 | glufosinate tolerance | rice | F*, G*; “Liberty Link Rice” (Bayer), |
| T2-17 | glufosinate tolerance | soybean | I* |
| T2-18 | dicamba tolerance | cotton | U.S. Pat. No. 7,105,724 |
| T2-19 | dicamba tolerance | soybean | U.S. Pat. No. 7,105,724 |
| T2-20 | bromoxynil tolerance | canola | Z* |
| T2-21 | bromoxynil tolerance | cotton | “BXN” (Calgene) |
| T2-22 | 2,4-D tolerance | maize | H* |
| T2-23 | imidazolinone tolerance | soybean | N* |

A* refers to U.S. Pat. No. 4,761,373, U.S. Pat. No. 5,304,732, U.S. Pat. No. 5,331,107, U.S. Pat. No. 5,718,079, U.S. Pat. No. 6,211,438, U.S. Pat. No. 6,211,439 and U.S. Pat. No. 6,222,100.
B* refers to Tan et. al, Pest Manag. Sci 61, 246-257 (2005).
C* refers to imidazolinone-herbicide resistant rice plants with specific mutation of the acetohydroxyacid synthase gene: S653N (see e.g. US 2003/0217381), S654K (see e.g. US 2003/0217381), A122T (see e.g. WO 04/106529) S653(At)N, S654(At)K, A122(At)T and other resistant rice plants as described in WO 2000/27182, WO 2005/20673 and WO 2001/85970 or US patents U.S. Pat. No. 5,545,822, U.S. Pat. No. 5,736,629, U.S. Pat. No. 5,773,703, U.S. Pat. No. 5,773,704, U.S. Pat. No. 5,952,553, U.S. Pat. No. 6,274,796 wherein plants with mutation S653A and A122T are most preferred.
D* refers to WO 04/106529, WO 04/16073, WO 03/14357, WO 03/13225 and WO 03/14356.
E* refers to U.S. Pat. No. 5,188,642, U.S. Pat. No. 4,940,835, U.S. Pat. No. 5,633,435, U.S. Pat. No. 5,804,425 and U.S. Pat. No. 5,627,061.
F* refers to U.S. Pat. No. 5,646,024 and U.S. Pat. No. 5,561,236.
G* refers to U.S. Pat. No. 6,333,449, U.S. Pat. No. 6,933,111 and U.S. Pat. No. 6,468,747.
H* refers to U.S. Pat. No. 6,153,401, U.S. Pat. No. 6,100,446, WO 2005/107437 and U.S. Pat. No. 5,608,147.
I* refers to Federal Register (USA), Vol. 61, No. 160, 1996, page 42581. Federal Register (USA), Vol. 63, No. 204, 1998, page 56603.
N* refers to the herbicide tolerant soybean plants presented under the name of Cultivance on the XVI Congresso Brasileiro de Sementes, 31st Augusta to 3^{rd} September 2009 at Estacão Embratel Convention Center - Curitiba/PR, Brazil
U* “Roundup Ready Canola” (Monsanto)
V* “Roundup Ready Corn”, “Roundup Ready 2” (Monsanto), “Agrisure GT”, “Agrisure GT/CB/LL”, “Agrisure GT/RW”, “Agrisure 3000GT” (Syngenta), “YieldGard VT Rootworm/RR2”, “YieldGard VT Triple” (Monsanto)
W* “Roundup Ready Cotton”, “Roundup Ready Flex” (Monsanto) x*“Roundup Ready Soybean” (Monsanto), “Optimum GAT” (DuPont, Pioneer)?
Y* “Liberty Link” (Bayer), “Herculex I”, “Herculex RW”, “Herculex Xtra”(Dow, Pioneer), “Agrisure GT/CB/LL”, “Agrisure CB/LL/RW” (Syngenta)
Z* “Navigator”, “Compass” (Rhone-Poulenc)

In a further one preferred embodiment, the present invention relates to a method of controlling harmful insects and/or increasing the health of cultivated plants by treating cultivated plants, parts of such plants, plant propagation materials, or at their locus of growth with compounds of formula I and their mixtures compounds of formula I or their mixtures selected from endosulfan, ethiprole and fipronil, wherein the plant is a plant, which express at least one insecticidal toxin, preferably a toxin from Bacillus species, more preferably from Bacillus thuringiensis.

In a more preferred embodiment, the present invention relates to a method of controlling harmful insects and/or increasing the health of cultivated plants by treating plant propagation materials, preferably seeds with compounds of formula I or their mixtures as defined above, preferably wherein the plant corresponds to a row of table 3.

In another more preferred embodiment, the present invention relates to a method of controlling harmful insects and/or increasing the health of cultivated plants by treating cultivated plants, parts of such plants or at their locus of growth with compounds of formula I and their mixtures compounds of formula I or their mixtures wherein the plant corresponds to a row of table 3.

In a most preferred embodiment, the present invention relates to a method of controlling harmful insects and/or increasing the health of plants by treating cultivated plants, parts of such plants or at their locus of growth with compounds of formula I and their mixtures, wherein the plant corresponds to a row of table 3.

In a most preferred embodiment, the present invention relates to a method of controlling harmful insects and/or increasing the health of plants by treating plant propagation materials, preferably seeds of cultivated plants of cultivated crops with compounds of formula I and their mixtures, wherein the plant corresponds to a row of table 3.

In another more preferred embodiment, the present invention relates to a method of controlling harmful insects and/or increasing the health of cultivated plants by treating cultivated plants, parts of such plants or their locus of growth with a compound of formula I, which is selected from the compounds I-1 to I-40 as defined in Table C, wherein the plant corresponds to a row of table A2. In this embodiment the compound of formula I is more specifically selected from compounds I-11, I-16, I-21, I-26, I-31 which are defined in accordance with Table C of the example section.

In a most preferred embodiment, the present invention relates to a method of controlling harmful insects and/or increasing the health of plants by treating cultivated plants, parts of such plants or their locus of growth with compounds of formula I, wherein the plant corresponds to a row of table A2, wherein the compound of formula I is compound I-11.

In a most preferred embodiment, the present invention relates to a method of controlling harmful insects and/or increasing the health of plants by treating cultivated plants, parts of such plants or their locus of growth with compounds of formula I, wherein the plant corresponds to a row of table A2, wherein the compound of formula I is compound I-16.

In a most preferred embodiment, the present invention relates to a method of controlling harmful insects and/or increasing the health of plants by treating cultivated plants, parts of such plants or their locus of growth with compounds of formula I, wherein the plant corresponds to a row of table A2, wherein the compound of formula I is compound I-26.

In a most preferred embodiment, the present invention relates to a method of controlling harmful insects and/or increasing the health of plants by treating cultivated plants, parts of such plants or their locus of growth with compounds of formula I, wherein the plant corresponds to a row of table A2, wherein the compound of formula I is compound I-31.

In a utmost preferred embodiment, the present invention relates to a method of controlling harmful insects and/or increasing the health of plants by treating cultivated plants, parts of such plants or at their locus of growth with compounds of formula I and their mixtures, wherein the plant is selected from T3-1, T3-2, T3-5, T3-6, T3-7, T3-8, T3-9, T3-10, T3-11, T3-12, T3-13, T3-14, T3-15, T3-16, T3-17, T3-18, T3-19, T3-20, T3-23 and T3-25.

In a utmost preferred embodiment, the present invention relates to a method of controlling harmful insects and/or increasing the health of plants by treating plant propagation materials, preferably seeds of cultivated plants of cultivated crops with compounds of formula I and their mixtures, wherein the plant is selected from T3-1, T3-2, T3-5, T3-6, T3-7, T3-8, T3-9, T3-10, T3-11, T3-12, T3-13, T3-14, T3-15, T3-16, T3-17, T3-18, T3-19, T3-20, T3-23 and T3-25.

TABLE A2

| | | transgenic | | literature/commercial |
|---|---|---|---|---|
| No | description | event | plant | plants |
| | Lepidoptera resistance | 281-24-236 | Gossypium hirsutum | available, DOW Agro- |
| | | (DAS- | L. (cotton) | Sciences LLC |
| | | 24236-5) | | |
| | Lepidoptera resistance | 281-24-236 × | Gossypium hirsutum | available, Dow Agro- |
| | | 3006-210- | L. (cotton) | Sciences |
| | | 23 | | |
| | Lepidoptera resistance | 3006-210- | Gossypium hirsutum | available, DOW Agro- |
| | | 23 (DAS- | L. (cotton) | Sciences LLC |
| | Lepidoptera resistance | COT102 | Gossypium hirsutum | available, Syngenta |
| | | (SYN- | L. (cotton) | Seeds, Inc. |
| | Lepidoptera resistance | DAS- | Gossypium hirsutum | available, DOW Agro- |
| | | 21Ø23-5 × | L. (cotton) | Sciences LLC |
| | | DAS-24236- | | |
| | Lepidoptera resistance | Event-1 | Gossypium hirsutum | available, JK Agri Genetics |
| | | | L. (cotton) | Ltd (India) |
| | Lepidoptera resistance | MON531/757/ | Gossypium hirsutum | available, Monsanto |
| | | 1076 | L. (cotton) | Company |
| | Lepidoptera resistance | 15985 | Gossypium hirsutum | available, Monsanto |
| | | (MON- | L. (cotton) | Company |
| | | 15985-7) | | |
| | Lepidoptera resistance | 5345 | Lycopersicon | available, Monsanto |
| | | | esculentum | Company |
| | | | (tomato) | |
| | Lepidoptera resistance | MIR162 | Zea mays L. | available, Syngenta |
| | | | (corn, maize) | Seeds, Inc. |
| | Lepidoptera resistance | MON89034 | Zea mays L. | available, Monsanto |
| | | | (corn, maize) | Company |
| | Corn Rootworm | MIR604 | Zea mays L. | available, Syngenta |
| | resistance | | (corn, maize) | Seeds, Inc. |
| | Corn Rootworm | MON863 | Zea mays L. | available, Monsanto |
| | resistance | | (corn, maize) | Company |
| | European Corn | 176 | Zea mays L. | available, Syngenta |
| | Borer resistance | | (corn, maize) | Seeds, Inc. |
| | European Corn | MON80100 | Zea mays L. | available, Monsanto |
| | Borer resistance | | (corn, maize) | Company |
| | European Corn | MON810 | Zea mays L. | available, Monsanto |
| | Borer resistance | | (corn, maize) | Company |
| | Colorado potato | ATBT04-6, | Solanum tuberosum | available, Monsanto |
| | beetle resistance | ATBT04-27, | L. (potato) | Company |
| | | ATBT04-30, | | |
| | | ATBT04-31, | | |
| | | ATBT04-36, | | |
| | | SPBT02-5, | | |
| | | SPBT02-7 | | |
| | Colorado potato | BT6, BT10, | Solanum tuberosum | available, Monsanto |
| | beetle resistance | BT12, | L. (potato) | Company |
| | | BT16, | | |
| | | BT17, | | |
| | | BT18, BT23 | | |
| | Colorado potato | RBMT15- | Solanum tuberosum | available, Monsanto |
| | beetle resistance | 101, | L. (potato) | Company |
| | | SEMT15- | | |
| | | 02, | | |
| | | SEMT15-15 | | |
| | Colorado potato | RBMT21- | Solanum tuberosum | available, Monsanto |
| | beetle resistance | 129, | L. (potato) | Company |
| | | RBMT21- | | |
| | | 350, | | |
| | | RBMT22- | | |
| | | 082 | | |
| | resistance to lepidopteran | COT67B | Gossypium hirsutum | available, Syngenta |
| | pests | | L. (Cotton) | Seeds |

In another more preferred embodiment, the present invention relates to a method of controlling harmful insects and/or increasing the health of cultivated plants by treating cultivated plants, parts of such plants or their locus of growth with a compound of formula I, which is selected from the compounds I-1 to I-40 as defined in Table C, wherein the plant corresponds to a row of table 3. In this embodiment the compound of formula I is more specifically selected from compounds I-11, I-16, I-21, I-26, I-31 which are defined in accordance with Table C of the example section.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 3, wherein the compound of formula I is compound I-11.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 3, wherein the compound of formula I is compound I-16.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 3, wherein the compound of formula I is compound I-26.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 3, wherein the compound of formula I is compound I-31.

TABLE 3

| | | | | Literature/commercial |
|---|---|---|---|---|
| No | detailed description [Event] | | plant | plants |
| T3-1 | corn rootworm resistance | | maize | B* |
| T3-2 | corn borer resistance | | maize | C* |
| T3-3 | western bean cutworm resistance | | maize | D* |
| T3-4 | black cutworm resistance | | maize | E* |
| T3-5 | fall armyworm resistance | | maize | “Herculex I” (Dow, |
| | | | | Pioneer), “Herculex |
| | | | | Xtra” (Dow, Pioneer) |
| T3-6 | tobacco budworm resistance | | cotton | “Bollgard I” (Monsanto), |
| | | | | E* |
| T3-7 | cotton bollworm resistance | | cotton | E* |
| T3-8 | fall armyworm resistance | | cotton | E* |
| T3-9 | beet armyworm resistance | | cotton | E* |
| T3-10 | cabbage looper resistance | | cotton | E* |
| T3-11 | soybean lopper resistance | | cotton | E* |
| T3-12 | pink bollworm resistance | | cotton | E* |
| T3-13 | rice stemborer resistance | | rice | A* |
| T3-14 | striped rice borer resistance | | rice | A* |
| T3-15 | rice leaf roller resistance | | rice | A* |
| T3-16 | yellow stemborer resistance | | rice | A* |
| T3-17 | rice skipper resistance | | rice | A* |
| T3-18 | rice caseworm resistance | | rice | A* |
| T3-19 | rice cutworm resistance | | rice | A* |
| T3-20 | rice armyworm resistance | | rice | A* |
| T3-21 | brinjal fruit and shoot borer resistance | | eggplant | F* |
| T3-22 | cotton bollworm resistance | | eggplant | F*″ |
| T3-23 | tobacco hornworm resistance | | potato | D* |
| T3-24 | lepidopteran resistance | | lettuce | U.S. Pat. No. 5,349,124 |
| T3-25 | lepidopteran resistance | | soybean | U.S. Pat. No. 7,432,421 |
| T3-26 | detailed description | Event | | |
| T3-27 | ILepidoptera | 281-24-236 (DAS- | Gossypium hirsutum | available, DOW |
| | resistance | 24236-5) | L. (cotton) | AgroSciences LLC |
| T3-28 | ILepidoptera | 281-24-236 × | Gossypium hirsutum | available, Dow Agro- |
| | resistance | 3006-210-23 | L. (cotton) | Sciences |
| T3-29 | ILepidoptera | 3006-210-23 | Gossypium hirsutum | available, DOW |
| | resistance | (DAS-21Ø23-5) | L. (cotton) | AgroSciences LLC |
| T3-30 | ILepidoptera | COT102 (SYN- | Gossypium hirsutum | available, Syngenta |
| | resistance | IR1Ø2-7) | L. (cotton) | Seeds, Inc. |
| T3-31 | ILepidoptera | DAS-21Ø23-5 × | Gossypium hirsutum | available, DOW |
| | resistance | DAS-24236-5 | L. (cotton) | AgroSciences LLC |
| T3-32 | ILepidoptera | Event-1 | Gossypium hirsutum | available, JK Agri |
| | resistance | | L. (cotton) | Genetics Ltd (India) |
| T3-33 | ILepidoptera | MON531/757/1076 | Gossypium hirsutum | available, Monsanto |
| | resistance | | L. (cotton) | Company |
| T3-34 | ILepidoptera | 15985 (MON- | Gossypium hirsutum | available, Monsanto |
| | resistance | 15985-7) | L. (cotton) | Company |
| T3-35 | ILepidoptera | 5345 | Lycopersicon | available, Monsanto |
| | resistance | | esculentum | Company |
| | | | (tomato) | |
| T3-36 | ILepidoptera | MIR162 | Zea mays L. | available, Syngenta |
| | resistance | | (corn, maize) | Seeds, Inc. |
| T3-37 | ILepidoptera | MON89034 | Zea mays L. | available, Monsanto |
| | resistance | | (corn, maize) | Company |
| T3-38 | Corn Root- | MIR604 | Zea mays L. | available, Syngenta |
| | worm resis- | | (corn, maize) | Seeds, Inc. |
| T3-39 | Corn Root- | MON863 | Zea mays L. | available, Monsanto |
| | worm resis- | | (corn, maize) | Company |
| T3-40 | European | 176 | Zea mays L. | available, Syngenta |
| | Corn Borer | | (corn, maize) | Seeds, Inc. |
| T3-41 | European | MON80100 | Zea mays L. | available, Monsanto |
| | Corn Borer | | (corn, maize) | Company |
| T3-42 | European | MON810 | Zea mays L. | available, Monsanto |
| | Corn Borer | | (corn, maize) | Company |
| T3-43 | Colorado potato | ATBT04-6, | Solanum tuberosum | available, Monsanto |
| | beetle | ATBT04-27, | L. (potato) | Company |
| | resistance | ATBT04-30, | | |
| | | ATBT04-31, | | |
| | | ATBT04-36, | | |
| | | SPBT02-5, | | |
| | | SPBT02-7 | | |
| T3-44 | Colorado potato | BT6, BT10, BT12, | Solanum tuberosum | available, Monsanto |
| | beetle | BT16, BT17, | L. (potato) | Company |
| | resistance | BT18, BT23 | | |
| T3-45 | Colorado potato | RBMT15-101, | Solanum tuberosum | available, Monsanto |
| | beetle | SEMT15-02, | L. (potato) | Company |
| | resistance | SEMT15-15 | | |
| T3-46 | Colorado potato | RBMT21-129, | Solanum tuberosum | available, Monsanto |
| | beetle | RBMT21-350, | L. (potato) | Company |
| | resistance | RBMT22-082 | | |
| T3-47 | resistance to | COT67B | Gossypium hirsutum | available, Syngenta |
| | lepidopteran | | L. (Cotton) | Seeds |
| | pests | | | |

A* refers to “Zhuxian B”, WO2001021821, Molecular Breeding, Volume 18, Number 1/August 2006.
B* “YieldGard corn rootworm” (Monsanto), “YieldGard Plus” (Monsanto), “YieldGard VT” (Monsanto), “Herculex RW” (Dow, Pioneer), “Herculex Rootworm” (Dow, Pioneer), “Agrisure 0CRW” (Syngenta)
C* “YieldGard corn borer” (Monsanto), “YieldGard Plus” (Monsanto), “YieldGard VT Pro” (Monsanto), “Agrisure CB/LL” (Syngenta), “Agrisure 3000GT” (Syngenta), “Hercules I”, “Hercules II” (Dow, Pioneer), “KnockOut” (Novartis), “NatureGard” (Mycogen), “StarLink” (Aventis)
D* “NewLeaf” (Monsanto), “NewLeaf Y” (Monsanto), “NewLeaf Plus” (Monsanto), U.S. Pat. No. 6,100,456
E* “Bollgard II” (Monsanto), “WideStrike” (Dow), “VipCot” (Syngenta)
F* U.S. Pat. No. 5,128,130, “Bt brinjal”, “Dumaguete Long Purple”, “Mara”

In a further one preferred embodiment, the present invention relates to a method of controlling harmful insects and/or increasing the health of cultivated plants by treating cultivated plants, parts of such plants, plant propagation materials, or at their locus of growth with compounds of formula I and their mixtures, preferably selected from the compounds I-1 to I-40 as defined in Table C; more specifically, selected from compounds I-11, I-16, I-21, I-26, I-31 which are defined in accordance with Table C of the example section, more specifically compound I-11, more specifically compound I-16, more specifically compound I-21, more specifically compound I-26, more specifically compound I-31., wherein the plant is a plant, which shows increased resistance against fungal, viral and bacterial diseases, more preferably a plant, which expresses antipathogenic substances, such as antifungal proteins, or which has systemic acquired resistance properties.

In a more preferred embodiment, the present invention relates to a method of controlling harmful insects and/or increasing the health of cultivated plants by treating plant propagation materials, preferably seeds with compounds of formula I or their mixtures selected from endosulfan, ethiprole and fipronil, wherein the plant corresponds to row of table 4.

In another more preferred embodiment, the present invention relates to a method of controlling harmful insects and/or increasing the health of cultivated plants by treating cultivated plants, parts of such plants or at their locus of growth with compounds of formula I or their mixtures selected from endosulfan, ethiprole and fipronil, wherein the plant corresponds to row of table 4.

In a most preferred embodiment, the present invention relates to a method of controlling harmful insects and/or increasing the health of plants by treating cultivated plants, parts of such plants or at their locus of growth with compounds of formula I or their mixtures, wherein the plant corresponds to a row of table 4 and the compounds of formula I or their mixtures is endosulfan. In another most preferred embodiment, the present invention relates to a method of controlling harmful insects and/or increasing the health of plants by treating cultivated plants, parts of such plants or at their locus of growth with compounds of formula I or their mixtures, wherein the plant corresponds to a row of table 4 and the mixture with the compound of formula I ethiprole.

In another most preferred embodiment, the present invention relates to a method of controlling harmful insects and/or increasing the health of plants by treating cultivated plants, parts of such plants or at their locus of growth with compounds of formula I or their mixtures, wherein the plant corresponds to a row of table 4 and the compounds of formula I or their mixtures is fipronil.

In a most preferred embodiment, the present invention relates to a method of controlling harmful insects and/or increasing the health of plants by treating plant propagation materials, preferably seeds of cultivated plants of cultivated crops with compounds of formula I or their mixtures, wherein the plant corresponds to a row of table 4 and the mixing partner of the compound of formula lis endosulfan.

In another most preferred embodiment, the present invention relates to a method of controlling harmful insects and/or increasing the health of plants by treating plant propagation materials, preferably seeds of cultivated plants of cultivated crops with compounds of formula I or their mixtures, wherein the plant corresponds to a row of table 4 and the mixing partner of the compound of formula lis ethiprole.

In another most preferred embodiment, the present invention relates to a method of controlling harmful insects and/or increasing the health of plants by treating plant propagation materials, preferably seeds of cultivated plants of cultivated crops with compounds of formula I or their mixtures, wherein the plant corresponds to a row of table 4 and the mixing partner of the compound of formula lis fipronil.

In another more preferred embodiment, the present invention relates to a method of controlling harmful insects and/or increasing the health of cultivated plants by treating cultivated plants, parts of such plants or their locus of growth with a compound of formula I, which is selected from the compounds I-1 to I-40 as defined in Table C, wherein the plant corresponds to a row of table 4. In this embodiment the compound of formula I is more specifically selected from compounds I-11, I-16, I-21, I-26, I-31 which are defined in accordance with Table C of the example section.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 4, wherein the compound of formula I is compound I-11.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 4, wherein the compound of formula I is compound I-16.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 4, wherein the compound of formula I is compound I-26.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 4, wherein the compound of formula I is compound I-31.

TABLE 4

| No | detailed description | plant | Literature |
|---|---|---|---|
| T4-1. | fungal resistance | apple | A*, B*, C* |
| T4-2. | fungal resistance | barley | A*, B*, C* |
| T4-3. | fungal resistance | banana | A*, B*, C* |
| T4-4. | fungal resistance | bean | B*, C* |
| T4-5. | fungal resistance | maize | A*, B*, C* |
| T4-6. | fungal resistance | cotton | A*, C* |
| T4-7. | fungal resistance | cucumber | B*, C* |
| T4-8. | fungal resistance | grape | C* |
| T4-9. | fungal resistance | oat | A*, C* |
| T4-10. | fungal resistance | pepper | B*, C* |
| T4-11. | fungal resistance | potato | A*, B*, C* |
| T4-12. | fungal resistance | rape | B*, C* |
| T4-13. | fungal resistance | rice | A*, B*, C* |
| T4-14. | fungal resistance | rye | A*, B*, C* |
| T4-15. | fungal resistance | Sorghum | B*, C* |
| T4-16. | fungal resistance | soybean | A*, B*, C* |
| T4-17. | fungal resistance | sugarcane | B*, C* |
| T4-18. | fungal resistance | tobacco | A*, B*, C* |
| T4-19. | fungal resistance | tomato | A*, B*, C* |
| T4-20. | fungal resistance | wheat | A*, B*, C* |
| T4-21. | bacterial resistance | apple | D* |
| T4-22. | bacterial resistance | barley | D* |
| T4-23. | bacterial resistance | banana | D* |
| T4-24. | bacterial resistance | bean | D* |
| T4-25. | bacterial resistance | maize | |
| T4-26. | bacterial resistance | cotton | D* |
| T4-27. | bacterial resistance | cucumber | D* |
| T4-28. | bacterial resistance | grape | D*, U.S. Pat. No. 6,172,280 |
| T4-29. | bacterial resistance | oat | D* |
| T4-30. | bacterial resistance | pepper | D* |
| T4-31. | bacterial resistance | potato | D* |
| T4-32. | bacterial resistance | rape | D* |
| T4-33. | bacterial resistance | rice | D* |
| T4-34. | bacterial resistance | rye | D* |
| T4-35. | bacterial resistance | sorghum | D* |
| T4-36. | bacterial resistance | soybean | D* |
| T4-37. | bacterial resistance | sugarcane | D* |
| T4-38. | bacterial resistance | tobacco | D* |
| T4-39. | bacterial resistance | tomato | D* |
| T4-40. | bacterial resistance | wheat | D* |
| T4-41. | viral resistance | apple | C* |
| T4-42. | viral resistance | barley | C* |
| T4-43. | viral resistance | banana | C* |
| T4-44. | viral resistance | bean | C* |
| T4-45. | viral resistance | maize | C* |
| T4-46. | viral resistance | cotton | C* |
| T4-47. | viral resistance | cucumber | C* |
| T4-48. | viral resistance | oat | C* |
| T4-49. | viral resistance | pepper | C* |
| T4-50. | viral resistance | potato | C* |
| T4-51. | viral resistance | rape | C* |
| T4-52. | viral resistance | rice | C* |
| T4-53. | viral resistance | rye | C* |
| T4-54. | viral resistance | sorghum | C* |
| T4-55. | viral resistance | soybean | C* |
| T4-56. | viral resistance | sugarcane | C* |
| T4-57. | viral resistance | tobacco | C* |
| T4-58. | viral resistance | tomato | C* |
| T4-59. | viral resistance | wheat | C* |
| T4-60. | fungal resistance | potato | E* |
| T4-61. | viral resistance (PRSV) [55- | Carica | available, Cornell University |
| | 1/63-1] | papaya | |
| | | (papaya) | |
| T4-62. | viral resistance (PRSV) [X17-2] | Carica | available, University of |
| | | papaya | Florida |
| T4-63. | viral resistance (CMV, ZYMV | Cucurbita | available, Asgrow (USA); |
| | and WMV resistance), [CZW-3] | pepo | Seminis Vegetable Inc. |
| | | (squash) | (Canada) |
| T4-64. | viral resistance (ZYMV and | Cucurbita | available, Upjohn (USA); |
| | WMV resistance), [ZW20] | pepo | Seminis Vegetable Inc. |
| | | | (Canada) |
| T4-65. | plum pox virus resistance[C5] | Prunus | available, United States |
| | | domestica | Department of Agriculture - |
| | | (plum tree) | Agricultural Research |
| | | | Service |

A* refers to U.S. Pat. No. 5,689,046 and U.S. Pat. No. 6,020,129.
B* refers to U.S. Pat. No. 6,706,952 and EP 1018553.
C* refers to U.S. Pat. No. 6,630,618.
D* refers to WO 1995/005731 and U.S. Pat. No. 5,648,599.
E* refers to the potato plant variety submitted for variety registration with the Community Plant Variety Office (CPVO), 3, boulevard Maréchal Foch, BP 10121, FR-49101 Angers Cedex 02, France and having the CPVO file number 20082800
Abbreviations used: cucumber mosaiv virus = CMV, zucchini yellow mosaic virus = ZYMV watermelon mosaic virus = WMV) resistance, papaya ringspot virus = PRSV

In another more preferred embodiment, the present invention relates to a method of controlling harmful insects and/or increasing the health of cultivated plants by treating cultivated plants, parts of such plants or their locus of growth with a compound of formula I, which is selected from the compounds I-1 to I-40 as defined in Table C, wherein the plant corresponds to a row of table 5. In this embodiment the compound of formula I is more specifically selected from compounds I-11, I-16, I-21, I-26, I-31 which are defined in accordance with Table C of the example section.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 5, wherein the compound of formula I is compound I-11.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 5, wherein the compound of formula I is compound I-16.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 5, wherein the compound of formula I is compound I-26.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 5, wherein the compound of formula I is compound I-31.

In a more preferred embodiment, the present invention relates to a method of controlling harmful insects and/or increasing the health of cultivated plants by treating cultivated plants, parts of such plants, plant propagation materials, or at their locus of growth with compounds of formula I or their mixtures selected from endosulfan, ethiprole and fipronil, wherein the plant is a plant, which is listed in table 5.

In a more preferred embodiment, the present invention relates to a method of controlling harmful insects and/or increasing the health of cultivated plants by treating plant propagation materials, preferably seeds with compounds of formula I or their mixtures selected from endosulfan, ethiprole and fipronil, wherein the plant corresponds to a row of table 5.

In another more preferred embodiment, the present invention relates to a method of controlling harmful insects and/or increasing the health of cultivated plants by treating cultivated plants, parts of such plants or at their locus of growth with compounds of formula I or their mixtures selected from endosulfan, ethiprole and fipronil, wherein the plant corresponds to a row of table 5.

In a most preferred embodiment, the present invention relates to a method of controlling harmful insects and/or increasing the health of plants by treating cultivated plants, parts of such plants or at their locus of growth with compounds of formula I or their mixtures, wherein the plant corresponds to a row of table 5 and the mixing partner of the compound of formula lis endosulfan. In another most preferred embodiment, the present invention relates to a method of controlling harmful insects and/or increasing the health of plants by treating cultivated plants, parts of such plants or at their locus of growth with compounds of formula I or their mixtures, wherein the plant corresponds to a row of table 5 and the mixing partner of the compound of formula lis ethiprole.

In another most preferred embodiment, the present invention relates to a method of controlling harmful insects and/or increasing the health of plants by treating cultivated plants, parts of such plants or at their locus of growth with compounds of formula I or their mixtures, wherein the plant corresponds to a row of table 5 and the mixing partner of the compound of formula lis fipronil.

In a most preferred embodiment, the present invention relates to a method of controlling harmful insects and/or increasing the health of plants by treating plant propagation materials, preferably seeds of cultivated plants of cultivated crops with compounds of formula I or their mixtures, wherein the plant corresponds to a row of table 5 and the mixing partner of the compound of formula lis endosulfan.

In another most preferred embodiment, the present invention relates to a method of controlling harmful insects and/or increasing the health of plants by treating plant propagation materials, preferably seeds of cultivated plants of cultivated crops with compounds of formula I or their mixtures, wherein the plant corresponds to a row of table 5 and the mixing partner of the compound of formula lis ethiprole.

In another most preferred embodiment, the present invention relates to a method of controlling harmful insects and/or increasing the health of plants by treating plant propagation materials, preferably seeds of cultivated plants of cultivated crops with compounds of formula I or their mixtures, wherein the plant corresponds to a row of table 5 and the mixing partner of the compound of formula lis fipronil.

In a utmost preferred embodiment, the present invention relates to a method of controlling harmful insects and/or increasing the health of plants by treating cultivated plants, parts of such plants or at their locus of growth with compounds of formula I or their mixtures, wherein the plant is selected from T5-1, T5-3, T5-4, T5-6, T5-9, T5-10, T5-12 and T5-13 and the mixing partner of the compound of formula lis endosulfan.

In another utmost preferred embodiment, the present invention relates to a method of controlling harmful insects and/or increasing the health of plants by treating cultivated plants, parts of such plants or at their locus of growth with compounds of formula I or their mixtures, wherein the plant is selected from T5-1, T5-3, T5-4, T5-6, T5-9, T5-10, T5-12 and T5-13 and the mixing partner of the compound of formula lis ethiprole.

In another utmost preferred embodiment, the present invention relates to a method of controlling harmful insects and/or increasing the health of plants by treating cultivated plants, parts of such plants or at their locus of growth with compounds of formula I or their mixtures, wherein the plant is selected from T5-2, T5-5, T5-6, T5-9, T5-10, T5-11, T5-12 and T5-13 and the mixing partner of the compound of formula lis fipronil.

In a utmost preferred embodiment, the present invention relates to a method of controlling harmful insects and/or increasing the health of plants by treating plant propagation materials, preferably seeds of cultivated plants of cultivated crops with compounds of formula I or their mixtures, wherein the plant is selected from T5-1, T5-3, T5-4, T5-6, T5-9, T5-10, T5-12 and T5-13 and the mixing partner of the compound of formula lis endosulfan.

In another utmost preferred embodiment, the present invention relates to a method of controlling harmful insects and/or increasing the health of plants by treating plant propagation materials, preferably seeds of cultivated plants of cultivated crops with compounds of formula I or their mixtures, wherein the plant is selected from T5-1, T5-3, T5-4, T5-6, T5-9, T5-10, T5-12 and T5-13 and the mixing partner of the compound of formula lis ethiprole.

In another utmost preferred embodiment, the present invention relates to a method of controlling harmful insects and/or increasing the health of plants by treating plant propagation materials, preferably seeds of cultivated plants of cultivated crops with compounds of formula I or their mixtures, wherein the plant is selected from T5-1, T5-3, T5-4, T5-6, T5-9, T5-10, T5-12 and T5-13 and the mixing partner of the compound of formula lis fipronil.

TABLE 5

| | | | Literature/ |
|---|---|---|---|
| No | detailed description | plant | commercial plants |
| T5-1 | broad fungicide resistance | maize | A*, B*, C* |
| T5-2 | broad fungicide resistance | soybean | A*, B*, C* |
| T5-3 | asian soybean rust resistance | soybean | WO 2008017706 |
| T5-4 | resistance against anthracnose leaf bligh, | maize | US2006/225152 |
| | anthracnose stalk rot (colletotrichum | | |
| | graminicola), diplodia ear rot, fusarium | | |
| | verticilioides, gibberella zeae, top dieback | | |
| T5-5 | fusarium resistance | wheat | U.S. Pat. No. 6,646,184, |
| | | | EP1477557 |
| T5-6 | apple scab resistance | apple | WO1999064600 |
| T5-7 | plum pox virus resistance | plum | US PP15154Ps |
| T5-8 | potato virus X resistance | potato | U.S. Pat. No. 5,968,828, |
| | | | EP0707069 |
| T5-9 | potato virus Y resistance | potato | EP0707069; |
| | | | “NewLeaf Y” |
| | | | (Monsanto) |
| T5-10 | potato leafroll virus resistance | potato | EP0707069, |
| | | | U.S. Pat. No. 5,576,202; “New- |
| | | | Leaf Plus” (Monsanto) |
| T5-11 | papaya ring spot virus resistance | papaya | U.S. Pat. No. 5,877,403, |
| | | | U.S. Pat. No. 6,046,384 |
| T5-12 | bacterial blight resistance | rice | D* |
| T5-13 | fungal resistance | potato | E* |

A* refers to U.S. Pat. No. 5,689,046 and U.S. Pat. No. 6,020,129.
B* refers to U.S. Pat. No. 6,706,952 and EP 1018553.
C* refers to U.S. Pat. No. 6,630,618.
D* refers to WO 2006/42145, U.S. Pat. No. 5,952,485, U.S. Pat. No. 5,977,434, WO 1999/09151 and WO 1996/22375.
E* refers to the potato plant variety submitted for variety registration with the Community Plant Variety Office (CPVO), 3, boulevard Maréchal Foch, BP 10121, FR-49101 Angers Cedex 02, France and having the CPVO file number 20082800.

In a further one preferred embodiment, the present invention relates to a method of controlling harmful insects and/or increasing the health of cultivated plants by treating cultivated plants, parts of such plants, plant propagation materials, or at their locus of growth with compounds of formula I or their mixtures selected from endosulfan, ethiprole and fipronil, wherein the plant is a plant, which is tolerant to abiotic stress, preferably drought, high salinity, high light intensities, high UV irradiation, chemical pollution (such as high heavy metal concentration), low or high temperatures, limited supply of nutrients and population stress, most preferably drought, high salinity, low temperatures and limited supply of nitrogen.

In a more preferred embodiment, the present invention relates to a method of controlling harmful insects and/or increasing the health of cultivated plants by treating plant propagation materials, preferably seeds with compounds of formula I or their mixtures selected from endosulfan, ethiprole and fipronil, wherein the plant corresponds to row of table 6.

In another more preferred embodiment, the present invention relates to a method of controlling harmful insects and/or increasing the health of cultivated plants by treating cultivated plants, parts of such plants or at their locus of growth with compounds of formula I or their mixtures selected from endosulfan, ethiprole and fipronil, wherein the plant corresponds to row of table 6.

In another more preferred embodiment, the present invention relates to a method of controlling harmful insects and/or increasing the health of cultivated plants by treating cultivated plants, parts of such plants or their locus of growth with a compound of formula I, which is selected from the compounds I-1 to I-40 as defined in Table C, wherein the plant corresponds to a row of table 6. In this embodiment the compound of formula I is more specifically selected from compounds I-11, I-16, I-21, I-26, I-31 which are defined in accordance with Table C of the example section.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 6, wherein the compound of formula I is compound I-11.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 6, wherein the compound of formula I is compound I-16.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 6, wherein the compound of formula I is compound I-26.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 6, wherein the compound of formula I is compound I-31.

In a most preferred embodiment, the present invention relates to a method of controlling harmful insects and/or increasing the health of plants by treating cultivated plants, parts of such plants or at their locus of growth with compounds of formula I or their mixtures, wherein the plant corresponds to a row of table 6 and the mixing partner of the compound of formula lis endosulfan. In another most preferred embodiment, the present invention relates to a method of controlling harmful insects and/or increasing the health of plants by treating cultivated plants, parts of such plants or at their locus of growth with compounds of formula I or their mixtures, wherein the plant corresponds to a row of table 6 and the mixing partner of the compound of formula lis ethiprole.

In another most preferred embodiment, the present invention relates to a method of controlling harmful insects and/or increasing the health of plants by treating cultivated plants, parts of such plants or at their locus of growth with compounds of formula I or their mixtures, wherein the plant corresponds to a row of table 6 and mixture is a compound of formula I with fipronil.

In a most preferred embodiment, the present invention relates to a method of controlling harmful insects and/or increasing the health of plants by treating plant propagation materials, preferably seeds of cultivated plants of cultivated crops with compounds of formula I or their mixtures, wherein the plant corresponds to a row of table 6 and the mixing partner of the compound of formula lis endosulfan.

In another most preferred embodiment, the present invention relates to a method of controlling harmful insects and/or increasing the health of plants by treating plant propagation materials, preferably seeds of cultivated plants of cultivated crops with compounds of formula I or their mixtures, wherein the plant corresponds to a row of table 6 and the mixing partner of the compound of formula lis ethiprole.

In another most preferred embodiment, the present invention relates to a method of controlling harmful insects and/or increasing the health of plants by treating plant propagation materials, preferably seeds of cultivated plants of cultivated crops with compounds of formula I or their mixtures, wherein the plant corresponds to a row of table 6 and the mixing partner of the compound of formula lis fipronil.

TABLE 6

| | detailed | | |
|---|---|---|---|
| No | description | plant | Literature |
| T6-1 | drought tolerance | alfalfa | A*, B*, F* |
| T6-2 | drought tolerance | barley | A*, B*, C* |
| T6-3 | drought tolerance | canola | A*, B*, F* |
| T6-4 | drought tolerance | maize | A*, B*, C*, F* |
| | | (maize) | |
| T6-5 | drought tolerance | cotton | A*, B*, C*, F* |
| T6-6 | drought tolerance | pomefruit | A*, B* |
| T6-7 | drought tolerance | potato | A*, B*, C* |
| T6-8 | drought tolerance | rapeseed | A*, B*, C* |
| T6-9 | drought tolerance | rice | A*, B*, C*, F* |
| T6-10 | drought tolerance | soybean | A*, B*, F* |
| T6-11 | drought tolerance | sugarbeet | A*, B* |
| T6-12 | drought tolerance | sugarcane | A*, B*, F* |
| T6-13 | drought tolerance | sunflower | A*, B* |
| T6-14 | drought tolerance | tomato | A*, B*, C* |
| T6-15 | drought tolerance | wheat | A*, B*, C*, F* |
| T6-16 | tolerance to high salinity | alfalfa | A*, B* |
| T6-17 | tolerance to high salinity | barley | A*, B* |
| T6-18 | tolerance to high salinity | canola | A*, B* |
| T6-19 | tolerance to high salinity | maize | A*, D* |
| T6-20 | tolerance to high salinity | cotton | A*, D* |
| T6-21 | tolerance to high salinity | pomefruit | A*, D* |
| T6-22 | tolerance to high salinity | potato | A*, D* |
| T6-23 | tolerance to high salinity | rapeseed | A*, D* |
| T6-24 | tolerance to high salinity | rice | A*, D*, |
| | | | U.S. Pat. No. |
| | | | 7,034,139, |
| | | | WO 2001/30990 |
| T6-25 | tolerance to high salinity | soybean | A*, D* |
| T6-26 | tolerance to high salinity | sugarbeet | A*, D* |
| T6-27 | tolerance to high salinity | sugarcane | A*, D* |
| T6-28 | tolerance to high salinity | sunflower | A*, D* |
| T6-29 | tolerance to high salinity | tomato | A*, D* |
| T6-30 | tolerance to high salinity | wheat | A*, D* |
| T6-31 | low temperature tolerance | alfalfa | A*, E* |
| T6-32 | low temperature tolerance | barley | A* |
| T6-33 | low temperature tolerance | canola | A* |
| T6-34 | low temperature tolerance | maize | A*, E* |
| T6-35 | low temperature tolerance | cotton | A*, E* |
| T6-36 | low temperature tolerance | pomefruit | A* |
| T6-37 | low temperature tolerance | potato | A* |
| T6-38 | low temperature tolerance | rapeseed | A*, E* |
| T6-39 | low temperature tolerance | rice | A*, E* |
| T6-40 | low temperature tolerance | soybean | A*, E* |
| T6-41 | low temperature tolerance | sugarbeet | A* |
| T6-42 | low temperature tolerance | sugarcane | A* |
| T6-43 | low temperature tolerance | sunflower | A* |
| T6-44 | low temperature tolerance | tomato | A* |
| T6-45 | low temperature tolerance | wheat | A*, E* |
| T6-46 | low nitrogen supply tolerance | alfalfa | A* |
| T6-47 | low nitrogen supply tolerance | barley | A* |
| T6-48 | low nitrogen supply tolerance | canola | A* |
| T6-49 | low nitrogen supply tolerance | maize | A* |
| T6-50 | low nitrogen supply tolerance | cotton | A* |
| T6-51 | low nitrogen supply tolerance | pomefruit | A* |
| T6-52 | low nitrogen supply tolerance | potato | A* |
| T6-53 | low nitrogen supply tolerance | rapeseed | A* |
| T6-54 | low nitrogen supply tolerance | rice | A* |
| T6-55 | low nitrogen supply tolerance | soybean | A* |
| T6-56 | low nitrogen supply tolerance | sugarbeet | A* |
| T6-57 | low nitrogen supply tolerance | sugarcane | A* |
| T6-58 | low nitrogen supply tolerance | sunflower | A* |
| T6-59 | low nitrogen supply tolerance | tomato | A* |
| T6-60 | low nitrogen supply tolerance | wheat | A* |

A* referes to WO 2000/04173, WO 2007/131699 and US 2008/0229448.
B* referes to WO 2005/48693.
C* referes to WO 2007/20001.
D* referes to U.S. Pat. No. 7,256,326.
E* referes to U.S. Pat. No. 4,731,499.
F* refers to WO 2008/002480.

In a more preferred embodiment, the present invention relates to a method of controlling harmful insects and/or increasing the health of cultivated plants by treating cultivated plants, parts of such plants, plant propagation materials, or at their locus of growth with compounds of formula I or their mixtures selected from endosulfan, ethiprole and fipronil, wherein the plant is a plant, which is listed in table 7.

In another more preferred embodiment, the present invention relates to a method of controlling harmful insects and/or increasing the health of cultivated plants by treating cultivated plants, parts of such plants or their locus of growth with a compound of formula I, which is selected from the compounds I-1 to I-40 as defined in Table C, wherein the plant corresponds to a row of table 76. In this embodiment the compound of formula I is more specifically selected from compounds I-11, I-16, I-21, I-26, I-31 which are defined in accordance with Table C of the example section.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 7, wherein the compound of formula I is compound I-11.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 7, wherein the compound of formula I is compound I-16.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 7, wherein the compound of formula I is compound I-26.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 7, wherein the compound of formula I is compound I-31.

In a more preferred embodiment, the present invention relates to a method of controlling harmful insects and/or increasing the health of cultivated plants by treating plant propagation materials, preferably seeds with compounds of formula I or their mixtures selected from endosulfan, ethiprole and fipronil, wherein the plant corresponds to a row of table 7.

In another more preferred embodiment, the present invention relates to a method of controlling harmful insects and/or increasing the health of cultivated plants by treating cultivated plants, parts of such plants or at their locus of growth with compounds of formula I or their mixtures selected from endosulfan, ethiprole and fipronil, wherein the plant corresponds to a row of table 7.

In a most preferred embodiment, the present invention relates to a method of controlling harmful insects and/or increasing the health of plants by treating cultivated plants, parts of such plants or at their locus of growth with compounds of formula I or their mixtures, wherein the plant corresponds to a row of table 7 and the mixing partner of the compound of formula lis endosulfan. In another most preferred embodiment, the present invention relates to a method of controlling harmful insects and/or increasing the health of plants by treating cultivated plants, parts of such plants or at their locus of growth with compounds of formula I or their mixtures, wherein the plant corresponds to a row of table 7 and the mixing partner of the compound of formula lis ethiprole.

In another most preferred embodiment, the present invention relates to a method of controlling harmful insects and/or increasing the health of plants by treating cultivated plants, parts of such plants or at their locus of growth with compounds of formula I or their mixtures, wherein the plant corresponds to a row of table 7 and the mixing partner of the compound of formula lis fipronil.

In a most preferred embodiment, the present invention relates to a method of controlling harmful insects and/or increasing the health of plants by treating plant propagation materials, preferably seeds of cultivated plants of cultivated crops with compounds of formula I or their mixtures, wherein the plant corresponds to a row of table 7 and the mixing partner of the compound of formula lis endosulfan.

In another most preferred embodiment, the present invention relates to a method of controlling harmful insects and/or increasing the health of plants by treating plant propagation materials, preferably seeds of cultivated plants of cultivated crops with compounds of formula I or their mixtures, wherein the plant corresponds to a row of table 7 and the mixing partner of the compound of formula lis ethiprole.

In another most preferred embodiment, the present invention relates to a method of controlling harmful insects and/or increasing the health of plants by treating plant propagation materials, preferably seeds of cultivated plants of cultivated crops with compounds of formula I or their mixtures, wherein the plant corresponds to a row of table 7 and the mixing partner of the compound of formula lis fipronil.

In a utmost preferred embodiment, the present invention relates to a method of controlling harmful insects and/or increasing the health of plants by treating cultivated plants, parts of such plants or at their locus of growth with compounds of formula I or their mixtures, wherein the plant is selected from T7-1, T7-3, T7-5, T7-6 and T7-8 and the mixing partner of the compound of formula lis endosulfan.

In another utmost preferred embodiment, the present invention relates to a method of controlling harmful insects and/or increasing the health of plants by treating cultivated plants, parts of such plants or at their locus of growth with compounds of formula I or their mixtures, wherein the plant is selected from T7-1, T7-3, T7-5, T7-6 and T7-8 and the mixing partner of the compound of formula lis ethiprole.

In another utmost preferred embodiment, the present invention relates to a method of controlling harmful insects and/or increasing the health of plants by treating cultivated plants, parts of such plants or at their locus of growth with compounds of formula I or their mixtures, wherein the plant is selected from T7-1, T7-3, T7-5, T7-6 and T7-8 and the mixing partner of the compound of formula lis fipronil.

In a utmost preferred embodiment, the present invention relates to a method of controlling harmful insects and/or increasing the health of plants by treating plant propagation materials, preferably seeds of cultivated plants of cultivated crops with compounds of formula I or their mixtures, wherein the plant is selected from T7-1, T7-3, T7-5, T7-6 and T7-8 and the mixing partner of the compound of formula lis endosulfan.

In another utmost preferred embodiment, the present invention relates to a method of controlling harmful insects and/or increasing the health of plants by treating plant propagation materials, preferably seeds of cultivated plants of cultivated crops with compounds of formula I or their mixtures, wherein the plant is selected from T7-1, T7-3, T7-5, T7-6 and T7-8 and the mixing partner of the compound of formula lis ethiprole.

In another utmost preferred embodiment, the present invention relates to a method of controlling harmful insects and/or increasing the health of plants by treating plant propagation materials, preferably seeds of cultivated plants of cultivated crops with compounds of formula I or their mixtures, wherein the plant is selected from T7-1, T7-3, T7-5, T7-6 and T7-8 and the mixing partner of the compound of formula lis fipronil.

TABLE 7

| | detailed | | |
|---|---|---|---|
| No | description | plant | Literature |
| T7-1 | drought tolerance | maize | A*, B*, C* |
| T7-2 | drought tolerance | canola | A*, B*, C* |
| T7-3 | drought tolerance | cotton | A*, B*, C* |
| T7-4 | drought tolerance | rapeseed | A*, B*, C* |
| T7-5 | drought tolerance | rice | A*, B*, C* |
| T7-6 | drought tolerance | soybean | A*, B* |
| T7-7 | drought tolerance | wheat | A*, B*, C* |
| T7-8 | tolerance to high salinity | rice | A*, D*, |
| | | | U.S. Pat. No. |
| | | | 7,034,139, |
| | | | WO 2001/30990 |
| T7-9 | tolerance to high salinity | tomato | A*, D* |
| T7-10 | low nitrogen supply tolerance | canola | A* |
| T7-11 | low nitrogen supply tolerance | maize | A* |

A* referes to WO 2000/04173, WO 2007/131699 and US 2008/0229448.
B* referes to WO 2005/48693.
C* referes to WO 2007/20001.
D* referes to U.S. Pat. No. 7,256,326.
E* referes to U.S. Pat. No. 4,731,499.

In a further one preferred embodiment, the present invention relates to a method of controlling harmful insects and/or increasing the health of cultivated plants by treating cultivated plants, parts of such plants, plant propagation materials, or at their locus of growth with compounds of formula I or their mixtures selected from endosulfan, ethiprole and fipronil, wherein the plant is a plant, which shows improved maturation, preferably fruit ripening, early maturity and delayed softening.

In a more preferred embodiment, the present invention relates to a method of controlling harmful insects and/or increasing the health of cultivated plants by treating cultivated plants, parts of such plants, plant propagation materials, or at their locus of growth compounds of formula I or their mixtures selected from, wherein the plant is a plant, which corresponds to a row of table 8.

In a more preferred embodiment, the present invention relates to a method of controlling harmful insects and/or increasing the health of cultivated plants by treating plant propagation materials, preferably seeds with compounds of formula I or their mixtures selected from, wherein the plant corresponds to row of table 8.

In another more preferred embodiment, the present invention relates to a method of controlling harmful insects and/or increasing the health of cultivated plants by treating cultivated plants, parts of such plants or their locus of growth with a compound of formula I, which is selected from the compounds I-1 to I-40 as defined in Table C, wherein the plant corresponds to a row of table 8. In this embodiment the compound of formula I is more specifically selected from compounds I-11, I-16, I-21, I-26, I-31 which are defined in accordance with Table C of the example section.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 8, wherein the compound of formula I is compound I-11.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 8, wherein the compound of formula I is compound I-16.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 8, wherein the compound of formula I is compound I-26.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 8, wherein the compound of formula I is compound I-31.

In another more preferred embodiment, the present invention relates to a method of controlling harmful insects and/or increasing the health of cultivated plants by treating cultivated plants, parts of such plants or at their locus of growth with compounds of formula I or their mixtures selected from ethiprole, fipronil, endosulfan, wherein the plant corresponds to row of table 8.

In a most preferred embodiment, the present invention relates to a method of controlling harmful insects and/or increasing the health of plants by treating cultivated plants, parts of such plants or at their locus of growth with compounds of formula I or their mixtures, wherein the plant corresponds to a row of table 8 and the mixing partner of the compound of formula I is endosulfan.

In a most preferred embodiment, the present invention relates to a method of controlling harmful insects and/or increasing the health of plants by treating plant propagation materials, preferably seeds of cultivated plants of cultivated crops with compounds of formula I or their mixtures, wherein the plant corresponds to a row of table 8 and the mixing partner of the compound of formula I is endosulfan.

In a utmost preferred embodiment, the present invention relates to a method of controlling harmful insects and/or increasing the health of plants by treating cultivated plants, parts of such plants or at their locus of growth with compounds of formula I or their mixtures, wherein the plant is T8-1 and the mixing partner of the compound of formula lis endosulfan.

In a utmost preferred embodiment, the present invention relates to a method of controlling harmful insects and/or increasing the health of plants by treating plant propagation materials, preferably seeds of cultivated plants of cultivated crops with compounds of formula I or their mixtures, wherein the plant is T8-1 and the mixing partner of the compound of formula lis endosulfan.

TABLE 8

| | detailed | | |
|---|---|---|---|
| No | description | plant/Event | Literature |
| T8-1 | fruit ripening | tomato | A* |
| T8-2 | fruit ripening | papaya | U.S. Pat. No. |
| | | | 5,767,376, |
| | | | U.S. Pat. No. |
| | | | 7,084,321 |
| T8-3 | fruit ripening | pepper | B* |
| T8-4 | fruit ripening | melon | WO1995035387 |
| T8-5 | fruit ripening | strawberry | WO1995035387 |
| T8-6 | fruit ripening | raspberry | WO1995035387 |
| T8-7 | fruit ripening | Cucumis melo/A, B | Agritope Inc. |
| T8-8 | fruit ripening | Lycopersicon | Florigene Pty Ltd. |
| | | esculentum/66 | |
| T8-9 | fruit ripening | Lycopersicon | DNA Plant |
| | | esculentum/1345-4 | Technology |
| | | | Corporation |
| T8-10 | fruit ripening | Lycopersicon | Agritope Inc. |
| | | esculentum/35 1 N | |
| T8-11 | fruit ripening | Lycopersicon | Monsanto Company |
| | | esculentum/8338 | |
| T8-12 | fruit ripening | Lycopersicon | Zeneca Seeds |
| | | esculentum/B, Da, F | |
| T8-13 | fruit ripening | Lycopersicon | Calgene Inc. |
| | | esculentum/FLAVR | |
| | | SAVR | |
| T8-14 | delayed ripening | Cucumis melo/A, B | available, |
| | | | Agritope Inc. |
| T8-15 | delayed sofenting | Lycopersicon | available, |
| | | esculentum/B, Da, F | Zeneca Seeds |
| T8-16 | delayed sofenting | Lycopersicon | available, Calgene Inc. |
| | | esculentum/FLAVR | |
| | | SAVR | |
| T8-17 | FRA | Lycopersicon | available, Monsanto |
| | | esculentum/8338 | Company |
| T8-18 | FRA | Lycopersicon | available, DNA plant |
| | | esculentum/1345-4 | technology corporation |
| T8-19 | FRA | Lycopersicon | available, |
| | | esculentum/35 1 N | Agritopoe Inc. |

*A U.S. Pat. No. 5,952,546, U.S. Pat. No. 5,512,466, WO1997/001952, WO1995035387 wo1992/008798, Plant Cell. 1989; 1(1): 53-63.
*B Plant Molecular Biology, Volume 50, 2002, Number 3
Abbreviations: FRA = fruit ripening alteration
Lycopersicon esculentum = tomato;
Cucumis melo (melon)

In a further one preferred embodiment, the present invention relates to a method of controlling harmful insects and/or increasing the health of cultivated plants by treating cultivated plants, parts of such plants, plant propagation materials, or at their locus of growth with compounds of formula I or their mixtures selected from endosulfan, ethiprole and fipronil, wherein the plant is a transgenic plant, which has modified content in comparison to wildtype plants, preferably increased vitamin content, altered oil content, nicotine reduction, increased or reduced amino acid content, protein alteration, modified starch content, enzyme alteration, altered flavonoid content and reduced allergens (hypoallergenic plants), most preferably increased vitamin content, altered oil content, nicotine reduction, increased lysine content, amylase alteration, amylopectin alteration.

In another more preferred embodiment, the present invention relates to a method of controlling harmful insects and/or increasing the health of cultivated plants by treating cultivated plants, parts of such plants or their locus of growth with a compound of formula I, which is selected from the compounds I-1 to I-40 as defined in Table C, wherein the plant corresponds to a row of table 9. In this embodiment the compound of formula I is more specifically selected from compounds I-11, I-16, I-21, I-26, I-31 which are defined in accordance with Table C of the example section.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 9, wherein the compound of formula I is compound I-11.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 9, wherein the compound of formula I is compound I-16.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 9, wherein the compound of formula I is compound I-26.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 9, wherein the compound of formula I is compound I-31.

In a more preferred embodiment, the present invention relates to a method of controlling harmful insects and/or increasing the health of cultivated plants by treating cultivated plants, parts of such plants, plant propagation materials, or at their locus of growth with compounds of formula I or their mixtures selected from endosulfan, ethiprole and fipronil, wherein the plant is a plant, which corresponds to a row of table 9.

In a more preferred embodiment, the present invention relates to a method of controlling harmful insects and/or increasing the health of cultivated plants by treating plant propagation materials, preferably seeds with compounds of formula I or their mixtures selected from endosulfan, ethiprole and fipronil, wherein the plant corresponds to a row of table 9.

In another more preferred embodiment, the present invention relates to a method of controlling harmful insects and/or increasing the health of cultivated plants by treating cultivated plants, parts of such plants or at their locus of growth with compounds of formula I or their mixtures selected from endosulfan, ethiprole and fipronil, wherein the plant corresponds to a row of table 9.

In a most preferred embodiment, the present invention relates to a method of controlling harmful insects and/or increasing the health of plants by treating cultivated plants, parts of such plants or at their locus of growth with compounds of formula I or their mixtures, wherein the plant corresponds to a row of table 9 and the mixing partner of the compound of formula lis endosulfan. In another most preferred embodiment, the present invention relates to a method of controlling harmful insects and/or increasing the health of plants by treating cultivated plants, parts of such plants or at their locus of growth with compounds of formula I or their mixtures, wherein the plant corresponds to a row of table 9 and the mixing partner of the compound of formula lis ethiprole.

In another most preferred embodiment, the present invention relates to a method of controlling harmful insects and/or increasing the health of plants by treating cultivated plants, parts of such plants or at their locus of growth with compounds of formula I or their mixtures, wherein the plant corresponds to a row of table 9 and the mixing partner of the compound of formula lis fipronil.

In another most preferred embodiment, the present invention relates to a method of controlling harmful insects and/or increasing the health of plants by treating cultivated plants, parts of such plants or at their locus of growth with compounds of formula I or their mixtures, wherein the plant corresponds to row T9-48 of table 9 and the mixture partner is selected from the group consisting of endosulfan, ethiprole and fipronil.

In a most preferred embodiment, the present invention relates to a method of controlling harmful insects and/or increasing the health of plants by treating plant propagation materials, preferably seeds of cultivated plants of cultivated crops with compounds of formula I or their mixtures, wherein the plant corresponds to a row of table 9 and the mixing partner of the compound of formula lis endosulfan.

In another most preferred embodiment, the present invention relates to a method of controlling harmful insects and/or increasing the health of plants by treating plant propagation materials, preferably seeds of cultivated plants of cultivated crops with compounds of formula I or their mixtures, wherein the plant corresponds to a row of table 9 and the mixing partner of the compound of formula lis ethiprole.

In another most preferred embodiment, the present invention relates to a method of controlling harmful insects and/or increasing the health of plants by treating plant propagation materials, preferably seeds of cultivated plants of cultivated crops with compounds of formula I or their mixtures, wherein the plant corresponds to a row of table 9 and the mixing partner of the compound of formula lis fipronil.

TABLE 9

| | detailed | | Literature/ |
|---|---|---|---|
| No | description | plant* | commercial plants |
| T9-1 | increased Vitamin A content | tomato | U.S. Pat. No. 6,797,498 |
| T9-2 | increased Vitamin A content | rice | “Golden rice”. |
| | | | Science 287, 303-305. |
| T9-3 | increased Vitamin E content | canola | U.S. Pat. No. 7,348,167, |
| | | | U.S. Ser. No. 11/170,711 (application) |
| T9-4 | increased Vitamin E content | barley | U.S. Ser. No. 11/170,711 (application) |
| T9-5 | increased Vitamin E content | maize | U.S. Ser. No. 11/170,711 (application) |
| T9-6 | increased Vitamin E content | rice | U.S. Ser. No. 11/170,711 (application) |
| T9-7 | increased Vitamin E content | rye | U.S. Ser. No. 11/170,711 (application) |
| T9-8 | increased Vitamin E content | potato | U.S. Pat. No. 7,348,167 |
| T9-9 | increased Vitamin E content | soybean | U.S. Pat. No. 7,348,167 |
| T9-10 | increased Vitamin E content | sunflower | U.S. Pat. No. 7,348,167 |
| T9-11 | increased Vitamin E content | wheat | U.S. Ser. No. 11/170,711 (application) |
| T9-12 | decreased nicotine content | tobacco | US 2006/0185684, |
| | | | WO 2005/000352, |
| | | | WO 2007/064636 |
| T9-13 | amylase alteration | maize | “AmylaseTM” |
| T9-14 | amylopectin alteration | potato | U.S. Pat. No. 6,784,338, |
| | | | WO 1997/044471 |
| T9-15 | amylopectin alteration | maize | US 20070261136 |
| T9-16 | modified oil content | balsam pear | A* |
| T9-17 | modified oil content | canola | U.S. Pat. No. 5,850,026, |
| | | | U.S. Pat. No. 6,441,278, |
| | | | U.S. Pat. No. 5,723,761 |
| T9-18 | modified oil content | catalpa | A* |
| T9-19 | modified oil content | cattail | A* |
| T9-20 | modified oil content | maize | A*, US 2006/0075515, |
| | | | U.S. Pat. No. 7,294,759 |
| T9-21 | modified oil content | cotton | U.S. Pat. No. 6,974,898, |
| | | | WO 2001/079499 |
| T9-22 | modified oil content | grape | A* |
| T9-23 | modified oil content | rapeseed | U.S. Pat. No. 5,723,761 |
| T9-24 | modified oil content | rice | A* |
| T9-25 | modified oil content | soybean | A*, U.S. Pat. No. 6,380,462, |
| | | | U.S. Pat. No. 6,365,802, |
| | | | “Vistive II”, ,,Vistsive III” |
| T9-26 | modified oil content | safflower | U.S. Pat. No. 6,084,164 |
| T9-27 | modified oil content | sunflower | A*, U.S. Pat. No. 6,084,164 |
| T9-28 | modified oil content | wheat | A* |
| T9-29 | modified oil content | vernonia | A* |
| T9-30 | hypoallergenic modification | soybean | U.S. Pat. No. 6,864,362 |
| T9-31 | increased lysine content | canola | Bio/Technology 13, 577-582 (1995) |
| T9-32 | increased lysine content | maize | ,,Mavera high value corn” |
| T9-33 | increased lysine content | soybean | Bio/Technology 13, 577-582 (1995) |
| T9-34 | altered starch content | maize | U.S. Pat. No. 7,317,146, EP 1105511 |
| T9-35 | altered starch content | rice | U.S. Pat. No. 7,317,146, EP 1105511 |
| T9-36 | altered starch content | wheat | EP 1105511 |
| T9-37 | altered starch content | barley | EP 1105511 |
| T9-38 | altered starch content | rye | EP 1105511 |
| T9-39 | altered starch content | oat | EP 1105511 |
| T9-40 | altered fllavonoid content | alfalfa | WO 2000/04175 |
| T9-41 | altered fllavonoid content | apple | WO 2000/04175 |
| T9-42 | altered fllavonoid content | bean | WO 2000/04175 |
| T9-43 | altered fllavonoid content | maize | WO 2000/04175 |
| T9-44 | altered fllavonoid content | grape | WO 2000/04175 |
| T9-45 | altered fllavonoid content | pea | WO 2000/04175 |
| T9-46 | altered fllavonoid content | tomato | WO 2000/04175 |
| T9-47 | increased protein content | soybean | ,,Mavera high value soybeans” |
| T9-48 | amylopectin alteration | potato | B* |
| T9-49 | altered starch content | potato | C* |
| T9-50 | oil profile alteration/23-18-17, | Brassica | av.**), Monsanto Company |
| | 23-198 | napus | |
| T9-51 | oil profile alteration/46A12, | Brassica | av., Pioneer Hi-Bred International |
| | 46A16 | napus | Inc. |
| T9-52 | oleic acid and linolenic acid | Brassica | av., Pioneer Hi-Bred International |
| | profile alteration/45A37, | napus | Inc. |
| | 46A40 | | |
| T9-53 | increased shelf-life/Carnation | Dianthus | av., Florigene Ltd |
| | Moonshadow 2 | caryophyllus | |
| T9-54 | linolenic acid profile alteration/ | Glycine max L. | av., Agriculture & Agri-Food |
| | OT96-15 | | Canada |
| T9-55 | oil profile alteration/G94-1, | Glycine max L. | av., DuPont Canada Agricultural |
| | G94-19, G168 | | Products |
| T9-56 | increased oleic acid content/ | Glycine max L. | av., Pioneer Hi-Bred International |
| | DP-305423 | | Inc. |
| T9-57 | Nicotine reduction/Vector 21-41 | Nicotiana | av., Vector Tobacco Inc. |
| | | tabacum L. | |
| T9-58 | starch with increased amylopectin | Solanum | av., BASF Plant Science |
| | content/EH92-527-1 | tuberosum L. | |
| T9-59 | enhanced lysin level/LY038 | Zea mays L. | av., Monsanto Company |
| T9-60 | modified amylase content/Event 3272 | Zea mays L. | av., Syngenta Seeds, Inc. |

A* refers to U.S. Pat. No. 7,294,759 and U.S. Pat. No. 7,157,621.
B* refers to the potato plant variety submitted for variety registration with the Community Plant Variety Office (CPVO), 3, boulevard Maréchal Foch, BP 10121, FR - 49101 Angers Cedex 02, France and having the CPVO file number 20031520.
C* refers to the potato plant variety submitted for variety registration with the Community Plant Variety Office (CPVO), 3, boulevard Maréchal Foch, BP 10121, FR - 49101 Angers Cedex 02, France and having the CPVO file number 20082534.
*Brassica napus (Argentine canola), Glycine max L. (soybean), Nicotiana tabacum L. (tobacco), Dianthus caryophyllus (carnation), Solanum tuberosum L. (potato), Zea mays L. (corn, maize)
**)available

In a more preferred embodiment, the present invention relates to a method of controlling harmful insects and/or increasing the health of cultivated plants by treating cultivated plants, parts of such plants, plant propagation materials, or at their locus of growth with compounds of formula I or their mixtures selected from endosulfan, ethiprole and fipronil, wherein the plant is a plant, which corresponds to a row of table 10.

In another more preferred embodiment, the present invention relates to a method of controlling harmful insects and/or increasing the health of cultivated plants by treating cultivated plants, parts of such plants or their locus of growth with a compound of formula I, which is selected from the compounds I-1 to I-40 as defined in Table C, wherein the plant corresponds to a row of table 6. In this embodiment the compound of formula I is more specifically selected from compounds I-11, I-16, I-21, I-26, I-31 which are defined in accordance with Table C of the example section.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 10, wherein the compound of formula I is compound I-11.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 10, wherein the compound of formula I is compound I-16.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 10, wherein the compound of formula I is compound I-26.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 10, wherein the compound of formula I is compound I-31.

In a more preferred embodiment, the present invention relates to a method of controlling harmful insects and/or increasing the health of cultivated plants by treating plant propagation materials, preferably seeds with compounds of formula I or their mixtures selected from endosulfan, ethiprole and fipronil, wherein the plant corresponds to row of table 10.

In another more preferred embodiment, the present invention relates to a method of controlling harmful insects and/or increasing the health of cultivated plants by treating cultivated plants, parts of such plants or at their locus of growth with compounds of formula I or their mixtures selected from endosulfan, ethiprole and fipronil, wherein the plant corresponds to row of table 10.

In a most preferred embodiment, the present invention relates to a method of controlling harmful insects and/or increasing the health of plants by treating cultivated plants, parts of such plants or at their locus of growth with compounds of formula I or their mixtures, wherein the plant corresponds to a row of table 10 and the mixing partner of the compound of formula lis endosulfan.

In another most preferred embodiment, the present invention relates to a method of controlling harmful insects and/or increasing the health of plants by treating cultivated plants, parts of such plants or at their locus of growth with compounds of formula I or their mixtures, wherein the plant corresponds to a row of table 10 and the mixing partner of the compound of formula lis ethiprole.

In another most preferred embodiment, the present invention relates to a method of controlling harmful insects and/or increasing the health of plants by treating cultivated plants, parts of such plants or at their locus of growth with compounds of formula I or their mixtures, wherein the plant corresponds to a row of table 10 and the mixing partner of the compound of formula lis fipronil.

In a most preferred embodiment, the present invention relates to a method of controlling harmful insects and/or increasing the health of plants by treating plant propagation materials, preferably seeds of cultivated plants of cultivated crops with compounds of formula I or their mixtures, wherein the plant corresponds to a row of table 10 and the mixing partner of the compound of formula lis endosulfan.

In another most preferred embodiment, the present invention relates to a method of controlling harmful insects and/or increasing the health of plants by treating plant propagation materials, preferably seeds of cultivated plants of cultivated crops with compounds of formula I or their mixtures, wherein the plant corresponds to a row of table 10 and the mixing partner of the compound of formula lis ethiprole.

In another most preferred embodiment, the present invention relates to a method of controlling harmful insects and/or increasing the health of plants by treating plant propagation materials, preferably seeds of cultivated plants of cultivated crops with compounds of formula I or their mixtures, wherein the plant corresponds to a row of table 10 and the mixing partner of the compound of formula lis fipronil.

In a utmost preferred embodiment, the present invention relates to a method of controlling harmful insects and/or increasing the health of plants by treating cultivated plants, parts of such plants or at their locus of growth with compounds of formula I or their mixtures, wherein the plant is selected from T10-1, T10-2, T10-5, T10-6, T10-10, T10-11 and T10-12 and the mixing partner of the compound of formula lis endosulfan.

In another utmost preferred embodiment, the present invention relates to a method of controlling harmful insects and/or increasing the health of plants by treating cultivated plants, parts of such plants or at their locus of growth with compounds of formula I or their mixtures, wherein the plant is selected from T10-1, T10-2, T10-5, T10-6, T10-10, T10-11 and T10-12 and the mixing partner of the compound of formula lis ethiprole.

In another utmost preferred embodiment, the present invention relates to a method of controlling harmful insects and/or increasing the health of plants by treating cultivated plants, parts of such plants or at their locus of growth with compounds of formula I or their mixtures, wherein the plant is selected from T10-1, T10-2, T10-5, T10-6, T10-10, T10-11 and T10-12 and the mixing partner of the compound of formula lis fipronil.

In a utmost preferred embodiment, the present invention relates to a method of controlling harmful insects and/or increasing the health of plants by treating plant propagation materials, preferably seeds of cultivated plants of cultivated crops with compounds of formula I or their mixtures, wherein the plant is selected from T10-1, T10-2, T10-5, T10-6, T10-10, T10-11 and T10-12 and the mixing partner of the compound of formula lis endosulfan.

In another utmost preferred embodiment, the present invention relates to a method of controlling harmful insects and/or increasing the health of plants by treating plant propagation materials, preferably seeds of cultivated plants of cultivated crops with compounds of formula I or their mixtures, wherein the plant is selected from T10-1, T10-2, T10-5, T10-6, T10-10, T10-11 and T10-12 and the mixing partner of the compound of formula lis ethiprole.

In another utmost preferred embodiment, the present invention relates to a method of controlling harmful insects and/or increasing the health of plants by treating plant propagation materials, preferably seeds of cultivated plants of cultivated crops with compounds of formula I or their mixtures, wherein the plant is selected from T10-1, T10-2, T10-5, T10-6, T10-10, T10-11 and T10-12 and the mixing partner of the compound of formula lis fipronil.

TABLE 10

| | detailed | | Literature/ |
|---|---|---|---|
| No | description | plant | commercial plants |
| T10-1 | increased Vitamin | tomato | U.S. Pat. No. 6,797,498 |
| | A content | | |
| T10-2 | increased Vitamin | rice | “Golden rice”. |
| | A content | | Science 287, 303-305. |
| T10-3 | increased Vitamin | canola | U.S. Pat. No. 7,348,167, |
| | E content | | U.S. Ser. No. 11/170,711 |
| | | | (application) |
| T10-4 | decreased nicotine | tobacco | US 20060185684, |
| | content | | WO 2005/000352, |
| | | | WO 2007/064636 |
| T10-5 | amylase alteration | maize | “AmylaseTM” |
| T10-6 | amylopectin | potato | U.S. Pat. No. 6,784,338, |
| | alteration | | WO 1997/044471 |
| T10-7 | modified oil content | canola | U.S. Pat. No. 5,850,026, |
| | | | U.S. Pat. No. 6,441,278, |
| | | | U.S. Pat. No. 5,723,761 |
| T10-8 | modified oil content | rapeseed | U.S. Pat. No. 5,723,761 |
| T10-9 | modified oil content | safflower | U.S. Pat. No. 6,084,164 |
| T10-10 | modified oil content | soybean | A*, U.S. Pat. No. 6,380,462, |
| | | | U.S. Pat. No. 6,365,802; |
| | | | “Vistive II”, |
| | | | ,,Vistsive III” |
| T10-11 | increased protein | soybean | ,,Mavera high value |
| | content | | soybeans” |
| T10-12 | increased lysine | maize | ,,Mavera high value corn” |
| | content | | |

A* refers to U.S. Pat. No. 7,294,759 and U.S. Pat. No. 7,157,621.

In a further one preferred embodiment, the present invention relates to a method of controlling harmful insects and/or increasing the health of cultivated plants by treating cultivated plants, parts of such plants, plant propagation materials, or at their locus of growth with compounds of formula I or their mixtures selected from endosulfan, ethiprole and fipronil, wherein the plant is a plant, which shows improved nutrient utilization, preferably the uptake, assimilation and metabolism of nitrogen and phosphorous.

In a more preferred embodiment, the present invention relates to a method of controlling harmful insects and/or increasing the health of cultivated plants by treating cultivated plants, parts of such plants, plant propagation materials, or at their locus of growth with compounds of formula I or their mixtures selected from endosulfan, ethiprole and fipronil, wherein the plant is a plant, which corresponds to a row of table 11.

In a more preferred embodiment, the present invention relates to a method of controlling harmful insects and/or increasing the health of cultivated plants by treating plant propagation materials, preferably seeds with compounds of formula I or their mixtures selected from endosulfan, ethiprole and fipronil, wherein the plant corresponds to a row of table 11.

In another more preferred embodiment, the present invention relates to a method of controlling harmful insects and/or increasing the health of cultivated plants by treating cultivated plants, parts of such plants or at their locus of growth with compounds of formula I or their mixtures selected from endosulfan, ethiprole and fipronil, wherein the plant corresponds to a row of table 11.

In another more preferred embodiment, the present invention relates to a method of controlling harmful insects and/or increasing the health of cultivated plants by treating cultivated plants, parts of such plants or their locus of growth with a compound of formula I, which is selected from the compounds I-1 to I-40 as defined in Table C, wherein the plant corresponds to a row of table 11. In this embodiment the compound of formula I is more specifically selected from compounds I-11, I-16, I-21, I-26, I-31 which are defined in accordance with Table C of the example section.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 11, wherein the compound of formula I is compound I-11.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 11, wherein the compound of formula I is compound I-16.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 11, wherein the compound of formula I is compound I-26.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 11, wherein the compound of formula I is compound I-31.

In a most preferred embodiment, the present invention relates to a method of controlling harmful insects and/or increasing the health of plants by treating cultivated plants, parts of such plants or at their locus of growth with compounds of formula I or their mixtures, wherein the plant corresponds to a row of table 11 and the mixing partner of the compound of formula lis endosulfan. In another most preferred embodiment, the present invention relates to a method of controlling harmful insects and/or increasing the health of plants by treating cultivated plants, parts of such plants or at their locus of growth with compounds of formula I or their mixtures, wherein the plant corresponds to a row of table 11 and the mixing partner of the compound of formula lis ethiprole.

In another most preferred embodiment, the present invention relates to a method of controlling harmful insects and/or increasing the health of plants by treating cultivated plants, parts of such plants or at their locus of growth with compounds of formula I or their mixtures, wherein the plant corresponds to a row of table 11 and the mixing partner of the compound of formula lis fipronil.

In a most preferred embodiment, the present invention relates to a method of controlling harmful insects and/or increasing the health of plants by treating plant propagation materials, preferably seeds of cultivated plants of cultivated crops with compounds of formula I or their mixtures, wherein the plant corresponds to a row of table 11 and the mixing partner of the compound of formula lis endosulfan.

In another most preferred embodiment, the present invention relates to a method of controlling harmful insects and/or increasing the health of plants by treating plant propagation materials, preferably seeds of cultivated plants of cultivated crops with compounds of formula I or their mixtures, wherein the plant corresponds to a row of table 11 and the mixing partner of the compound of formula lis ethiprole.

In another most preferred embodiment, the present invention relates to a method of controlling harmful insects and/or increasing the health of plants by treating plant propagation materials, preferably seeds of cultivated plants of cultivated crops with compounds of formula I or their mixtures, wherein the plant corresponds to a row of table 11 and the mixing partner of the compound of formula lis fipronil.

In a utmost preferred embodiment, the present invention relates to a method of controlling harmful insects and/or increasing the health of plants by treating cultivated plants, parts of such plants or at their locus of growth with compounds of formula I or their mixtures, wherein the plant is selected from T11-4, T11-5, T11-8 and T11-9 and the mixing partner of the compound of formula lis endosulfan.

In another utmost preferred embodiment, the present invention relates to a method of controlling harmful insects and/or increasing the health of plants by treating cultivated plants, parts of such plants or at their locus of growth with compounds of formula I or their mixtures, wherein the plant is selected from T11-4, T11-5, T11-8 and T11-9 and the mixing partner of the compound of formula lis ethiprole.

In another utmost preferred embodiment, the present invention relates to a method of controlling harmful insects and/or increasing the health of plants by treating cultivated plants, parts of such plants or at their locus of growth with compounds of formula I or their mixtures, wherein the plant is selected from T11-4, T11-5, T11-8 and T11-9 and the mixing partner of the compound of formula lis fipronil.

In a utmost preferred embodiment, the present invention relates to a method of controlling harmful insects and/or increasing the health of plants by treating plant propagation materials, preferably seeds of cultivated plants of cultivated crops with compounds of formula I or their mixtures, wherein the plant is selected from T11-4, T11-5, T11-8 and T11-9 and the mixing partner of the compound of formula lis endosulfan.

In another utmost preferred embodiment, the present invention relates to a method of controlling harmful insects and/or increasing the health of plants by treating plant propagation materials, preferably seeds of cultivated plants of cultivated crops with compounds of formula I or their mixtures, wherein the plant is selected from T11-4, T11-5, T11-8 and T11-9 and the mixing partner of the compound of formula lis ethiprole.

In another utmost preferred embodiment, the present invention relates to a method of controlling harmful insects and/or increasing the health of plants by treating plant propagation materials, preferably seeds of cultivated plants of cultivated crops with compounds of formula I or their mixtures, wherein the plant is selected from T11-4, T11-5, T11-8 and T11-9 and the mixing partner of the compound of formula lis fipronil.

TABLE 11

| | detailed | | |
|---|---|---|---|
| No | description | plant | Literature |
| T11-1 | nitrogen utilization (D*) | alfalfa | A*, B*, F* |
| T11-2 | nitrogen utilization (D*) | barley | A*, B* |
| T11-3 | nitrogen utilization (D*) | canola | A*, B*, F* |
| T11-4 | nitrogen utilization (D*) | maize | A*, B*, F* |
| T11-5 | nitrogen utilization (D*) | cotton | B*, F* |
| T11-6 | nitrogen utilization (D*) | potato | B*, E*, F* |
| T11-7 | nitrogen utilization (D*) | rapeseed | B* |
| T11-8 | nitrogen utilization (D*) | rice | A*, B*, F* |
| T11-9 | nitrogen utilization (D*) | soybean | A*, B*, F* |
| T11-10 | nitrogen utilization (D*) | sugarbeet | B*, E* |
| T11-11 | nitrogen utilization (D*) | sugarcane | B*, E* |
| T11-12 | nitrogen utilization (D*) | sunflower | B* |
| T11-13 | nitrogen utilization (D*) | tobacco | E*, F* |
| T11-14 | nitrogen utilization (D*) | tomato | B*, F* |
| T11-15 | nitrogen utilization (D*) | wheat | A*, B*, F* |
| T11-16 | phosphorous utilization (D*) | alfalfa | C* |
| T11-17 | phosphorous utilization (D*) | barley | C* |
| T11-18 | phosphorous utilization (D*) | canola | C* |
| T11-19 | phosphorous utilization (D*) | maize | C* |
| T11-20 | phosphorous utilization (D*) | cotton | C* |
| T11-21 | phosphorous utilization (D*) | potato | U.S. Pat. No. |
| | | | 7,417,181, C* |
| T11-22 | phosphorous utilization (D*) | rapeseed | C* |
| T11-23 | phosphorous utilization (D*) | rice | C* |
| T11-24 | phosphorous utilization (D*) | soybean | C* |
| T11-25 | phosphorous utilization (D*) | sugarbeet | C* |
| T11-26 | phosphorous utilization (D*) | sugarcane | C* |
| T11-27 | phosphorous utilization (D*) | sunflower | C* |
| T11-28 | phosphorous utilization (D*) | tomato | U.S. Pat. No. |
| | | | 7,417,181, C* |
| T11-29 | phosphorous utilization (D*) | wheat | C* |
| T11-30 | low nitrogen supply tolerance | canola | G* |
| T11-31 | low nitrogen supply tolerance | maize | G* |

A* refers to U.S. Pat. No. 6,084,153.
B* referes to U.S. Pat. No. 5,955,651 and U.S. Pat. No. 6,864,405.
C* refers to U.S. Ser. No. 10/898,322 (application).
(D*) the term “utilization” refers to the improved nutrient uptake, assimilation or metabolism.
E* refers to WO 1995/009911.
F* refers to WO 1997/030163.
G* referes to WO 2000/04173, WO 2007/131699 and US 2008/0229448

In a further one preferred embodiment, the present invention relates to a method of controlling harmful insects and/or increasing the health of plants by treating cultivated plants parts of such plants, plant propagation materials, or at their locus of growth with a compounds of formula I and their mixtures, preferably selected from the compounds I-1 to I-40 as defined in Table C; more specifically, selected from compounds I-11, I-16, I-21, I-26, I-31 which are defined in accordance with Table C of the example section, more specifically compound I-11, more specifically compound I-16, more specifically compound I-21, more specifically compound I-26, more specifically compound I-31. In case of mixtures, the compounds as preferred above are mixed with a compound selected from endosulfan, ethiprole and fipronil, wherein the plant is a plant selected from the group consisting of cotton, fiber plants (e.g. palms) and trees, preferably a cotton plant, which produces higher quality fiber, preferably improved micronaire of the fiber, increased strength, improved staple length, improved length unifomity and color of the fibers.

In a more preferred embodiment, the present invention relates to a method of controlling harmful insects and/or increasing the health of cotton plants by treating cultivated plants parts of such plants, plant propagation materials, or at their locus of growth with compounds of formula I or their mixtures selected from endosulfan, ethiprole and fipronil.

In another more preferred embodiment, the present invention relates to a method of controlling harmful insects and/or increasing the health of cultivated plants by treating cultivated plants, parts of such plants or their locus of growth with a compound of formula I, which is selected from the compounds I-1 to I-40 as defined in Table C, wherein the plant corresponds to a row of table 12. In this embodiment the compound of formula I is more specifically selected from compounds I-11, I-16, I-21, I-26, I-31 which are defined in accordance with Table C of the example section.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 12, wherein the compound of formula I is compound I-11.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 12, wherein the compound of formula I is compound I-16.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 12, wherein the compound of formula I is compound I-26.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 12, wherein the compound of formula I is compound I-31.

In a more preferred embodiment, the present invention relates to a method of controlling harmful insects and/or increasing the health of cultivated plants by treating cultivated plants, parts of such plants, plant propagation materials, or at their locus of growth with compounds of formula I or their mixtures selected from endosulfan, ethiprole and fipronil, wherein the plant is a plant, which is listed in table 12.

In a more preferred embodiment, the present invention relates to a method of controlling harmful insects and/or increasing the health of cultivated plants by treating plant propagation materials, preferably seeds with compounds of formula I or their mixtures selected from endosulfan, ethiprole and fipronil, wherein the plant corresponds to row of table 12.

In another more preferred embodiment, the present invention relates to a method of controlling harmful insects and/or increasing the health of cultivated plants by treating cultivated plants, parts of such plants or at their locus of growth with compounds of formula I or their mixtures selected from endosulfan, ethiprole and fipronil, wherein the plant corresponds to row of table 12.

In a most preferred embodiment, the present invention relates to a method of controlling harmful insects and/or increasing the health of plants by treating cultivated plants, parts of such plants or at their locus of growth with compounds of formula I or their mixtures, wherein the plant corresponds to a row of table 12 and the mixing partner of the compound of formula lis endosulfan.

In a most preferred embodiment, the present invention relates to a method of controlling harmful insects and/or increasing the health of plants by treating plant propagation materials, preferably seeds of cultivated plants of cultivated crops with compounds of formula I or their mixtures, wherein the plant corresponds to a row of table 12 and the mixing partner of the compound of formula lis endosulfan.

TABLE 12

| | detailed | | |
|---|---|---|---|
| No | description | plant | Literature |
| T12-1 | male sterility | canola | U.S. Pat. No. |
| | | | 6,720,481 |
| T12-2 | male sterility | maize | A*, B*, C* |
| T12-3 | male sterility | rice | B*, EP1135982 |
| T12-4 | male sterility | soybean | B*, C*, |
| | | | WO1996040949 |
| T12-5 | male sterility | sunflower | C* |
| T12-6 | male sterility | tomato | U.S. Pat. No. |
| | | | 7,345,222 |
| T12-7 | male sterility | wheat | B* |
| T12-8 | male sterility2)/MS1, | B. napus 4) | AVC 1) |
| | RF1 => PGS1 | | |
| T12-9 | male sterility2)/MS1, | B. napus 4) | AVC 1) |
| | RF2 => PGS2 | | |
| T12-10 | male sterility2)/MS8xRF3 | B. napus 4) | BCS 5) |
| T12-11 | male sterility3)/PHY14, | B. napus 4) | AVC 1) |
| | PHY35 | | |
| T12-12 | male sterility3)/PHY36 | B. napus 4) | AVC 1) |

A* refers to U.S. Pat. No. 6,281,348, U.S. Pat. No. 6,399,856, U.S. Pat. No. 7,230,168, U.S. Pat. No. 6,072,102./
B* refers to WO2001062889.
C* refers to WO1996040949.
1) Aventis Crop Science (formerly Plant Genetic Systems)/
5) Bayer CropScience (Aventis CropScience(AgrEvo)/
2)Male-sterility, fertility restoration, pollination control system displaying glufosinate herbicide tolerance. MS lines contained the barnase gene from Bacillus amyloliquefaciens, RF lines contained the barstar gene from the same bacteria, and both lines contained the phosphinothricin N-acetyltransferase (PAT) encoding gene from Streptomyces hygroscopicus.
3)Male sterility was via insertion of the barnase ribonuclease gene from Bacillus amyloliquefaciens; fertility restoration by insertion of the barstar RNase inhibitor; PPT resistance was via PPT-acetyltransferase (PAT) from Streptomyces hygroscopicus.
4) Brassica napus (Argentine Canola)

In a further one preferred embodiment, the present invention relates to a method of controlling harmful insects and/or increasing the health of cultivated plants by treating cultivated plants, parts of such plants, plant propagation materials, or at their locus of growth with compounds of formula I or their mixtures selected from endosulfan, ethiprole and fipronil, wherein the plant is resistant to antibiotics, more referably resistant to kanamycin, neomycin and ampicillin, most preferably resistant to kanamycin.

In a more preferred embodiment, the present invention relates to a method of controlling harmful insects and/or increasing the health of cultivated plants by treating cultivated plants, parts of such plants, plant propagation materials, or at their locus of growth with compounds of formula I or their mixtures selected from endosulfan, ethiprole and fipronil, wherein the plant is a plant corresponding to a row of table 13.

In a more preferred embodiment, the present invention relates to a method of controlling harmful insects and/or increasing the health of cultivated plants by treating plant propagation materials, preferably seeds with compounds of formula I or their mixtures selected from endosulfan, ethiprole and fipronil, wherein the plant corresponds to a row of table 13.

In another more preferred embodiment, the present invention relates to a method of controlling harmful insects and/or increasing the health of cultivated plants by treating cultivated plants, parts of such plants or at their locus of growth with compounds of formula I or their mixtures selected from endosulfan, ethiprole and fipronil, wherein the plant corresponds to a row of table 13.

In another more preferred embodiment, the present invention relates to a method of controlling harmful insects and/or increasing the health of cultivated plants by treating cultivated plants, parts of such plants or their locus of growth with a compound of formula I, which is selected from the compounds I-1 to I-40 as defined in Table C, wherein the plant corresponds to a row of table 13. In this embodiment the compound of formula I is more specifically selected from compounds I-11, I-16, I-21, I-26, I-31 which are defined in accordance with Table C of the example section.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 13, wherein the compound of formula I is compound I-11.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 13, wherein the compound of formula I is compound I-16.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 13, wherein the compound of formula I is compound I-26.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 136, wherein the compound of formula I is compound I-31.

In a most preferred embodiment, the present invention relates to a method of controlling harmful insects and/or increasing the health of plants by treating cultivated plants, parts of such plants or at their locus of growth with compounds of formula I or their mixtures, wherein the plant corresponds to a row of table 13 and the mixing partner of the compound of formula lis endosulfan. In another most preferred embodiment, the present invention relates to a method of controlling harmful insects and/or increasing the health of plants by treating cultivated plants, parts of such plants or at their locus of growth with compounds of formula I or their mixtures, wherein the plant corresponds to a row of table 13 and the mixing partner of the compound of formula lis ethiprole.

In another most preferred embodiment, the present invention relates to a method of controlling harmful insects and/or increasing the health of plants by treating cultivated plants, parts of such plants or at their locus of growth with compounds of formula I or their mixtures, wherein the plant corresponds to a row of table 13 and the mixing partner of the compound of formula lis fipronil.

In a most preferred embodiment, the present invention relates to a method of controlling harmful insects and/or increasing the health of plants by treating plant propagation materials, preferably seeds of cultivated plants of cultivated crops with compounds of formula I or their mixtures, wherein the plant corresponds to a row of table 13 and the mixing partner of the compound of formula lis endosulfan.

In another most preferred embodiment, the present invention relates to a method of controlling harmful insects and/or increasing the health of plants by treating plant propagation materials, preferably seeds of cultivated plants of cultivated crops with compounds of formula I or their mixtures, wherein the plant corresponds to a row of table 13 and the mixing partner of the compound of formula lis ethiprole.

In another most preferred embodiment, the present invention relates to a method of controlling harmful insects and/or increasing the health of plants by treating plant propagation materials, preferably seeds of cultivated plants of cultivated crops with compounds of formula I or their mixtures, wherein the plant corresponds to a row of table 13 and the mixing partner of the compound of formula lis fipronil.

In a utmost preferred embodiment, the present invention relates to a method of controlling harmful insects and/or increasing the health of plants by treating cultivated plants, parts of such plants or at their locus of growth with compounds of formula I or their mixtures, wherein the plant is T13-2, T13-4 and the mixing partner of the compound of formula lis endosulfan. In another utmost preferred embodiment, the present invention relates to a method of controlling harmful insects and/or increasing the health of plants by treating cultivated plants, parts of such plants or at their locus of growth with compounds of formula I or their mixtures, wherein the plant is T13-2, T13-4 and the mixing partner of the compound of formula lis ethiprole.

In another utmost preferred embodiment, the present invention relates to a method of controlling harmful insects and/or increasing the health of plants by treating cultivated plants, parts of such plants or at their locus of growth with compounds of formula I or their mixtures, wherein the plant is T13-2, T13-4 and the mixing partner of the compound of formula lis fipronil.

In a utmost preferred embodiment, the present invention relates to a method of controlling harmful insects and/or increasing the health of plants by treating plant propagation materials, preferably seeds of cultivated plants of cultivated crops with compounds of formula I or their mixtures, wherein the plant is T13-2, T13-4 and the mixing partner of the compound of formula lis endosulfan.

In another utmost preferred embodiment, the present invention relates to a method of controlling harmful insects and/or increasing the health of plants by treating plant propagation materials, preferably seeds of cultivated plants of cultivated crops with compounds of formula I or their mixtures, wherein the plant is T13-2, T13-4 and the mixing partner of the compound of formula lis ethiprole.

In another utmost preferred embodiment, the present invention relates to a method of controlling harmful insects and/or increasing the health of plants by treating plant propagation materials, preferably seeds of cultivated plants of cultivated crops with compounds of formula I or their mixtures, wherein the plant is T13-2, T13-4 and the mixing partner of the compound of formula lis fipronil.

TABLE 13

| | detailed | | Literature/ |
|---|---|---|---|
| No | description | plant | commercial plants |
| T13-1 | kanamycin resistance | canola | A* |
| T13-2 | kanamycin resistance | cotton | A* |
| T13-3 | kanamycin resistance | flax | A* |
| T13-4 | kanamycin resistance | maize | A* |
| T13-5 | kanamycin resistance | oilseed rape | A* |
| T13-6 | kanamycin resistance | potato | A* |
| T13-7 | kanamycin resistance | rape seed | A* |
| T13-8 | kanamycin resistance | sugar beet | A* |
| T13-9 | kanamycin resistance | tomato | A*, B* |

A* refers to Plant Cell Reports, 20, 2001, 610-615. Trends in Plant Science, 11, 2006, 317-319. Plant Molecular Biology, 37, 1998, 287-296. Mol Gen Genet., 257, 1998, 606-13.
B* refers to Plant Cell Reports, 6, 1987, 333-336.

In a further preferred embodiment, the present invention relates to a method of controlling harmful insects and/or increasing the health of cultivated plants by treating cultivated plants, parts of such plants, plant propagation materials, or at their locus of growth with a compound of formula I and a mixture partner selected from endosulfan, ethiprole and fipronil, wherein the plant has the trait of improved fiber quality.

In a more preferred embodiment, the present invention relates to a method of controlling harmful insects and/or increasing the health of cultivated plants by treating cultivated plants, parts of such plants, plant propagation materials, or at their locus of growth with a compound of formula I and a mixture partner selected from endosulfan, ethiprole and fipronil, wherein the plant is a cotton plant comprising the DP 104 B2RF event (“DP 104 B2RF-A new early maturing B2RF variety” presented at 2008 Beltwide Cotton Conferences by Tom R. Speed, Richard Sheetz, Doug Shoemaker, Monsanto/Delta and Pine Land, see http://www.monsanto.com/pdf/beltwide_{—}08/dp104b2rf_doc.pdf.

In a further more preferred embodiment, the present invention relates to a method of controlling harmful insects and/or increasing the health of cultivated plants by treating cultivated plants, parts of such plants, plant propagation materials, or at their locus of growth with a compound of formula I and a mixture partner selected from endosulfan, ethiprole and fipronil, wherein the plant is a transgenic plant, which has two traits stacked, more preferably two or more traits selected from the group consisting of herbicide tolerance, insect resistance, fungal resistance, viral resistance, bacterial resistance, stress tolerance, maturation alteration, content modification and modified nutrient uptake, most preferably the combination of herbicide tolerance and insect resistance, two herbicide tolerances, herbicide tolerance and stress tolerance, herbicide tolerance and modified content, two herbicide tolerances and insect resistance, herbicide tolerance, insect resistance and stress tolerance, herbicide tolerance, insect resistance and modified content.

In a more preferred embodiment, the present invention relates to a method of controlling harmful insects and/or increasing the health of cultivated plants by treating plant propagation materials, preferably seeds with compounds of formula I or their mixtures selected from endosulfan, ethiprole and fipronil, wherein the plant corresponds to a row of table 14.

In another more preferred embodiment, the present invention relates to a method of controlling harmful insects and/or increasing the health of cultivated plants by treating cultivated plants, parts of such plants or their locus of growth with a compound of formula I, which is selected from the compounds I-1 to I-40 as defined in Table C, wherein the plant corresponds to a row of table 14. In this embodiment the compound of formula I is more specifically selected from compounds I-11, I-16, I-21, I-26, I-31 which are defined in accordance with Table C of the example section.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 14, wherein the compound of formula I is compound I-11.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 14, wherein the compound of formula I is compound I-16.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 14, wherein the compound of formula I is compound I-26.

In a most preferred embodiment, the present invention relates to a method of controlling harmful insects and/or increasing the health of plants by treating cultivated plants, parts of such plants or their locus of growth with compounds of formula I, wherein the plant corresponds to a row of table 14, wherein the compound of formula I is compound I-31.

In another more preferred embodiment, the present invention relates to a method of controlling harmful insects and/or increasing the health of cultivated plants by treating cultivated plants, parts of such plants or at their locus of growth with compounds of formula I or their mixtures selected from endosulfan, ethiprole and fipronil, wherein the plant corresponds to a row of table 14.

In another most preferred embodiment, the present invention relates to a method of controlling harmful insects and/or increasing the health of plants by treating cultivated plants, parts of such plants or at their locus of growth with compounds of formula I or their mixtures, wherein the plant corresponds to a row of table 14 and the mixing partner of the compound of formula lis fipronil.

In another most preferred embodiment, the present invention relates to a method of controlling harmful insects and/or increasing the health of plants by treating plant propagation materials, preferably seeds of cultivated plants of cultivated crops with compounds of formula I or their mixtures, wherein the plant corresponds to a row of table 14 and the mixing partner of the compound of formula lis fipronil.

In another utmost preferred embodiment, the present invention relates to a method of controlling harmful insects and/or increasing the health of plants by treating cultivated plants, parts of such plants or at their locus of growth with compounds of formula I or their mixtures, wherein the plant is selected from T14-1, T14-2, T14-3, T14-4, T14-5, T14-6, T14-7, T14-8, T14-9, T14-10, T14-11, T14-12, T14-13, T14-14, T14-15, T14-17, T14-23, T14-24, T14-25, T14-26, T14-31, T14-36 and T14-37 and the mixing partner of the compound of formula lis fipronil.

In a utmost preferred embodiment, the present invention relates to a method of controlling harmful insects and/or increasing the health of plants by treating plant propagation materials, preferably seeds of cultivated plants of cultivated crops with compounds of formula I or their mixtures, wherein the plant is selected from T14-1, T14-2, T14-3, T14-4, T14-5, T14-6, T14-7, T14-8, T14-9, T14-10, T14-11, T14-12, T14-13, T14-14, T14-15, T14-17, T14-23, T14-24, T14-25, T14-26, T14-31, T14-36 and T14-37 and the mixing partner of the compound of formula lis endosulfan.

TABLE 14

| | detailed | | Literature/ |
|---|---|---|---|
| No | description/Event | plant | commercial plants |
| T14-1 | corn borer resistance + glyphosate | maize | “YieldGard Roundup Ready”, |
| | tolerance | | YieldGard Roundup Ready |
| | | | 2” (Monsanto) |
| T14-2 | corn borer resistance + glufosinate | maize | “Agrisure CB/LL” (Syntenta) |
| | tolerance | | |
| T14-3 | glyphosate tolerance + corn rootworm | maize | “Yield Gard VT Rootworm/RR2” |
| | resistance | | |
| T14-4 | glyphosate tolerance + corn rootworm/ | maize | “Yield Gard VT Triple” |
| | corn borer resistance | | |
| T14-5 | glufosinate tolerance + LPn resistance | maize | “Herculex I” |
| | (Cry1F; western bean cutworm, | | |
| | corn borer, black cutworm, fall | | |
| | armyworm resistance) | | |
| T14-6 | glyphosate tolerance + corn rootworm | maize | “YieldGard Corn Rootworm/ |
| | resistance | | Roundup Ready 2” (Monsanto) |
| T14-7 | glyphosate tolerance + gluphosinate | maize | “Herculex I/Roundup Ready 2”; |
| | tolerance + LPn resistance (Cry1F; | | |
| | western bean cutworm, corn borer, | | |
| | black cutworm, fall armyworm re- | | |
| | sistance) | | |
| T14-8 | glyphosate tolerance + corn rootworm | maize | “YieldGard Plus/Roundup |
| | resistance + corn borer resistance | | Ready 2” (Monsanto) |
| T14-9 | gluphosinate tolerance + LPn | maize | “Agrisure GT/RW” |
| | resistance (Cry3A; western corn | | (Syngenta) |
| | rootworm, northern corn rootworm, | | |
| | Mexican corn rootworm resistance) | | |
| T14-10 | glyphosate tolerance + gluphosinate | maize | “Agrisure GT/CB/LL” |
| | tolerance + corn borer resistance | | (Syngenta) |
| T14-11 | glufosinate tolerance + LPn resistance | maize | “Herculex RW” |
| | (Cry34/35Ab1; western corn rootworm, | | (Dow, Pioneer) |
| | northern corn rootworm, Mexican corn | | |
| | rootworm resistance) | | |
| T14-12 | glufosinate tolerance + LPn resistance | maize | “Herculex Xtra” |
| | (Cry1F + Cry34/35Ab1; western corn | | (Dow, Pioneer) |
| | rootworm, northern corn rootworm, | | |
| | Mecxican corn rootworm, western bean | | |
| | cutworm, corn borer, black cutworm, | | |
| | fall armyworm resistance) | | |
| T14-13 | glyphosate tolerance + glufosinate | maize | ,,Herculex Quad-Stack” |
| | tolerance + corn borer resistance + | | |
| | corn rootworm resistance | | |
| T14-14 | glyphosate tolerance + corn rootworm | maize | “Yield Gard VT |
| | resistance | | Rootworm/RR2” |
| T14-15 | glufosinate tolerance + corn borer | maize | “Agrisure CB/LL/RW” |
| | resistance (Cry1Ab) + LPn resistance 3) | | (Syngenta) |
| T14-16 | glyphosate tolerance + corn borer | maize | “Agrisure 3000GT” |
| | resistance (Cry1Ab) + LPn resistance 3) | | (Syngenta) |
| T14-17 | glyphosate tolerance + resistance to | maize | ,,Mavera high-value corn” |
| | corn borer and corn rootworm + high | | (Monsanto) |
| | lysine content | | |
| T14-18 | glyphosate tolerance + ALS herbicide | soy-bean | “Optimum GAT” (DuPont, |
| | tolerance (F*) | | Pioneer) |
| T14-19 | glyphosate tolerance + LP resistance | soy-bean | A*, U.S. Pat. No. 7,432,421 |
| | (Bt) | | |
| T14-20 | glyphosate tolerance + Dicamba | soy-bean | A*, U.S. Pat. No. 7,105,724 |
| | tolerance | | |
| T14-21 | glyphosate tolerance + modified oil | soy-bean | A*, G* |
| | content | | |
| T14-22 | glufosinate tolerance + modified oil | soy-bean | G*, I* |
| | content | | |
| T14-23 | glyphosate tolerance + dicamba | cotton | A*, U.S. Pat. No. 7,105,724, |
| | tolerance | | WO2008051633 |
| T14-24 | glufosinate tolerance + LPn resistance | cotton | D*, U.S. Pat. No. 5,646,024, |
| | | | U.S. Pat. No. 5,561,236 |
| T14-25 | glyphosate tolerance + LPn resistance | cotton | A*, D* |
| T14-26 | glufosinate tolerance + dicamba | cotton | U.S. Pat. No. 5,646,024, |
| | tolerance | | U.S. Pat. No. 5,561,236, |
| | | | U.S. Pat. No. 7,105,724, |
| | | | WO2008051633 |
| T14-27 | glyphosate tolerance + improved | cotton | A*, E* |
| | fiber quality | | |
| T14-28 | glufosinate tolerance + improved | cotton | E*, U.S. Pat. No. 5,646,024, |
| | fiber quality | | U.S. Pat. No. 5,561,236 |
| T14-29 | glyphosate tolerance + drought | cotton | A*, C* |
| | tolerance | | |
| T14-30 | glyphosate tolerance + dicamba | cotton | A*, C*, U.S. Pat. No. 7,105,724, |
| | tolerance + drought tolerance | | WO 2008/051633 |
| T14-31 | glufosinate tolerance + insect | cotton | D*, U.S. Pat. No. 5,646,024, |
| | resistance (tobacco budworm, cotton | | U.S. Pat. No. 5,561,236 |
| | bollworm, fall armyworm, beet | | |
| | armyworm, cabbage looper, soybean | | |
| | lopper, pink bollworm resistance) | | |
| T14-32 | glyphosate tolerance + modified oil | canola | A*, U.S. Pat. No. 5,850,026, |
| | content | | U.S. Pat. No. 6,441,278, |
| | | | U.S. Pat. No. 5,723,761, |
| | | | WO 2005/033319 |
| T14-33 | glufosinate tolerance + modified oil | canola | U.S. Pat. No. 5,646,024, |
| | content | | U.S. Pat. No. 5,561,236, |
| | | | U.S. Pat. No. 5,850,026, |
| | | | U.S. Pat. No. 6,441,278, |
| | | | U.S. Pat. No. 5,723,761, |
| | | | WO 2005/033319 |
| T14-34 | glyphosate tolerance + insect resistance | canola | D*, A* |
| T14-35 | glufosinate tolerance + insect resistance | canola | D*, U.S. Pat. No. 5,646,024, |
| | | | U.S. Pat. No. 5,561,236 |
| T14-36 | IMI tolerance + Coleoptera resistance | rice | B*, WO 2001/021821 |
| T14-37 | IMI tolerance + LP resistance | rice | B*, WO 2001/021821 |
| T14-38 | IMI tolerance + modified oil content | sun-flower | Tan et. al, Pest Manag. Sci |
| | | | 61, 246-257 (2005). |
| T14-39 | Coleoptera resistance, + Kanamycin | potato | H* |
| | resistance | | |
| T14-40 | Coleoptera resistance, + Kanamycin | potato | H* |
| | resistance + potato leaf roll | | |
| | virus resistance | | |
| T14-41 | Coleoptera resistance, + Kanamycin | potato | H* |
| | resistance + potato leaf roll | | |
| | virus resistance | | |
| T14-42 | Glyphosate tolerance and ALH- | Glycine max L. | available, Pioneer Hi-Bred |
| | inhibitor tolerance/DP356043 | | International Inc. |
| T14-43 | Glyphosate tolerance and ALS- | Zea mays L. | available, Pioneer Hi-Bred |
| | inhibitor/Event 98140tolerance | | International Inc. |
| T14-44 | LP resistance and enhanced lysine | Zea mays L. | available, Monsanto |
| | content/MON-ØØ81Ø-6 × LY038 | | Company |
| T14-45 | Corn root worm resistance and EPC/ | Zea mays L. | available, Monsanto |
| | MON863 × MON810 (MON-ØØ863- | | Company |
| | 5, MON- ØØ81Ø-6)resistance | | |
| T14-46 | EPC resistance and enhanced lysine | Zea mays L. | available, Monsanto |
| | level/MON810 × LY038 | | Company |
| T14-47 | Glyphosate tolerance and LPn resistance/ | Gossypium | available, Monsanto |
| | MON-ØØ531-6 × MON-Ø1445-2 | hirsutum L. | Company |
| | | (cotton) | |
| T14-48 | Glufosinate ammonium tolerance | Gossypium | available, Bayer |
| | and LPn resistance/LLCotton25 × | hirsutum L. | CropScience (Aventis |
| | MON15985 | (cotton) | CropScience(AgrEvo)) |
| T14-49 | Glyphosate tolerance and LPn | Gossypium | available, DOW AgroSciences |
| | resistance/DAS-21Ø23-5 × DAS- | hirsutum L. | LLC and Pioneer Hi-Bred |
| | 24236-5 × MON88913 (DAS-24236- | (cotton) | International Inc. |
| | 5, DAS-21Ø23-5, MON-88913-8) | | |
| T14-50 | Glyphosate tolerance and LPn resistance/ | Gossypium | available, Monsanto |
| | MON15985 × MON88913 (MON-15985-7, | hirsutum L. | Company |
| | MON-88913-8) | (cotton) | |
| T14-51 | Glyphosate tolerance and LPn resistance/ | Gossypium | available, Monsanto |
| | MON-15985-7 × MON-Ø1445-2 | hirsutum L. | Company |
| | | (cotton) | |
| T14-52 | Oxynil tolerance and LPn resistance/ | Gossypium | available, Calgene Inc. |
| | 31807/31808 | hirsutum L. | |
| | | (cotton) | |
| T14-53 | Glyphosate tolerance and LPn | Gossypium | available, DOW |
| | resistance/DAS-21Ø23-5 × DAS- | hirsutum L. | AgroSciences LLC |
| | 24236-5 × MON-Ø1445-2 | (cotton) | |
| T14-54 | Glufosinate tolerance and | Zea mays L. | available, DOW AgroSciences |
| | Coleoptera and LP resistance/ | | LLC and Pioneer Hi-Bred |
| | TC1507 × DAS-59122-7 (DAS- | | International Inc. |
| | Ø15Ø7-1, DAS-59122-7) | | |
| T14-55 | Glyphosate tolerance and | Zea mays L. | available, Monsanto |
| | Coleoptera and LP resistance/ | | Company |
| | MON810 × MON88017 | | |
| T14-56 | Glyphosate tolerance and Coleoptera | Zea mays L. | available, Monsanto |
| | and LP resistance/MON89034 × | | Company |
| | MON88017 (MON-89Ø34-3, MON- | | |
| | 88Ø17-3) | | |
| T14-57 | Glyphosate tolerance and | Zea mays L. | available, DOW AgroSciences |
| | Glufosinate ammonium tolerance | | LLC and Pioneer Hi-Bred |
| | and Coleoptera and LP resistance/ | | International Inc. |
| | DAS-59122-7 × TC1507 × NK603 | | |
| T14-58 | Glufosinate ammonium tolerance | Zea mays L. | available, Syngenta Seeds, |
| | and Coleoptera resistance/BT11 × | | Inc. |
| | MIR604 (SYN-BTØ11-1, SYN- | | |
| | IR6Ø4-5) | | |
| T14-59 | Glyphosate tolerance and Coleoptera | Zea mays L. | available, DOW AgroSciences |
| | resistance/DAS-59 122-7 × NK603 | | LLC and Pioneer Hi-Bred |
| | | | International Inc. |
| T14-60 | Glyphosate tolerance and Coleoptera | Zea mays L. | available, Syngenta Seeds, |
| | resistance/MIR604 × GA21 | | Inc. |
| T14-61 | Glyphosate tolerance and Coleoptera | Zea mays L. | available, Monsanto |
| | resistance/MON863 × NK603 | | Company |
| | (MON-ØØ863-5, MON-ØØ6Ø3-6 | | |
| T14-62 | Glyphosate tolerance and | Zea mays L. | available, Monsanto |
| | Coleoptera resistance and LP | | Company |
| | resistance/MON863 × MON810 × | | |
| | NK603 | | |
| T14-63 | Glufosinate ammonium tolerance | Zea mays L. | available, DOW AgroSciences |
| | and Corn root worm resistance/ | | LLC and Pioneer Hi-Bred |
| | DAS-59122-7 | | International Inc. |
| T14-64 | Glyphosate tolerance and Corn root | Zea mays L. | available, Monsanto |
| | worm resistance/MON88017 | | Company |
| T14-65 | Glufosinate ammonium tolerance | Zea mays L. | available, Dow AgroSciences |
| | and Corn root worm resistance/ | | |
| | DAS-59122-7 | | |
| T14-66 | Glufosinate ammonium tolerance | Zea mays L. | available, Syngenta Seeds, |
| | and EPC resistance/BT11 | | Inc. |
| | (X4334CBR, X4734CBR) | | |
| T14-67 | Glufosinate ammonium tolerance | Zea mays L. | available, Aventis |
| | and EPC resistance/CBH-351 | | CropScience |
| T14-68 | Glufosinate ammonium tolerance | Zea mays L. | available, Dekalb Genetics |
| | and EPC resistance/DBT418 | | Corporation |
| T14-69 | Glufosinate ammonium tolerance | Zea mays L. | available, Mycogen (c/o Dow |
| | and EPC resistance/TC1507 | | AgroSciences); Pioneer (c/o |
| | | | Dupont) |
| T14-70 | Glyphosate tolerance and EPC | Zea mays L. | available, Monsanto |
| | resistance/MON802 | | Company |
| T14-71 | Glyphosate tolerance and EPC | Zea mays L. | available, Pioneer Hi-Bred |
| | resistance/MON809 | | International Inc. |
| T14-72 | Glufosinate ammonium tolerance | Zea mays L. | available, Syngenta Seeds, |
| | and LPn resistance/BT11 × MIR162 | | Inc. |
| | (SYN-BTØ11-1, SYN-IR162-49 | | |
| T14-73 | Glufosinate ammonium tolerance | Zea mays L. | available, DOW |
| | and LPn resistance/DAS-06275-8 | | AgroSciences LLC |
| T14-74 | Glufosinate ammonium tolerance | Zea mays L. | available, Syngenta Seeds, |
| | and Glyphosate tolerance and LP | | Inc. |
| | resistance/BT11 × GA21 (SYN- | | |
| | BTØ11-1, MON-ØØØ21-9) | | |
| T14-75 | Glufosinate ammonium tolerance | Zea mays L. | available, Syngenta Seeds, |
| | and Glyphosate tolerance and LP | | Inc. |
| | resistance/BT11 × MIR604 × GA21 | | |
| | (SYN-BTØ11-1, SYN-IR6Ø4-5, | | |
| | MON-ØØØ21-9) | | |
| T14-76 | Glufosinate ammonium tolerance | Zea mays L. | available, DOW |
| | and Glyphosate tolerance and LP | | AgroSciences LLC |
| | resistance/TC1507 × NK603 (DAS- | | |
| | Ø15Ø7-1 × ØØ6Ø3-6)MON- | | |
| T14-77 | Glyphosate tolerance and LPn | Zea mays L. | available, Monsanto |
| | resistance/GA21 × MON810 | | Company |
| T14-78 | Glyphosate tolerance and LPn | Zea mays L. | available, Monsanto |
| | resistance/MON89034 × NK603 | | Company |
| | (MON-89Ø34-3, MON- ØØ6Ø3-6) | | |
| T14-79 | Glyphosate tolerance and LPn | Zea mays L. | available, Monsanto |
| | resistance/NK603 × MON810 (MON- | | Company |
| | ØØ6Ø3-6, MON-ØØ81Ø-6) | | |
| T14-80 | Glufosinate ammonium tolerance | Zea mays L. | available, Bayer |
| | and LPn resistance/T25 × MON810 | | CropScience (Aventis |
| | (ACS-ZMØØ3-2, MON-ØØ81Ø-6) | | CropScience(AgrEvo)) |
| T14-81 | Gluphosinate tolerance and male | Brassica napus | available, Bayer |
| | sterility/MS1, RF1 (PGS1) | | CropScience (Aventis |
| | | | CropScience(AgrEvo)) |
| T14-82 | Gluphosinate tolerance and male | Brassica napus | available, Aventis |
| | sterility/MS1, RF2 (PGS2) | | CropScience (formerly |
| | | | Plant Genetic Systems) |
| T14-83 | Gluphosinate tolerance and male | Brassica napus | available, Bayer |
| | sterility/MS8xRF3 | | CropScience (Aventis |
| | | | CropScience(AgrEvo)) |
| T14-84 | Gluphosinate tolerance and male | Zea mays L. | available, Bayer |
| | sterility/MS3 (ACS-ZMØØ1-9) | | CropScience (Aventis |
| | | | CropScience(AgrEvo)) |
| T14-85 | Gluphosinate tolerance and male | Zea mays L. | available, Bayer |
| | sterility/MS6 (ACS-ZMØØ5-4) | | CropScience (Aventis |
| | | | CropScience(AgrEvo)) |
| T14-86 | glyphosate tolerance and high oleic | Glycine max L. | available, Pioneer Hi-Bred |
| | acid content/305423 × 40-3-2 | | |
| T14-87 | coloration and sulfonylurea herbicide | D. caryophyllus | available, Florigene Pty Lt |
| | tolerance/4, 11, 15, 16 | | |
| T14-88 | coloration and sulfonylurea herbicide | D. caryophyllus | available, Florigene Pty Lt |
| | tolerance/959A, 988A, , 1363A, | | |
| | 1400A 1226A, 1351A | | |
| T14-89 | Increased shelf-life and sulfonylurea | D. caryophyllus | available, Florigene Pty Lt |
| | herbicide tolerance/66 | | |

*) Glycine max L. (soybean), Zea mays L. (corn, maize), Brassica napus (Argentine canola), D. caryophyllus = Dianthus caryophyllus (carnation)
**) European corn borer = EPC, Lepidoptera LP, Lepidopteran LPn, Glyphosate tolerance = GLY-T
A* refers to U.S. Pat. No. 5,188,642, U.S. Pat. No. 4,940,835, U.S. Pat. No. 5,633,435, U.S. Pat. No. 5,804,425 and U.S. Pat. No. 5,627,061.
B* refers to imidazolinone-herbicide resistant rice plants with specific mutation of the acetohydroxyacid synthase gene: S653N (see e.g. US 2003/0217381), S654K (see e.g. US 2003/0217381), A122T (see e.g. WO 2004/106529) S653(At)N, S654(At)K, A122(At)T and other resistant rice plants as described in WO 2000/27182, WO 2005/20673 and WO 2001/85970 or U.S. Patents U.S. Pat. No. 5,545,822, U.S. Pat. No. 5,736,629, U.S. Pat. No. 5,773,703, U.S. Pat. No. 5,773,704, U.S. Pat. No. 5,952,553, U.S. Pat. No. 6,274,796, wherein plants with mutation S653A and A122T are most preferred.
C* referes to WO 2000/04173, WO 2007/131699, US 20080229448 and WO 2005/48693.
D* refers to WO 1993/07278 and WO 1995/34656.
E* refers to WO 1996/26639, U.S. Pat. No. 7,329,802, U.S. Pat. No. 6,472,588 and WO 2001/17333.
(F*) refers to sulfonylurea and imidazolinone herbicides, such as imazamox, imazethapyr, imazaquin, chlorimuron, flumetsulam, cloransulam, diclosulam and thifensulfuron.
G* refers to U.S. Pat. No. 6,380,462, U.S. Pat. No. 6,365,802, U.S. Pat. No. 7,294,759 and U.S. Pat. No. 7,157,621.
H* refers to Plant Cell Reports, 20, 2001, 610-615. Trends in Plant Science, 11, 2006, 317-319. Plant Molecular Biology, 37, 1998, 287-296. Mol Gen Genet., 257, 1998, 606-13. Federal Register (USA), Vol. 60, No. 113, 1995, page 31139. Federal Register (USA), Vol. 67, No. 226, 2002, page 70392. Federal Register (USA), Vol. 63, No. 88, 1998, page 25194. Federal Register (USA), Vol. 60, No. 141, 1995, page 37870. Canadian Food Inspection Agency, FD/OFB-095-264-A, October 1999, FD/OFB-099-127-A, October 1999.
I* refers to Federal Register (USA), Vol. 61, No. 160, 1996, page 42581. Federal Register (USA), Vol. 63, No. 204, 1998, page 56603.
3) (Cry3A; western corn rootworm, northern corn rootworm, Mexican corn rootworm resistance)

In a more preferred embodiment, the present invention relates of methods of controlling harmful insects and/or increasing the health of plants by treating cultivated plants, parts of such plants or at their locus of growth with compounds of formula I or their mixtures, wherein the plant is selected from the plants listed in table A and the mixing partner of the compound of formula I compound is endosulfan.

In a more preferred embodiment, the present invention relates of methods of controlling harmful insects and/or increasing the health of plants by treating cultivated plants, parts of such plants or at their locus of growth with compounds of formula I or their mixtures, wherein the plant is selected from the plants listed in table A and the mixing partner of the compound of formula I compound is ethiprole.

In a more preferred embodiment, the present invention relates of methods of controlling harmful insects and/or increasing the health of plants by treating cultivated plants, parts of such plants or at their locus of growth with compounds of formula I or their mixtures, wherein the plant is selected from the plants listed in table A and the mixing partner of the compound of formula I compound is fipronil.

Another preferred embodiment of the invention are those methods of controlling harmful insects and/or increasing the health of plants by treating cultivated plants, parts of such plants or at their locus of growth with compounds of formula I or their mixtures, wherein the plant is a transgenic plant which is selected from the plants listed in table B.

In a more preferred embodiment, the present invention relates of methods of controlling harmful insects and/or increasing the health of plants by treating cultivated plants, parts of such plants or at their locus of growth with compounds of formula I or their mixtures, wherein the plant is selected from the plants listed in table B and the mixing partner of the compound of formula I compound is endosulfan.

In a more preferred embodiment, the present invention relates of methods of controlling harmful insects and/or increasing the health of plants by treating cultivated plants, parts of such plants or at their locus of growth with compounds of formula I or their mixtures, wherein the plant is selected from the plants listed in table B and the mixing partner of the compound of formula I compound is ethiprole.

In a more preferred embodiment, the present invention relates of methods of controlling harmful insects and/or increasing the health of plants by treating cultivated plants, parts of such plants or at their locus of growth with compounds of formula I or their mixtures, wherein the plant is selected from the plants listed in table B and the mixing partner of the compound of formula I compound is fipronil.

In another preferred embodiment, the present invention relates of methods of controlling harmful insects and/or increasing the health of plants by treating cultivated plants, parts of such plants or at their locus of growth with compounds of formula I or their mixtures, wherein the plant is selected from B-3, B-4, B-5, B-7, B-8, B-11, B-23, B-28, B-29, B-30, B-39, B-42, B-44, B46, B-47, B-55, B-59, B-61, B-63, B-64, B-69, B-70, B-71 of table B.

In a most preferred embodiment, the present invention relates of methods of controlling harmful insects and/or increasing the health of plants by treating cultivated plants, parts of such plants or at their locus of growth with compounds of formula I or their mixtures, wherein the plant is selected from B-3, B-4, B-5, B-7, B-8, B-11, B-23, B-28, B-29, B-30, B-39, B-42, B-44, B-46, B47, B-55, B-59, B-61, B-63, B-64, B-69, B-70, B-71 of table B and the mixing partner of the compound of formula I compound is endosulfan.

In a most preferred embodiment, the present invention relates of methods of controlling harmful insects and/or increasing the health of plants by treating cultivated plants, parts of such plants or at their locus of growth with compounds of formula I or their mixtures, wherein the plant is selected from B-3, B-4, B-5, B-7, B-8, B-11, B-23, B-28, B-29, B-30, B-39, B-42, B-44, B-46, B47, B-55, B-59, B-61, B-63, B-64, B-69, B-70, B-71 of table B and the mixing partner of the compound of formula I compound is ethiprole.

In a most preferred embodiment, the present invention relates of methods of controlling harmful insects and/or increasing the health of plants by treating cultivated plants, parts of such plants or at their locus of growth with compounds of formula I or their mixtures, wherein the plant is selected from B-3, B-4, B-5, B-7, B-8, B-11, B-23, B-28, B-29, B-30, B-39, B-42, B-44, B-46, B47, B-55, B-59, B-61, B-63, B-64, B-69, B-70, B-71 of table B and the mixing partner of the compound of formula I compound is fipronil.

Further preferred embodiments of the invention are those methods of controlling harmful insects and/or increasing the health of plants by treating cultivated plants, parts of such plants or at their locus of growth with compounds of formula I or their mixtures, wherein the plant expresses one or more genes selected from CP4 epsps, pat, bar, Cry1Ab, Cry1Ac, Cry3Bb1, Cry2Ab, Cry1F, Cry34Ab1 and Cry35Ab1.

In a more preferred embodiment, the present invention relates of methods of controlling harmful insects and/or increasing the health of plants by treating cultivated plants, parts of such plants or at their locus of growth with compounds of formula I or their mixtures, wherein the mixing partner of the compound of formula I compound is endosulfan and the plant expresses one or more genes selected from CP4 epsps, pat, bar, Cry1Ab, Cry1Ac, Cry3Bb1, Cry2Ab, Cry1F, Cry34Ab1 and Cry35Ab1.

In a more preferred embodiment, the present invention relates of methods of controlling harmful insects and/or increasing the health of plants by treating cultivated plants, parts of such plants or at their locus of growth with compounds of formula I or their mixtures, wherein the mixing partner of the compound of formula I compound is ethiprole and the plant expresses one or more genes selected from CP4 epsps, pat, bar, Cry1Ab, Cry1Ac, Cry3Bb1, Cry2Ab, Cry1F, Cry34Ab1 and Cry35Ab1.

In a more preferred embodiment, the present invention relates of methods of controlling harmful insects and/or increasing the health of plants by treating cultivated plants, parts of such plants or at their locus of growth with compounds of formula I or their mixtures, wherein the mixing partner of the compound of formula I compound is fipronil and the plant expresses one or more genes selected from CP4 epsps, pat, bar, Cry1Ab, Cry1Ac, Cry3Bb1, Cry2Ab, Cry1F, Cry34Ab1 and Cry35Ab1.

Further preferred embodiments of the invention are those methods of controlling harmful insects and/or increasing the health of plants by treating cultivated plants, parts of such plants or at their locus of growth with compounds of formula I or their mixtures, wherein the plant corresponds to a row of table 14.

In a more preferred embodiment, the present invention relates of methods of controlling harmful insects and/or increasing the health of plants by treating cultivated plants, parts of such plants or at their locus of growth with compounds of formula I or their mixtures, wherein the plant is selected from the plants listed in table C and the mixing partner of the compound of formula I compound is endosulfan.

In a more preferred embodiment, the present invention relates of methods of controlling harmful insects and/or increasing the health of plants by treating cultivated plants, parts of such plants or at their locus of growth with compounds of formula I or their mixtures, wherein the plant is selected from the plants listed in table C and the mixing partner of the compound of formula I compound is ethiprole.

In a more preferred embodiment, the present invention relates of methods of controlling harmful insects and/or increasing the health of plants by treating cultivated plants, parts of such plants or at their locus of growth with compounds of formula I or their mixtures, wherein the plant is selected from the plants listed in table C and the mixing partner of the compound of formula I compound is fipronil.

All embodiments of the mixing partner of the compound of formula I as defined above are also referred to herein after as compounds of formula I and their mixtures according to the present invention. They can also be converted into agrochemical compositions comprising a solvent or solid carrier and at least one compound of formula (I) and their mixing partner according to the present invention.

An agrochemical composition comprises an insecticidal and/or plant health effective amount of compounds of formula I or their mixtures according to the present invention. The term “effective amount” denotes an amount of the composition of the compound of formula I and optionally a mixing partner according to the present invention, which is sufficient to achieve the synergistic effects related to fungal control and/or plant health and which does not result in a substantial damage to the treated plants. Such an amount can vary in a broad range and is dependent on various factors, such as the fungal species to be controlled, the treated cultivated plant or material, the climatic conditions.

Examples of agrochemical compositions are solutions, emulsions, suspensions, dusts, powders, pastes and granules. The composition type depends on the particular intended purpose; in each case, it should ensure a fine and uniform distribution of the compound according to the invention.

More precise examples for composition types are suspensions (SC, OD, FS), pastes, pastilles, wettable powders or dusts (WP, SP, SS, WS, DP, DS) or granules (GR, FG, GG, MG), which can be water-soluble or wettable, as well as gel formulations for the treatment of plant propagation materials such as seeds (GF). Usually the composition types (e. g. SC, OD, FS, WG, SG, WP, SP, SS, WS, GF) are employed diluted. Composition types such as DP, DS, GR, FG, GG and MG are usually used undiluted.

The compositions are prepared in a known manner (cf. U.S. Pat. No. 3,060,084, EP-A 707 445 (for liquid concentrates), Browning: “Agglomeration”, Chemical Engineering, Dec. 4, 1967, 147-48, Perry's Chemical Engineer's Handbook, 4th Ed., McGraw-Hill, New York, 1963, S. 8-57 and WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman: Weed Control as a Science (J. Wiley & Sons, New York, 1961), Hance et al.: Weed Control Handbook (8th Ed., Blackwell Scientific, Oxford, 1989) and Mollet, H. and Grubemann, A.: Formulation technology (Wiley VCH Verlag, Weinheim, 2001).

The agrochemical compositions may also comprise auxiliaries which are customary in agrochemical compositions. The auxiliaries used depend on the particular application form and active substance, respectively.

Examples for suitable auxiliaries are solvents, solid carriers, dispersants or emulsifiers (such as further solubilizers, protective colloids, surfactants and adhesion agents), organic and anorganic thickeners, bactericides, anti-freezing agents, anti-foaming agents, if appropriate colorants and tackifiers or binders (e. g. for seed treatment formulations).

Suitable solvents are water, organic solvents such as mineral oil fractions of medium to high boiling point, such as kerosene or diesel oil, furthermore coal tar oils and oils of vegetable or animal origin, aliphatic, cyclic and aromatic hydrocarbons, e. g. toluene, xylene, paraffin, tetrahydronaphthalene, alkylated naphthalenes or their derivatives, alcohols such as methanol, ethanol, propanol, butanol and cyclohexanol, glycols, ketones such as cyclohexanone and gammabutyrolactone, fatty acid dimethylamides, fatty acids and fatty acid esters and strongly polar solvents, e. g. amines such as N-methylpyrrolidone.

Solid carriers are mineral earths such as silicates, silica gels, talc, kaolins, limestone, lime, chalk, bole, loess, clays, dolomite, diatomaceous earth, calcium sulfate, magnesium sulfate, magnesium oxide, ground synthetic materials, fertilizers, such as, e. g., ammonium sulfate, ammonium phosphate, ammonium nitrate, ureas and products of vegetable origin, such as cereal meal, tree bark meal, wood meal and nutshell meal, cellulose powders and other solid carriers.

Suitable surfactants (adjuvants, wtters, tackifiers, dispersants or emulsifiers) are alkali metal, alkaline earth metal and ammonium salts of aromatic sulfonic acids, such as ligninsoulfonic acid (Borresperse® types, Borregard, Norway) phenolsulfonic acid, naphthalenesulfonic acid (Morwet® types, Akzo Nobel, U.S.A.), dibutylnaphthalene-sulfonic acid (Nekal® types, BASF, Germany), and fatty acids, alkylsulfonates, alkylarylsulfonates, alkyl sulfates, laurylether sulfates, fatty alcohol sulfates and sulfated hexa-, hepta- and octadecanolates, sulfated fatty alcohol glycol ethers, furthermore condensates of naphthalene or of naphthalenesulfonic acid with phenol and formaldehyde, polyoxy-ethylene octylphenyl ether, ethoxylated isooctylphenol, octylphenol, nonylphenol, alkylphenyl polyglycol ethers, tributylphenyl polyglycol ether, tristearylphenyl polyglycol ether, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and proteins, denatured proteins, polysaccharides (e. g. methylcellulose), hydrophobically modified starches, polyvinyl alcohols (Mowiol® types, Clariant, Switzerland), polycarboxylates (Sokolan® types, BASF, Germany), polyalkoxylates, polyvinylamines (Lupasol® types, BASF, Germany), polyvinylpyrrolidone and the copolymers thereof.

Examples for thickeners (i. e. compounds that impart a modified flowability to compositions, i. e. high viscosity under static conditions and low viscosity during agitation) are polysaccharides and organic and anorganic clays such as Xanthan gum (Kelzan®, CP Kelco, U.S.A.), Rhodopol® 23 (Rhodia, France), Veegum® (R.T. Vanderbilt, U.S.A.) or Attaclay® (Engelhard Corp., NJ, USA). Bactericides may be added for preservation and stabilization of the composition. Examples for suitable bactericides are those based on dichlorophene and benzylalcohol hemi formal (Proxel® from ICI or Acticide® RS from Thor Chemie and Kathon® MK from Rohm & Haas) and isothiazolinone derivatives such as alkylisothiazolinones and benzisothiazolinones (Acticide® MBS from Thor Chemie).

Examples for suitable anti-freezing agents are ethylene glycol, propylene glycol, urea and glycerin.

Examples for anti-foaming agents are silicone emulsions (such as e. g. Silikon® SRE, Wacker, Germany or Rhodorsil®, Rhodia, France), long chain alcohols, fatty acids, salts of fatty acids, fluoroorganic compounds and mixtures thereof.

Suitable colorants are pigments of low water solubility and water-soluble dyes. Examples to be mentioned and the designations rhodamin B, C. I. pigment red 112, C. I. solvent red 1, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108. Examples for tackifiers or binders are polyvinylpyrrolidons, polyvinylacetates, polyvinyl alcohols and cellulose ethers (Tylose®, Shin-Etsu, Japan).

Powders, materials for spreading and dusts can be prepared by mixing or concomitantly grinding the compounds I and, if appropriate, further active substances, with at least one solid carrier.

Granules, e. g. coated granules, impregnated granules and homogenous granules, can be prepared by binding the active substances to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, e. g., ammonium sulfate, ammonium phosphate, ammonium nitrate, ureas and products of vegetable origin, such as cereal meal, tree bark meal, wood meal and nutshell meal, cellulose powders and other solid carriers.

Examples for composition types are:

1. Composition Types for Dilution with Water

i) Water-Soluble Concentrates (SL, LS)

10 parts by weight of compounds of formula I or their mixtures according to the present invention are dissolved in 90 parts by weight of water or in a water-soluble solvent. As an alternative, wetting agents or other auxiliaries are added. The active substance dissolves upon dilution with water. In this way, a composition having a content of 10% by weight of active substance is obtained.

ii) Dispersible Concentrates (DC)

20 parts by weight of compounds of formula I or their mixtures according to the present invention are dissolved in 70 parts by weight of cyclohexanone with addition of 10 parts by weight of a dispersant, e. g. polyvinylpyrrolidone. Dilution with water gives a dispersion. The active substance content is 20% by weight.

iii) Emulsifiable Concentrates (EC)

15 parts by weight of compounds of formula I or their mixtures according to the present invention are dissolved in 75 parts by weight of xylene with addition of calcium dodecylbenzenesulfonate and castor oil ethoxylate (in each case 5 parts by weight). Dilution with water gives an emulsion. The composition has an active substance content of 15% by weight.

iv) Emulsions (EW, EO, ES)

25 parts by weight of compounds of formula I or their mixtures according to the present invention are dissolved in 35 parts by weight of xylene with addition of calcium dodecylbenzenesulfonate and castor oil ethoxylate (in each case 5 parts by weight). This mixture is introduced into 30 parts by weight of water by means of an emulsifying machine (Ultraturrax) and made into a homogenous emulsion. Dilution with water gives an emulsion. The composition has an active substance content of 25% by weight.
v) Suspensions (SC, OD, FS)

In an agitated ball mill, 20 parts by weight of compounds of formula I or their mixtures according to the present invention are comminuted with addition of 10 parts by weight of dispersants and wetting agents and 70 parts by weight of water or an organic solvent to give a fine active substance suspension. Dilution with water gives a stable suspension of the active substance. The active substance content in the composition is 20% by weight.
vi) Water-Dispersible Granules and Water-Soluble Granules (WG, SG)

50 parts by weight of compounds of formula I or their mixtures according to the present invention are ground finely with addition of 50 parts by weight of dispersants and wetting agents and prepared as water-dispersible or water-soluble granules by means of technical appliances (e. g. extrusion, spray tower, fluidized bed). Dilution with water gives a stable dispersion or solution of the active substance. The composition has an active substance content of 50% by weight. vii) Water-dispersible powders and water-soluble powders (WP, SP, SS, WS) 75 parts by weight of compounds of formula I or their mixtures according to the present invention are ground in a rotor-stator mill with addition of 25 parts by weight of dispersants, wetting agents and silica gel. Dilution with water gives a stable dispersion or solution of the active substance. The active substance content of the composition is 75% by weight.
viii) Gel (GF)

In an agitated ball mill, 20 parts by weight of compounds of formula I or their mixtures according to the present invention are comminuted with addition of 10 parts by weight of dispersants, 1 part by weight of a gelling agent wetters and 70 parts by weight of water or of an organic solvent to give a fine suspension of the active substance. Dilution with water gives a stable suspension of the active substance, whereby a composition with 20% (w/w) of active substance is obtained.

ix) Microemulsion (ME)

5-20 wt % of a compound I according to the invention are added to 5-30 wt % organic solvent blend (e.g. fatty acid dimethylamide and cyclohexanone), 10-25 wt % surfactant blend (e.g. alkohol ethoxylate and arylphenol ethoxylate), and water up to 100%. This mixture is stirred for 1 h to produce spontaneously a thermodynamically stable microemulsion.

x) Microcapsules (CS)

An oil phase comprising 5-50 wt % of a compound I according to the invention, 0-40 wt % water insoluble organic solvent (e.g. aromatic hydrocarbon), 2-15 wt % acrylic monomers (e.g. methylmethacrylate, methacrylic acid and a di- or triacrylate) are dispersed into an aqueous solution of a protective colloid (e.g. polyvinyl alcohol). Radical polymerization initiated by a radical initiator results in the formation of poly(meth)acrylate microcapsules. Alternatively, an oil phase comprising 5-50 wt % of a compound I according to the invention, 0-40 wt % water insoluble organic solvent (e.g. aromatic hydrocarbon), and an isocyanate monomer (e.g. diphenylmethene-4,4′-diisocyanatae) are dispersed into an aqueous solution of a protective colloid (e.g. polyvinyl alcohol). The addition of a polyamine (e.g. hexamethylenediamine) results in the formation of a polyurea microcapsules. The monomers amount to 1-10 wt %. The wt % relate to the total CS composition.

2. Composition Types to be Applied Undiluted
xi) Dustable Powders (DP, DS)

5 parts by weight of compounds of formula I or their mixtures according to the present invention are ground finely and mixed intimately with 95 parts by weight of finely divided kaolin. This gives a dustable composition having an active substance content of 5% by weight.

xii) Granules (GR, FG, GG, MG)

0.5 parts by weight of compounds of formula I or their mixtures according to the present invention according to the invention is ground finely and associated with 99.5 parts by weight of carriers. Current methods are extrusion, spray-drying or the fluidized bed. This gives granules to be applied undiluted having an active substance content of 0.5% by weight.

xiii) ULV Solutions (UL)

10 parts by weight of compounds of formula I or their mixtures according to the present invention are dissolved in 90 parts by weight of an organic solvent, e. g. xylene. This gives a composition to be applied undiluted having an active substance content of 10% by weight.

The agrochemical compositions generally comprise between 0.01 and 95%, preferably between 0.1 and 90%, most preferably between 0.5 and 90%, by weight of active substance. The active substances are employed in a purity of from 90% to 100%, preferably from 95% to 100% (according to NMR spectrum).

In one embodiment, a suspoconcentration (SC) is preferred for the application in crop protection. In one sub-embodiment thereof, the SC agrochemical composition comprises between 50 to 500 g/L (grams per Litre), or between 100 and 250 g/L, or 100 g/L or 150 g/L or 200 g/L or 250 g/L.

In a further embodiment, the granules according to formulation type xii are especially preferred for the application in rice.

Water-soluble concentrates (LS), flowable concentrates (FS), powders for dry treatment (DS), water-dispersible powders for slurry treatment (WS), water-soluble powders (SS), emulsions (ES) emulsifiable concentrates (EC) and gels (GF) are usually employed for the purposes of treatment of plant propagation materials, particularly seeds. These compositions can be applied to plant propagation materials, particularly seeds, diluted or undiluted. The compositions in question give, after two-to-tenfold dilution, active substance concentrations of from 0.01 to 60% by weight, preferably from 0.1 to 40% by weight, in the ready-to-use preparations. Application can be carried out before or during sowing. Methods for applying or treating agrochemical compounds and compositions thereof, respectively, on to plant propagation material, especially seeds, are known in the art and include dressing, coating, pelleting, dusting, soaking and in-furrow application methods of the propagation material. In a preferred embodiment, the compounds or the compositions thereof, respectively, are applied on to the plant propagation material by a method such that germination is not induced, e. g. by seed dressing, pelleting, coating and dusting.

In a preferred embodiment, a suspension-type (FS) composition is used for seed treatment. Typically, a FS composition may comprise 1-800 g/l of active substance, 1-200 g/I Surfactant, 0 to 200 g/I antifreezing agent, 0 to 400 g/l of binder, 0 to 200 g/l of a pigment and up to 1 liter of a solvent, preferably water.

The compounds of formula I or their mixtures according to the present invention can be used as such or in the form of their compositions, e. g. in the form of directly sprayable solutions, powders, suspensions, dispersions, emulsions, oil dispersions, pastes, dustable products, materials for spreading, or granules, by means of spraying, atomizing, dusting, spreading, brushing, immersing or pouring. The application forms depend entirely on the intended purposes; it is intended to ensure in each case the finest possible distribution of the active substances according to the invention.

Aqueous application forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. Alternatively, it is possible to prepare concentrates composed of active substance, wetter, tackifier, dispersant or emulsifier and, if appropriate, solvent or oil and such concentrates are suitable for dilution with water.

The active substance concentrations in the ready-to-use preparations can be varied within relatively wide ranges. In general, they are from 0.0001 to 10%, preferably from 0.001 to 1% by weight of active substance.

The active substances may also be used successfully in the ultra-low-volume process (ULV), it being possible to apply compositions comprising over 95% by weight of active substance, or even to apply the active substance without additives.

When employed in plant protection, the amounts of active substances applied are, depending on the kind of effect desired, from 0.001 to 2 kg per ha, preferably from 0.001 to 1 kg per ha, more preferably from 0.005 to 0.9 kg per ha, in particular from 0.005 to 0.5 kg per ha.

In treatment of plant propagation materials such as seeds, e. g. by dusting, coating or drenching seed, amounts of active substance of from 0.1 to 1000 g, preferably from 0.1 to 300 g, more preferably from 0.1 to 100 g and most preferably from 0.25 to 100 g, per 100 kilogram of plant propagation material (preferably seed) are generally required.

Various types of oils, wetters, adjuvants, herbicides, fungicides, bactericides, other insecticides and/or pesticides may be added to the active substances or the compositions comprising them, if appropriate not until immediately prior to use (tank mix). These agents can be admixed with the compositions according to the invention in a weight ratio of 1:100 to 100:1, preferably 1:10 to 10:1.

Adjuvants which can be used are in particular organic modified polysiloxanes such as Break Thru S 240®; alcohol alkoxylates such as Atplus 245®, Atplus MBA 1303®, Plurafac LF 300® and Lutensol ON 30®; EO/PO block polymers, e. g. Pluronic RPE 2035® and Genapol B®; alcohol ethoxylates such as Lutensol XP 80®; and dioctyl sulfosuccinate sodium such as Leophen RA®.

The compositions according to the invention can, in the use form as insecticides, also be present together with other active substances, e. g. with herbicides, fungicides, growth regulators or else with fertilizers, as pre-mix or, if appropriate, not until immediately prior to use (tank mix).

In a preferred embodiment of the invention, the inventive mixtures are used for the protection of the plant propagation material, e.g. the seeds and the seedlings' roots and shoots, preferably the seeds.

Seed treatment can be made into the seedbox before planting into the field.

For seed treatment purposes, the weight ration in the binary, ternary and quaternary mixtures of the present invention generally depends from the properties of the compounds of formula I or their mixtures according to the present invention.

Compositions, which are especially useful for seed treatment are e.g.:

A Soluble concentrates (SL, LS)

D Emulsions (EW, EO, ES)

E Suspensions (SC, OD, FS)

F Water-dispersible granules and water-soluble granules (WG, SG)

G Water-dispersible powders and water-soluble powders (WP, SP, WS)

H Gel-Formulations (GF)

I Dustable powders (DP, DS)

These compositions can be applied to plant propagation materials, particularly seeds, diluted or undiluted. These compositions can be applied to plant propagation materials, particularly seeds, diluted or undiluted. The compositions in question give, after two-to-tenfold dilution, active substance concentrations of from 0.01 to 60% by weight, preferably from 0.1 to 40% by weight, in the ready-to-use preparations. Application can be carried out before or during sowing. Methods for applying or treating agrochemical compounds and compositions thereof, respectively, on to plant propagation material, especially seeds, are known in the art and include dressing, coating, pelleting, dusting and soaking application methods of the propagation material (and also in furrow treatment). In a preferred embodiment, the compounds or the compositions thereof, respectively, are applied on to the plant propagation material by a method such that germination is not induced, e. g. by seed dressing, pelleting, coating and dusting.

In the treatment of plant propagation material (preferably seed), the application rates of the inventive mixture are generally for the formulated product (which usually comprises from 10 to 750 g/l of the active(s).

The invention also relates to the propagation products of cultivated plants and especially the seed comprising, that is, coated with and/or containing, compounds of formula I and their mixtures as defined above or a composition containing the mixture of two or more active ingredients or a mixture of two or more compositions each providing one of the active ingredients. The plant propagation material (preferably seed) comprises the inventive mixtures in an amount of from 0.1 g to 10 kg per 100 kg of plant propagation material (preferably seed).

### EXAMPLES

The present invention is now illustrated in further detail by the following examples.

The compounds I of formula I can be accomplished according to standard methods of organic chemistry, e.g. by the methods or working examples described in WO 2007/006670, PCT/EP2012/065650, PCT/EP2012/065651.

The characterization can be done by coupled High Performance Liquid Chromatography/mass spectrometry (HPLC/MS), by NMR or by their melting points.

A group of especially preferred compounds of formula I are compounds of formula IA-1 as listed in table C above.

Method A: Analytical HPLC column: RP-18 column Chromolith Speed ROD from Merck KgaA (Germany). Elution: acetonitrile+0.1% trifluoroacetic acid (TFA)/water+0.1% trifluoroacetic acid (TFA) in a ratio of from 5:95 to 95:5 in 5 minutes at 40° C.

Method B: Analytical UPLC column: Phenomenex Kinetex 1.7 μm XB-C18 100A; 50×2.1 mm; mobile phase: A: water+0.1% trifluoroacetic acid (TFA); B: acetonitrile+0.1% TFA; gradient: 5-100% B in 1.50 minutes; 100% B 0.20 min; flow: 0.8-1.0 mL/min in 1.50 minutes at 60° C.

MS-method: ESI positive.

¹H-NMR. The signals are characterized by chemical shift (ppm) vs. tetramethylsilane, by their multiplicity and by their integral (relative number of hydrogen atoms given). The following abbreviations are used to characterize the multiplicity of the signals: m=multiplett, q=quartett, t=triplett, d=doublet and s=singulett.

### Preparation Examples

log P determinations were performed via capillary electrophorese on a cePro9600™ from CombiSep.

Starting Materials

6,8-dichloro-1H-benzo[d][1,3]oxazine-2,4-dione and 6-chloro-8-methyl-1H-3,1-benzoxazine-2,4-dione were prepared according to WO 2007/43677.

S,S-Diisopropyl-S-aminosulfonium 2,4,6-trimethylphenylsulfonat was prepared according to Y. Tamura et al, Tetrahedron 1975, 31, 3035-3040.

2-(3-Chloropyridin-2-yl)-5-bromo-2H-pyrazole-3-carbonyl chloride was prepared according to WO 2007/24833.

### Preparation Examples P.1 to P.9

### Example P.1

### S,S-Dimethyl sulfinium sulfate

To a solution of sodium methylate (15.76 g of a 30% solution in methanol, 87.54 mmol, 1.100 equiv.) in methanol (60 mL) was added dimethyl sulphide (5.44 g, 6.40 mL, 87.6 mmol, 1.10 equiv.) at −5-0° C. To this mixture was added a pre-cooled solution (−20° C.) of hydroxylamine-O-sulfonic acid (9.00 g, 79.6 mmol) in methanol (60 mL) and the internal temperature was maintained at −5-0° C. After stirring at room temperature overnight, all solids were removed by filtration. The filtrate was concentrated in vacuo and the residue was triturated with acetonitrile (50 mL) to yield the title compound (7.88 g, 39%).

The following compounds were prepared by analogy to example P.1:
S,S-diethyl sulfinium sulfate
S-ethyl-S-isopropyl sulfinium sulfate
S,S-diisopropyl sulfinium sulfate
S,S-bis(2-cyclopropylmethyl) sulfinium sulfate
S,S-bis(2-cyclopropylethyl) sulfinium sulfate
S,S-bis(cyclobutylmethyl) sulfinium sulfate
S,S-bis(cyclopentylmethyl) sulfinium sulfate
S-cyclopropylmethyl-S-ethyl sulfinium sulfate
S-(2-cyclopropylethyl)-S-ethyl sulfinium sulfate
S-(2-cyclopropylethyl)-S-isopropyl sulfinium sulfate
S-(1-cyclopropylethyl)-S-isopropyl sulfinium sulfate
S-cyclobutylmethyl-S-ethyl sulfinium sulfate
S-cyclopentylmethyl-S-ethyl sulfinium sulfate
S-cyclopropylmethyl-S-isopropyl sulfinium sulfate
S-cyclobutylmethyl-S-isopropyl sulfinium sulfate
S-cyclopentylmethyl-S-isopropyl sulfinium sulfate
S,S-di-n-propyl sulfinium sulfate
S-vinyl-S-ethyl sulfinium sulfate

### Example P.2

### 8-Bromo-6-chloro-1H-benzo[d][1,3]oxazine-2,4-dione

To a solution of 2-amino-3-bromo-5-chlorobenzoic acid (10.0 g, 39.9 mmol) in dioxane (170 mL) was added phosgene (20% in toluene, 42.0 mL, 79.9 mmol) over a period of 15 mins. The reaction was stirred at ambient temperature for 48 h and then concentrated in vacuo. The resulting solid was crushed and further dried in vacuo to yield the desired product (12.6 g, 114%) which was used in the subsequent step without further purification.

The following compounds were prepared by analogy to example P.2:
6,8-dichloro-1H-benzo[d][1,3]oxazine-2,4-dione,
6,8-dibromo-1H-benzo[d][1,3]oxazine-2,4-dione,
6-Bromo-8-chloro-1H-benzo[d][1,3]oxazine-2,4-dione,
8-Bromo-6-chloro-1H-benzo[d][1,3]oxazine-2,4-dione,
6-chloro-8-methyl-1H-benzo[d][1,3]oxazine-2,4-dione,
6-bromo-8-methyl-1H-benzo[d][1,3]oxazine-2,4-dione,
6-cyano-8-methyl-1H-benzo[d][1,3]oxazine-2,4-dione,
6-chloro-8-trifluoromethyl-1H-benzo[d][1,3]oxazine-2,4-dione,
8-chloro-6-trifluoromethyl-1H-benzo[d][1,3]oxazine-2,4-dione,
6-bromo-8-trifluoromethyl-1H-benzo[d][1,3]oxazine-2,4-dione,
8-bromo-6-trifluoromethyl-1H-benzo[d][1,3]oxazine-2,4-dione,
8-chloro-6-cyano-1H-benzo[d][1,3]oxazine-2,4-dione,
6-chloro-8-methoxy-1H-benzo[d][1,3]oxazine-2,4-dione,
6-chloro-8-cyclopropyl-1H-benzo[d][1,3]oxazine-2,4-dione,
6-chloro-8-ethyl-1H-benzo[d][1,3]oxazine-2,4-dione,
6-difluoromethoxy-8-methyl-1H-benzo[d][1,3]oxazine-2,4-dione,
6-cyano-8-methoxy-1H-benzo[d][1,3]oxazine-2,4-dione,
6-fluoro-8-methyl-1H-benzo[d][1,3]oxazine-2,4-dione,
6-iodo-8-methyl-1H-benzo[d][1,3]oxazine-2,4-dione,
6-nitro-8-methyl-1H-benzo[d][1,3]oxazine-2,4-dione,
6-(5-chloro-2-thienyl)-8-methyl-1H-benzo[d][1,3]oxazine-2,4-dione,
6-(3-pyrazol-1H-yl)-8-methyl-1H-benzo[d][1,3]oxazine-2,4-dione,
6-(3-isoxazolyl)-8-methyl-1H-benzo[d][1,3]oxazine-2,4-dione,
6-(hydroxyiminomethyl)-8-methyl-1H-benzo[d][1,3]oxazine-2,4-dione,
6-(methoxyiminomethyl)-8-methyl-1H-benzo[d][1,3]oxazine-2,4-dione,
6-(dimethylhydrazonomethyl)-8-methyl-1H-benzo[d][1,3]oxazine-2,4-dione and
6-(2,2,2-trifluoroethylhydrazonomethyl)-8-methyl-1H-benzo[d][1,3]oxazine-2,4-dione.

### Example P.3

### 1-(3-chloro-2-pyridyl)-3-trifluoromethyl-1H-pyrazol

a) 2.71 kg of 1,1,1-trifluoro-4-methoxy-but-3-en-2-one, 2.44 kg of ethanol and 3.10 kg of water were charged into a reaction vessel. 20 ml of concentrated hydrochloric acid and 0.80 kg of hydrazine hydrate were successively added and the mixture was heated to reflux for 4 h. The mixtures was allowed to cool and neutralized by addition of 10% aqueous NaOH to about pH 4-5. Then the mixture was evaporated. Toluene was added and the mixture was again evaporated to yield 2 kg of raw 3-trifluoromethylpyrazole with a purity of >85%.

b) 1.72 kg (10.75 mol) of the raw 3-trifluoromethylpyrazole obtained in step a), 1.75 kg (11.83 mol) of 2,3-dichloropyridine and 4.73 kg of dimethyl formamide were charged to a reaction vessel. 2.97 kg (21.50 mol) of potassium carbonate were added, the mixture was heated to 120° C. with stirring and kept at 120-125° C. for further 3 h. The reaction mixtures was cooled to 25° C. and poured into 20 l of water. The thus obtained mixture was extracted twice with 5 L of tert.-butylmethyl ether. The combined organic phases were washed with 4 l of water and then evaporated to dryness. Toluene was added and the mixture was again evaporated to dryness. Thereby, the 2.7 kg of the title compound was obtained (purity >75% as determined by GC; yield 81.5%). The product can be purified by distillation.

¹H-NMR (400 MHz, CDCl₃): δ [delta]=6.73 (d, 1H), 7.38 (d, 1H), 7.95 (m, 1H), 8.14 (m, 1H), 8.46 (m, 1H).

### Example P.4

### 2-(3-Chloropyridin-2-yl)-5-trifluoromethyl-2H-pyrazole-3-carbonyl chloride

In a reaction vessel equipped with a thermometer, septum, nitrogen inlet and stirring bar, 10.0 g (40.4 mmol) of 1-(3-chloro-2-pyridyl)-3-trifloromethyl-1H-pyrazole were dissolved in 50 ml of dry dimethoxyethane. By means of a syringe, 40.4 ml of a 2 M solution (80.8 mmol, 2.0 equiv.) of isopropyl magnesium chloride in tetrahydrofuran were added dropwise with stirring, while cooling the vessel with an ice bath and keeping the internal temperature at about 5° C. The mixture was stirred for further 2 hours at 5° C. Then the ice-bath was removed and carbon dioxide was bubbled through mixture causing an increase of the temperature up to 28° C. After 10 minutes, the exothermic reaction has ceased, and, the mixture was cooled and all volatiles were removed by evaporation. The residue containing the carboxylate compound I-A was taken up in 50 mL of dichloromethane and one drop of dry DMF was added. To this mixture, 14.41 g (121.2 mmol, 3.0 equiv.) of thionyl chloride were added and heated to reflux for 3 hours. After cooling, the resulting precipitate was removed by filtration and the mother liquid was concentrated in vacuum to obtain 13.0 g of the title compound (purity >85%, yield 100%) which was used in the next step without further purification.

¹H-NMR (400 MHz, CDCl₃): δ[delta]=7.43-7.54 (m, 2H), 7.93 (d, 1H), 8.52 (m, 1H).

### Example P.5

### 2-amino-5-chloro-N-(dimethyl-λ⁴-sulfanylidene)-3-methylbenzamide

To a solution of 6-chloro-8-methyl-1H-3,1-benzoxazine-2,4-dione (3.00 g, 12.8 mmol) in dichloromethane (40 mL) was added dimethyl sulfinium sulfate (2.25 g, 8.93 mmol, 0.70 equiv.) and potassium tert-butylate (1.58 g, 14.0 mmol, 1.10 equiv.) at room temperature. The mixture was stirred for 1.5 h, upon which water was added and the layers were separated. The aqueous layer was extracted with dichloromethane, combined organic layers were dried over sodium sulphate and concentrated in vacuo. The residue was purified by flash-chromatography on silica gel to yield the title compound (2.63 g, 84%).

Characterization by HPLC-MS: 1.855 min, M=245.00.

### Example P.6

### 2-amino-5-chloro-N-(bis-2-methylpropyl-λ⁴-sulfanylidene)-3-methylbenzamide

To a solution of 6-chloro-8-methyl-1H-3,1-benzoxazine-2,4-dione (3.00 g, 12.8 mmol) in dichloromethane (40 mL) was added bis-2-methylpropyl sulfinium sulfate (3.76 g, 8.93 mmol, 0.70 equiv.) and potassium tert-butylate (1.58 g, 14.0 mmol, 1.10 equiv.) at room temperature. The mixture was stirred for 1.5 h, upon which water was added and the layers were separated. The aqueous layer was extracted with dichloromethane, combined organic layers were dried over sodium sulphate and concentrated in vacuo. The residue was purified by flash-chromatography on silica gel to yield the title compound (2.89 g, 69%).

Characterization by ¹H-NMR (400 MHz, DMSO-d₆): δ[delta]=1.04 (m, 12H), 2.06 (s, 3H), 2.96 (m, 2H), 3.01 (m, 2H), 6.62 (br. s, 2H), 7.03 (s, 1H), 7.72 (s, 1H).

### Example P.7

### 2-amino-5-chloro-N-(diethyl-λ⁴-sulfanylidene)-3-methylbenzamide

To a solution of 6-chloro-8-methyl-1H-3,1-benzoxazine-2,4-dione (2 g, 0.01 mol) in anhydrous propylene carbonate (30 mL) was added bis-2-ethyl sulfinium sulfate (2.04 g, 0.01 mol, 0.70 equiv.) and triethyl amine (1.38 mL, 1.0 g g, 0.01 mol, 1.05 equiv.) at room temperature. The mixture was stirred for 4.5 h, and then added dropwise to ice-water. The mixture was extracted with dichloromethane and the combined organic layers were dried over sodium sulphate and concentrated in vacuo. The residue was triturated with ether to yield the title compound (1.43 g, 55%).

Characterization by ¹H-NMR (400 MHz, CDCl₃): δ[delta]=1.39 (t, 6H), 2.13 (s, 3H), 3.02 (q, 4H), 5.95 (br. S, 2H), 7.01 (s, 1H), 7.98 (s, 1H).

### Example P.8

### 2-amino-3,5-dichloro-N-(bis-2-methylpropyl-λ⁴-sulfanylidene)-benzamide

The title compound was prepared by analogy to the method of example P.6

Yield: 60%

Characterization by ¹H-NMR (400 MHz, DMSO-d₆): δ[delta]=1.23 (d, 6H), 1.38 (d, 6H), 3.42 (m, 2H), 7.02 (br. s, 2H), 7.41 (s, 1H), 7.95 (s, 1H).

### Example P.9

### 2-amino-3,5-dibromo-N-(bis-2-methylpropyl-λ⁴-sulfanylidene)-benzamide

The title compound was prepared by analogy to the method of example P.6

Yield: 66%

Characterization by HPLC-MS: 3.409 min, m/z=410.90 (Method A)

### Preparation of the Compounds of Formula IA-1

### Examples 1 to 4

### Example 1

### 2-(3-chloro-2-pyridyl)-N-[2,4-dichloro-6-[(diethyl-λ⁴-sulfanylidene)carbamoyl]phenyl]-5-(trifluoromethyl)pyrazole-3-carboxamide (Compound I-16)

To a suspension of potassium carbonate (8.08 g, 58.5 mmol, 1.50 equiv) and 2-amino-3,5-dichloro-N-(diethyl-λ⁴-sulfanylidene)benzamide (11.43 g, 38.98 mmol) in acetonitrile (100 mL) was added a solution of 2-(3-chloro-2-pyridyl)-5-(trifluoromethyl)pyrazole-3-carbonyl chloride (15.8 g, 43.31 mmol, 1.10 equiv.) in acetonitrile (50 mL) at room temperature. After 6 h at this temperature, the solids were filtered off. The resulting filtrate was washed with water and dried over Na₂SO₄. After filtration, the filtrate was concentrated in vacuum and the resulting solids were crystallized from diisopropyl ether to yield the title compound (19.53 g, 88%).

Characterization by ¹H-NMR (400 MHz, DMSO-d₆):

δ[delta]=1.13 (t, 6H), 2.91 (m, 2H), 3.08 (m, 2H), 7.67 (dd, 1H), 7.77 (s, 2H), 7.89 (s, 1H), 8.22 (d, 1H), 8.51 (d, 1H), 10.73 (s, 1H).

### Example 2

### Synthesis of 2-(3-chloro-2-pyridyl)-N-[2,4-dichloro-6-[(bis-2-propyl-λ⁴-sulfanylidene)carbamoyl]phenyl]-5-(trifluoromethyl)pyrazole-3-carboxamide (Compound (I-26)

To a suspension of potassium carbonate (0.892 g, 6.46 mmol, 1.10 equiv) and 2-amino-3,5-dichloro-N-(bis-2-propyl-λ⁴-sulfanylidene)benzamide (2.05 g, 5.87 mmol) in toluene (30 mL) was added a solution of 2-(3-chloro-2-pyridyl)-5-(trifluoromethyl)pyrazole-3-carbonyl chloride (2.02 g, 5.87 mmol, 1.00 equiv.) in toluene (20 mL) at 60° C. After 45 min at this temperature, the mixture was cooled and water was added. The resulting precipitate was collected by filtration, washed with water and toluene and dried to obtain the title compound (3.07 g, 84%).

Characterization by HPLC-MS: 1.395 min, M=602.1 (Method B)

Characterization by ¹H-NMR (400 MHz, DMSO-d₆):

δ[delta]=1.18 (d, 6H), 1.22 (d, 6H), 3.30 (m, 2H), 7.68 (dd, 1H), 7.75 (m, 2H), 7.81 (s, 1H), 8.21 (d, 1H), 8.54 (d, 1H), 10.76 (s, 1H).

### Example 3

### Synthesis of 2-(3-chloro-2-pyridyl)-N-[2-methyl-4-chloro-6-[(bis-2-propyl-λ⁴-sulfanylidene)carbamoyl]phenyl]-5-(trifluoromethyl)pyrazole-3-carboxamide (Compound I-21)

To a suspension of potassium carbonate (126.01 g, 911.76 mmol, 1.30 equiv) and 2-amino-3-methyl-5-chloro-N-(bis-2-propyl-λ⁴-sulfanylidene)benzamide (211 g, 701 mmol) in dichloromethane (300 mL) was added a solution of 2-(3-chloro-2-pyridyl)-5-(trifluoromethyl)pyrazole-3-carbonyl chloride (256.78 g, 771.49 mmol, 1.10 equiv.) in dichloromethane (200 mL) at room temperature. After 2 h at this temperature, the solids were filtered off. The resulting filtrate was washed with water and dried over Na₂SO₄. After filtration, the filtrate was concentrated in vacuum and the resulting solids were crystallized from diisopropyl ether to yield the title compound (344.2 g, 85%).

Characterization by HPLC-MS: 1.303 min, M=574.3 (Method B)

Characterization by ¹H-NMR (400 MHz, DMSO-d₆): δ[delta]=1.20 (d, 6H), 1.30 (d, 6H), 2.15 (s, 3H), 3.30 (m, 2H), 7.41 (s, 1H), 7.62 (m, 2H), 7.80 (s, 1H), 8.22 (d, 1H), 8.52 (d, 1H), 10.88 (s, 1H).

### Example 4a

### 2-(3-chloro-2-pyridyl)-N-[2-methyl-4-chloro-6-[(diethyl-λ⁴-sulfanylidene)carbamoyl]phenyl]-5-(trifluoromethyl)pyrazole-3-carboxamide (Compound I-11)

To a suspension of potassium carbonate (0.71 g, 10 mmol, 1.3 equiv) and 2-amino-3-methyl-5-chloro-N-(diethyl-λ⁴-sulfanylidene)benzamide (1.42 g, 3.96 mmol) in propylene carbonate (20 mL) was added a solution of 2-(3-chloro-2-pyridyl)-5-(trifluoromethyl)pyrazole-3-carbonyl chloride (1.35 g, 4.35 mmol, 1.10 equiv.) in propylene carbonate (10 mL) at room temperature. After 24 h at this temperature, the mixture was poured onto water and spiked with ethanol under vigorous stirring. The resulting solids were collected by filtration and contained pure title compound (1.57 g, 73%).

Characterization by HPLC-MS: 1.19 min, m/z 546.1 (M+H)⁺; (Method B)

Characterization by ¹H-NMR (500 MHz, DMSO) [delta]: 10.87 (s, 1H), 8.53 (d, 1H), 8.22 (d, 1H), 7.75 (s, 1H), 7.65 (m, 2H), 7.40 (s, 1H), 3.09 (m, 2H), 2.92 (m, 2H) 1.15 (m, 6H).

### Example 4b

### 2-(3-chloro-2-pyridyl)-N-[2-methyl-4-chloro-6-[(diethyl-λ⁴-sulfanylidene)carbamoyl]phenyl]-5-(trifluoromethyl)pyrazole-3-carboxamide (Compound I-11)

To a solution of 2-(3-chloro-2-pyridyl)-5-(trifluoromethyl)pyrazole-3-carbonyl chloride (150 g, 435 mmol) in acetonitrile (900 mL) at room temperature was added potassium carbonate (59 g, 427 mmol). A solution of 2-amino-5-chloro-N-(diethyl-sulfanylidene)-3-methylbenzamide (117 g, 427 mmol) in acetonitrile (100 mL) was added dropwise within 1 hour while maintaining a reaction temperature of 25-28° C. with occasional cooling (slightly exothermic reaction). The mixture was stirred for 16 hours at room temperature. The reaction mixture was then poured on ice-water mixture (5

L) and the pH was adjusted to 7-8 with concentrated HCl. The mixture stirred for an additional 2 hours. The light brown solid was filtered, washed with water and dried under air to give the crude product (229 g).

3 combined batches of crude product (789 g) were suspended in acetonitrile (2.6 L) and dissolved upon heating at 60° C. After 1 hour of stirring at 60° C. the solution was cooled by means of an ice-bath and the thereby formed solid was filtered off. The mother-liquor was concentrated to 300 mL and cooled with ice-bath. Thereby additional solid formed was filtered. The combined solids were washed with cold acetonitrile and dried at 50° C. in a vacuum-oven over night to give the title product (703 g, 89%) as a crystalline white solid.

By the methods described in examples 1 to 4 or analogy thereof, the compounds of formula (IA1) summarized in table C were prepared:

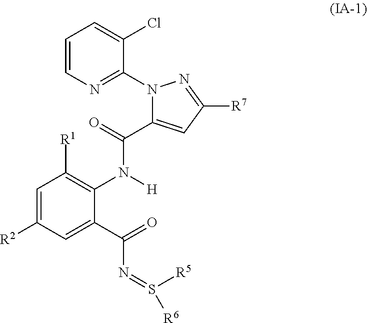

TABLE C

| | | | | | | | RT | |
|---|---|---|---|---|---|---|---|---|
| | R¹ | R² | R⁷ | R⁵ | R⁶ | MS | [min] | m/z |
| I-1 | Me | Cl | CF₃ | CH₃ | CH₃ | logP: 2.9 [pH = | | |
| | | | | | | 10.0]; m.p: 182° C. | | |
| I-2 | Me | Cl | CHF₂ | CH₃ | CH₃ | B | 1.06 | 500.2 |
| I-3 | Me | Cl | Br | CH₃ | CH₃ | A | 3.067 | 529.95 |
| I-4 | Me | Cl | Cl | CH₃ | CH₃ | | | |
| I-5 | Me | Cl | CN | CH₃ | CH₃ | | | |
| I-6 | Cl | Cl | CF₃ | CH₃ | CH₃ | A | 3.372 | 539.95 |
| I-7 | Cl | Cl | CHF₂ | CH₃ | CH₃ | B | 1.062 | 520.2 |
| I-8 | Cl | Cl | Br | CH₃ | CH₃ | A | 3.015 | 549.80 |
| I-9 | Cl | Cl | Cl | CH₃ | CH₃ | | | |
| I-10 | Cl | Cl | CN | CH₃ | CH₃ | | | |
| I-11 | Me | Cl | CF₃ | C₂H₅ | C₂H₅ | B | 1.207 | 546.1 |
| I-12 | Me | Cl | CHF₂ | C₂H₅ | C₂H₅ | B | 1.134 | 528.2 |
| I-13 | Me | Cl | Br | C₂H₅ | C₂H₅ | A | 3.309 | 557.95 |
| I-14 | Me | Cl | Cl | C₂H₅ | C₂H₅ | | | |
| I-15 | Me | Cl | CN | C₂H₅ | C₂H₅ | B | 1.098 | 503.3 |
| I-16 | Cl | Cl | CF₃ | C₂H₅ | C₂H₅ | A | 3.450 | 565.90 |
| I-17 | Cl | Cl | CHF₂ | C₂H₅ | C₂H₅ | B | 1.144 | 549.9 |
| I-18 | Cl | Cl | Br | C₂H₅ | C₂H₅ | | | |
| I-19 | Cl | Cl | Cl | C₂H₅ | C₂H₅ | | | |
| I-20 | Cl | Cl | CN | C₂H₅ | C₂H₅ | B | 1.119 | 524.9 |
| I-21 | Me | Cl | CF₃ | CH(CH₃)₂ | CH(CH₃)₂ | B | 1.303 | 574.3 |
| I-22 | Me | Cl | CHF₂ | CH(CH₃)₂ | CH(CH₃)₂ | B | 1.225 | 556.3 |
| I-23 | Me | Cl | Br | CH(CH₃)₂ | CH(CH₃)₂ | logP: 2.9 [pH = 10.0] | | |
| I-24 | Me | Cl | Cl | CH(CH₃)₂ | CH(CH₃)₂ | | | |
| I-25 | Me | Cl | CN | CH(CH₃)₂ | CH(CH₃)₂ | B | 1.19 | 531.3 |
| I-26 | Cl | Cl | CF₃ | CH(CH₃)₂ | CH(CH₃)₂ | A | 3.835 | 596.05 |
| I-27 | Cl | Cl | CHF₂ | CH(CH₃)₂ | CH(CH₃)₂ | B | 1.24 | 578 |
| I-28 | Cl | Cl | Br | CH(CH₃)₂ | CH(CH₃)₂ | A | 3.538 | 605.80 |
| I-29 | Cl | Cl | Cl | CH(CH₃)₂ | CH(CH₃)₂ | | | |
| I-30 | Cl | Cl | CN | CH(CH₃)₂ | CH(CH₃)₂ | B | 1.209 | 553.1 |
| I-31 | Br | Br | CF₃ | C₂H₅ | C₂H₅ | B | 1.218 | 655.9 |
| I-32 | Br | Br | CHF₂ | C₂H₅ | C₂H₅ | B | 1.171 | 638.1 |
| I-33 | Br | Br | Br | C₂H₅ | C₂H₅ | | | |
| I-34 | Br | Br | Cl | C₂H₅ | C₂H₅ | | | |
| I-35 | Br | Br | CN | C₂H₅ | C₂H₅ | | | |
| I-36 | Br | Br | CF₃ | CH(CH₃)₂ | CH(CH₃)₂ | A | 3.665 | 683.90 |
| I-37 | Br | Br | CHF₂ | CH(CH₃)₂ | CH(CH₃)₂ | B | 1.245 | 666.1 |
| I-38 | Br | Br | Br | CH(CH₃)₂ | CH(CH₃)₂ | | | |
| I-39 | Br | Br | Cl | CH(CH₃)₂ | CH(CH₃)₂ | | | |
| I-40 | Br | Br | CN | CH(CH₃)₂ | CH(CH₃)₂ | | | |

B. Biology

Synergism can be described as an interaction where the combined effect of two or more compounds is greater than the sum of the individual effects of each of the compounds. The presence of a synergistic effect in terms of percent control, between two mixing partners (X and Y) can be calculated using the Colby equation (Colby, S. R., 1967, Calculating Synergistic and Antagonistic Responses in Herbicide Combinations, Weeds, 15, 20-22):

$$E = X + Y - \frac{XY}{100}$$

When the observed combined control effect is greater than the expected combined control effect (E), then the combined effect is synergistic.

The following tests demonstrate the control efficacy of compounds, mixtures or compositions of this invention on specific pests. However, the pest control protection afforded by the compounds, mixtures or compositions is not limited to these species. In certain instances, combinations of a compound of this invention with other invertebrate pest control compounds or agents are found to exhibit synergistic effects against certain important invertebrate pests.

The analysis of synergism or antagonism between the mixtures or compositions was determined using Colby's equation.

B1: Test on GMO Soybeans

Trial was carried out under greenhouse conditions on soybean (Glycine max, variety: BMX Potencia RR, growth stage 109). 12 treatments were compared in a complete randomize blocks (4 replications) with plot size of 1 m×3 meters. Only 7 plants were considered for artificial infestation and evaluations.

Due to glyphosate timing for application on RR-soybeans, all treatments were applied in older plants (GS 109) otherwise a significant phytotoxicity is expected. Application was done, using 400 I/ha. All treatments were applied using a CO₂ backpack (nozzle type TXVK-10). Temperature at the time of applications was 31.8° C. and air humidity was of 55%. Soil condition was R4 (when <75% of surface is dried up) and the moisture was moist (normal).

Premio® (Chlorantraniliprole @200 g/L) was used as standard in the rate of 25 g a.i./ha. Roundup Original® (Glyfosate-sal isopropilamina @360 g/L) was used in the rate of 867 g a.i./ha.

Artificial infestation was done one day after the application. The species used was Anticarsia gemmatalis (Hübner)[Thermesia elegantula (Herrich-Schaffer, 1869)], Noctuidae. 5 plants/plot were infested with 3 larvae (stage L2) using a entomological metallic tweezers, totaling 15 larvae per repetition. All larvae used in this trial were provided by BASF rearing laboratory, Campinas, Brazil.

A second infestation was held seven days after application in the same plants and using the same larval numbers. A third infestation might be done if necessary in order to observe residual activity.

The mortality (number) and eating damage (%) are evaluated with 01, 02, 05, 07, 14 and 21 DAA (days after application), comparing to untreated control plants.

In this test, after 2 days after application, increased mortalities in combination with the application of roundup were observed when compared to the untreated control plants:

| mortality 2 DAA | 6.25 g a.i./ha | 12.5 g a.i./ha | 50 g a.i./ha |
|---|---|---|---|
| compound I-11 solo | 83% | 81% | 87% |
| compound I-11 + | 90% | 87% | 94% |
| 867 g/ha Roundup | | | |

Additionally, in this test, after 5 days after application at 12.5 g a.i./ha a 100% reduction of feeding damage compared to the untreated controls.

In another test, a non-GM soybean variety was treated with 12.5 g a.i./ha and showed a reduction in feeding damage of 97% compared to the untreated controls.

1-20. (canceled)

21. A method for controlling pests and/or increasing plant health of a cultivated plant with at least one modification as compared to the respective non-modified control plant, comprising applying at least one pesticide to a plant with at least one modification, parts of such plant, plant propagation material, or at its locus of growth, wherein the pesticide is a pesticide compound of formula (I): 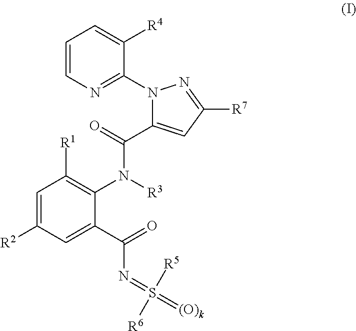
wherein
R¹ is selected from the group consisting of halogen, methyl and halomethyl;
R² is selected from the group consisting of hydrogen, halogen, halomethyl and cyano;
R³ is selected from hydrogen, C₁-C₆ alkyl, C₁-C₆ haloalkyl, C₂-C₆-alkenyl, C₂-C₆-haloalkenyl, C₂-C₆-alkinyl, C₂-C₆-haloalkinyl, C₃-C₈-cycloalkyl, C₃-C₈-halocycloalkyl, C₁-C₄-alkoxy-C₁-C₄-alkyl, C₁-C₄-haloalkoxy-C₁-C₄-alkyl, C(═O)R^{a}, C(═O)OR^{b} and C(═O)NR^{c}R^{d};
R⁴ is hydrogen or halogen;
R⁵, R⁶ are selected independently of one another from the group consisting of hydrogen, C₁-C₁₀-alkyl, C₃-C₈-cycloalkyl, C₂-C₁₀-alkenyl, C₂-C₁₀-alkynyl, wherein the aforementioned aliphatic and cycloaliphatic radicals may be substituted with 1 to 10 substituents R^{e}, and phenyl, which is unsubstituted or carries 1 to 5 substituents R^{f}; or
R⁵ and R⁶ together represent a C₂-C₇-alkylene, C₂-C₇-alkenylene or C₆-C₉-alkynylene chain forming together with the sulfur atom to which they are attached a 3-, 4-, 5-, 6-, 7-, 8-, 9- or 10-membered saturated, partially unsaturated or fully unsaturated ring, wherein 1 to 4 of the CH₂ groups in the C₂-C₇-alkylene chain or 1 to 4 of any of the CH₂ or CH groups in the C₂-C₇-alkenylene chain or 1 to 4 of any of the CH₂ groups in the C₆-C₉-alkynylene chain may be replaced by 1 to 4 groups independently selected from the group consisting of C═O, C═S, O, S, N, NO, SO, SO₂ and NH, and wherein the carbon and/or nitrogen atoms in the C₂-C₇-alkylene, C₂-C₇-alkenylene or C₆-C₉-alkynylene chain may be substituted with 1 to 5 substituents independently selected from the group consisting of halogen, cyano, C₁-C₆-alkyl, C₁-C₆-haloalkyl, C₁-C₆-alkoxy, C₁-C₆-haloalkoxy, C₁-C₆-alkylthio, C₁-C₆-haloalkylthio, C₃-C₈-cycloalkyl, C₃-C₈-halocycloalkyl, C₂-C₆-alkenyl, C₂-C₆-haloalkenyl, C₂-C₆-alkynyl and C₂-C₆-haloalkynyl; said substituents being identical or different from one another if more than one substituent is present;
R⁷ is selected from the group consisting of bromo, chloro, difluoromethyl, trifluoromethyl, nitro, cyano, OCH₃, OCHF₂, OCH₂F, OCH₂CF₃, S(═O)ₙCH₃, and S(═O)ₙCF₃;
R^{a} is selected from the group consisting of C₁-C₆-alkyl, C₂-C₆-alkenyl, C₂-C₆-alkinyl, C₃-C₈-cycloalkyl, C₁-C₆-alkoxy, C₁-C₆-alkylthio, C₁-C₆-alkyl sulfinyl, C₁-C₆-alkylsulfonyl, wherein one or more CH₂ groups of the aforementioned radicals may be replaced by a C═O group, and/or the aliphatic and cycloaliphatic moieties of the aforementioned radicals may be unsubstituted, partially or fully halogenated and/or may carry 1 or 2 substituents selected from C₁-C₄ alkoxy; phenyl, benzyl, pyridyl and phenoxy, wherein the last four radicals may be unsubstituted, partially or fully halogenated and/or carry 1, 2 or 3 substituents selected from C₁-C₆-alkyl, C₁-C₆-haloalkyl, C₁-C₆-alkoxy, C₁-C₆-haloalkoxy, (C₁-C₆-alkoxy)carbonyl, C₁-C₆-alkylamino and di-(C₁-C₆-alkyl)amino,
R^{b} is selected from the group consisting of C₁-C₆-alkyl, C₂-C₆-alkenyl, C₂-C₆-alkinyl, C₃-C₈-cycloalkyl, C₁-C₆-alkoxy, C₁-C₆-alkylthio, C₁-C₆-alkylsulfinyl, C₁-C₆-alkylsulfonyl, wherein one or more CH₂ groups of the aforementioned radicals may be replaced by a C═O group, and/or the aliphatic and cycloaliphatic moieties of the aforementioned radicals may be unsubstituted, partially or fully halogenated and/or may carry 1 or 2 substituents selected from C₁-C₄-alkoxy; phenyl, benzyl, pyridyl and phenoxy, wherein the last four radicals may be unsubstituted, partially or fully halogenated and/or carry 1, 2 or 3 substituents selected from C₁-C₆-alkyl, C₁-C₆-haloalkyl, C₁-C₆-alkoxy, C₁-C₆-haloalkoxy and (C₁-C₆-alkoxy)carbonyl;
R^{c}, R^{d} are, independently from one another and independently of each occurrence, selected from the group consisting of hydrogen, cyano, C₁-C₆-alkyl, C₂-C₆-alkenyl, C₂-C₆-alkinyl, C₃-C₈-cycloalkyl, wherein one or more CH₂ groups of the aforementioned radicals may be replaced by a C═O group, and/or the aliphatic and cycloaliphatic moieties of the aforementioned radicals may be unsubstituted, partially or fully halogenated and/or may carry 1 or 2 radicals selected from C₁-C₄-alkoxy;
C₁-C₆-alkoxy, C₁-C₆-haloalkoxy, C₁-C₆-alkylthio, C₁-C₆-alkylsulfinyl, C₁-C₆-alkylsulfonyl, C₁-C₆-haloalkylthio, phenyl, benzyl, pyridyl and phenoxy, wherein the four last mentioned radicals may be unsubstituted, partially or fully halogenated and/or carry 1, 2 or 3 substituents selected from C₁-C₆-alkyl, C₁-C₆-haloalkyl, C₁-C₆-alkoxy, C₁-C₆ haloalkoxy and (C₁-C₆-alkoxy)carbonyl; or
R^{c} and R^{d}, together with the nitrogen atom to which they are bound, may form a 3-, 4-, 5-, 6- or 7-membered saturated, partially unsaturated or fully unsaturated heterocyclic ring which may additionally contain 1 or 2 further heteroatoms or heteroatom groups selected from N, O, S, NO, SO and SO₂, as ring members, where the heterocyclic ring may optionally be substituted with halogen, C₁-C₄-haloalkyl, C₁-C₄-alkoxy or C₁-C₄-haloalkoxy;
R^{e} is independently selected from the group consisting of halogen, cyano, nitro, —OH, —SH, —SCN, C₁-C₆-alkyl, C₂-C₆-alkenyl, C₂-C₆-alkinyl, C₃-C₈-cycloalkyl, wherein one or more CH₂ groups of the aforementioned radicals may be replaced by a C═O group, and/or the aliphatic and cycloaliphatic moieties of the aforementioned radicals may be unsubstituted, partially or fully halogenated and/or may carry 1 or 2 radicals selected from C₁-C₄ alkoxy;
C₁-C₆-alkoxy, C₁-C₆-haloalkoxy, C₁-C₆-alkylthio, C₁-C₆-alkylsulfinyl, C₁-C₆-alkylsulfonyl, C₁-C₆-haloalkylthio, —OR^{a}, —NR^{c}R^{d}, —S(O)ₙR^{a}, —S(O)ₙNR^{c}R^{d}, —C(═O)R^{a}, —C(═O)NR^{c}R^{d}, —C(═O)OR^{b}, —C(═S)R^{a}, —C(═S)NR^{c}R^{d}, —C(═S)OR^{b}, —C(═S)SR^{b}, —C(═NR^{c})R^{b}, —C(═NR^{c})NR^{c}R^{d}, phenyl, benzyl, pyridyl and phenoxy, wherein the last four radicals may be unsubstituted, partially or fully halogenated and/or carry 1, 2 or 3 substituents selected from C₁-C₆-alkyl, C₁-C₆-haloalkyl, C₁-C₆-alkoxy and C₁-C₆-haloalkoxy; or
two vicinal radicals R^{e} together form a group ═O, ═CH(C₁-C₄-alkyl), ═C(C₁-C₄-alkyl)C₁-C₄-alkyl, ═N(C₁-C₆-alkyl) or ═NO(C₁-C₆-alkyl);
R^{f} is independently selected from the group consisting of halogen, cyano, nitro, —OH, —SH, —SCN, C₁-C₆-alkyl, C₂-C₆-alkenyl, C₂-C₆-alkinyl, C₃-C₈-cycloalkyl, wherein one or more CH₂ groups of the aforementioned radicals may be replaced by a C═O group, and/or the aliphatic and cycloaliphatic moieties of the aforementioned radicals may be unsubstituted, partially or fully halogenated and/or may carry 1 or 2 radicals selected from C₁-C₄ alkoxy;
C₁-C₆-alkoxy, C₁-C₆-haloalkoxy, C₁-C₆-alkylthio, C₁-C₆-alkyl sulfinyl, C₁-C₆-alkylsulfonyl, C₁-C₆-haloalkylthio, —OR^{a}, —NR^{c}R^{d}, —S(O)ₙR^{a}, —S(O)—NR^{c}R^{d}, —C(═O)R^{a}, —C(═O)NR^{c}R^{d}, —C(═O)OR^{b}, —C(═S)R^{a}, —C(═S)NR^{c}R^{d}, —C(═S)OR^{b}, —C(═S)SR^{b}, —C(═NR^{c})R^{b}, and —C(═NR^{e})NR^{c}R^{d};
k is 0 or 1;
n is 0, 1 or 2;
or a stereoisomer, salt, tautomer or N-oxide, or a polymorphic crystalline form, a co-crystal or a solvate of a compound or a stereoisomer, salt, tautomer or N-oxide thereof.

22. The method according to claim 21, comprising applying a mixture of a pesticide of formula I and at least one pesticide II to a plant with at least one modification, parts of such plant, plant propagation material, or at its locus of growth, wherein the pesticide II is an insecticide or a fungicide.

23. Method according to claim 21, in which the compound of formula I is a compound of formula IA: 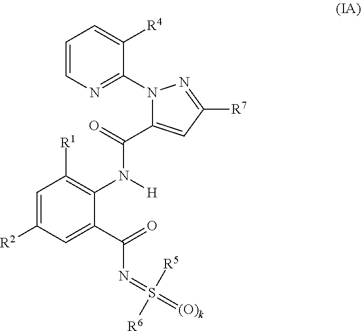
wherein
R⁴ is halogen.

24. Use according to claim 21, in which the compound of formula I is a compound of formula IB: 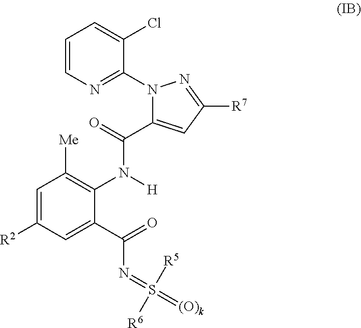
wherein
R² is selected from the group consisting of bromo, chloro, cyano;
R⁷ is selected from the group consisting of bromo, chloro, trifluoromethyl. OCHF₂.

25. Method according to claim 21, in which the compound of formula I is a compound of formula IC: 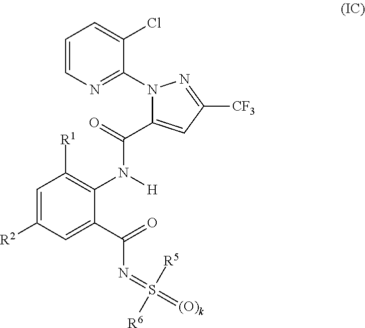
wherein
R¹ is selected from the group consisting of halogen and halomethyl;
R² is selected from the group consisting of bromo, chloro and cyano.

26. Method according to claim 21, in which the compound of formula I is a compound of formula ID: 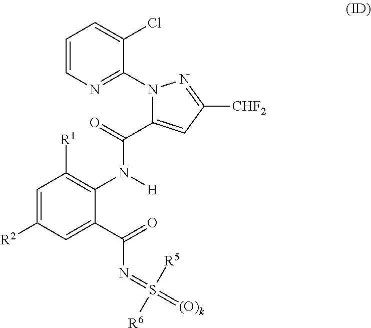
wherein
R¹ is selected from the group consisting of halogen, methyl and halomethyl;
R² is selected from the group consisting of bromo, chloro and cyano.

27. Method according to claim 21, in which in the compound of formula I R⁵ and R⁶ are selected from methyl, ethyl, isopropyl, n-propyl, n-butyl, isobutyl, tert-butyl, cyclopropyl, cyclopropylmethyl.

28. Method according to claim 21, in which in the compound of formula I R⁵ and R⁶ are identical.

29. Method according to claim 21, wherein the yield of a cultivated plant is increased.

30. The method according to claim 21, wherein, wherein the modification of the cultivated plant is selected from the following properties: herbicide tolerance, insect resistance, fungal resistance or viral resistance or bacterial resistance, stress tolerance, maturation alteration, content modification of chemicals present in the cultivated plant, modified nutrient uptake, antibiotic resistance and male sterility compared to the corresponding control plant respectively.

31. The method according to claim 21, wherein the plant is tolerant to the action of herbicides.

32. The method according to claim 21, wherein the plant is tolerant to the action of glyphosate.

33. The method according to claim 21, wherein the plant is tolerant to the action of glufosinate.

34. The method according to claim 21, wherein the plant is tolerant to the action of imidazolinone-herbicides.

35. The method according to claim 21, wherein the plant is tolerant to the action of dicamba.

36. The method according to any of claims 31 to 35, additionally comprising the application of a herbicide, to which the plant is tolerant.

37. The method according to claim 21, wherein the plant is capable of synthesizing at least one selectively acting toxins derived from the bacterial Bacillus spp.

38. The method according to claim 21, wherein the at least one pesticide is applied to the plant propagation material of the cultivated plant.

39. The method according to claim 21, wherein the treatment(s) are carried out by applying at least one pesticide to the cultivated plant, parts of the cultivated plant or to their habitat.

40. Seed of a cultivated plant with at least one modification as compared to the respective non-modified control plant, treated with at least one pesticide as defined in claim 21.
